(19) United States
(12) Patent Application Publication
(10) Pub. No.: US 2012/0176237 A1
(43) Pub. Date: Jul. 12, 2012

(54) HOMELAND INTELLIGENCE SYSTEMS TECHNOLOGY "H-LIST" AND BATTLEFIELD APPARATUS

(76) Inventor: JOSEPH AKWO TABE, Silver Spring, MD (US)

(21) Appl. No.: 13/004,912

(22) Filed: Jan. 12, 2011

(51) Int. Cl. G08B 1/08

(52) U.S. Cl. 340/539.12

(57) ABSTRACT

Homeland Intelligence Systems Technology “H-LIST” and battlefield apparatus comprises nano-sensors embedded in a silicon substrate and etched/fused in a micro-fibered material. The silicon substrate is alloyed with miniaturized steel responsive to weapons, preventing bullet penetration and providing effective detection platform on an outfit. The outfit is operable for monitoring suspicious terrorist activities and for tracking biological and chemical gases, and explosives, including weapons of mass destruction and physiological conditions of personnel. Disclosed embodiments provide wearable detection apparatus comprising plurality sensors on an outfit configured to be worn by military personnel, an officer, a security officer, a bus driver, hostesses, Doctors, civil establishment hospital patients and the like, for protection and for sensing deadly gases, explosives, and physiological conditions in a defined area. A receptor is operatively configured and worn proximate to the outfit responsive to detection signals. The receptor is communicatively connected to the sensors and operable for receiving/analyzing detection signal communications wirelessly indicative of the presence of a sensed agent, whereby detected signals are transported wirelessly to a central security monitoring station, providing communications to first responders. The communications could be reachable to backup security personnel or agents, prompting them to respond to the vicinity of the detection. The sensors are multifunctional and coded to recognize wavelike pattern of gases and explosives traveling through the wave. Embodiments provide the outfit and the receptor being operable to process the portion of the detection signal to determine the detection type and/or whether there is a concealed object by conducting a test in which a first characteristic of a first dielectric constant associated with a person is determined, and a second characteristic of a second dielectric constant associated with the concealed object and or weapons of mass destruction is determined to expedite data transmission and communication to first responders.

This application claims priority benefit from application Ser. No. 11/821,776 filed Jun. 25, 2007 and now U.S. Pat. No. 7,872,575 issued Jan. 18, 2010, which claims priority benefit from application Ser. No. 10/660, 473, filed Sep. 12, 2003 and now U.S. Pat. No. 7,271,720 issued Sep. 18, 2007, which claims priority benefit from Provisional Application Ser. No. 60/426,800, filed Nov. 18, 2002. All of these applications are incorporated herein by reference in their entirety.

### PURPOSE

Disclosed embodiments provide wearable approach to enable mobile detection and monitoring. Terrorist activities today are so globalized and involve strategic positioning that stationary devices cannot keep up with the mobility. Embodiments provide advanced global positioning system configured to guard against terrorist activities and is operable to reveal a mobile and innovative approach to home-land intelligence. Disclosed embodiments provide detection apparatus that is configured to:
1 Provide digital combat on a battlefield.
2 Provide home-land intelligence
3 Advance homeland security technology into randomly patrolled mobile system.
4 Keep airport perimeters and access under secured security control system.
5 Safeguard personnel against bacteria caused by the launching of weapons of mass destruction.
6 Provide revolutionary advanced wearable detection device for civil establishment hospital patients and Doctors.
7 Reduce the hassles involved in airport securities and procedures while also improving and safeguarding the lives of occupants.
8 Monitor battlefield personnel physiological signs, their heart rates, and their respiratory system.
9 Monitor battlefield enemies, their movements, and the location of their weapons.
10 Provide wireless digital network for home-land environment, homeland security and army personnel.
11 Advance technologies that will provide flight attendants with self protection for the safety of aircrafts and their occupants.
12 Improve homeland security standard when defending an assigned area of a building.
13 Improve security standards on transit trains, trucks, buses and the like.
14 Besides barriers or security guards, drivers will safeguard their buses against explosives, chemical or biological agents, and drugs such as narcotics.
15 Nuclear power plants access restriction will be better safeguarded.
16 Improve security standards on power plants such as nuclear power plant and the like.
17 Provide innovative military advanced combat gears.
18 Provide detection of weapons of mass destruction or when a chemical or biological gas has been used in a battlefield and ensure a timely evacuation of the area so affected.
19 Provide detection of anthrax spore, bacterial, fungal spores, and viruses.

### FIELD OF THE INVENTION

Embodiments provide Home-Land Intelligence Systems Technology comprises a revolutionary multipurpose nanotechnology application. The multipurpose nanotechnology application is configured on a detection platform for a wearable outfit operable for detection, protection, and for monitoring of and intervention into monitored environments. Disclosed embodiments consist of nano-sensors embedded in silicon substrate and etched/fused in a micro-fibered material with excellent electrical characteristics to exhibit effective and efficient detection platform on the outfit responsive to various national emergency conditions. Certain embodiments of the disclosure provide a receptor operatively configured for analyzing detection data in communication with the detection platform. Disclosed embodiments provide the receptor being worn proximately close to the outfit and communicatively configured for providing direct communication to a central communication post when detection is enabled. Disclosed embodiments further provide wearable apparatus operable with higher sensitivity and selectivity of current and projected forms of detection of and protection against weapons of mass destruction. Some embodiments provide wearable apparatus for monitoring, and protection against biological and chemical contexts. Certain embodiments provide wearable apparatus configured for facilitating the hyper-sensitive and selective monitoring and control of assigned environments. Disclosed embodiments provide the wearable apparatus comprising outfit that protects the body against body bacteria from weapons of mass destruction. Certain embodiments provide a wearable apparatus that monitors battlefield personnel physiological signs, their heart rates, and their respiratory system. Other embodiments of the disclosure provide the wearable apparatus being configured with the receptor being operable to report all communicative data and detected information to the central security reporting stations or network. Some embodiments provide the stations comprising a network being operable with interactive links in communication with the receptor and other law enforcement networks to enable instant response to anticipatory attack. Disclosed embodiments provide communication apparatus operatively configured to convert sound waves, vibrations, solar energy, and pressure force into electrical energy communicable to a battery cell. Disclosed embodiment encompasses three modes of communications—wireless communications, wireless Internet applications, and Global communication and information.

Disclosed embodiments further provide nanotechnology based outfit being configured for detection and communication. Certain embodiments provide a revolutionary multipurpose wearable outfit application through a detection platform configured for detection, protection, and monitoring of personnel physiological conditions in a hostile environment. The wearable outfit consists of nano-sensors embedded in silicon substrate. Some embodiments provide the silicon substrate being etched/fused in a micro-fibered material having excellent electrical characteristics to provide effective and efficient detection platform being operable for monitoring the physiological conditions, including heart rate, vital signs, and blood pressure. The detection platform further provides detection of the environmental conditions at the vicinity of personnel assignments. Embodiments provide the receptor in communication with the detection platform for analyzing detection data about the personnel's physiological condition and for providing direct communication to a central communication post. The sensitivity and selectivity of detection characteristics are important, thus, embodiments provide current and projected forms of detection of and protection against environment conditions associated with influencing a change in physiological conditions. Some embodiments provide a communication apparatus, broadcasting device, entertainment device, remote control device, a GPS device, medical diagnostics device, emergency communications and alarm apparatus, interactive touch screen device, object controlled communication device, control systems for single and/or multimode communications, tele-informatics device, telemetry device, advanced vehicular computing and battlefield media applications for in-vehicle interactive communications, and wireless Internet applications. Embodiments further provide sensors being embedded in silicon substrate and fused in micro fiber material having excellent electrical characteristics. Certain embodiments provide battlefield communication apparatus including voice enabled applications comprising human voice auditory, signal amplification, better data and graphical transmission. Embodiment provide sensory platform on a screen apparatus comprising a display device configured with touch screen methods comprising graphical user interface operable for determining commands. Disclosed embodiments provide a centralized communication vehicle comprising a platform for advancing battlefield knowledge, includes social network for enabling, battlefield personnel to talk to each other seamlessly in real time through the centralized system. Certain embodiments provide an engine for extracting battlefield topics of information from a centralized database having information relating to different battlefield conditions. Some embodiments provide the engine comprising a computer apparatus configured for enabling communication with different systems and responsive to different platforms. Other embodiments provide a communication apparatus in communication with a centralized searchable vehicle operable for enabling searches for topics of information relating specifically to battlefield topics and for knowledge sharing, and to aid file sharing for mining terrorist data within a centralized database.

Disclosed embodiments provide a wearable outfit relating to battlefield and hospital events. The outfit is configured with silicon-microfiber/nano-fiber comprising nano-sensors configured for monitoring continuous physiological conditions, including body temperature and personnel physical locations such as may be derived from at least an incidental collision with an enemy personnel in a battlefield environment. Disclosed embodiments consist of nano-sensors embedded in silicon substrate and etched/fused in a micro-fibered material with excellent electrical characteristics to exhibit effective and efficient detection platform responsive to various battlefield logistics influential to combat operations and medical emergency conditions.

### BACKGROUND OF THE INVENTION

In a battlefield environment, constantly military personnel are subjected to routing hits where body parts under-go severe stresses and strains. Regularly, these military personnel sustain severe injuries that are live threatening and sometimes some military personnel are paralyzed either by ground battle or due to vehicular accidents. These military personnel, in fear of their life sometimes will continue fighting without the slightest idea about the severity of their injuries. Additionally, some battlefield has become so suicidal that monitoring the physical and physiological condition of a person during war time is eminent. Disclosed embodiments provide a force responsive wearable detection outfit operable for detecting weapons of mass destructions and for communicating detection characteristics wirelessly to a computer device at the command post to expedite the safety and security of personnel. Regularly personnel are reminded of the dangers imposed from exercising and/or fighting in severe battlefield environment. Though well trained military personnel and military recruits sometimes are afflicted with bullet illnesses and deaths with predictable regularities, still the bullets incidence occur in high profile deaths and the deaths may continue to occur as the battle continues. Therefore, without the use of a force responsive wearable detection outfit that comprises nano-sensors configured for continuous monitoring of battlefield logistics, including vehicular collisions, tire explosion, tire problems, personnel physiological condition and body temperature monitoring, battlefield personnel would be more susceptible to further injuries. Disclosed embodiments further provide a detection platform on a wearable outfit configured with MEMS load cells embedded with strain gauges operable for monitoring the degree of force impacted on military personnel during a hit or collision in a battlefield environment, including any war environment wherein a personnel is likely susceptible to illnesses in which the environment is subjected to.

Prior art teachings of biological, chemical, and explosive detection devices have been developed and mounted on fixed positions to perform assigned tasks, such as locating explosive devices through sensors at the gateway of airports, or doorway of government buildings. Still, some undetected explosives have been used to blow off planes and buses because somehow, the prior art devices failed to detect the explosives at the time they were un-wrapped from their carefully sealed plastics. Other detection devices are so disturbing when used within portable environment, including around the airport and government buildings operable to detect weapons of mass destruction on one's body. More so, terrorist groups are expanding the act of suicide bombing through technologies, which are strategically planned for and carried on the public streets, public transportations, recreational environments, or outside some government buildings. With the suicide bombers strategic selection of key targets and location to perform such deadly acts, current detection systems have no way of sensing that a parked car with explosives and the like, is in front of any of these locations waiting to be detonated.

In view of the statistical reports about tire failure type battlefield accident such as low air pressure and/or high tire temperature and their effects on rollovers and flip-over, prior art devices have failed to keep tracks of the characteristics that affect tire air pressure for military vehicles. These characteristics include temperature effects on tire failures and how these affect tire pressure, tire design, and tire life. VIEW A PSI is configured for monitoring contextual characteristics that affect pressure change and operable for retrieval of relevant detection information on tires. Statistics have proven that failed tires such as un-balanced tire pressure or tire alignment have cost many battlefield deaths and accidents. Disclosed embodiments further provide apparatus for monitoring contextual characteristics that are influential to tire pressure change and for keeping track of all the possible characteristics that enable tire failure. Disclosed embodiments provide VIEW A PSI, further configured for providing audiovisual communication. VIEW A PSI further comprises electronic control module responsive to the database information collected from tires. Certain embodiments provide the electronic control module further configured for providing audiovisual communication to the operator of the vehicle.

Disclosed embodiments provide VIEW A PSI comprising apparatus for detecting fault and for monitoring contextual characteristics influential to pressure change within a closed system. Certain disclosed embodiments are directly linked to characteristics that affect change in tire air pressure. Some embodiments provide VIEW A PSI comprising embedded sensors configured for generating valuable contextual tire information such as tire temperature, tire pressure, rim corrosion, valve stem contamination, and pressure balance on all wheels and enabling audio visual communication thereon. Disclosed embodiments provide materials, sensors being configured on a wearable platform in communication with a communication apparatus for processing detection data of personnel's physiological conditions. Certain embodiments provide the detection data being analyzed and networked as conceptualized within the homeland security. Some embodiments provide the communication apparatus being operable through control functions in communication with the detection platform. Disclosed embodiments provide the communication apparatus comprising a receptor configuration, being operable to provide real time communication. Certain embodiments provide the detection platform comprising wearable outfit operable for outfitting personnel so that a consistent network to physiological detection and communication is ascertained, including individual activities of the personnel, which may require them to plug-in their bodies into hostile environment.

Disclosed embodiments further provide a communication apparatus being operable for communicating not only the detection data, but also any detected body information and behaviors of personnel being monitored according to their medical emergence. At least an antenna apparatus is provided comprising CMOS” digital circuitry design, and include microprocessors operable on integrated circuits (chips). Certain embodiments provide antenna method with CMOS circuitry being operable to dissipate less power when static. Embodiments provide antenna apparatus with CMOS processes and variants. Disclosed embodiments provide CMOS circuit that allows the implementation logic gates through p-type and n-type metal oxide semiconductor field effect transistors to create paths to the output from either the voltage source or ground. When a path to output is created from the voltage source, the circuit is pulled up. The other circuit state occurs when a path to output is created from ground and the output pulled down to the ground potential. Disclosed embodiments provide software in communication with the logic circuit being configured for analyzing signal strength and data speed. The chip is a solution which depends on cell phone antenna configuration operable on CDMA, TDMB, Digital/Analog/GSM, and location area network. Disclosed embodiments provide a communication apparatus operable for better communication clarity, data transmission, downloadable data, and to electronically send mails.

Prior art devices for homeland security detection thrive upon the formation of different devices such as stationary detection devices. These stationary devices are nowhere more apparent than emergent nanotechnologies with embedded nano-sensors approach for providing detection of personnel physiological conditions. Disclosed embodiments provide silicon-micro-fiber approaches to nanotechnology applications in homeland intelligence as the future of invasive technological approach to detection, protection, and monitoring of, and the intervention of threat to personnel. Certain embodiments of the disclosure provide a wearable detection platform configured with threat functions for applications in any environment in which failure to detect could lead to a dominant disaster in that nation, the military, and the civil medical environment.

Some prior art devices focuses only on signal interception, but have no way of detecting explosives that are in a parked car, or on the body of a person entering a bus. Other prior art devices have failed to detect explosives on the body of a person who carefully sealed such device and successfully finds his way inside an air plane. Yet, prior art devices have failed to detect explosives already used within an environment and contain deadly gases. Moreover, some deadly gas applications on a battle field are not visible after being lunched, including a chemical or biological weapon. Prior art devices would not detect explosive that has successfully gotten inside a stadium on a super bowl game and just waiting to be detonated. Disclosed embodiments provide detection method that advances the intelligence of homeland security. Certain embodiments of the disclosure provide a portable detection apparatus that provide mobile detection of explosives and deadly gases in a person's body, or inside a parked car on the street. Applicant acknowledges that besides fixed or stationed detection machines, homeland security can intelligently be operable to protect its environment if the detection devices are mobile, have wireless means to communicate, and can be self carried by security officers.

Applicant also acknowledges that for the detection device to be self carried and used intelligently, it has to be worn by the security officers at the vicinity of the protective area. Disclosed embodiments provide a wearable detection apparatus comprising an outfit configured for security officers. With disclosed embodiments, a security officer is sure to patrol an assigned area randomly with the device in his body and alarming thereof if a weapon is detected. Certain embodiments provide advanced methods of approaching homeland security and the monitoring of our nation. Disclosed embodiments provide biosensors comprising chemical sensors with high selectivity and sensitivity. Some embodiments provide the biosensors comprising of biologically active material. Certain embodiments provide an oscillating piezoelectric crystal in conjunction with nano-sensors being embedded in a detection platform configured for an outfit operable for detections. The detection platform is configured to detect an environment which is affected by the change in mass being sensed on the surface of the crystal due to the resonant frequency on the sensing materials. Some embodiment provide the sensing material being made of non-ferrous material such as silver and or gold to provide ideal biosensor layer for detection of any liquid, solid. Disclosed embodiments provide gaseous phase explosive detection being operable in their mobile environment. The change in mass occurs when the frequency changes as a result of the environmental condition. The change in mass is measured by a piezoelectric immunosensors in communication with a receptor. The potential application of this technology includes civil establishment hospitals, law enforcement agencies, industrial applications, security agencies, Homeland security, Military, postal services, transportation and transit authorities, airports and aviation environment. Certain embodiments provide a revolutionary approach to detections, comprises nanotechnology applications consisting of nano-sensors being configured for bringing signals that contain chemical targets into contact with the detection platform, allowing chemical targets to be bound to discrete region of the various sensor means.

The receptor is operable for eying these biochemical sensors, comprises analytical tool that consists of biologically active materials such as surface resonance spectroscope communication with devices disclosed embodiments being operable to convert biochemical signal into quantifiable electrical signal. Disclosed embodiments further provide devices being operable for communication. Certain embodiments provide a communication apparatus being operable for communicating detected information. Detection is being provided through the electrical signals or pulses. These electrical signals or pulses are signal communications traveling between the detection platform and the receptor. The detection signals are transported wirelessly through waves, including radio waves and/or microwaves, to the central security monitoring stations. Prior art devices are not wearable, and disclosed embodiment is a wearable outfit that include camouflage outfit configured with sensors for detection of weapons of mass destructions. Furthermore, prior art devices are limited in their zones and have no way of extending sensitivity to detecting explosives in a parked car. Disclosed embodiments provide a detection platform on a wearable outfit configured for protective sensing, and is not limited to analytical techniques of detecting, polluting, water and microbial contamination analyses, industrial gases and liquids, mining and toxic gases, explosives and military arena; but extends to protecting the airports, transport planes, government buildings, tunnels, city malls, recreational areas, battle field personnel, common buildings and the like. Certain embodiments provide biochemical sensor, including at least one of:
(a) A receptor: responsible for the selectivity/sensitivity of a sensor to transform chemical or biological information into energy form which is measured by a transducer. The receptor part is based on physical, chemical, or biochemical principles and functions like an analyzer, sampling responses and transporting said responses through processed signals as a function of time, e.g. enzymes, antibodies, and liquid layers.
(b) A detector: like a transducer, responsible for translating the physical or chemical change by recognizing the analyte and relaying it through electrical signals to a receptor, e.g. pH can be a pH-electrode, an oxygen electrode, or a piezoelectric crystal to measure the target analyte without using reagents.
(c) Transducer: responsible for transforming chemical or biological energy into useful analytical signal.
(d) Electrochemical sensor: responsible for transforming the effect of the electrochemical interaction analyte electrode into useful signal.
(e) Electrical chemical sensor: responsible for measuring the change in electrical properties caused by the interaction of the analyte.
(f) Thermometric chemical sensors: responsible for measuring the heat effects of a specific chemical reaction or absorption which is involved in an analyte
(g) Optical chemical sensor: responsible for transforming changes of optical phenomena as a result of an interaction of the analyte with the receptor part.
(h) Magnetic chemical sensors: responsible for the change of paramagnetic properties of the gas being analyzed.
(i) Mass sensitive sensor: responsible for transforming the mass change at a specially modified surface into a change of a property of the support material. The mass change is caused by absorption of mass of the analyte at the oscillator.
(j) Photo-ionization detector: detects unknown organic gases and vapors and also determines their concentration level.
(k) APD 2000: detects the presence and relative concentrations of military chemical agents, e.g. sarin, mustard gases, cesium
(l) Bioassay strips: determines the presence of some biological agents and send results to an optical reader in the receptor to evaluate the test strip.
(m) RFID chip, a nano-structured processor for detection of weapons of mass destruction, detection of functional inability of personnel, and also for wirelessly networking with stations or fiber towers.

Applicant acknowledges that the design of the detection platform within the outfit may include at least one of the five design techniques:
1 Piezoelectric thin film coating through pattern recognition technique.
2 Cantilever beam deflection technique.
3 Piezoelectric AIN Thin films sensors
4 Infrared reflectometry technique
5 Micro electro-mechanical system with RFD chip.

The advancement of the detection outfit in H-LIST provides biological sensing elements which would selectively recognize a particular biological molecule through a reaction specific adsorption, or other physical or chemical processes. The detection platform is configured for allowing the transducers to convert the result of its recognition into a usable signal, which can be quantified and amplified. Disclosed embodiments provide a transducer operable for detection analysis consist of at least one of: optical, electro-optical, or electrochemical devices configured for plurality sensing opportunities. Some embodiments provide biosensors operable for specific applications such as Homeland Intelligence Systems Technology “H-LIST.” A typical detector such as a transducer will translate physical or chemical change within an area by recognizing an analyte and relaying its analysis through signal communication from the wired/wireless connections with the embedded sensors disposed in the detection platform. The detection platform is in signal communication with the receptor in communication with centralized stations. Disclosed embodiments further provide apparatus for processing biological or chemical gases, and involves binding of chemical species with another chemical species, which has a complementary structure. H-LIST provides two classes that have the bio-recognition processes for detection. These classes are bio-affinity recognition and bio-metabolic recognition and offer different methods of detection. Bio-affinity recognition has stronger binding and enables the transducer to detect the presence of the bound receptor-analyte pair and provide communication thereof. However, with the receptor-ligand and antibody-antigen bind, the processes are common to the detection environment.

Disclosed embodiments further provide detection apparatus comprising of pattern recognition technique and operable for different recognition, such as metabolic recognition, where the analyte and other co-reactants are chemically altered to form the product molecules and providing communication thereof. The biomaterials that can be recognized by the bio-recognition elements are as varied as the different reactants that occur in biological system's detection in which analyte molecule will have a complementary structure to the antibody while the bound pair will be in a lower energy state than the two separate molecules, making it very difficult to break. Disclosed embodiments provide interaction between antibodies with corresponding antigen, including an antibody based chemical and biosensors like immunosensors. When antibody is raised against an analyte, an immunosensors would enable its recognition. The specificity and affinity of antibodies towards complementary ligand molecules would prevent most antibody antigen interactions from causing any electronically measurable change. However, a piezoelectric effect in various crystalline substances would allow detection of analyte within that vicinity.

Disclosed embodiments provide piezoelectric immunosensors operable to detect antigens both in gaseous phase and liquid phase. Certain embodiments provide Piezoelectric being operable to detect micro-bacteria antigen in biological fluids and is incorporated in the design of H-LIST, a wearable and portable device for providing detection of gases and explosives in any environment. Devices to detect weapons of mass destruction have been previously used in the art but all failed to teach a portable and wireless system with sensors wired in an outfit for detection and communication. Example of such device is described in U.S. Pat. No. 4,866,439 and discloses an explosive detection system for aircrafts to deter terrorist activities. This system fails to show a portable and mobile system needed for homeland security. U.S. Pat. No. 5,465,607 teaches an explosive detection screening system for detection of explosives and other controlled substances. This system shows detection of relatively volatile and non-volatile vapors and particulates but did not teach a wired outfit detection device. U.S. Pat. No. 3,718,918 teaches detection of nuclear explosion through radiated transient radio frequency signal and still fails in its teaching to show a wired outfit system that enables communication to at least a network when detection is eminent.

U.S. Pat. No. 6,573,107 teaches immunochemical detection of explosive substance in the gas phase through surface Plasmon resonance spectroscopy. Still, the system fails to teach a portable, mobile and communicative system wired in an outfit to enable network interface. U.S. Pat. No. 6,569,630 teaches a method and composition for aptamers against anthrax. This system relates to detection of biological agents using different compositions and still fails in its entirety to teach a wired outfit for biological and chemical agent detection in their mobile environment. All the above references cited, whether taken in singularly or in any combination, failed to teach a wired outfit design for detection of weapons of mass destruction in anticipation of terrorism.

### SUMMARY OF THE INVENTION

Disclosed embodiments provide a wearable detector crystal in alpha quartz, which is suitable for piezoelectric applications in the silicon-micro-fibered material comprising embedded sensors for detections. The crystal in alpha quartz is insoluble in water and has better resistance to high temperatures and electrical properties. Disclosed embodiments provide apparatus operable for the transformation of electronic detection system in homeland security. The resonant frequency of the quartz crystal depends on the physical dimension of the quartz plate and the thickness of the electrode deposited. These crystals are in the form of a disc, square, or rectangle in their design. The piezoelectric quartz crystal is driven by a low frequency transistor oscillator in the receptor and is powered by a direct current regulator power supply. Certain embodiments provide the crystal being mounted on a holder with a stainless steel with leads embedded inside the silicon and etched on the micro-fibered material. The receptor oscillator circuit is configured with frequency counter connected to the oscillator device of the receptor. Some embodiments provide silver composite communicatively connected to the electrode, enabling the crystal electrodes to be modified with a 5 ml coating of protein A, and providing better adhesion of the antibodies to the surface of the transducer. Embodiments provide Protein A, which is a polypeptide isolated from staphylococcus aureus to bind specifically to the immunoglobulin molecules for sensor sensitivity and selectivity for trained specific recognition.

Furthermore, Homeland security involves some personnel casting their bodies in environments that require invasive monitoring. These environments are sometimes affected with chemical and/or biological agents and sometimes are exposed to temperature conditions that are harmful to the personnel and can limit their focus and concentrations. Disclosed embodiments provide methods to improve vast information network for personnel who throw their bodies on hostile environments. Certain embodiments provide wearable apparatus to monitor personnel's physiological conditions and provide direct communication to a command/communication post.

The incorporation of silicon substrate in the configuration of a detection platform would enable the outfit to exhibit some contraction and expansion at key sections of the body, while the electrical characteristics of the micro-fibered material would advance detection sensitivity and selectivity. The detection platform would comprise of the silicon substrate, the micro-fibered material, and plurality nano-sensors each configured for specific detection, such that the physiological condition of personnel are monitored and various detection data are communicated to the command/communication post.

Disclosed embodiments provide wearable outfit configured with contracting characteristics at key points of the body. Certain embodiments provide apparatus configured to reveal data about the personnel assigned in hostile environments. Additionally, if the personnel's condition was initiated by a fall in which broken body parts were detected, the outfit would serve as the first initial treatment to the broken body parts while also providing communication to a command/communication post. In the environment where weapon of mass destruction has been detected, the outfit would serve as a protective gear and a monitoring device. Disclosed embodiments provide a detection apparatus operable with GPS configured for directing responders to the vicinity of the detection, providing first hand information and the conditions of the environment and also the conditions of each personnel. Medical preparation for personnel's physiological conditions would be accelerated with the first hand information. In addition, some treatments would be readily administered through the outfit configuration. The sensors are being coated with silicon substrate polymer and/or with zinc oxide layer to provide energy transport platform.

Disclosed embodiments provide silicon substrates consisting of at least one of: polydimethylsiloxane, amorphous silica, petroleum distillates, methyltriacetoxy silane, and ethyltriacetoxy silane for the detection platform. Certain embodiments provide apparatus for monitoring personnel's physiological conditions, and for protecting the personnel's body from getting in contact with external exposure to emergency environmental conditions. In this regard, the outfit would further serve as a sealant that would resist environmental conditions, including severe weather conditions, and would exhibit flexibility, toughness, and also served as a body waterproof.

Applicant acknowledges that different techniques may be employed in transforming biochemical sensors, such as infrared reflectometry to characterize the thickness. Certain embodiments provide optical properties of thin films being operable for the advancement of the integrated circuit for converting solar energy into electrical energy. Disclosed embodiments further provide smaller feature sizes, faster switching speeds, and lower power consumption. Some embodiments provide basic wiring such as dielectric and photolithographic layers, providing a circuit for electrical energy production. This integrated circuit could employ copper/low-k interconnects, silicon-germanium and silicon on insulator-based transistor structures, or chemically amplified deep ultraviolet and x-ray lithography and new metal suicide ohmic contact materials. Infrared spectroscopy offers a metrology approach to sensing through the outfit, complementary to UV-VIS techniques that provide excellent sensitivity to layer composition, including chemical bond densities and free carriers with the enhanced immunity to roughness induced scattering. Infrared spectroscopy shares many of the inherent advantages of UV-VIS spectroscopy as a non-destructive process control tool for further usage in H-LIST because it can be implemented as a reflectance sensor embedded within the outfit. A reflectance spectrum is acquired by incorporating a reflectometer equipped with a linearized liquid nitrogen detector. Software is also incorporated to analyze input to the model-based.

The dielectric function of the layer is modeled with a set of damped harmonic oscillators closely spaced in frequency, with equal damping constants and spacing. The arrays of oscillators are located in the spectral regions where absorption is expected in the film. During the fit, the amplitudes of the oscillators, high frequency dielectric constant, and layer thickness are varied to fit the model to the measured data. By combining model-based infrared spectral analysis with high performance reflectometry hardware, disclosed embodiments would extract quantitative data on multiple parameters relating to film properties. Disclosed embodiments further provide unique sensitivity to film composition, which is applicable to a wide range of films including ultrathin oxides, doped semiconductors, and complex materials such as photo-resistive and low-k dielectrics. Certain embodiments provide high accuracy reflectometer which characterizes the reflectance of ultrathin gate oxides and chemically amplified deep ultraviolet photo-resistive thin films configured to further convert solar energy into electrical energy. The gate oxide reflectance data is related to the deposition time needed to model the thermal oxidation growth kinetics. Disclosed embodiments employ non-destructive measurements on every product wafer as a means of gathering data and information needed to control the process of monitoring biological or chemical gases or weapons of mass destruction in a confined environment. Some embodiments provide ultraviolet visible reflectometry and ellipsometry relating to electromagnetic radiation of wavelengths beyond the violet end of the visible light spectrum method for production monitoring of transparent thin films.

### BRIEF DESCRIPTION OF THE DRAWINGS

In order that disclosed embodiments may be readily carried into effect, it will now be described with reference to the accompanying drawings, wherein:

FIG. 1 is seen to represent exemplary embodiment of a battlefield environment;

FIG. 2 illustrates exemplary embodiments of the processes of extracting battlefield topics of information from battlefield database;

FIG. 3 illustrates an exemplary embodiment of a system for the network environment;

FIG. 4 illustrates further exemplary embodiment of the network comprising a command post consisting of multiple computer system configured for Internet/intranet applications, further comprises a decision engine, a wireless device application, and a server system for the network;

FIG. 5 is seen to represent a remote control programmable configured for enabling/disabling tire sensory platform;

FIG. 6 is an exemplary embodiment of the sensory platform configured for detections and for providing communications involving tire characteristics influential to pressure change;

FIG. 7 is an exemplary embodiment of unwanted elements inside the tire and detection is enabled by the sensory platform to detect the elements;

FIG. 8 is seen to represent a network environment for providing information and for enabling communications for alerting the driver of a vehicle about tire/battlefield conditions;

FIG. 9 is further seen to represent a wireless network of the tire system for use in a battlefield environment;

FIG. 10 is seen to represent a electronic control module configured for analyzing tire information and information within the vicinity of the battlefield vehicle;

FIG. 11 is seen to represent a valve stem wired in communication with an electronic control module;

FIG. 12 is an exemplary embodiment of a detection platform for releasing tire characteristics influential to pressure change and providing battlefield environmental detection;

FIG. 13 is an exemplary embodiment of tires for battlefield vehicles configured with sensors embedded in a silicon substrate and etched in a re-enforced micro-fibered material for detection;

FIG. 14 is an exemplary embodiment of a piezoelectric quartz and receptor transducer on an outfit comprising a detection platform;

FIG. 15 is an exemplary embodiment of an officer randomly patrolling an environment.

FIG. 16 is an exemplary embodiment of a cantilever beam system on a detection platform in association with a receptor;

FIG. 17 is an exemplary embodiment of a piezoelectric and micro electro-mechanical system on the detection platform operatively connected to the receptor;

FIG. 18 is an exemplary embodiment of a receptor communicatively connected to wearable detection outfit. Section AA is a cutout view of the receptor;

FIG. 19 is an exemplary embodiment of a block diagram showing the receptor performance hardware;

FIG. 20 is an exemplary embodiment of a detection array for the detection platform;

FIG. 21 is an exemplary embodiment of a circuit diagram for the receptor; further comprising a privacy indicator and/or a silicon battery cells;

FIG. 22 is an exemplary embodiment of a sailing military ship configured with wind towers comprising turbines for empowering military camps, vessels, outfits, and receptors.

FIG. 23 is an exemplary embodiment of various networks;

FIG. 24 is an exemplary embodiment of stationary wind turbines, command post, and wind stations communications environment;

FIG. 25 is an exemplary embodiment of a circuit diagram for the receptor, comprising random switching generator configured with receivers and transmitters;

FIG. 26 is an exemplary embodiment of security officers outfitted with disclosed embodiments for monitoring the streets and the government buildings;

FIG. 27 is an exemplary embodiment of the different possible combinations of outfit design with the detection platform for monitoring/detections;

FIG. 28 is an exemplary embodiment of military personnel whose uniforms have detected a vehicle that is equipped with explosives;

FIG. 29 is an exemplary embodiment of a planned outline of the outfit in association with micro-fibered material and the embedded sensors;

FIG. 30 is an exemplary embodiment of the military outfit configured for monitoring, protecting, and detecting;

FIG. 31 is a perspective view of a portable communication apparatus with GSM and CPU in accordance with disclosed embodiment;

FIG. 32 is a perspective view of a portable device in a first configuration of a mobile phone with a WAP browser in accordance with one embodiment of the present invention;

FIG. 33 is an exemplary embodiment of a mobile phone with integrated GPS and MP3 music capability;

FIG. 34 is an exemplary embodiment of a slide-able mobile phone with predictive text massaging platform and QWERTY keyboard;

FIG. 35 is an exemplary embodiment of a slide-able mobile phone with Bluetooth technology, infrared sensors, calendar, and FM radio;

FIG. 36 is an exemplary embodiment of a clamshell mobile phone with GPRS Internet services, comprises QWERTY keyboard and virtual keyboard on a touch screen configured with social network platform;

FIG. 37 is an exemplary embodiment of a mobile phone with LCD display screen, video recognition, phonebook, and dictionary;

FIG. 38 is an exemplary embodiment of a mobile phone comprising a gaming apparatus configured with an interface device;

FIG. 39 is an exemplary embodiment of a mobile phone configured with Internet connectivity operable for global roaming;

FIG. 40 is an exemplary embodiment of a mobile phone comprising a pocket PC, a PDA phone with dual processor;

FIG. 41 is an exemplary embodiment of a mobile phone with a touch screen panel operable for communications; interactive gaming; music applications; a slider operable for accessing multimedia buttons;

FIG. 42 is an exemplary embodiment of a mobile phone with numeric keypads operable to provide voice over texting applications; a slide out keyboard; and a resistive touch screen character recognition;

FIG. 43 is seen exemplary embodiments of nanotechnology application comprising CMOS multiple antenna on a chip to realize at least a 60 GHz frequency;

FIG. 44 is seen exemplary embodiments of the nanotechnology application configured with energy transport medium;

FIG. 45 is seen further exemplary embodiments of a communication device configured with CMOS multiple antennas on a chip comprising substrate microfiber/nano-fiber configured with meta-material for communications and for providing a platform for harvesting electrical energy;

FIG. 46 is seen further exemplary embodiments of communication device including energy medium comprising energy platform;

FIG. 47 is seen exemplary embodiments of a charge transport comprising microfiber/nano-fiber material being configured with silicon substrate;

FIG. 48 is an exemplary embodiment of a communication environment comprising a monitoring station, an agency, and a government building;

FIG. 49 is seen further embodiment of a monitoring station 70 comprising a fiber tower network;

FIG. 50 is an exemplary embodiment of a transmitter configured with energy apparatus comprising a battery cell which may be charged wirelessly;

FIG. 51 is seen further exemplary embodiment of a transmitter and a receiver;

FIG. 52 is seen an embodiment of the circuit diagram of the communication apparatus comprising a privacy indicator, switch (S1) communicatively connected to RFID CHIP for signal amplification;

FIG. 53 is seen further exemplary embodiment of the communication apparatus;

FIG. 54 is seen an exemplary embodiment of a network environment in association with the communication apparatus in communication with an output device;

FIG. 55 is seen further exemplary embodiment of the communication apparatus comprising storage medium, a processing unit in communication with a memory device;

FIG. 56 is an exemplary embodiment of a network environment comprising a communication apparatus in communication with a computer system comprising a display device;

FIG. 57 is an exemplary embodiment of intelligence logic for the communication apparatus, comprising a blogging module configured with the session layer and software;

FIG. 58 is further exemplary embodiment of the communication apparatus in a network environment comprising at least a server application;

FIG. 59 is an exemplary embodiment of the communication apparatus in communication with a virtual private network;

FIG. 60 is seen further exemplary embodiments of the communication network;

FIG. 61 is seen further exemplary embodiments of the communication apparatus in communication with interactive voice module;

FIG. 62 is an exemplary embodiment of a vessel plant comprising wind turbines, grids, and transmission lines;

FIG. 63 A is seen further exemplary embodiment of the disclosure comprising the vessel plant configured with a device for producing electrical energy, hydrogen, oxygen, methane, salt, and desalinated water;

FIG. 63 B is seen further exemplary embodiment of the disclosure, further comprising a vessel device for producing hydrogen from seawater;

FIG. 64 is seen further exemplary embodiment of the disclosure comprising a vessel device for producing desalinated water;

FIG. 65 is seen further exemplary embodiments of the vessel plant desalination device configured for hydrogen production and for production of salt and methane;

FIG. 66 is seen an exemplary embodiments of the disclosure further comprising a vessel device for producing desalinated water and hydrogen;

FIG. 67 is seen an exemplary embodiment of the vessel plant comprising regenerative hydropower apparatus, tidal energy conversion device, turbine assembly, transmission lines and grids for harnessing the abundance of ocean energies;

FIG. 68 is further exemplary embodiments configured for producing renewable electrical energy;

FIG. 69 is seen further exemplary description of other embodiments configured for producing renewable electrical energy;

FIG. 70 is seen further exemplary description of certain embodiments of the vessel apparatus comprising extended view of the wind and hydropower vessel plant configured for producing renewable electrical energy;

FIG. 71 is seen further exemplary description of disclosed embodiments configured for converting ocean energy sources into renewable electrical energy;

FIG. 72 is seen further exemplary description of a standard turbine assembly;

FIG. 73 is seen further exemplary embodiments including the turbine configuration with the vessel plant;

FIG. 74 is seen further exemplary description of other aspects of disclosed embodiments;

FIG. 75 is seen further exemplary description of disclosed embodiments;

FIG. 76 is seen further exemplary description of certain aspects of disclosed embodiments;

FIG. 77 is seen further exemplary description of some aspects of disclosed embodiments;

FIG. 78 is seen further exemplary description of other aspects of disclosed embodiments;

FIG. 79 is an exemplary embodiment of communication apparatus in a monitoring environment, the communication apparatus is configured to communicate with various network interfaces;

FIG. 80 is an exemplary embodiment of a circuit diagram of the energy platform, comprising logic interface configured for operation with the communication apparatus;

FIG. 81 is an exemplary embodiment of a circuit diagram comprising a platform array for the communication apparatus, comprising a control device communicatively connected to the communication apparatus being configured with a chip operable for signal amplification;

FIG. 82 is an exemplary embodiment of a flow chart illustrating the exemplary process of extracting topics of information from a database;

Referring to FIG. 83 is seen further exemplary embodiment of the network in communication with the search engine for routing information in the network and for extracting information from the database.

### DETAILED DESCRIPTION OF THE INVENTION

The terminology used herein is for the purpose of describing particular embodiments only and is not intended to be limiting of embodiments. As used herein, the singular forms “a”, “an”, “at least”, “each”, “one of”, and “the” are intended to include the plural forms as well, unless the context clearly indicates otherwise. It would be further understood that the terms “include”, “includes” and/or “including”, where used in this specification, specify the presence of stated features, integers, steps, operations, elements, and/or components, but do not preclude the presence or addition of one or more other features, integers, steps, operations, elements, components, and/or groups thereof. In describing example embodiments as illustrated in the drawings, specific terminology is employed for the sake of clarity. However, the disclosure of this patent specification is not intended to be limited to the specific terminology so selected and it is to be understood that each specific element includes all technical equivalents that operate and/or function in a similar manner. It would be further noted that some embodiments of the enclosed communication apparatus is used concomitantly and/or not used concomitantly with megatel. In some embodiments, the communication apparatus comprises a platform array responsive to media communications. In some embodiments, the communication apparatus further comprises of a platform array responsive to signal radiation. Other embodiments herein describe apparatus configured for entertainment.

The foregoing and/or other objects and advantages would appear from the description to follow. Reference is made to the accompanying drawing, which forms a part hereof, and in which is shown by way of illustration specific embodiments in which the embodiments may be practiced. These embodiments being described in sufficient detail to enable those skilled in the art to practice the teachings, and it is to be understood that other embodiments may be utilized and that further structural changes may be made without departing from the scope of the teachings. The detailed description is not to be taken in a limiting capacity, and the scope of the present embodiments is best defined by the appended claims. Referencing the drawings, wherein reference numerals designate identical or corresponding parts throughout the several views, exemplary embodiments of the present patent application are hereafter described. The numbers refer to elements of some embodiments of the disclosure throughout. As used herein, the terms “and/or” and “at least one of” include any and all combinations of one or more of the associated listed items.

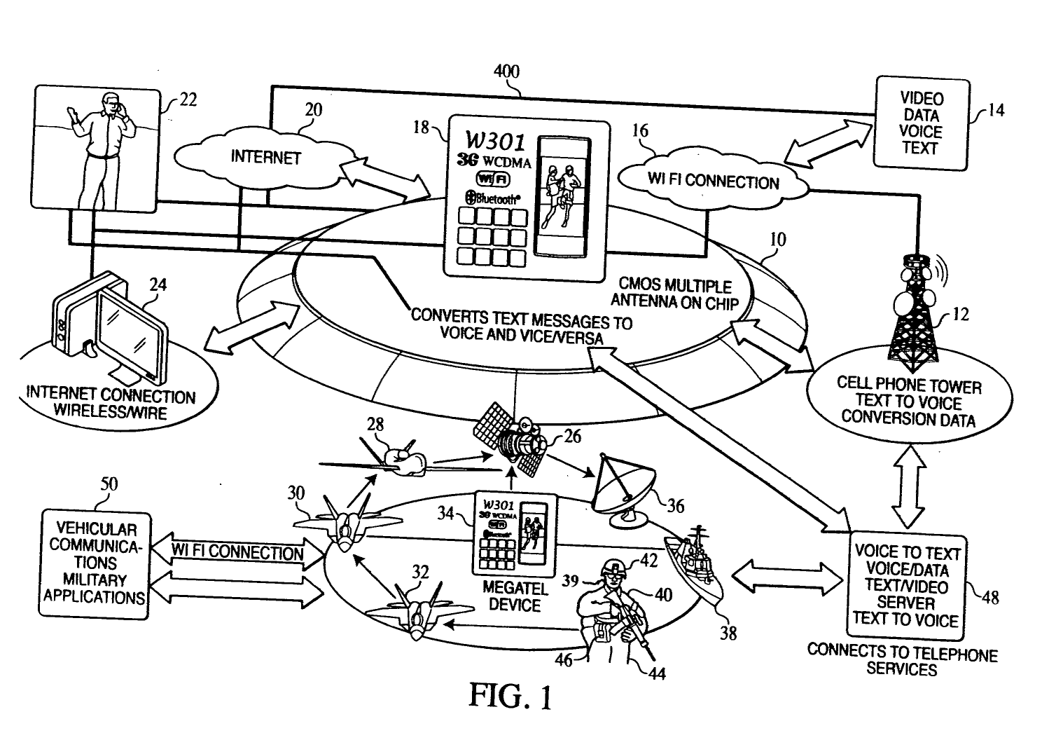

Referring to FIG. 1 is seen exemplary disclosed embodiment comprising CMOS multiple antennas on chip 10. The CMOS multiple antennas on chip is configured with silicon substrate microfiber/nano-fiber. Disclosed embodiments provide the CMOS multiple antennas on chip configured for communications and for converting text messages to voice auditory messages and for converting voice messages to text messages. The CMOS multiple antennas on chip is configured for installation on cell phone towers 12. Certain embodiments provide the CMOS multiple antennas on chip comprising a video data/voice text device 14. Some embodiments provide the CMOS multiple antennas on chip operable for WiFi connections 16. Other embodiments provide the CMOS multiple antennas on chip comprising at least a receiver apparatus and/or a transmitter apparatus for communication device 18. The communication device may comprise at least a 4G and/or at least a 3 G communication device operable on a WCDMA and/or a WiFi network. Disclosed embodiments further provide the communication device comprising at least a Bluetooth. Certain embodiments provide the CMOS multiple antennas on chip further comprising Internet device 20, operable for communications and for providing faster data transmission and communication clarity. The Internet device further comprises at least a handheld device 22. Some embodiments provide the Internet device further comprises a computer apparatus 24 configured for wired/wireless Internet connectivity. Other embodiments provide the Internet device comprising apparatus operable for Intranet communications. Disclosed embodiments further provide the CMOS multiple antenna on chip device comprising at least a transceiver apparatus 26. Certain embodiments provide the transceiver apparatus further comprising at least aircraft 28. Some embodiments provide the transceiver apparatus further comprises at least airplane 30. Other embodiments provide the transceiver apparatus further comprises military craft 32.

Disclosed embodiments further provide the transceiver apparatus further comprising at least a portable communication device 34. In the disclosure, the transceiver apparatus may comprise at least a stationary communication apparatus 36. Certain embodiments provide the transceiver apparatus further disposed on at least a vessel apparatus 38. Some embodiments provide at least a military personnel 39, being outfitted with the transceiver apparatus, comprising at least a battlefield gear consisting of at least one of: a camouflage 40 and 44; a head gear 42; a communication apparatus 46. Other embodiments provide the transceiver apparatus further comprising communication apparatus 48 configured to connect to at least a telephone service. The telephone service may comprise at least voice to text monitoring/transmission, voice data monitoring/transmission, text data monitoring/transmission, video data monitoring/transmission, text to voice, and server data monitoring/transmission. The transceiver apparatus further comprises vehicular communication apparatus 50. Disclosed embodiments further provide the vehicular communication apparatus further operable for military applications. Some embodiments provide the vehicular apparatus further comprises at least a mega telecommunication apparatus “MEGATEL.” Certain embodiments provide a communication apparatus 400 comprising at least of: a transmitter apparatus; a receiver apparatus; a transceiver apparatus.

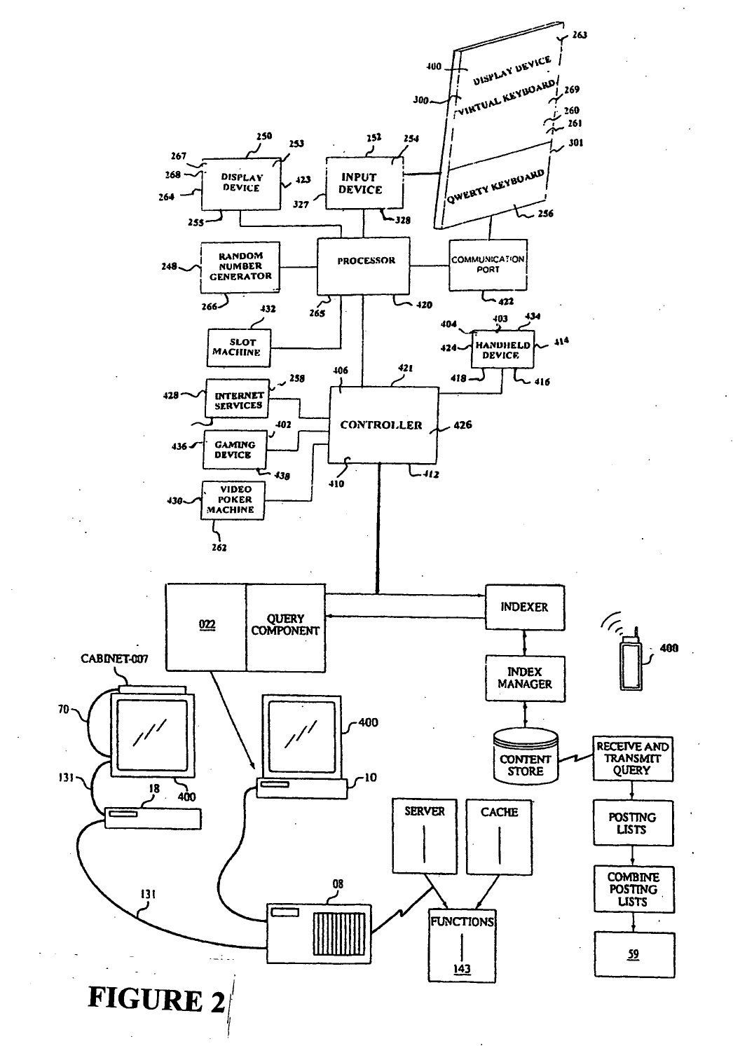

Referring to FIG. 2 is seen an exemplary embodiment of the search engine comprising a communication apparatus. The communication apparatus further includes a cell phone 400. The communication apparatus further comprises at least an input device 252, including a keyboard 254. The keyboard 254 may consist of a virtual keyboard 255 and/or QWERTY keyboard 256 in further communication with a random number generator 248. The communication apparatus further comprises a centralized transportation search engine comprising battlefield topics data processing system operable on a social platform 258 operatively configured for multicast virtual private network for advancing battlefield knowledge. The social platform 258 comprises a social network application in communication with the processor 420. Disclosed embodiments further provide the keyboard disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265, and camera 263. Disclosed embodiments further provide the communication apparatus further comprising at least one of: a mobile communication device 400, a gaming device 402, a media device 403, and an interface device 404. The communication apparatus further comprises a computer apparatus 400 comprising a computer recordable medium 10 being operable on a computer readable program being recorded to cause at least one computer device to receive plurality of battlefield reference documents. The computer apparatus further comprises database comprising topics of information relating to battlefield topics and medical topics. The computer apparatus is further operable for storing a frequency through which a module generates content when queried and is further operable for determining keyword compatibility based on the frequency. Disclosed embodiments provide the interface device comprising at least an integrated phone/PDA 400 being configured with integrated connectivity apparatus 406 operable to provide global roaming for communications and for accessing battlefield topics of information. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, social network, and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber/nano-fiber consisting of resistive touch screen 260 and/or character recognition 269 and/or a communication board 300. Certain embodiments provide housing 301 for the communication apparatus 400 comprising a carbon fiber 408 and/or a silicon microfiber and/or silicon substrate nano-fiber. Disclosed embodiments further provide a communication apparatus being configured with at least a WAP browser 410 and/or an integrated GPS device 412 and/or an MP3 music device 414 and/or a camera apparatus 416 in communication with an interactive interface apparatus. The interactive interface apparatus operatively configured with at least a multi-protocol label switching comprising a label switched path operable on at least a support system operatively configured for mapping desired communications and to execute at least a process to at least a reference document. Disclosed embodiments further provide a communication apparatus further configured with an internal antenna apparatus 418 being configured with a controller 421 in communication with a predictive text messaging applications 423. Disclosed embodiments further provide the support system communicatively connected to at least a dedicated processing element being operable for providing carrier based multicasting virtual private networks. Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 430 and/or a slot machine 432, and/or a handheld device 434 and/or a gaming device 436 and/or a play station 438 in communication with communication port 422. Preferred embodiments provide the communication apparatus 400 comprising a search engine for routing battlefield topics of information.

Some embodiments provide the network 20 comprising distributed collection of nodes interconnected by communication links 131 and segments for transporting reference document data between end nodes. Other embodiments provide the end notes comprising computer devices and workstations. Disclosed embodiments provide the network comprising local area networks (LANs); wide area networks (WANs). The communication apparatus 400 further comprises circuit board comprising electronic system's applications being configured for embedded network for at least one of: a wired communications device, a wireless communications device, a cell phone, a handheld communication device, laptop computer, desktop computer, telemetry device, a switching device, MP3 player, a router, a repeater, a codec, a LAN, a WLAN, a Bluetooth enabled device, a digital camera, a digital audio player and/or recorder, a digital video player and/or recorder, a computer, a monitor, a television set, a satellite set top box, a cable modem, a digital automotive control system, a control module, a communication module, a digitally-controlled home appliance, a printer, a copier, a digital audio or video receiver, an RF transceiver, a personal digital assistant (PDA), a digital game playing device, a digital testing and/or measuring device, a digital avionics device, a media device, a medical device, and a digitally-controlled medical equipment.

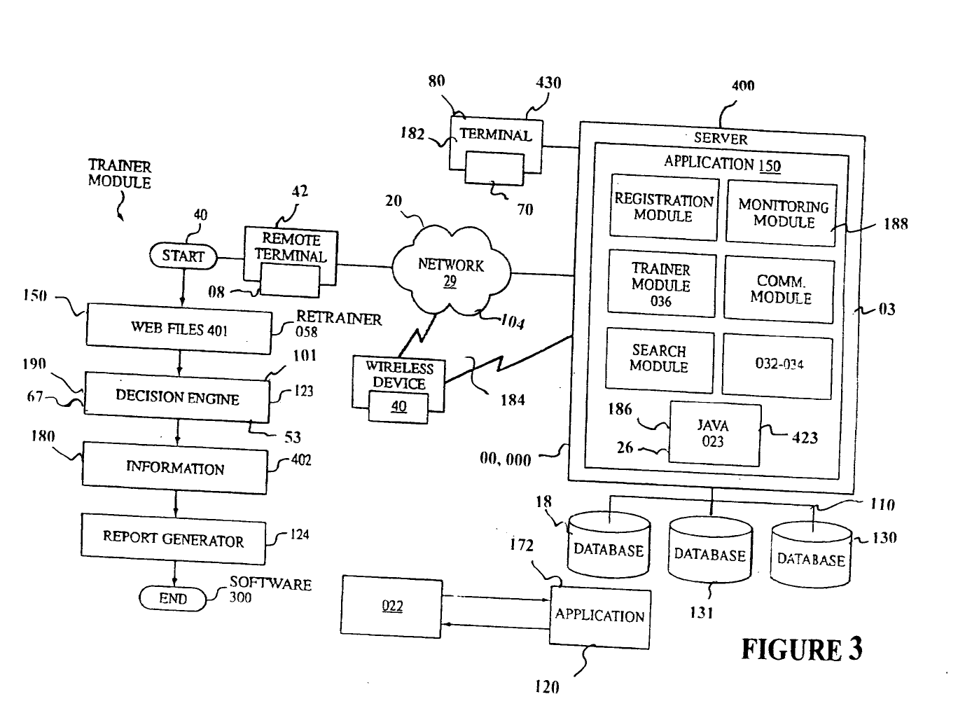

Referring to FIG. 3 is seen an exemplary embodiment of a network environment, comprising a communication apparatus 400 in communication with an output device 70 operable for outputting battlefield topics of information and medical topics of information. Disclosed embodiments further provide the communication apparatus 400 further comprising at least a computer apparatus 430 configured with software 300 further comprises an operating system. Certain embodiments provide the computer apparatus 430 comprising at least a server 00, 000 in communication with a client module 120 for determining that at least a key word maps to battlefield object identifier. The communication apparatus 400 is communicatively connected to the client interactive interface module 172 in communication with network 20 comprising a link to a profile being configured for providing network services for battlefield topics. The communication apparatus 400 further comprising at least a software program 300, wherein at least one software program is configured with at least a memory device 180 in communication with search module 190 comprising values being accessible to the dedicated processing elements 423. The communication apparatus further comprising at least a hardware means comprising the dedicated processing elements being configured with an input array 182, an output array 184, and/or a query array 186. The computer apparatus 430 further comprising at least a database comprising an application module 130 configured for providing information relating to battlefield topics and/or topics of information. Certain embodiments provide a monitoring module 188 operable for monitoring and storing the frequency through which each module generates content when queried. Some embodiments provide a communication module 192 in communication with registration module 194 operable for determining keyword compatibility based on the frequency.

The client interactive interface module 172 is communicatively connected to at least one computer apparatus 430, further comprising at least a decision engine 123 disposed with a data bus comprising a platform for writing input into at least a data memory for at least one array. Other embodiments further provide the decision engine 123 operatively configured with a report generator 124 in communications with network connection keys. The network connection keys in communication with files, forms, documents, and/or industrial files 18, network files 110, graphic user interface 101, sensors 104, web files 401, and system memory 53. Certain embodiments provide the communication apparatus being further configured with system bus architecture 67 in communication with an input device 80. Disclosed embodiments provide report generator 124 in communication with an instruction program 26. Certain embodiments provide the instruction program 26 configured with trainer module 036 and retrainer module 058. The trainer module 036 and retrainer module 058 are configured with CPU 03. The CPU 03 is in communication with a java class 023, a clickn Vest Servlet class 032, and a Servletrunner application 034. Disclosed embodiments further provide the files, forms, and documents further comprising data relating to battlefield topics of information. The communication apparatus further comprises a wireless device 40 comprising applications operable for optimizing and/or for sharing transportation and/or engineering topics of information. Certain embodiments provide the communication apparatus comprising a remote terminal and/or a network terminal 022. The communication apparatus further configured with a readout tool 08 in communication with an address book 131 communicatively connected to content store. Disclosed embodiments further provide the computer apparatus 430 further comprising at least a module for determining that at least a key word maps to an object identifier for battlefield topics of information. The network terminal 022 is provided in communication with a query component. Certain embodiments provide the communication apparatus 400 in a network environment 29 comprising at least a server application 150. The server application 150 further includes at least one of: a registration module 194, a monitoring module 188, a trainer module 036, a communication module 192, a search module 190, and/or java application software 023. Certain embodiments provide the java application software 023 in communication with a database server 000. Disclosed embodiments provide the communication apparatus 400 further comprises ports and/or terminals comprising a network terminal 022 in communication with the application module 130. Certain embodiments provide the communication apparatus being turn on by at least a start button in communication with at least a control device. Other embodiments provide the control device comprising a wireless device 40 communicatively configured for communications with remote terminals 42. Disclosed embodiments further provide a communication apparatus comprising at least one of: report generator module 124, information module 402, retrainer module 058, web-files module 401, a clickn Vest Servlet class 032, and a Servletrunner application 034, and/or a decision engine.

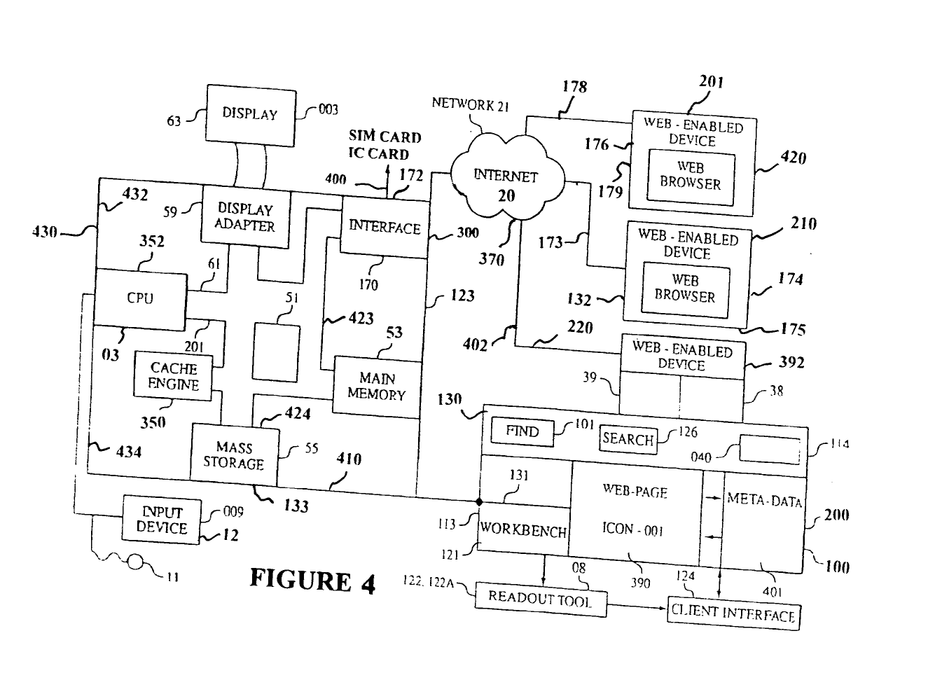

Referring to FIG. 4 is an illustration of a network environment 21 comprising a communication apparatus 400 in communication with a computer system comprising a display device 003, a sound card 61, speakers 63, a cache engine 350, a network interface 170, a display adapter 59, intelligence logic 352, a media device 201, and a central processor 51. The communication apparatus further include an input device 009 comprising at least a keyboard 11 and a mouse 12. The communication apparatus further include an IC card and a SIM card in communication with network interface 170. The CPU 03 is operable with the intelligence logic 352 to process commands and applications, in communication with memory 53, decision engine 123 and web-enabled devices. Disclosed embodiments further provide the web enabled devices comprising a browser 040. The network 21 is responsive to communications through the Internet. Certain embodiments provide a communication apparatus being configured with the browser 040, a server search report 39, and client search programs 38. Disclosed embodiments further provide a communication apparatus configured with graphic user interface 101, a search program manager 126, a browser 040, an ICON 001, and a storage medium comprising at least a meta-data 114. At least a web-page manager 392 is provided comprising addresses 131, corporations 200, battlefield transportation department 100, ware houses 121 and a workbench 113. The computer system further comprises an affinity analyzer 122, a data analyzer 122A, a readout tool 08, a web-page 390, a report generator 124, web file module 401, and client interface being operable with software application 300.

The communication apparatus 400 comprises battlefield topics of information. Disclosed embodiments provide the communication apparatus 400 further comprising a data processing system 410 operable on a social platform 420. The social platform 420 comprises a social network environment operatively configured for multicast virtual private network. Disclosed embodiments provide the virtual private network 178 comprising apparatus operable for transmitting same data to multiple receivers in a network. Certain embodiments provide the multicast virtual private network 178 comprising at least a multicast packet 176 configured for replication with at least a router 179. The multicast private network comprises a network interface 170 for advancing battlefield knowledge. The network interface 170 further comprises: at least a computer apparatus 430 comprising a computer recordable medium 432 being operable on a computer readable program 434. The computer readable program 434 is configured to cause at least one computer device to receive plurality of battlefield reference documents in communication with client interactive interface module 172 operatively configured with at least a multi-protocol label switching 173 being operable on at least a support system 210 operatively configured for mapping desired communications. Disclosed embodiments further provide the multicast-protocol label switching 173 comprising apparatus configured to direct data from network note 20 to network note 21 in communication with a virtual link. Certain embodiments provide the multi-protocol label switching comprising apparatus configured for carrying data from network note 20 to network note 21 in communication with a virtual link. At least one support system 210 is configured with the social platform 420 and communicatively connected to at least a dedicated processing element 423. The multi-protocol label switching 173 is further configured to speed up network traffic flow to effectively manage structured reference documents comprising battlefield topics of information. Other embodiments provide the virtual private network 178 further comprising the router 179 in communication with the multiprotocol label switching network 173. The router 179 configured for the distribution of battlefield medical topics of information across a shared multiprotocol label switching network. Disclosed embodiments provide the router further includes Internet protocol addresses for establishing multiple switched paths with the multiprotocol label switching network. Other embodiments provide the multiple switched paths comprising plurality point to point paths assignments for military personnel/battlefield social network. Some embodiments provide the router 179 further configured for maintaining communications with the database 130 containing battlefield reference documents for the topics of information. Other embodiments provide the database further comprising prefix of the topics of information that matches battlefield/medical topics addresses in the packet's network destinations address field. Disclosed embodiments further provide the Internet protocol configured to determine at least a direction for the packet transmission from the router to at least a remote computer system. In the disclosure, the packets further include Internet protocol data-gram comprising network addresses for remote destinations.

The dedicated processing elements 423 being operable for providing carrier based multicast virtual private networks 178. Some embodiments provide multi-protocol label switching 173 consisting of labels 175 comprising packets 176 to forward decisions made on the contents of the labels. Disclosed embodiments further provide the communication apparatus 400 further operable for categorizing transportation and engineering files referenced by initial search results, comprising implementing at least a method for receiving at least a query that maps to objects identifier for transportation and engineering topics. The virtual network further comprises interactive collaboration within a secured battlefield reference document. The virtual network further comprises a server-based social network operable for community distribution of knowledge. The network is configured with document management system comprising a server database that includes at least a professional functionality and a plurality of interactive functionalities. Scientists, engineers, and transportation personnel may assemble into the network through the social platform. Interactive functionalities include allowing networks of scientists, engineers, students, universities, transportation personnel to share knowledge and documents in a remote secured environment. Disclosed embodiments provide the communication apparatus 400 being configured with software applications 300, further operable to remotely create, delete, edit and manage battlefield/medical documents and view information about the documents in a plurality of customized locations.

Certain embodiments provide the communication apparatus 400 comprising a neural network 220 in communications with at least a cache engine 350 being operable for responding to at least a transportation and engineering topic request using a server response data that is cached at a network operable with at least a programmable architecture 424. Disclosed embodiments provide the programmable architecture 424 being configured with at least one dedicated processing elements 423. Certain embodiments further provide the cache engine 350 in communication with cache database 133. Some embodiments provide the search engine 402 in communication with the cache engine 350 configured for applications that include interne 370. Other embodiments provide the search engine 402 in communication with at least a crawler 174 and an index database 132. Disclosed embodiments further provide the communication apparatus 400 comprising a display adaptor 59 operable for communications with corporations 200, battlefield transportation department 100, and web file modules 401, and personnel interface 172.

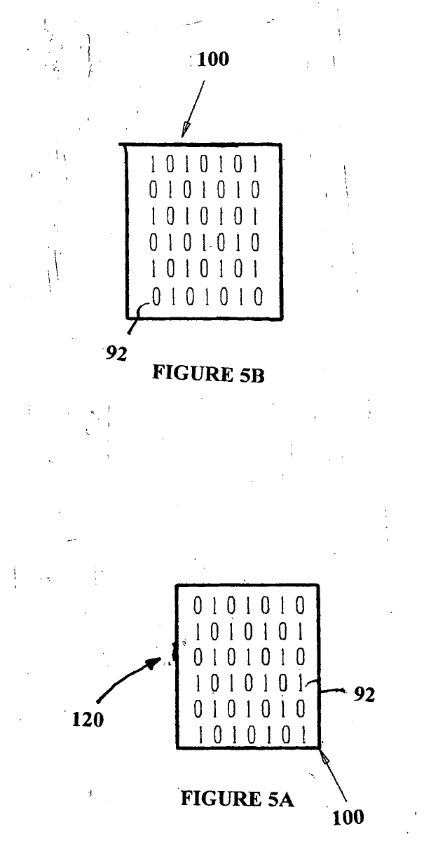

Referring to FIG. 5A is seen exemplary embodiment of transistorized switches 92 configured for binary operations. The transistorized switches 92 are communicatively connected to the electronic control modules 100. The transistorized switches 92 may be disposed within the structures of the detection platform 120.

Referring to FIG. 5B is seen further exemplary embodiments of the transistorized switches 92, further configured with the electronic control module 100 for communicating detections to the operator of the vehicle.

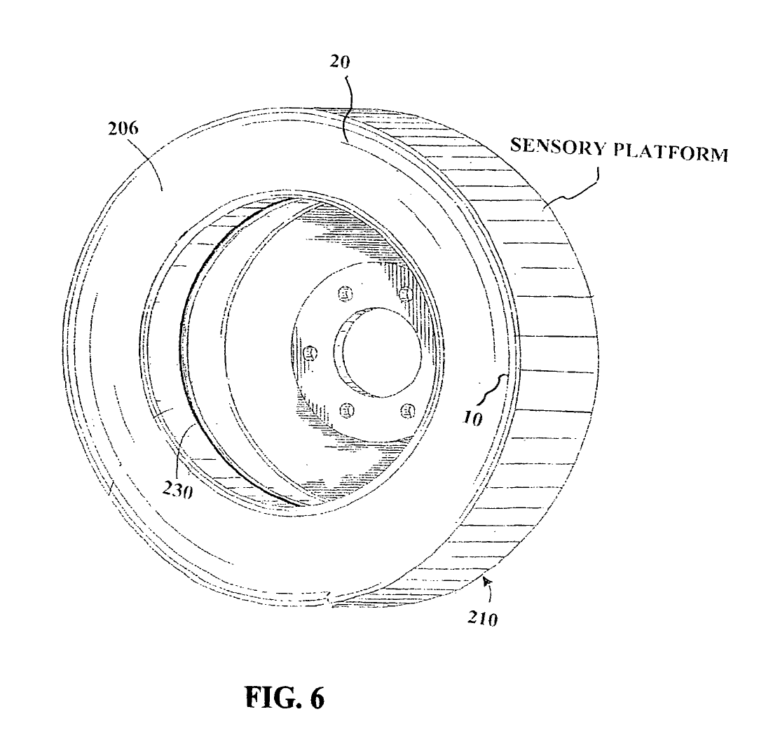

Referring to FIG. 6 is seen further exemplary embodiments of the silicon substrate 10 being etched and/or fused on a micro-fibered material 20 to provide a sensory platform 126 operable for detection. The sensory platform 126 is disposed on the tire structure 210 comprising the rim 230, the tire 200, the valve stem 240, and the tire environment 250. The sensory platform 126 is further configured to detect weak spots or weak area 206 within the tire structure 210.

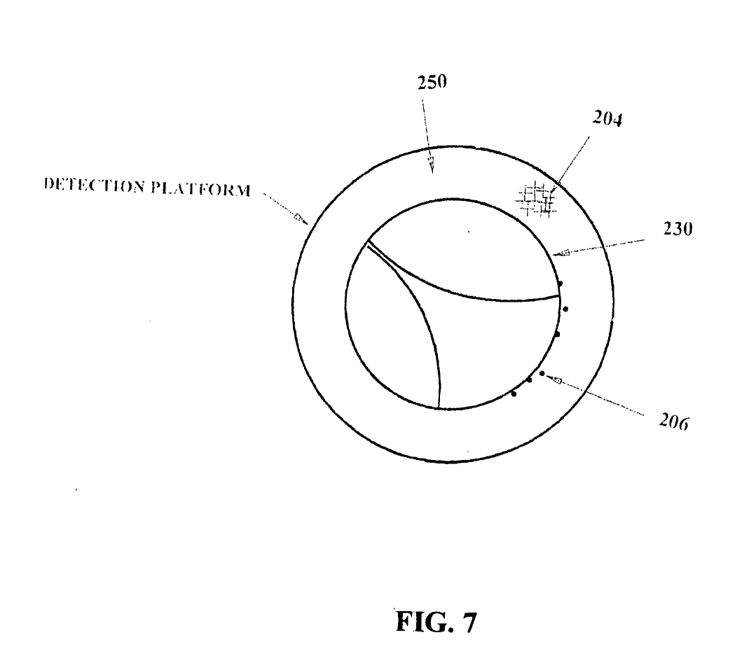

Referring to FIG. 7 is seen further exemplary embodiments of the sensory platform 126, comprising a detection platform 120 disposed within the tire environment 250. The tire environment 250 further includes the rim 230. The detection platform 120 is further responsive to characteristics contained in the waves 204 or weak area 206 of the tire environment 250.

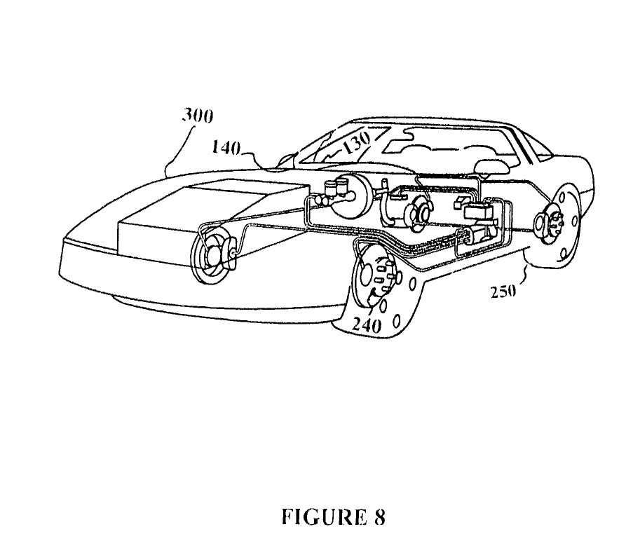

Referring to FIG. 8 is seen further exemplary embodiments of the disclosure, comprising a valve stem 240 being disposed within the tire environment 250. Disclosed embodiments provide the valve stem 240 further configured for communications with the electronic control module 100. Certain embodiments provide the electronic control module 100 in communication with audiovisual devices 130 and 140 disposed within a vehicle 300 comprising a steering wheel 310 and/or within the dashboard 320. Some embodiments provide the audiovisual devices 130 and 140 comprise a speaker 130 operable for broadcasting voice auditory responses responsive to detection signals. Other embodiments provide the audiovisual devices comprise a visual device 140 operable for displaying detected data.

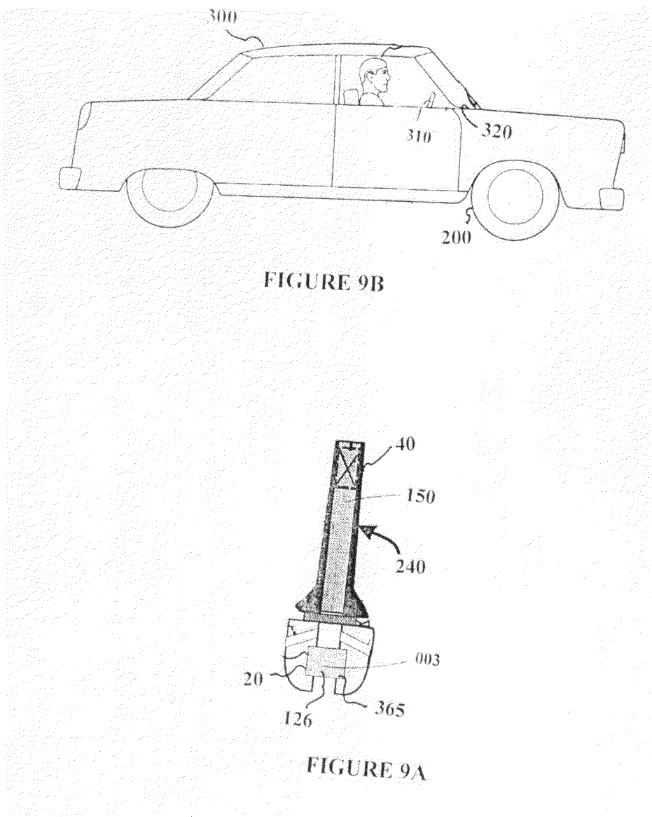

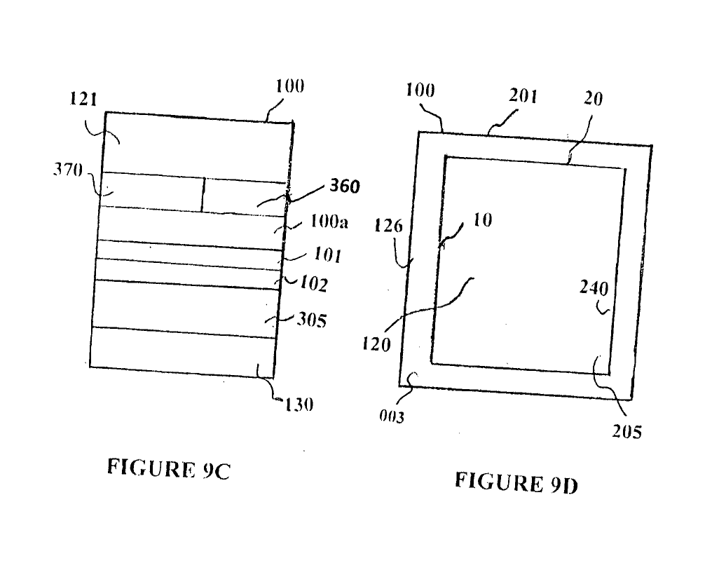

Referring to FIG. 9a is seen further exemplary embodiment the sensory platform 126 further comprises micro-fibered material 20 configured with silicon substrate 10 being embedded with at least one of sensors 001, 002, 003, 004, and 005. Disclosed embodiments provide the sensory platform 126 being disposed with the valve stem 240. Antenna 40 and 150 are further configured with transmitter/receiver 365. Certain embodiments provide the transmitter/receiver 365 further comprising a transmitting apparatus and a receiving apparatus. Some embodiments provide the transmitter/receiver 365 further comprising sensor 003 being operable for receiving and transmitting detection signals. In the disclosure, embodiments provide sensor 003 in communication with the electronic control module 100.

Referring to FIG. 9b is seen exemplary embodiment of a vehicle 300 comprising a dashboard 320 being disposed with audiovisual devices. Disclosed embodiments provide the audiovisual devices comprises of the audio device 130 and the visual device 140. Certain embodiments provide the audio device being configured with speakers 135 for broadcasting communication signals from the tire 200 to the driver 308 of vehicle in control of the steering wheel 310.

Referring to FIG. 9c is seen exemplary embodiments of the electronic control module 100. Disclosed embodiments provide the electronic control module 100 is configured with an electromagnetic element 101. The electronic control module 100 is further communicatively connected to an operating unit 102, which is operatively connected to an interface device 121. The electronic control module 100 is further configured with membrane 370 passing through memory 360. Certain embodiments provide the membrane 370 communicatively configured with the audiovisual device 130. The electronic control module 100 further comprises a microprocessor 305 operatively configured with software 100a.

Referring to FIG. 9d is seen exemplary embodiment of the detection platform 120 comprising silicon substrate 10 etched/fused in a micro-fibered material 20. The detection platform 120 is disposed within the tire material 201. The tire material 201 is configured with the rim 230 and the valve stem 240. The valve stem 240 responsive to detection signals in communication with the electronic control module 100 that analyzes the signals. Detection signals are being analyzed through communications between the RFID Chip 003 and the electronic control module 100. The RFID chip 003 comprises an operational component comprising the sensory platform 126 and the valve stem 240. Detection communications are transmitted through the valve stem 240 to the electronic control module 100. Disclosed embodiments provide a system comprising of excellent electrical properties configured for temperature control. The system further provides the electrical properties for the re-enforced micro-fibered material 20 for enabling excellent detection selectivity and detection sensitivity through the detection platform. The configuration of the detection platform is further provided for allowing the electrical properties to thermostatically control the temperature within the closed system.

Disclosed embodiments provide the sensing surface of the detection platform 120 comprising effective communication and efficient detection and intelligence environment. Certain embodiments provide the location of the detection surface and the communication environment of the sensory platform in close proximity within a close distance from the air 205 to increase sensitivity and also improve effective communication for the driver of a vehicle.

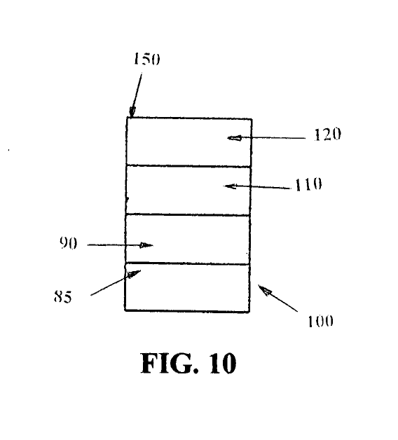

Referring to FIG. 10 is seen an exemplary embodiment of a communication network comprising a detection platform 120. The detection platform 120 further comprises silicon substrate 10. Disclosed embodiments provide tag 85, and an antenna. 150 further embedded in the silicon substrate 10 and fused/etched in the microfiber/nano-fiber material 20. The electronic control module 100 further comprises a reader 90 configured for reading detection signals. Certain embodiments provide an encoder 110 operable for converting detection data into a digital form recognizable by the electronic control module 100.

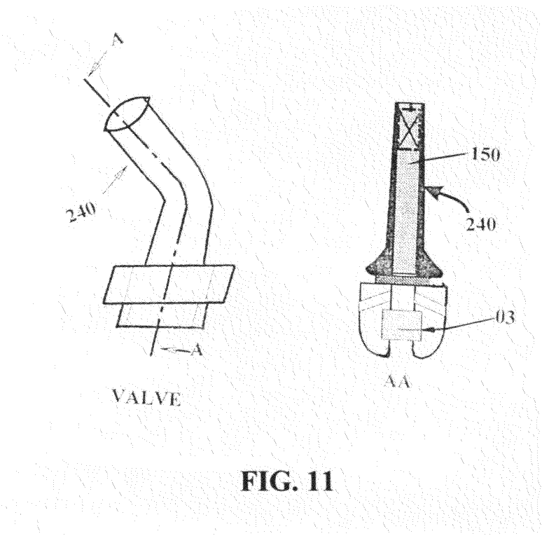

Referring to FIG. 11 is seen an exemplary embodiment of the valve stem 240 configured with sensor 03 in communications with antenna 150. The antenna 150 is embedded within the structure of the valve stem 240 as seen in section AA.

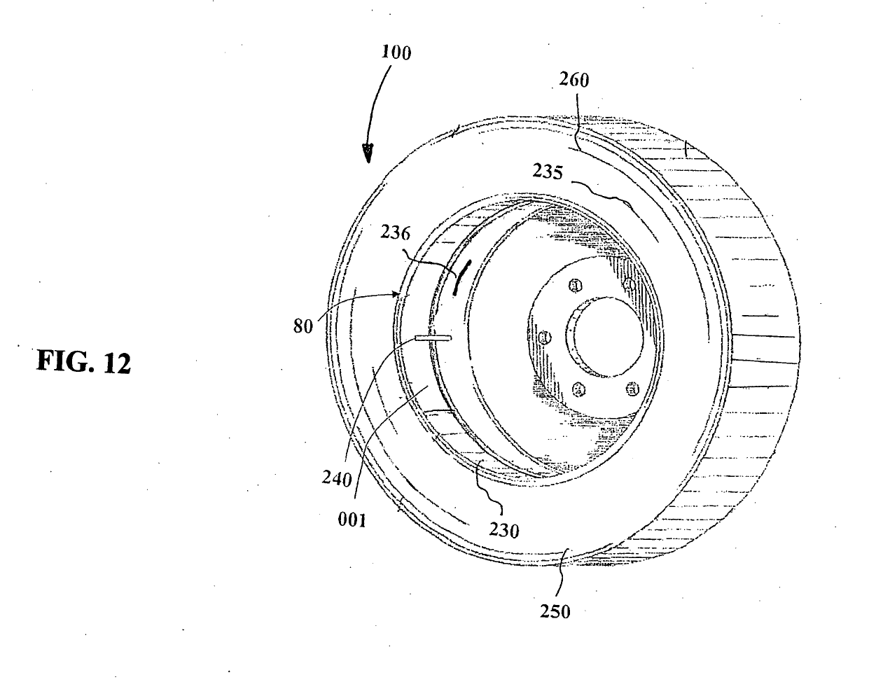

Referring to FIG. 12 is seen exemplary embodiment of the tire material 201 comprising a platform responsible for enabling detection of contextual characteristics influential to pressure and/or property change. The sensor 001 further comprises antenna 80 communicatively configured with control module 100. Sensor 001 is in the platform etched/fused within the tire environment 250. Disclosed embodiments provide the sensors on the platform, comprising a detection platform 120 being positioned within the tire environment 250 configured for monitoring of weaknesses around the tire walls 260, and responsive to detection of corrosion 236, contamination 235, and change in air pressure 205 within the closed environment comprising the complete assembly of the rim 230 and the tire environment 250. The detection platform 120 further comprises a valve stem 240 operable for detection pressure change and for communications. The valve stem 240 is communicatively configured for communications and for detecting weaknesses between the tire 200 and the tire environment in communication with the electronic control module 100 by means of optical radiation, reflection, or emitted signals. The electronic control module 100 further comprises at least a power amplifier configured with IC or module to increase integration. The electronic control module 100 is further operable to allow greater functionality and linearity. Disclosed embodiments further provide the valve stem 240 further comprising a transmitter 230 operable to enable communication to a receiving means. Certain embodiments provide the receiving means comprising the operator of the vehicle and transmitter 230 configured to wirelessly transmit detected signals.

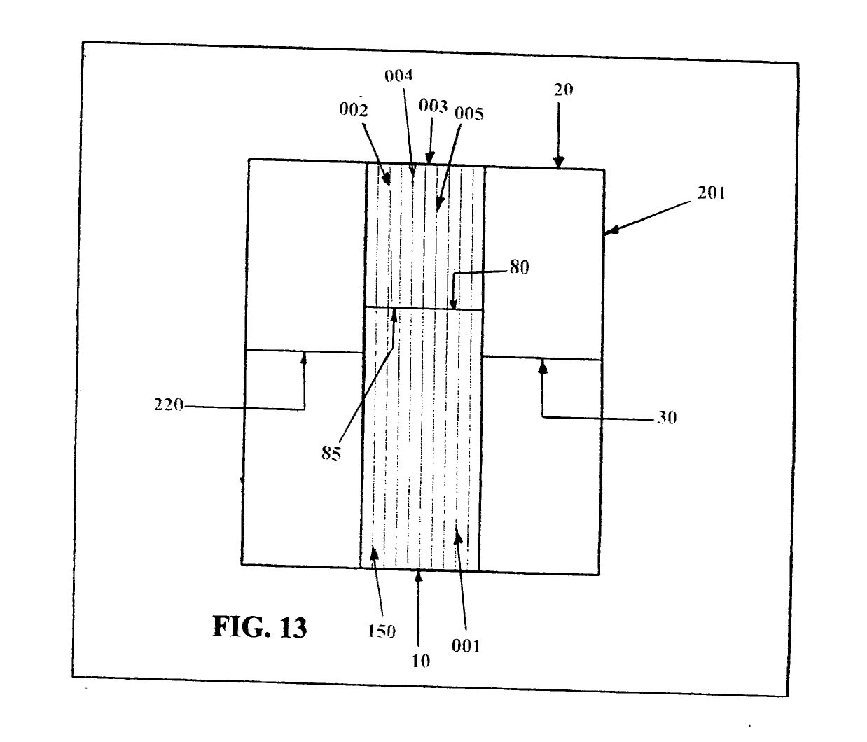

Referring to FIG. 13 is seen exemplary embodiments of sensors 001, 002, 003, 004, and 005 are disposed on a detection platform 120. The detection platform 120 may comprise of at least one of: nano sensors 001, silicon ultrasonic 002, RFID chip 003, piezoelectric sensors 004, MEMS 005 and the like, each sensor being embedded in a silicon substrate 10 to enable a platform for detection. Next, the silicon substrate 10 and the embedded plurality sensors 001, 002, 003, 004, and 005 are etched in a re-enforced micro-fibered material 20. The micro-fibered material 20 is of excellent electrical properties. The electrical properties are further responsive to thermostatic properties of the sensors disposed in the closed environment of at least a tire apparatus. Thirdly, the micro-fibered material 20 is fused in the tire apparatus comprising a tire material 201 to re-enforce the internal coating of the tire 200 with a sensory platform configured for detection. Antenna 80 and 150 are operatively configured with the platform. Disclosed embodiments further provide the antenna 80 and 150 comprising a transmitter/receiver 30. The transmitter/receiver 30 is configured with the detection platform 22. The platform further comprises embedded tags 85 and nitride membrane 220.

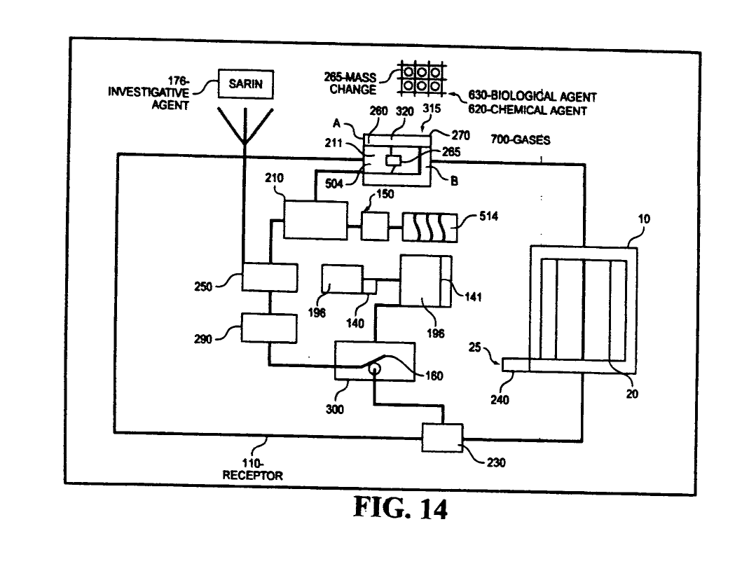

Referring to FIG. 14 is seen nanotechnology applications on an outfit 10 configured with at least a lining 20, a connector 25, and a fiber optic ribbon 240. The outfit 10 is operatively configured with an interface 300 comprising an adaptor 160, an electronic nose 230, and at least a detector 290. Plurality detectors are provided comprising sensitive detector 250, cantilever sensor 210, and piezoelectric detector 211 configured with piezoelectric crystals 260. The detectors are operatively connected to at least a chip 140, in communication with a controller 196 and 320. A CPU 141 is provided responsive to signals from the controllers 196 and 320. An analyzer 150 comprising an analyte is configured to analyze at least a resonance frequency shift 514. The piezoelectric detector 211 comprises piezoelectric crystal 260, being operable to allow antibodies 270 being coated with the crystals to provide multiple use potentials in solid, liquid, gaseous and explosive detections. The antibodies 270 are coated on the surfaces of the piezoelectric to provide a change of mass 265. An investigative agent 176 is configured with at least the analyte responsive to useful signal communications.

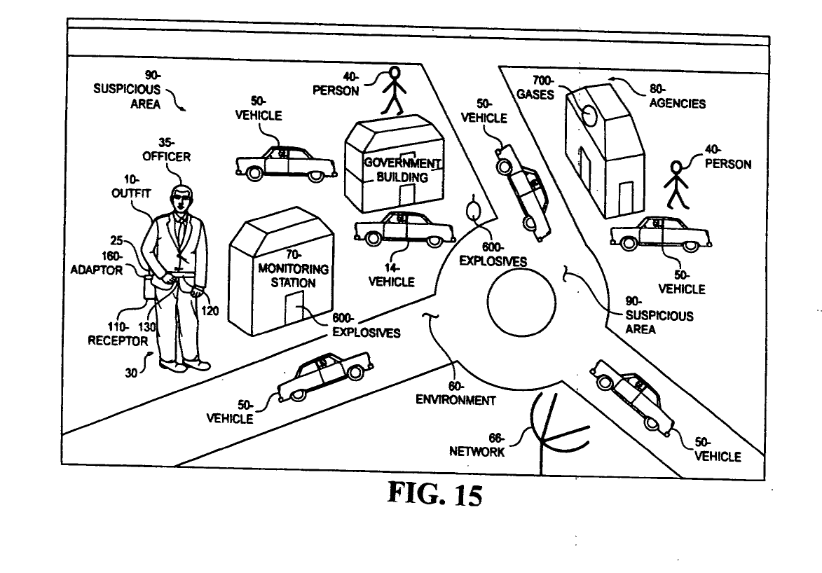

Referring to FIG. 15 is seen an environment 60, comprising a monitoring station 70, agencies 80 and a government building. Vehicles 14 and 50 and at least a person 40 are being watched by an Officer 35 monitoring a suspicious area 90. The Officer 35 is outfitted with the embodiments of current invention comprising outfit 10, adaptor 160, receptor 110, wearable outfit 30, waist belt 120, and a connector 25 being disposed within the waist area 130. Officer 35 is seen to have identified a suspicious person 40 patrolling at least agencies 80. The outfits 10, 30, and 120 are seen to show exemplary embodiments of detected explosives 600 and gases 700. The receptor 110 is seen to have analyzed the detections and is in communication with a network 66.

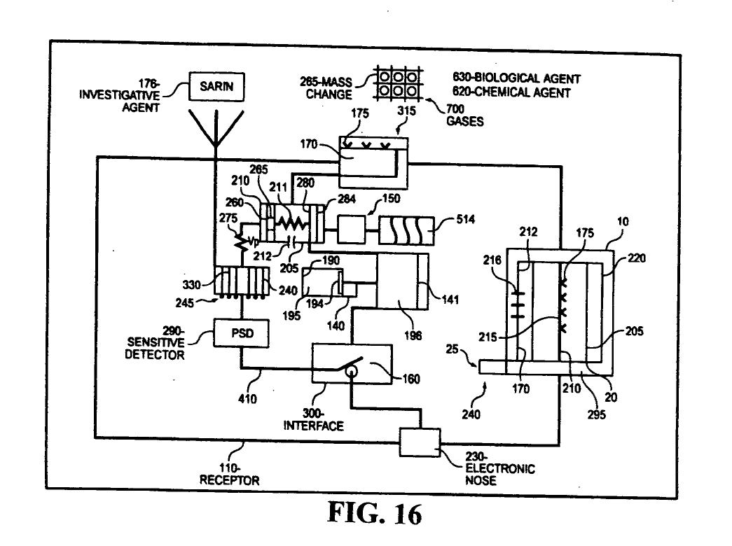

Referring to FIG. 16 is seen sensory layout for an outfit 10 configured with at least a lining 20, a connector 25, and a fiber optic ribbon 240. Outfit 10 is operatively configured with analyzer 150 comprising an analyte being configured to analyze at least a resonance frequency shift 514. Embodiments provide piezoelectric detector 211 comprises piezoelectric crystal 260, operable with antibodies 270 being coated with the crystals to enable multiple use potentials in solid, liquid, gaseous and explosive detections. The antibodies 270 are coated on the surfaces of the piezoelectric to detect a change of mass 265. An investigative agent 176 is configured with at least the analyte responsive to useful signal communications. The outfit 10 comprises nanotechnology applications comprising nano-sensors 200, 210, 211, 280, 290, and 315. The nano-sensors 200, 210, 211, 280, 290, 315 are embedded in a silicon substrate 205 and etched/fused in a microfiber/nano-fiber material 220 to provide more sensitive detection platform 295. The microfiber/nano-fiber material 220 comprises of a micro fibered material with excellent electrical characteristics.

Sensor 315 could be a transducer being operatively configured with the detection platform 295 for providing multiple sensing to specific detections. The detection platform 295 further comprises electronic nose 230, responsive to detection of odors. The detection platform 295 is further configured to recognize wavelike properties, such as could be seen in explosives 600, gases 700, biological agents 630, and chemical agent 620. These detections are analyzed by analyzer 150 communicatively configured with investigative agent 176. The investigative agent 176 is operatively configured with the receptor 110 responsible for providing communications indicative of the detection type and communicable to at least a monitoring station 70 and/or at least a network 66 as seen in FIG. 2. Receptor 110 may comprise of at least a GPS technology responsive to identifying personnel locations.

At least a cantilever sensor 210 is further provided and being coated at the side with sensor materials 212 to enable specific detections. Micro machined cavities 216 consisting of multifunctional sensors 215 are further arranged to provide other specific detection types. Detection signals are analyzed as they are exposed to an analyte 175 comprising aqueous solutions. The electronic nose 230 provides detection of odors in communication with at least a receptor layer 170. The receptor layer 170 is communicatively connected to the analyte 175. Receptor 110 further configured with at least an analyte chamber 195 comprising sensor array 330 communicatively connected to input adaptor 160 to provide better detection selectivity and sensitivity. Grains of membranes 190 are etched in the analyte chamber 195 to provide signal separations. Embodiments provide apparatus to read signal simultaneously through beam deflection 284, and the signal may be transmitted through a fiber-optic ribbon 240. Transmission control 194 is configured with receptor 110 responsible for providing information about detected agent, and is responsive to false signals. Signals may be transmitted to transmitter 311, and receiver 312.

The detection platform 295 further comprises microelectronic circuit 410 comprising multifunctional sensor arrays 330, 420, 420. Sensors 290 and 200 are further configured to enable communications through active interface 300. Multiple light sources 245 are operatively connected to membrane 190 and to the analyte chamber 195 responsive to cantilever illumination. Multiple light sources 245 is deflected from cantilever 210 to shine on sensitive detector 250 being responsive to bending due to voltage pressure (Vp). The bending is initiated by photocurrent 275 due to stress. The detector platform 295 is further operatively connected to at least a chip 140, in communication with a controller 196 and 320. A CPU 141 is provided responsive to signals from the controllers 196 and 320. The analyzer 150 comprises an analyte is configured to analyze at least a resonance frequency shift 514. The piezoelectric detector 211 comprises piezoelectric crystal 260, which allows antibodies 270 to be coated with the crystals to provide multiple use potentials in solid, liquid, gaseous and explosive detections. The antibodies 270 are coated on the surfaces of the piezoelectric to enable a change of mass 265. An investigative agent 176 is configured with at least the analyte responsive to useful signal communications.

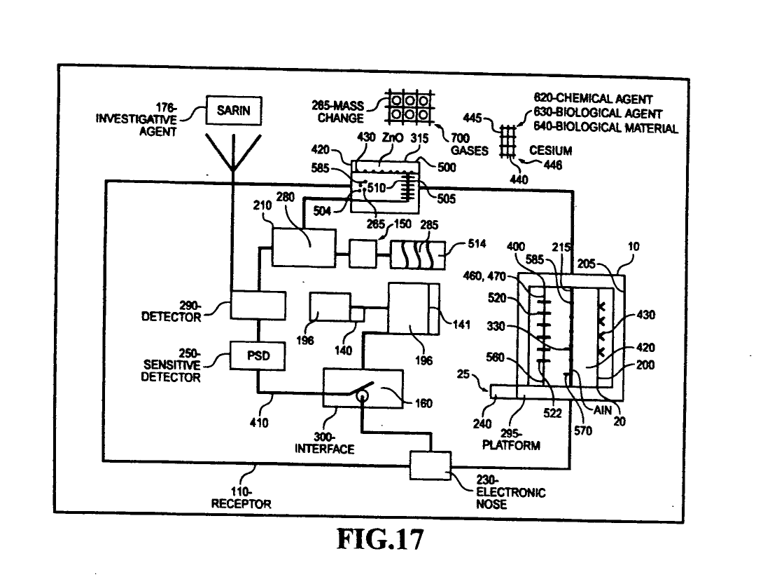

Referring to FIG. 17 is seen further embodiment of the sensory platform, an outfit 10 is seen comprising at least a silicon substrate 205. The silicon substrate 205 comprises of nanotechnology applications consisting of sensors 200, 215, 280, 330, 400, 420, 430, and AIN. The outfit 10 further comprises of lining 20 responsive to body protection. A ribbon 25 is communicatively connected to an adaptor 160 configured with the outfit 10. Surface acoustic wave line 570 is coated with paste and/or ink 585 comprising of passive glass film. MEMS 420 and multifunctional sensor 215 are configured with a 430, in communication with at least a microelectronic circuit 410 to further convert solar energy into electrical energy. The surface acoustic wave line 570, the paste 585, the MEMS 420, the thin film 430, and the multifunctional sensor array 330 are embedded in the silicon substrate 205 and etched/fused in a micro-fibered material 220 to provide energy generating detection platform 295. The silicon substrate is micro-machined in a chemical and/or electromechanical etch technique.

In other embodiment, a silicon to silicon bonding 460 and/or silicon to ceramic wafer bonding 470 is employed for detection and for generating electrical energy. The silicon to ceramic wafer is further responsive to solar energy. The silicon to ceramic wafer bonding may include at least silicon to glass bonding 470, forming single crystal silicon to improve the micro-acoustics and micro optics in the nanotechnology applications. Multifunctional sensor 215 further comprises surface acoustic wave resonators 500 responsive to frequency shift. The frequency shift may be influenced by mechanical, chemical, and electrical perturbation within the boundary of active interface 300. The electrical perturbations may occur in metal films 543. The metal film 543 may have different conductive values deposited on the resonators 500 responsive to loading effects on the liquid and/or solid media 505. The metal film is further configured for generating electrical energy. Gas selectivity is further influenced by metal clusters 520. The metal clusters 520 are further configured to increase sensor selectivity caused by gas absorption due to the coupling between sensing surface 400 and catalytic properties 504. The catalytic properties 504 consist of metal oxide 530 being further configured for converting pressure force into electrical energy. The metal clusters 520 are operatively configured with sensors 180, 200 to increase selectivity. The metal clusters 520 further comprises semiconductor oxide substrate 560 configured with chemical sensitization to enable metal particles 522 to act as centers for surface gas absorption. The addition of clusters 520 further provide electronic sensitization resulting from oxide surface 540. Disclosed embodiments further provide silicon-substrate-metal oxide 530, further comprising antimicrobial metal consisting of at least silver being laminated to at least a liquid absorbing nonwoven material being fused/etched in microfiber/nano-fiber material to provide a pathogen detection environment on the detection platform 295. Certain embodiments provide the silicon-substrate-metal oxide-micro fiber 530 further comprising the nonwoven material consisting of metal coating including metal particles facing at least a liquid absorbing material to retain disinfection effect. Certain embodiments provide wearable outfit comprising sensors 200 being configured to retain antimicrobial effect. Some embodiments provide silicon-substrate-metal oxide 530 being configured with silicon-substrate-thin film 430, providing a detection platform 295 configured with plurality sensors 200 operable for detecting pre-use and post-use of weapons of mass destructions. Certain embodiments provide the nonwoven material comprising at least a polyethylene mesh forming an antimicrobial composites comprising antimicrobial metal coating.

Other embodiments of the disclosure provide sensor 315 operatively configured with the detection platform 295 to provide multiple sensing for specific detections. The detection platform 295 further comprises electronic nose 230, responsive to detection of odors. The detection platform 295 is configured to recognize pre-used and post-used of weapons of mass destructions, including wavelike properties, such as could be seen in explosives 600, gases 700, biological agents 630, and chemical agent 620. The detection platform 295 comprises plurality sensors 200, include antimicrobial metal consisting of at least silver being laminated to the micro fiber material 220, including at least a liquid absorbing nonwoven material further comprising perforated firm and a mesh being fused/etched in the microfiber/nano-fiber material to provide a pathogen detection environment, and further consist of biomaterial 640 comprising a space charge region 445 operatively configured for surface oxide conductivity 440 within a surface environment 446 operable for converting pressure force, vibration, heat, and sound wave into electrical energy. Disclosed embodiments further provide apparatus for analyzing detections, including an analyzer 150 communicatively configured with investigative agent 176. The nonwoven material is further disposed on the detection platform via vapor deposition. The detection platform further comprises antimicrobial composite comprising liquid permeable material and/or liquid absorbing material operable for pathogen detection. The investigative agent 176 is operatively configured with the receptor 110 responsible for providing communications indicative of the detection type and communicable to at least a monitoring station 70 and/or at least a network 66 as seen in FIG. 2. Receptor 110 and the detection platform 295 may comprise of at least a GPS technology responsive to identifying personnel locations.

The outfit 10 is operatively configured with an interface 300 comprising an adaptor 160, an electronic nose 230, and at least a detector 290. Plurality detectors are further provided, comprising transducers 315 sensitive detector 250, cantilever sensor 210. The detectors are operatively connected to at least a chip 140, in communication with a controller 196. A CPU 141 is provided responsive to signals from the controller 196. An analyzer 150 comprising an analyte is configured to analyze at least a resonance frequency shift 514. The detectors further comprises of antibodies 270 coated with crystals to enable multiple use potentials in solid, liquid, gaseous and explosive detections. The antibodies 270 are coated on the surfaces of the detectors to enable detection of a change of mass 265 within an environment. An investigative agent 176 is being configured with at least the analyte 150 responsive to useful signal communications, including pre-use and post-used of weapons of mass destruction.

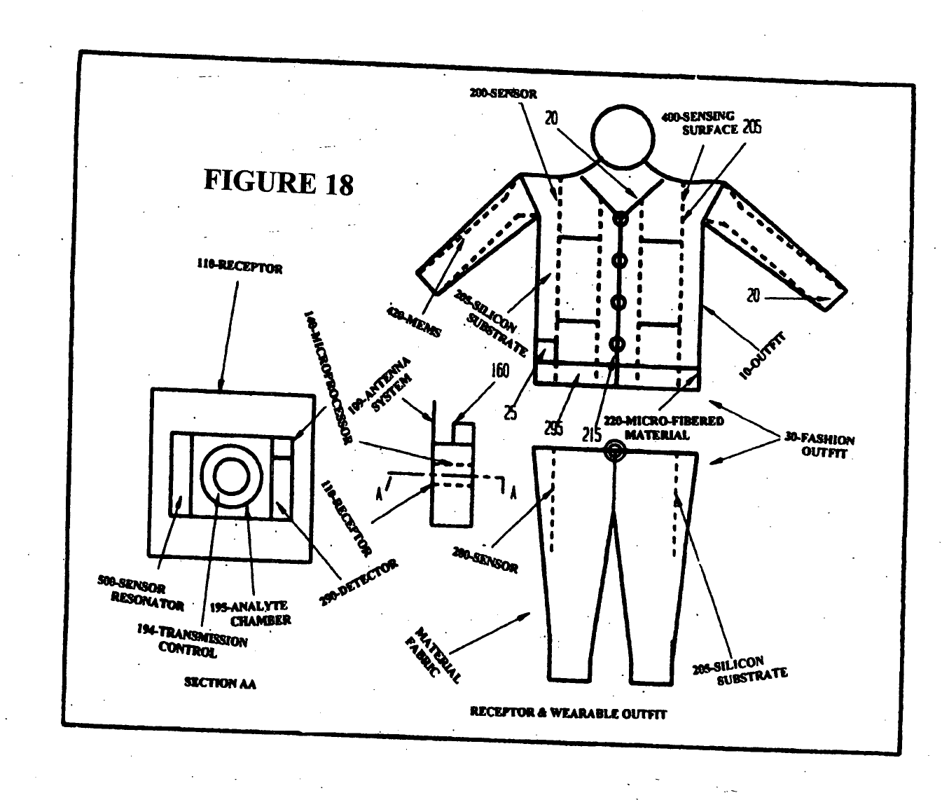

Referring to FIG. 18, is seen at least an exemplary embodiment of outfit 10 comprising a silicon substrate 205. At least a sensor 200 is embedded in the silicon substrate 205 and fused/etched in a micro-fibered material 220 comprising a detection platform 295. The outfit 10 further comprises at least a fashion outfit 30 comprising of at least a material fabric consisting of at least a lining 20 and at least a connector 25 each operatively configured with the detector platform 295. The detection platform comprises at least a sensing surface 400 operatively connected to at least sensors 200 and 420. The lining 20 is responsive to protection. The detection platform 295 is operatively configured with a receptor 110. The receptor 110 comprises at least an adaptor 160 operatively configured with the adaptor for the outfit 10. Section AA is seen to represent sections of the receptor 110 consisting of sensor resonator 500, a transmission control 194, an analyte chamber 195, detectors 290, and a microprocessor 140. The receptor 110 further comprises an antenna 109 responsive to input and output signals. The antenna 109 is operable to increase signal strength and may comprise internal antenna apparatus being configured with a chip operable on a logic circuit. The chip is operatively configured to boost communication signals through the antenna to improve sound quality and reduce dropped communications. The chip is operable on a logic circuit being communicatively connected with the receptor circuit board and in communication with the antenna. Disclosed embodiments provide software in communication with the logic circuit being configured for analyzing signal strength and data speed. The amplification of the signals would improve wireless data transmissions, data card “IC card and SIM card” reception, providing faster data transfer speeds. The chip is further operable to move the wireless signal radiation away from personnel's head and to reduce exposure to cellular radio signals, which may cause health issues. The chip is a solution which depends on antenna configuration and may be operable on CDMA, TDMB, Digital/Analog/GSM, and location area network.

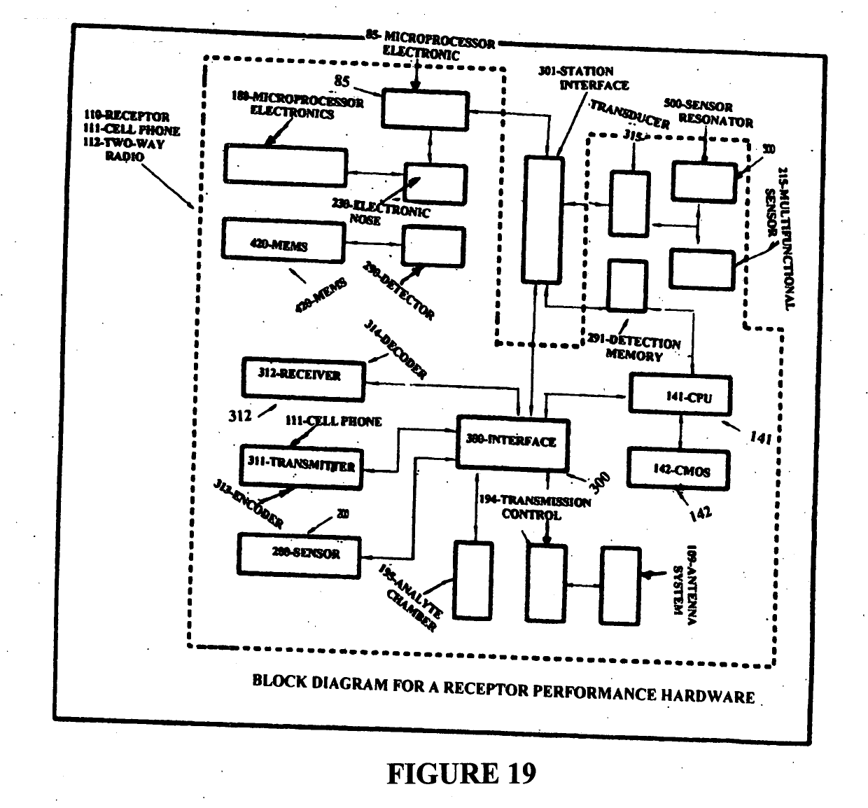

Referring to FIG. 19 is seen a block diagram of comprising an exemplary embodiment a receptor 110. Receptor 110 may comprise other communication devices such as at least a cell phone 111, and/or at least a two-way radio. The receptor 110 further comprises of other components, including microprocessor electronics 85 and 180. At least a station interface 301 is operatively configured with the microprocessor electronics 85 and 180. At least a transducer 315 is operatively configured with sensor resonator 500 and multifunctional sensor 215 and communicatively connected to detection memory 291. The detection memory 291 is communicatively connected to station interface 301 and operatively configured with CPU 141. The CPU 141 and the CMOS 142 are communicatively connected to interface 300 comprising at least an analyte chamber 195, at least a transmission control 194, and at least an antenna system 109. Receiver 312, transmitter 311, encoder 313 and decoder 314 are communicatively connected to interface 300. The microprocessor electronics 85 and 180 are communicatively connected to MEMS 420, electronic nose 230, and detector 290. Station interface 301 is operatively configured with interface 300. The receptor 110 further comprises communication control device comprising silicon controlled rectifier consisting of a p-type and n-type gates. The communication control device is further operable in forward and/or reverse bias mode. The silicon control rectifier is further operatively configured for signal amplification and/or communication signal booster. Disclosed embodiments further provide the chip comprising a CMOS 142 operable on a digital circuitry. Certain embodiments provide integrated circuits (chips). The CMOS circuitry is operable to dissipate less power. Certain embodiments of the disclosure further provide a static logic configuration being operable on p-type and n-type metal-oxide-semiconductor field-effect-transistors “MOSFET's.” being configured for implementing logic gates. Embodiments provide the CMOS 142 comprising logic being implemented with discrete devices of transistors of both p-type and n-type on silicon and or silicon substrate 205 commonly called chips, dice, dies. Embodiments provide CMOS 142 comprising fabrication of solar cells on n-type CZ silicon substrates, including Polycrystalline thin-film cells, lightly boron-doped CZ, or gallium-, indium-, and aluminum-doped CZ for converting solar energy, pressure force, sound wave, vibration, wind force into electrical energy. Disclosed embodiments further provide a thin-film 430 comprising of thin layer of transparent conducting oxide, including tin oxide. Certain embodiments provide the oxides being highly transparent and configured to conduct electricity efficiently. Some embodiments provide antireflection coatings. Other embodiments provide Polycrystalline thin-film cells comprising tiny crystalline grains of semiconductor materials operable for converting solar energy into electrical energy.

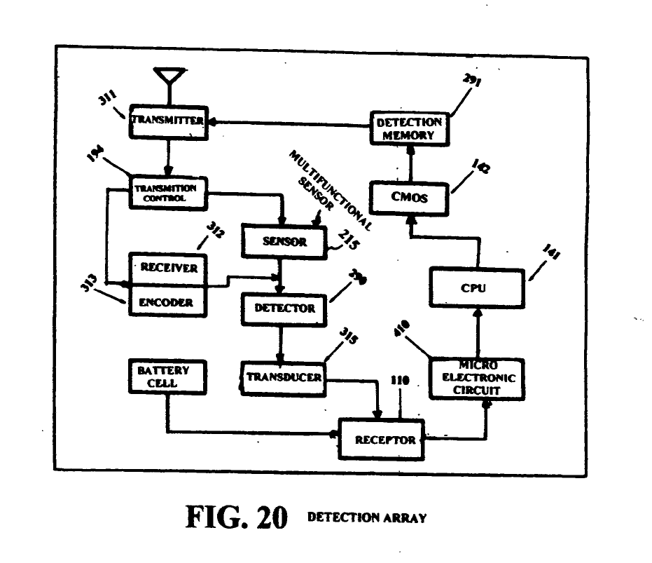

Referring to FIG. 20 is seen an exemplary embodiment of a detection array is presented in accordance with other aspects of the disclosure. At least a receptor 110 normally comprise of a transmitter 311 operatively configured with transmission control 194. Detection memory 291 is communicatively connected to the transmitter 311 and multifunctional sensor 215. Transmission control 194, receiver 312, encoder 313, and detector 290 are communicatively connected to detection memory 291. The detection memory 291 is communicatively connected to CMOS 142 and CPU 141. The CPU 141 and the CMOS 142 are communicatively connected to micro-electronic circuit 410 comprising at least an antenna system 109. Receiver 312, transmitter 311, and encoder 313 are communicatively connected to a battery cell operatively configured with the receptor 110.

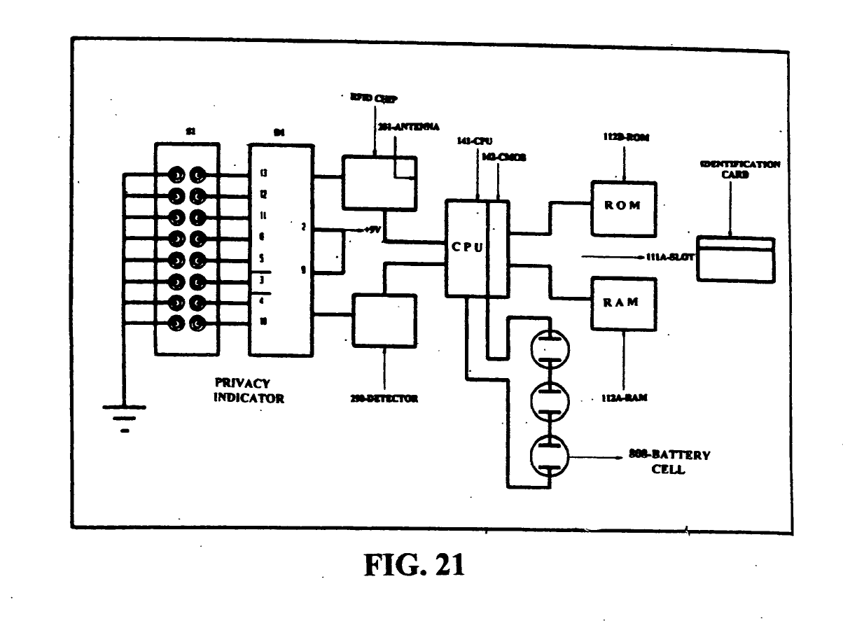

Referring to FIG. 21 is seen an exemplary embodiment of the receptor 110 comprising a communication apparatus including privacy indicator. Switch (S1) is communicatively connected to RFID CHIP in communication with antenna 201. The common node display (D1) is operatively configured with at least an energy means operable for converting solar energy into electrical energy. RFID CHIP is operatively configured with antenna 201, further responsive to solar energy. A CPU 141 is operatively configured with detection device 290, and communicatively connected to at least a CMOS 142 being operatively connected to a battery cell 808. The receptor 110 further comprises an insertion slot 111A, operatively configured for checking identification cards at security stations and/or by homeland security agents. In one embodiment of the disclosure, trained personnel may request an identification card 112 from at least a suspect. The ID card 112 would then be inserted in the insertion slot 111A. The receptor 110 comprises IC card and/or SIM card comprising wireless communication applications in communication with software program operatively configured with the ROM 112B to read the ID card 112. The ROM 112B is communicatively configured to enable communications to the RAM 112A. The RAM 112A is responsive to the database 113 where such ID information may be stored for retrieval. A screen read-out 113A comprises a display device being is configured with the receptor 110 responsive to full information about the suspect. Suspected person's information may be retrieved from at least database 113. An 8-pin privacy indicator switch (S1) is operatively configured with the receptor and responsible for communicating to an officer in private when a pre-used and/or post used weapon is sensed within the body of a suspicious person. Switch (S1) comprises of display selections corresponding to cathode A, cathode G, and cathode D of at least a 7-segment common anode display settings (D1). Chip 200a comprises a detection tool responsible for providing detections and communications to at least a security agency and/or the military and responsive to identifying threats or any object of terrorist attack or enemies at battle fields.

In other embodiment, the RFID chip 200a is coded and in communication with the IC card and/or the SIM card to identify members of the agencies such as battlefield personnel and other security personnel. Still in another embodiment, the RFID chip is configured to distinguish the said personnel from enemies at battle front and/or from terrorist personnel. The coding of RFID chip is responsive to detections, providing the receptor with data operable to provide means of communicating to trained security personnel and military personnel information about the detections with reliability, accuracy, and in real time alert. The information may include anticipatory act of terrorism and/or any mobility of enemy personnel in a battle field. Disclosed embodiment further provides an innovative approach to combating any future war. The technical characteristics of the RFID chip 200a and other sensors embodied in the nanotechnology applications provide many opportunities for innovation to combat the war of terrorism and any other war thereon.

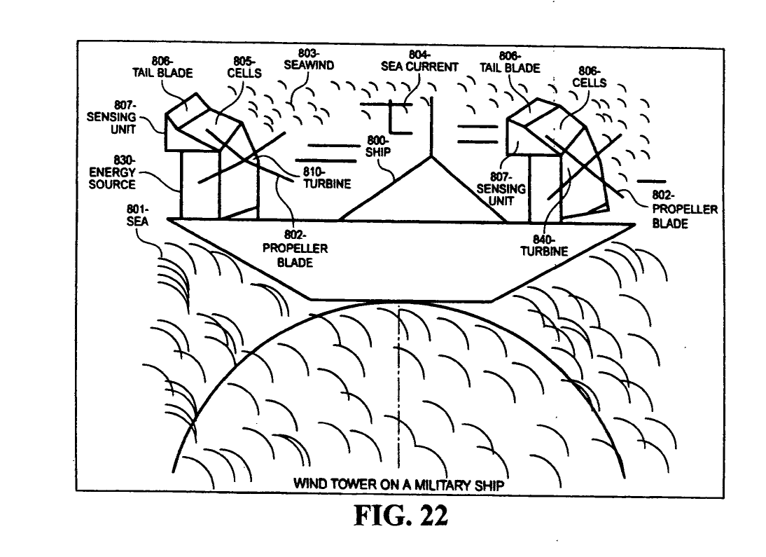

Referring to FIG. 22 is an embodiment of a wind tower on a military ship. A battleship 800 is positioned at sea 801. The sea 801 consist of natural energy such as sea wind 803 and sea current 804. The battleship 800 is operatively configured with means to transform the sea wind 803 and sea current 804 into usable energy source 830. In one embodiment, the ship provides apparatus for transforming sea wind 803 and sea current into energy source 830. The ship 800 is configured with at least a turbine 810 and 840. In other embodiment, the turbine 810, 840 comprises at least a tail vane 806. In other embodiment, the tail vane 806 comprises at least a sensing unit 807. Yet in other embodiment, the turbine 810, 840 comprise of at least a propeller blade 802. Still in other embodiment, the tail vane 806 is configured with at least a cell 805. Yet, in still another embodiment, the turbine 810, 840 comprise of at least a wind tower 71 operatively configured with the tail vane 806 and the propeller blade 802. The propeller blade 802 is operatively configured to be powered by the sea wind 803. The tail vane 806 is operatively configured to enable the propeller blade 802 to rotate with the sea wind 803. The sea wind 803 comprises sea current 804. Disclosed embodiments provide the propeller blade 802 is rotatable so that kinetic energy is created along its movement. The kinetic energy along the direction of the wind is converted into mechanical energy by a generator apparatus being disposed with the turbine 810, 840 to generate electrical energy via the flow of sea current 804, which is then stored in cells 805. The stored energy at the cells 805 is transferable to the receptors 110, which is normally carried by officers 35 as shown in FIG. 2.

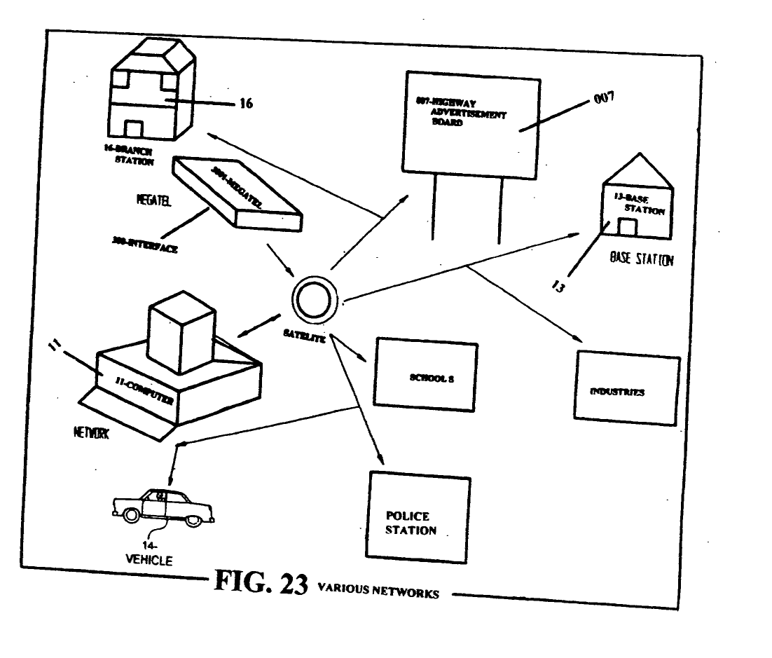

Referring to FIG. 23 is seen exemplary embodiments of various networks are shown communicable with the receptor 110, in communication with the outfit. Signals are transmitted through at least the interface 300, and 3001, and at least the satellite network. The interface 300 is configured for mega communications, and comprises mega telecommunication and information “megatel” interface 3001. Signals are processed and decoded within the receptor, and the decoded signals are transmitted through interface 300 and 3001. Interface 300 and 3001 are operatively configured with the receptor responsive to detection signal communications, and in communications with the central security monitoring station 70. Monitoring station 70 comprises at least a branch station 16, at least a base station 13, at least a police station, schools, and industries in communications with at least one another within a set network environment. The network further includes a computer 11, an advertisement board 007, a vehicle 14, satellite, and other stations.

Referring to FIG. 24 is seen an exemplary embodiment of the network environment comprises a wind fiber tower 71, a fiber tower network 69, a monitoring station 70, and a network 66.

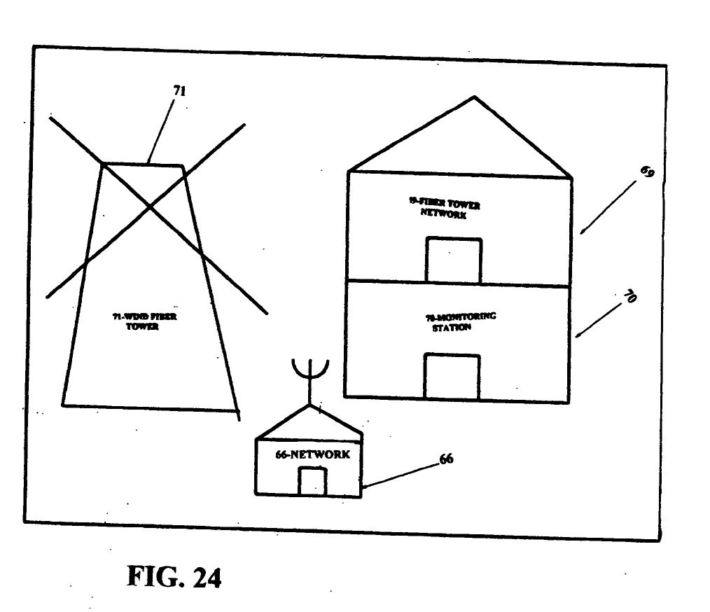

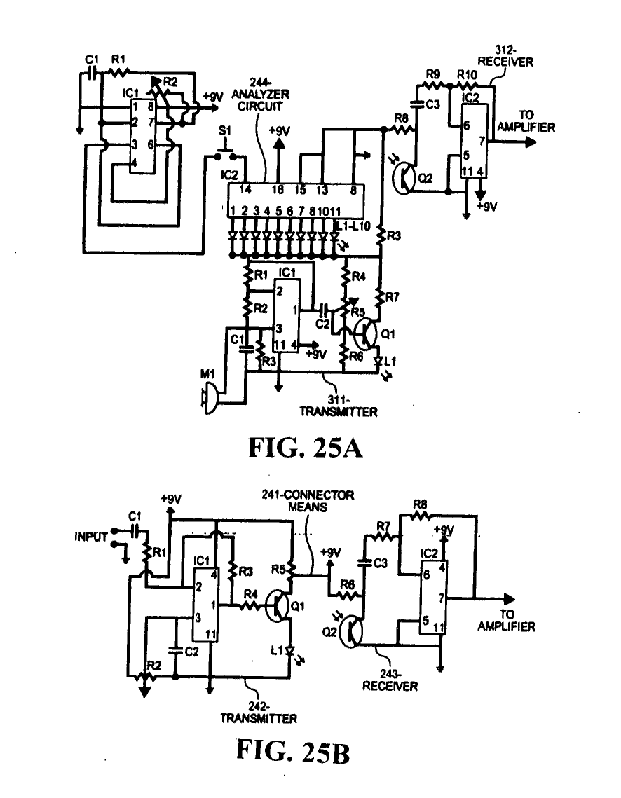

Referring to FIG. 25 is an exemplary embodiment of a communication apparatus comprising receptor 110, comprises a transmitter 242 and 311, and a receiver 243 and 312. Referring to FIG. 25A, the transmitter 242 comprises a battery which may be charged wirelessly. An amplifier is configured with the receptor for amplifying signal communications. The CMOS circuitry is operable to dissipate less power. Certain embodiments of the disclosure further provide a static logic configuration being operable on p-type and n-type metal-oxide-semiconductor field-effect-transistors “MOSFET's.” being configured for implementing logic gates. Transmitter 311 and receiver 312 are communicatively connected to analyzer circuit 244.

Referring to FIG. 25B, the amplifier is seen responsive to signal amplification. Transmitter 242 is seen operatively configured with receiver 243 and communicatively connected to connector beam 244. The amplifier is communicatively connected to receiver 243 and operatively configured with transmitter 242. The transmitter 242 and 311, and the receiver 243 and 312 comprise CMOS comprising of solar cells on n-type CZ silicon substrates, including Polycrystalline thin-film cells, lightly boron-doped CZ, or gallium-, indium-, and aluminium-doped CZ for converting solar energy, pressure force, sound wave, vibration, wind force into electrical energy. Disclosed embodiments further provide a thin-film comprising of thin layer of transparent conducting oxide, including tin oxide. Certain embodiments provide the oxides being highly transparent and configured to conduct electricity efficiently. Some embodiments provide antireflection coatings. Other embodiments provide Polycrystalline thin-film cells comprising tiny crystalline grains of semiconductor materials operable for converting solar energy into electrical energy. At least a CPU-1C1 is provided in communication with RFD) chip reader-1C2. L1 and L2 are LED. S1 is an automatic momentary single pole double throw switch operative for transmitting and for receiving signals. C1 is an electrolytic capacitor being disposed on an energy platform comprising C2 and C3, which are imf capacitors. Q1 and Q2 are infrared LED emitter and M1 is a speaker microphone. R1 through R10 are resistors responsive to signals.

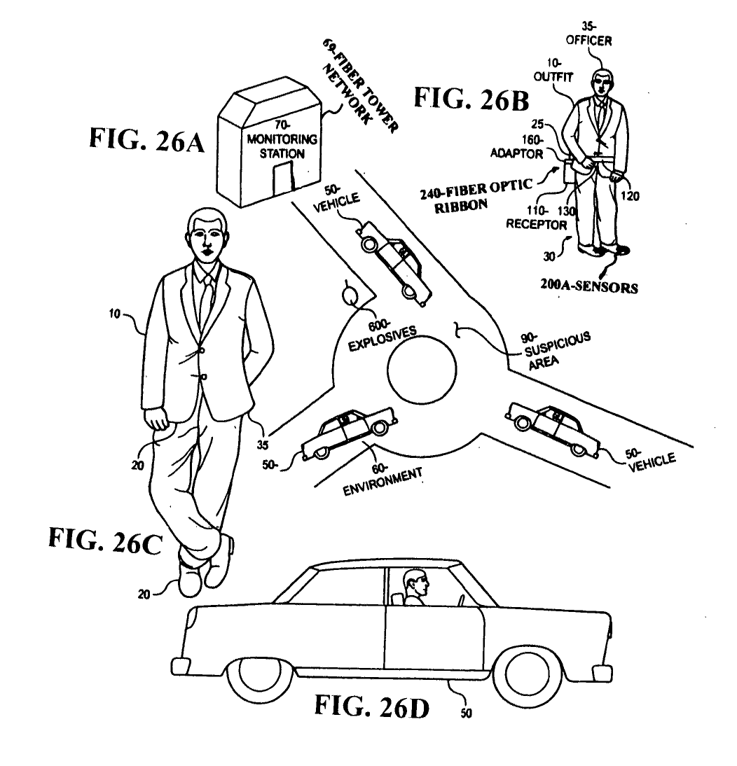

Referring to FIG. 26A is seen further embodiment of a monitoring station 70 and a fiber tower network 69. FIG. 26B is seen an exemplary embodiments of officer 35, wearing outfit 10, 30, and 120. The officer 35 is seen outfitted with receptor 110, outfit 10, 30, 120, and 130. Adaptor 160 is seen configured with the outfits. The receptor 110 is communicatively configured and responsible for networking with the monitoring station 70 and the fiber tower network 69. The receptor 110 is further configured with battery cells, which are responsive to solar energy, pressure force, and further responsible for supplemental energy for empowering the detection platform. At least a fiber optic ribbon 240 is operatively configured with the outfit 10 and 10A, and responsive to supplemental connection between the receptor 110 through at least a connector 25. Referring to FIG. 26C is seen further exemplary embodiment of an Officer 35 being outfitted with disclosed embodiments. Disclosed embodiments further provide a detection platform, comprises nanotechnology applications within outfit 10 and 20. Referring to FIG. 26B and FIG. 26C are seen perspective embodiments of officers 35 monitoring a vehicle 50 entering an environment 60. A suspicious environment 90 is seen being detected with explosive 600 in a suspicious vehicle 50. Referring to FIG. 26D, the suspicious vehicle 50 is seen to have been stopped for inspection after the detection of at least a weapon.

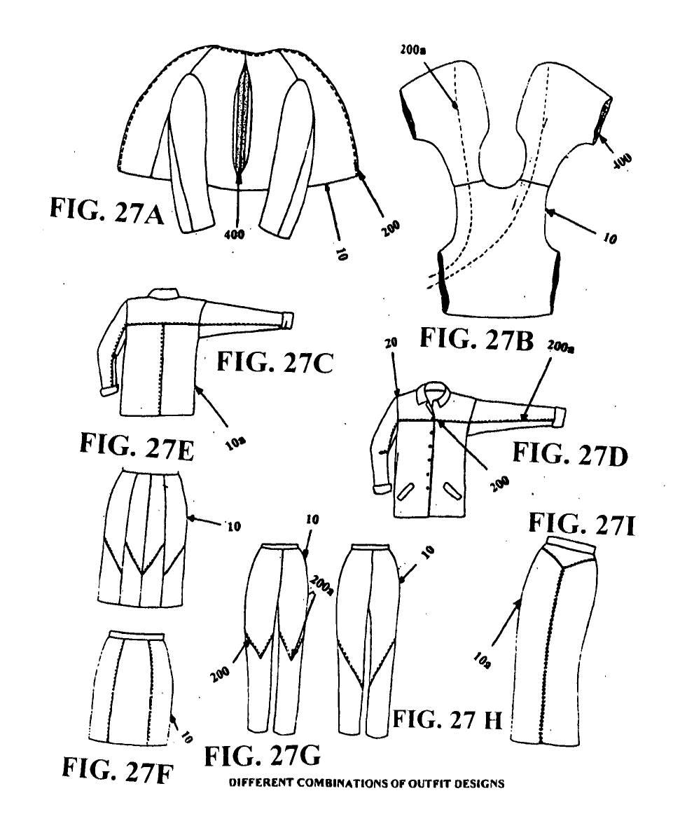

Referring to FIG. 27, different configurations of nanotechnology applications are presented without any limitations to the scope of the disclosure. In FIG. 27A, outfit 10 is seen comprising a detection platform 295 configured with sensors 200 and 400. FIG. 27B is seen a supplemental configuration of outfit 10 comprising the detection platform 295 configured with sensors 200A and 400. FIG. 27C is seen another supplemental configuration of the outfit consisting of outfit 10A. FIG. 27D is seen further supplemental configuration of outfit 20 comprising the detection platform 295 being configured with sensors 200A and 200. In FIG. 27E, FIG. 27F, FIG. 27G, FIG. 27H, and FIG. 171, are seen similar configurations of the detection platform 295 for outfit 10 and 20 consisting of nanotechnology applications.

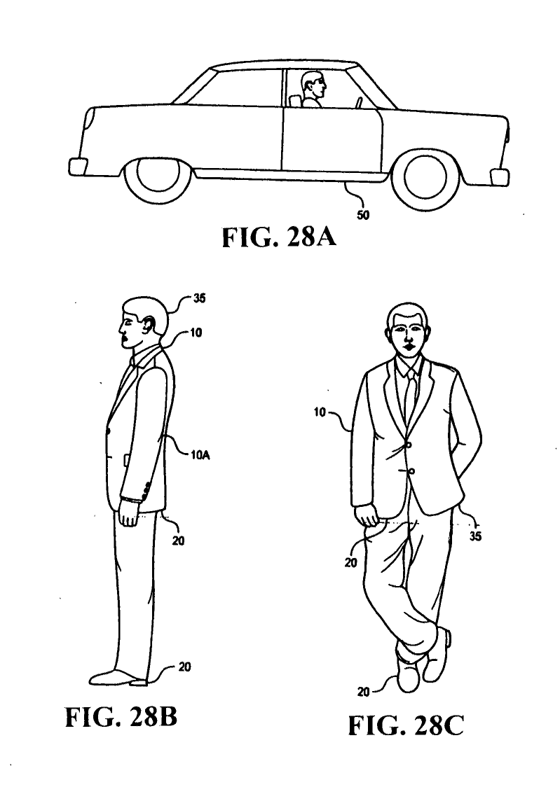

Referring to FIG. 28A, is seen perspective embodiment of a suspicious vehicle 50 carrying weapons of mass destruction being detected by disclosed embodiments. Referring to FIG. 28B is seen further exemplary embodiment of the outfit 10, 10A, and 20 worn by an officer 35. The officer 35 is seen monitoring the detection of vehicle 50 as seen in FIG. 28A. Referring to FIG. 28C, is seen a second exemplary embodiment of the outfit 10 and 20 and worn by officer 35. Officer 35 is further seen monitoring the detection of vehicle 50 as seen in FIG. 28A.

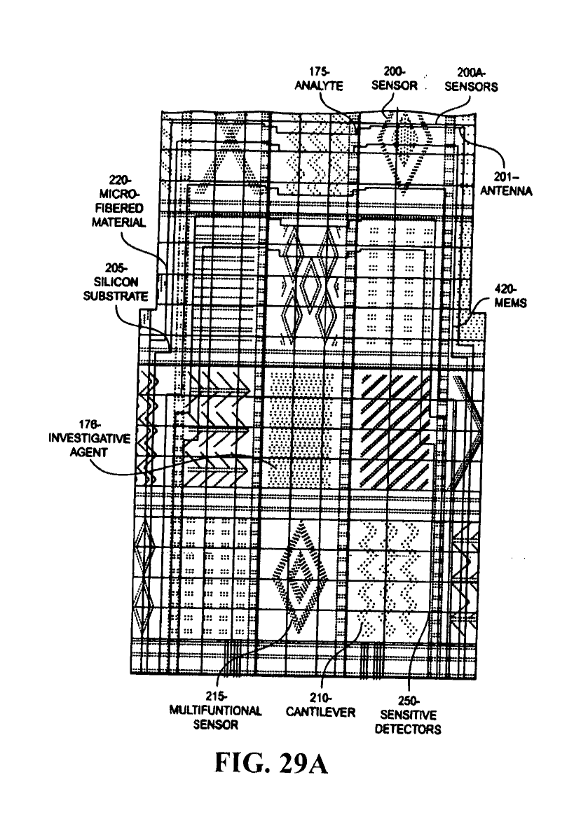

Referring to FIG. 29A, is seen an exemplary embodiment of the material for an outline configured for providing a detection platform comprising a silicon substrate 205. Sensors 200, 200A, 210, 215, and 420 are embedded in the silicon substrate 205. The silicon substrate is fused and/or etched in micro-fibered material 220. The micro-fibered material 220 comprises of at least a material consisting of microfiber/nano-fiber characteristics that exhibits excellent electrical properties. The detection platform further comprises an investigative agent 176 operatively configured with an analyte 175. Antenna 201 is embedded in the silicon substrate 205 and communicatively configured with sensors 200, 200A, 210, 215, 250, and 420.

Referring to FIG. 29B, is seen further exemplary embodiment of the disclosure, providing perspective embodiment of the material for the detection platform, comprising micro-fibered material 220 configured with sensors 200 and 200A.

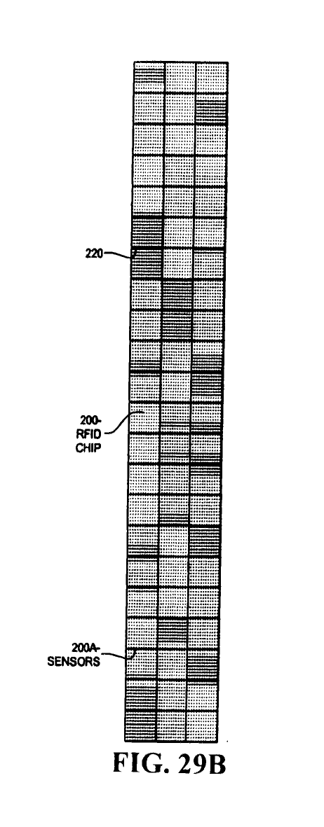

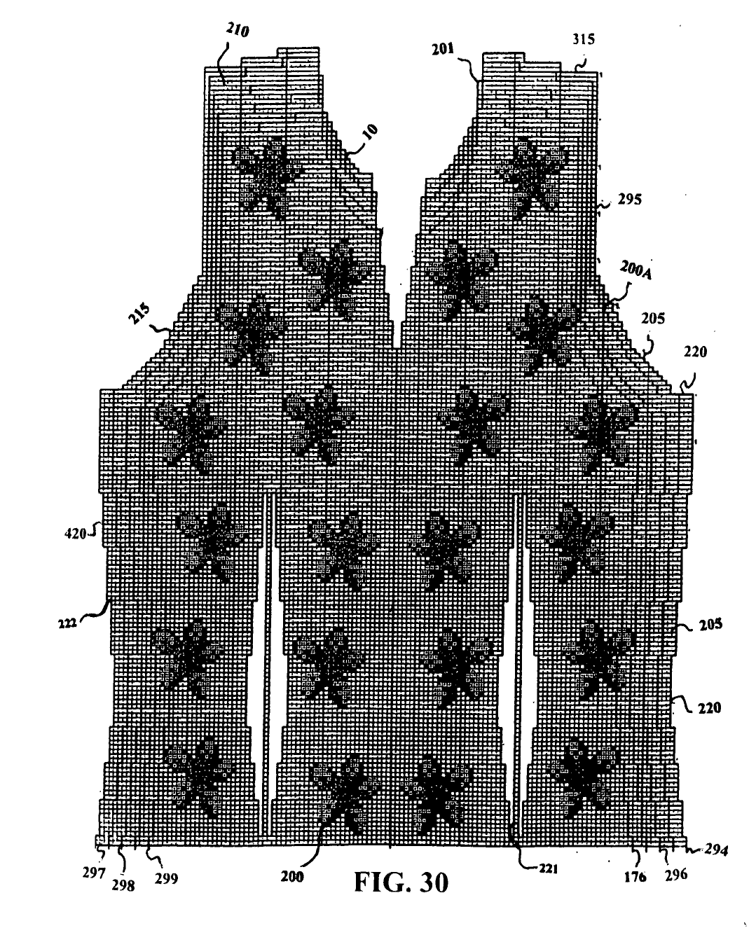

Referring to FIG. 30, is seen an exemplary embodiment of the outline for the outfit 10. Disclosed embodiments further provide sensors 200, 200A, 210, 215, and 420 being embedded in a silicon substrate 205 and etched/fused in a microfiber/nano-fiber material 220 comprising at least a material with good electrical characteristics to provide efficient detection selectivity for the detection platform 295, energy platform 296, and cell platform 297. The detection platform 295 further comprises miniaturized steels comprising nano-wires being configured to provide electrodes 298. The outfit 10 is operatively configured to monitor, detect, and protect. The detection platform further comprises silicon substrate 205. Sensors 200, 200A, 210, and 215 are further embedded in the silicon substrate 205. In one embodiment, the silicon substrate 205 is further configured with ferrous and/or non-ferrous materials 221. In other embodiment, the material 221 is alloyed with the micro-fibered material 220. Still in other embodiment, the material 221 comprises malleability properties comprising a malleable miniaturized steel 222. Antenna 201 is embedded within the structures of the detection platform and communicatively connected to the sensors. Investigative agent 176 is operatively configured with analyte 175 and communicatively connected to the detection platform responsive to detection signal communications. Disclosed embodiments provide the detection platform 295 comprising electrical isolated layer 299 configured with infrared transmitter-receiver and/or transducer 315.

Disclosed embodiments provide an outfit method of detection comprising a detection platform consisting of sensors 200A, 200A, 210, and 215. Certain embodiments provide a sensory platform comprising MEMS 200, RFID 200a, TRANSDUCERS 315 and nano-sensors being embedded in a silicon substrate 205 and fused in a micro-fibered material 220 to enable the detection platform.

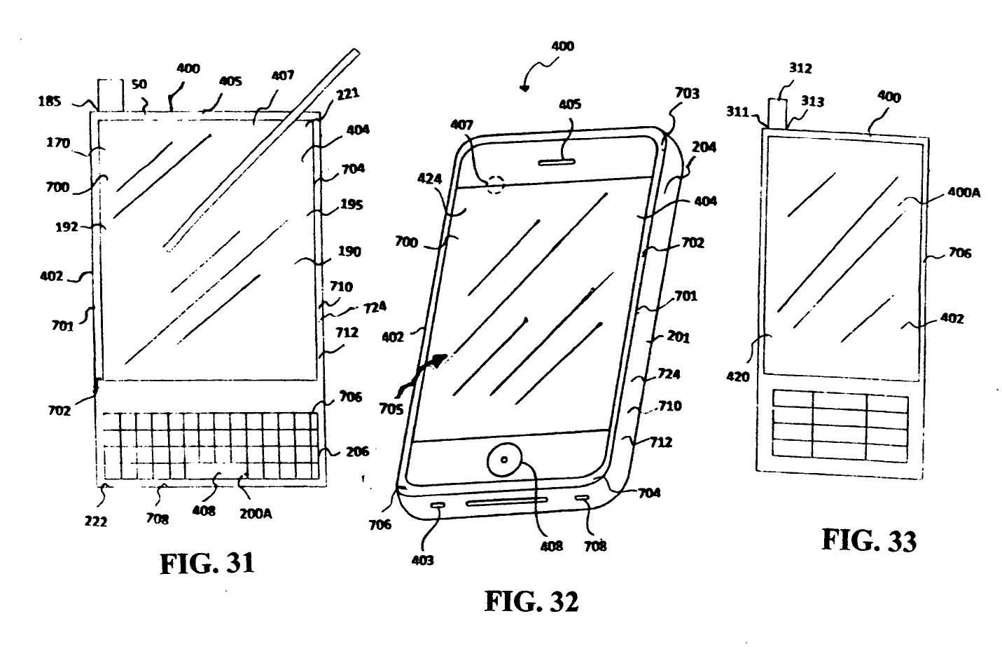

Referring to FIG. 31 is seen exemplary embodiment of a communication apparatus 400 with GSM, touch screen, and CPU in accordance with one embodiment of the invention. The communication apparatus 400 comprises a housing 402 comprising of a sensory platform 700 consisting of nanotechnology application. The sensory platform further includes strain gauges 701 embedded in load cells 702. Disclosed embodiment further provide nano technology applications comprising nano sensors 704 being embedded in silicon substrate 712 alloyed with meta-material structure cavity and fused/etched in microfiber/nano-fiber material 710, providing a silicon microfiber/nano-fiber 724. The sensory platform 700 being operable to provide a detection platform 706 being further operable for communications and/or for converting at least a form of energy into electrical energy. The detection platform 706 further comprises at least multiple CMOS antenna circuit consisting of on chip antenna operable for intra-chip network, further comprising at least a transformer module operable with at least a battery module. The transformer module further comprises electronic interface circuit operable to match the power need for the communication apparatus. The communication apparatus 400 further comprises a hand-held device operable for providing communication services. Certain embodiments provide the communication services comprising voice communications.

Some embodiments provide communication services comprising cellular phone functionalities, including symbol processing. At least the functionality may include an antenna apparatus being configured with a chip in communication with a radio module. The communication apparatus 400 is further disposed with hardware enclosing at least a control logic in communication with a software operable for providing the communication services and for performing symbol processing. The software comprises an operating system. In the embodiments further include radio functionalities operable for providing communication services. Certain embodiments provide the communication apparatus 400 comprising a computer device operable for providing the communication services. At least one communication service comprises Internet services. At least one switch device comprises application button being operable for controlling functions of the communication apparatus 400 and directions of the symbols. At least one symbol is associated with the display/input device 424, and further comprises a scroll-up and/or scroll-down button.

Disclosed embodiments further provide the sensory platform 700 further comprising a display/input device 404 being disposed with the housing 402. Certain embodiments provide the housing 402 further consisting of speakers 405, microphones 408 embedded antenna apparatus 201 in communication with at least a signal booster comprising a chip 403, in communication with a logic circuit 407. The communication apparatus 400 further comprises mobile broadband device configured with the detection platform 706 comprising sensors 708 being operable for detecting objects proximity to at least the display/input 404. The communication apparatus 400 may comprise at least one of: cellular telephone, telephonic, media device, PDA device, cellular telephone, GPS device, entertainment device and/or an information device being operable for road and traffic communications, including road side advertisement. The media device further consists of input and output devices. Disclosed embodiments provide the communication apparatus 400 configured in the housing comprising of a cellular telephone, a game device, and a media player and a PDA. The communication apparatus 400 is portable and may fit within the hand of normal adult and grown children. In one embodiment, the display/input device 404 may include at least one of multi-point interactive touch input screen, an LCD display. In one embodiment, the multi-point interactive touch screen is a capacitive sensing medium configured to detect multiple touches, including blobs on the display from a user's face or multiple fingers touching or nearly touching the display.

The load cell 702 further comprises silicon load cell comprising of force sensor in communication with software 204. Disclosed embodiments provide force measurement apparatus being operable to perform measurement and to generate energy by compressing a meander-like strain gage 701. Certain embodiments provide a second strain gage, which is not loaded, operatively configured for temperature compensation and for compensation of bending and stretching stresses in the chip comprising energy platform 705, eliminating a zero-load resistor values on the communication apparatus 400. Some embodiments provide the communication apparatus 400 being configured with a bridge 703, whereby the output of the bridge 703 is at least a linear function of the total force and independent of the force distribution on the silicon chip comprising the energy platform 705. Disclosed embodiments further provide a communication apparatus 400 comprising load cell to MEMS system integration being operable with integrated systems' interface. The physical scales as well as the magnitude of signals of various integrated subsystems vary widely. The communication apparatus 400 provide a MEMS load cell system integration being further configured for high capacity load sensing, including a micro-machined sensing gauge, interface electronics and energy module for communication signal characterization. Disclosed embodiments further provide a communication apparatus 400 comprising silicon substrate-microfiber/nano-fiber hybrid technologies. The subsystem further provides piezoelectric sensor comprising of piezo-resistive sensing being operable on CMOS processes. Embodiments provide the silicon substrate-microfiber/nano-fiber further comprising a metal semiconductor being configured with the CMOS processes to provide nano-scale webcam and antenna apparatus 201 that could effectively couple light into a semiconductor light emitter. The configuration of the subsystem includes a sensing layer being configured to reduce the offset, temperature drift, and residual stress effects of the piezo-resistive sensor. Disclosed embodiments further provide CMOS multiple antennas configured with MEMS sensors. Certain embodiments provide a MEMS antenna configured for energy harvesting. Other embodiments provide the MEMS sensors disposed on at least energy recovery circuit comprising radio frequency CMOS circuitry configured for plurality frequencies.

The load cell 702 comprises of built-in electronics for signal conditioning, processing, and communication. Certain embodiments provide the CMOS comprising of multiple antennas configuration with at least a metal oxide semiconductor; providing multiple on chip antennas in communication with motherboard for communication apparatus 400. The multiple on chip antennas provide intra-chip antenna network for efficient wireless communications. The CMOS multiple antennas further comprises CMOS-MEMS-RESONATOR. Some embodiments provide the CMOS multiple antennas further comprises silicon wafer glass filtration membrane coupled to CMOS-MEMS on a circuit. The circuit further comprises an oscillator circuit for sensing resonance frequency shift and humidity. The CMOS multiple antennas comprises silicon wafer configured with reflective meta-material structured surface, providing a thin surface layer to improve circuit performance for faster data transport transceiver. Wireless data transmissions are applied on the multiple layers and between the chips, in communication with the communication circuit board. The silicon substrate microfiber/nano-fiber material is alloyed with meta-material to provide excellent electrical characteristics and compensate for CMOS conductor loss. Disclosed embodiments provide CMOS multiple antennas comprising on chip dielectric substrate.

Referring to FIG. 32 is seen exemplary embodiment of a communication apparatus 400 in a first configuration of a mobile phone with a WAP browser in accordance with one embodiment of the present invention. The communication apparatus 400 further comprises a detection platform 706 being further operable for providing multiple communications environment and mobile broadband services. Disclosed embodiments further provide a communication apparatus 400 comprising single and/or multiple communication environments 400A. Certain embodiments provide at least a communication environment 400A including at least one of: position finder, Radio Frequency Identification Devices (RFID), emergency communication device, medical diagnostics, General Packet Radio Service (GPRS), transportation information highway (TIHW), at least a Modulation Format Selectable cellular device (MFSCD), mobile wireless apparatus, satellite device, land based device, Global Mobile communication device, mobile broadband device, Enhanced Digital GSM (EDGSM), SD card slot, HDMI/USB ports, and/or Code Division Multiple Access (CDMA).

Disclosed embodiments provide a communication apparatus 400 being further configured for multiple communications. The communication apparatus 400 further comprises at least one of: broadcast device, tracking device, location finder, position finder, processor in communication with at least one of: transmitter, receiver, transceiver, entertainment device, remote control device, educational device, gaming device, medical device, signal detection device, video and/or visual image signal detector, infrared device, Global Positioning System (GPS) receiver and/or an interface to a GPS receiver, temperature detection device, electrical signal detection device, mobile broadband device, webcam device, video camera device, and Radio Frequency Identification Device (RFID.

Some embodiments provide a communication environment 400A further comprises at least one of: Wideband Code Division Multiple Access (WCDMA), Time Division Multiple Access (TDMA), Infrared (IR), Wireless Fidelity (Wi-Fi), Orthogonal Frequency Division Multiplex (OFDM), and/or Bluetooth application. Disclosed embodiments provide a communication apparatus 400 further comprising a communication environment including at least one of: an interface device 402, a processor 420, a transmitter 311, a receiver 312, and/or a transceiver 313. Disclosed embodiments further provide the interface device 402 comprising content composed of user interface component objects operable for receiving contents. Certain embodiments provide the interface device 402 comprising user interface component objects operable for extracting exportable information. At least one of the exportable information is being exportable outside the content. Disclosed embodiments further provide the interface device configured for detecting at least one of action and providing a signal for transferring the exportable information to at least a target object.

Referring to FIG. 33 is an illustration of an exemplary embodiment of the communication apparatus 400 comprising a mobile phone with integrated GPS and MP3 music capability configured with sensors 704, 708 embedded in silicon substrate microfiber/nano-fiber 724 for providing detection platform 706 with sensitivity and selectivity in accordance with the present invention. Embodiments provide nanotechnology application on a detection platform 706 comprising image and/or sound sensor device 170 operatively configured with RFID chip 200. The detection platform further comprises nano sensors being embedded in a silicon substrate 712 being alloyed with meta-material structure surface cavity and etched/fused in a microfiber/nano-fiber material 710 to improve wireless communication efficiency and remove radiation pattern back lobe. Disclosed embodiments provide a communication apparatus configured with nano sensors, including image and/or sound sensor 170, load cell 702, RFID chip 200, strain gauge 701, and temperature sensor 200A. Some embodiments provide the detection platform 706 comprising nano sensors, including at least one of: load cells 702, strain gauge 701, membrane 195, resilient membrane 206, optical sensors 50, MEMS 192, detection means 190, and/or transducer 185. The detection platform 706 further comprises ferrous and/or non ferrous material 221, 222 being alloyed with the silicon substrate 712 and etched/fused in microfiber/nano-fiber material 710. The communication apparatus 400 further comprises a housing 402, a display/input device 404, a speaker 405 device, a logic circuit 407, and a microphone 408. The substrate may further comprise optical elements suitable for electronic wafer module. The wafer module may comprise light shield film and/or UV curing resin configured with transparent support substrate.

The optical sensor 50 is further configured for optical video modulation. Disclosed embodiments provide the display device 404 comprising a display screen operable for displaying information. Certain embodiments provide the display device 404 comprising an input/output unit operable for receiving input of information and for sending output information. Other embodiments provide the display device 404 configured with a storage medium operable for storing data therein a plurality of executable and/or relation information, including object information operable for indicating an object is correlated with relationship information having a relationship with other objects. Yet, certain embodiments provide the display device operable for selecting object information and for apparatus for providing relationship information with an object. Disclosed embodiments provide the object further comprises a user of an electronic device. Certain embodiments provide the object further comprising switches and buttons embedded in a touch screen device. At least said one touch screen device comprises a control unit for causing the display device to display the selected information stored in the storage medium. Some embodiments provide the selected information being displayed in a display position of the touch screen. The display position further comprises a predetermined distance being displayed within the embodiment of a display device. At least one predetermined distance further comprises information normally displayed by a global positioning system (GPS) from selected information within a directory of a predetermined direction.

The transparent support substrate may comprise at least a glass plate. The wafer module further comprises energy management apparatus. Photon in sunlight passed through the silicon microfiber/nano-fiber semiconducting materials, or reflects through the silicon microfiber/nano-fiber semiconducting material, or absorbed by silicon microfiber/nano-fiber semiconducting materials. Electron (negatively charged) is knocked loose from their atoms, allowing them to flow through the silicon microfiber/nano-fiber material to produce electricity on a solar cell “Energy Platform” operable to extend battery life. Due to the special composition of solar cells, the electrons are only allowed to move in a single direction. The solar cells are configured to convert solar energy into a usable amount of electrical energy. The solar cells are further configured with light absorbing material within the cell structure to absorb photons and generate electrons via the photovoltaic effect. Tin film is further provided to reduce the amount of light absorbing material required for the solar cell. The absorbing material may include cadmium telluride. Embodiments further provide high-rate deposition of materials including at least one of: thin film, polymer, carbon, silicon, metals, metal oxides, and the like, onto at least a substrate. Disclosed embodiments provide communication apparatus 400 is further configured with silicon substrate microfiber/nano-fiber 712. The silicon substrate microfiber/nano-fiber 724 further comprises fiber mesh and/or synthetic fiber mesh to inhabit shrinkage cracking and to reduce settlement cracking. Some embodiments provide a communication apparatus 400 being configured with silicon substrate microfiber/nano-fiber 724 to improve cohesion and reduce explosive spalling in high temperature or impact. Certain embodiments provide the communication apparatus 400 includes camera/video device being configured with the silicon substrate microfiber/nano-fiber 724 to reduce water migration and permeability while providing a residual strength. Disclosed embodiments further provide a communication apparatus 400 being configured with silicon substrate microfiber/nano-fiber 724 to generate electrical energy, improve communication clarity, resist shattering, resist fatigue, and boost communication signal.

Certain embodiments provide particles of the material being mixed with fluid and injected against at least a metal at high pressure and high velocity. Some embodiments provide the particles of the material forming a current collection surface of the metal. The metal further comprises cathode and/or anode combined with a separator to form at least an energy platform further comprising at least one of: fuel cell, metal-ceramic membranes, film composite metal-ceramic materials being configured with the communication apparatus. The silicon substrate may include carbon nano-tube; single crystalline silicon; and polycrystalline silicon. The silicon substrate may further be disposed with an intrinsic layer comprising at least one of: silicon dioxide; silicon nitride; silicon-on-insulator substrate; silicon-substrate-fiber mesh; carbon fiber mesh substrate; diamond-like carbon fiber mesh; and silicon oxide, and may be formed on a substrate and or a continuous substrate. The silicon substrate is further configured with CMOS processes circuitry. The CMOS circuitry further comprises camera and webcam devices. Certain embodiments provide the communication apparatus 400 further comprising a display/input/output device being configured with laminated of a transparent substrate comprising synthetic fiber mesh being plated with metal alloy, providing an adequate shielding against electromagnetic waves from at least a plasma display. The diamond-like carbon mesh is attached to a silicon substrate configured for converting heat energy into electrical energy. The metal alloy comprises material with excellent electromagnetic shielding and having the ability to absorb near infrared rays. The silicon-substrate-fiber mesh further provides an apparatus for transferring data efficiently on and off of an integrated circuit in communication with a network node. Disclosed embodiments further provide a communication apparatus 400 configured with optical switch device. The communication apparatus 400 further comprises energy absorption device.

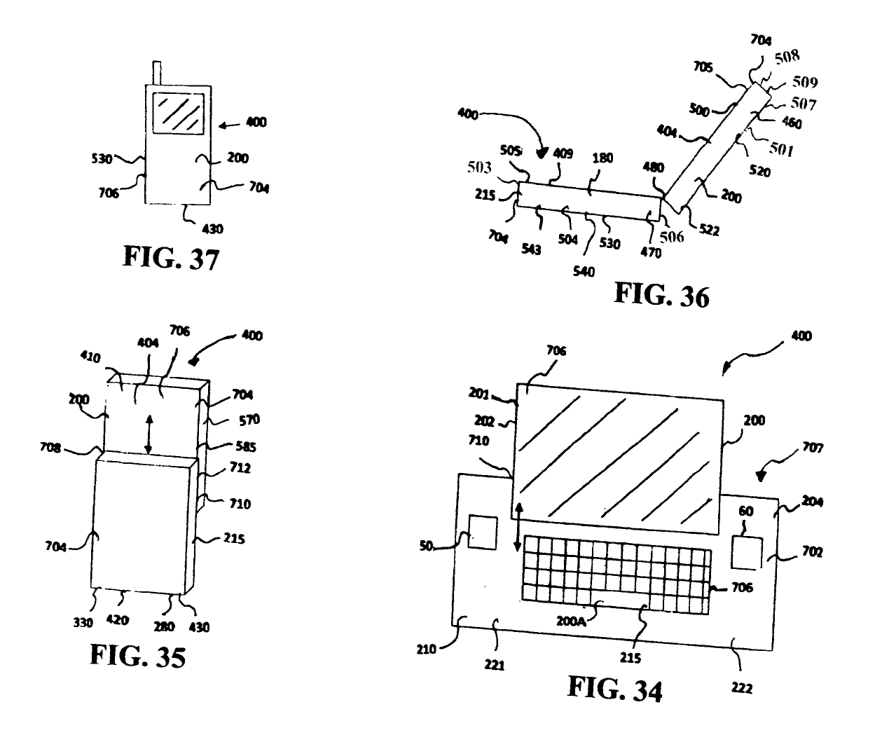

Referring to FIG. 34 is an illustration of an exemplary embodiment of the communication apparatus 400 comprising a slide-able mobile phone with predictive text massaging platform and QWERTY keyboard. The communication apparatus further comprising sensors embedded in silicon substrate microfiber/nano-fiber to provide a sensory environment for the detection platform 706 in accordance with the present invention. The detection platform further comprises electronic wafer module being configured with sensors. The wafer module further comprises solar panel being configured for converting light photons to a photon generated electrical current. At least a heating module and a cooling module are provided with the wafer module. FIG. 4 further depicts the detection platform 706 further comprises a wearable outfit 707 being configured for housing the communication apparatus 400. The wearable outfit 707 further comprises a cell phone case configured for generating electrical energy. The communication apparatus is operable for communications and for generating electrical energy. Disclosed embodiments provide a communication apparatus being transformed into force responsive device operable for communications and for detecting logistics influential to communication signals, data transmissions, communications environment including touch screen display.

Disclosed embodiments further provide a communication apparatus being outfitted with the housing 707 configured for converting at least one of: solar energy, vibration, pressure force, and/or wind force into electrical energy. The communication apparatus further comprising sensors on silicon substrate 712. Certain embodiments provide the silicon substrate 712 being sensitized with microfiber/nano-fiber material 710 configured with complementary metal oxide semiconductor; providing a selective and sensitive detection platform 706. The detection platform 706 further comprises antenna apparatus 201 in communication with at least a chip 202 comprising signal booster. The chip 202 further comprises logic configured with software 204 comprising an operating system in communication with the communication apparatus 400. The communication apparatus is further configured with sensors, including at least one of: cantilever sensors 210, load cells 702, multifunctional sensors 215, optical sensors 50, temperature sensors 200A, investigative agent 176, RFID chip 200, and/or electro optical sensors 60. Disclosed embodiments further provide the communication apparatus 400 being re-enforced with at least one of: ferrous material 221, and/or non ferrous material 222. Disclosed embodiments provide the chip 202 further comprises multiple antenna apparatus operable for intra-chip communication network. Embodiments provide on-chip antennas 202 operable for wireless communication interconnections. The on-chip antenna 202 comprises multiple CMOS antennas comprising on-chip signal communication network for wireless communications; comprising Multicast Protocol Label Switching Network “MPLSN.” The MPLSN is operable on a contemporary layer of the communication circuit board; comprising a CMOS antenna network platform.

Referring to FIG. 35 is seen further embodiment of the communication apparatus 400 comprising mobile phone with Bluetooth technology, infrared sensors, calendar, FM radio and a sensory platform 704. The sensory platform further comprises cell environment 708 being operable for communications, for display/input, and for generating electrical energy. The sensory platform 704 comprises at least a silicon substrate 712. The silicon substrate 712 comprises of nanotechnology applications consisting of at least one of: nano sensors 200, multifunctional sensors 215, micro beam devices 280, sensory array 330, MEMS 420, thin film 430, including piezoelectric thin film AIN, being fused/etched in microfiber/nano-fiber material 710 to provide detection platform 706 with efficient detection selectivity and efficient detection sensitivity. Disclosed embodiments further provide the nanotechnology application comprising of nano sensors. At least one nano sensor comprises an accelerometer. Certain embodiments provide the sensory environment 704 being configured with sensors, including surface acoustic wave line 570 being coated with paste and/or ink 585 comprising of passive glass film. MEMS 420 and multifunctional sensor 215 are configured with thin film 430, in communication with at least a microelectronic circuit 410 to further convert solar energy into electrical energy. The surface acoustic wave line 570, the paste 585, the MEMS 420, the thin film 430, and the multifunctional sensor array 330 are embedded in the silicon substrate 712 and etched/fused in a micro-fibered material 710 to provide a detection platform 706 further operable for generating electrical energy. The silicon substrate is micro-machined in a chemical and/or electromechanical etch technique.

Referring to FIG. 36 is seen further embodiments of the communication apparatus 400 comprising a clamshell mobile phone with GPRS Internet services, QWERTY keyboard and virtual keyboard on a touch screen configured with social network platform, and a sensory environment 704 consisting of energy platform 705 operable to extend battery life. Other embodiment of the sensory environment provide a silicon to silicon bonding 460 and/or silicon to ceramic wafer bonding 470 being configured for detection and for generating electrical energy. The silicon to ceramic wafer bonding is further responsive to solar energy for generating electrical energy. The silicon to ceramic wafer bonding may include at least silicon to glass bonding 480, forming single crystal silicon to improve the micro-acoustics and micro optics in the nanotechnology applications. Multifunctional sensor 215 are employed, further comprises surface acoustic wave resonators 500 responsive to frequency shift. The frequency shift may be influenced by mechanical, chemical, and electrical perturbation within the boundary of active interface with the sensory environment 704. The electrical perturbations may occur in at least metal films 543. The metal film 543 may have different conductive values deposited on the resonators 500 responsive to loading effects on the display/input device 404. Disclosed embodiments provide the communication apparatus comprising a changeable amplified output/input signal configured for altering any back gate voltage above predetermined sensor value to eliminate any potential radiation induced charges. The resonator 500 further comprises cavity resonator comprising of metal plates 501 and metal slab 503 being coupled with the meta-material structure surface being disposed with the antenna in communication with at least a capacitance 505 and/or inductance 506. Certain disclosed embodiments provide the CMOS multiple antennas comprising of parallel plate transmission lines 507 consisting of at least an opened end 508 and at least a shorted end 509. The configuration of the meta-material surface with the CMOS multiple antennas on chip structure further removes radiation pattern back lobe to protect consumers against signal radiation. Disclosed embodiments provide a monolithic integrated CMOS multiple antennas architecture comprising of intra-chip network.

The display/input device 404 consists of at least liquid and/or solid media 505. The metal film is further configured for generating electrical energy. Detection selectivity is further influenced by metal clusters 520. The metal clusters 520 are further configured to increase sensor selectivity caused by pressure absorption due to the coupling between sensing surface 409 and other properties 504. These other properties 504 may consist of metal oxide 530 being further configured for converting pressure force into electrical energy. The metal clusters 520 are operatively configured with sensors 180, 200 to increase selectivity. The metal clusters 520 further comprises semiconductor oxide substrate 560 configured with sensor sensitization to enable metal particles 522 to act as centers for surface pressure absorption. The addition of clusters 520 further provide electronic sensitization resulting from the oxide surface 540.

Referring to FIG. 37 is seen further embodiment of the communication apparatus 400 comprising a mobile phone with LCD display screen, video recognition, phonebook, dictionary, and a sensory environment 704. Disclosed embodiments further provide silicon-substrate-metal oxide 530, further comprising antimicrobial metal consisting of at least silver being laminated to at least a liquid absorbing nonwoven material being fused/etched in microfiber/nano-fiber material to provide at least a detection environment on the detection platform 706. Certain embodiments provide the silicon-substrate-metal oxide-micro fiber 530 further comprising the nonwoven material consisting of metal coating including metal particles facing at least a liquid absorbing material to retain surface effect. Certain embodiments provide communication apparatus comprising sensors 200 being configured to retain antimicrobial effect. Some embodiments provide silicon-substrate-metal oxide 530 being configured with silicon-substrate-thin film 430, providing a detection platform 706 configured with plurality sensors 200 operable for detecting pre-use and post-use of communication apparatus 400. Certain embodiments provide the nonwoven material comprising at least a polyethylene mesh forming an antimicrobial composites comprising antimicrobial metal coating.

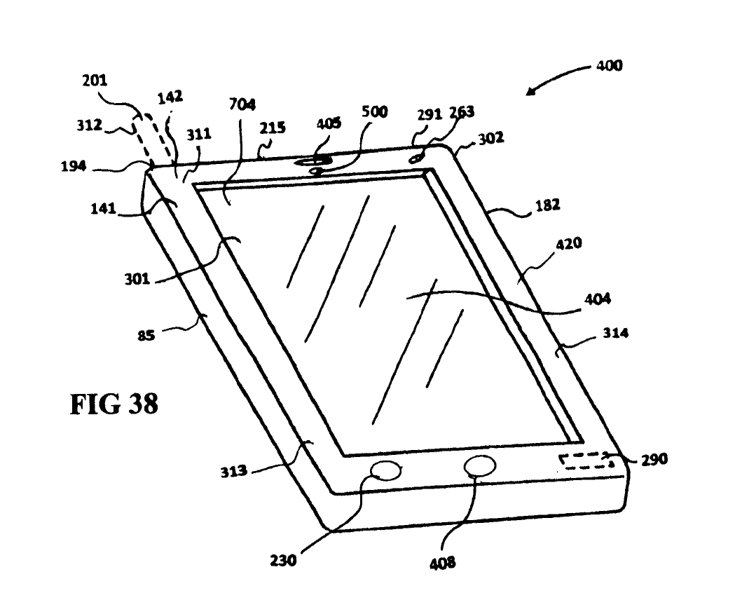

Referring to FIG. 38 is seen further embodiment of the communication apparatus 400 comprising a mobile phone comprising a gaming apparatus configured with an interface device and a sensory platform 704. The antenna 201 is operable to increase signal strength and may comprise internal antenna apparatus being configured with a chip operable on a logic circuit. The chip is operatively configured to boost communication signals through the antenna to improve sound quality and reduce dropped communications. The chip is operable on a logic circuit being communicatively connected to the circuit board for the communication apparatus 400 in communication with the antenna. Disclosed embodiments provide software in communication with the logic circuit being configured for analyzing signal strength and data speed. The amplification of the signals would improve wireless data transmissions, data card “IC card and SIM card” reception, providing faster data transfer speeds. The chip is further operable to move the wireless signal radiation away from the head to reduce exposure to cellular radio signals, which may cause health issues. The chip is a solution which depends on antenna configuration and may be operable on CDMA, TDMB, Digital/Analog/GSM, and location area network. At least a station interface 302 is operatively configured with the microprocessor electronics 85 and 182. At least a transducer 315 is operatively configured with sensor resonator 500 and multifunctional sensor 215 and communicatively connected to detection memory 291. The detection memory 291 is communicatively connected to station interface 302 and operatively configured with CPU 141. The CPU 141 and the CMOS 142 are communicatively connected to the communication apparatus 400 in communication with station interface device 302. The station interface 302 further comprising at least a transmission control 194 in communication with at least antenna apparatus 201. Receiver 312, transmitter 311, encoder 313 and decoder 314 are communicatively connected to interface device 302. The microprocessor electronics 85 and 182 are communicatively connected to MEMS 420, accelerator 230, and detector 290. Station interface 302 is operatively configured with interface device 301 in communication with display/input device 404. Disclosed embodiments further provide communication apparatus 400 being configured with speakers 405, microphones 408, camera 263, and display/input device 404.

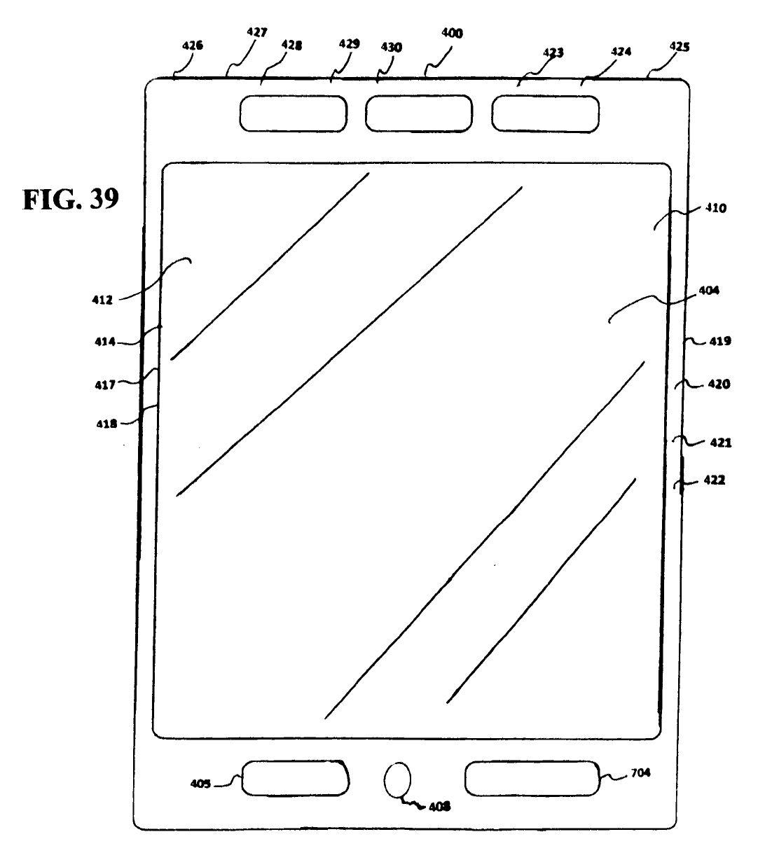

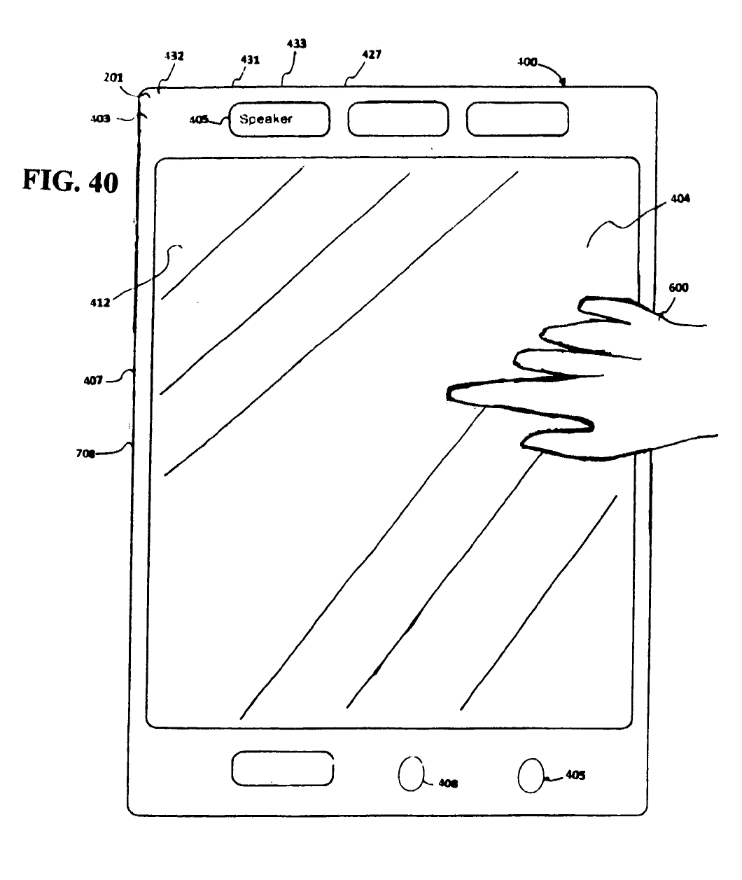

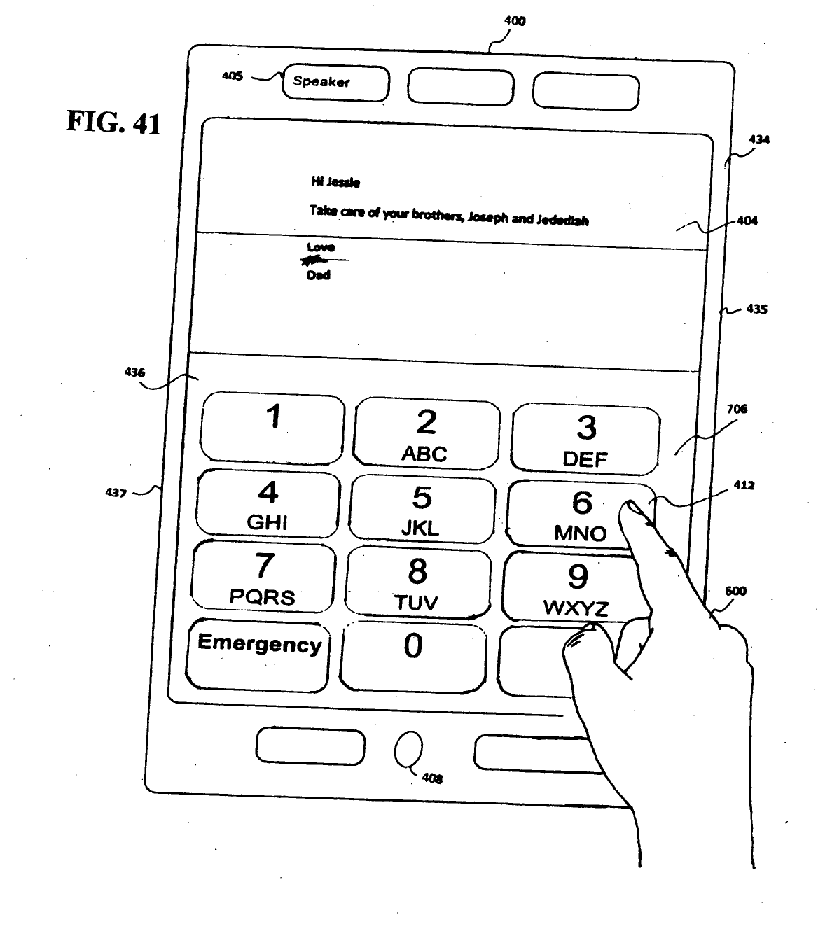

Referring to FIG. 39 is seen exemplary embodiments of communication apparatus 400 comprising touch screen display/input 404 on a mobile phone configured with Internet connectivity operable for global roaming. Display/input device 404 further provides visual information to the user. Disclosed embodiment provide a display/input device 404 comprising liquid crystal display (LCD) 410, a touch screen display 412 or another type of display operable for providing information to a use. Certain embodiments provide a display/input device 404 being further operable for providing information regarding incoming or outgoing telephone calls and/or incoming or outgoing electronic mail (email), instant messages, short message services, multi-media message services, calendar application, text message application, the current time display, video games applications, downloaded content display, mobile broadband and media applications.

The communication apparatus 400 further includes a cellular radiotelephone, personal digital assistant (PDA) 416, pager 417, gaming device 418, data communications device 419, data processing device 420, web-based appliance 421, Web browser 422 and/or other application providing Internet/Intranet access and messaging application programs. The messaging program includes text messaging, multi-media messaging, instant messaging, e-mail, an organizer application program, a calendar application program, video application and/or a global positioning system (GPS) receiver 423, personal computer (PC) 424, laptop computer 425, palmtop receiver 426, remote control device 427, radio-telephone transceiver 428, data processing device 429, and/or data communication device 430. The communication apparatus is further configured with speakers 405, microphones 408, and nano sensors 704. Disclosed embodiments further provide the communication apparatus 400 comprising the personal computer (PC) 424. Certain embodiments provide the personal (PC) 424 comprising an information processing apparatus. Some embodiments provide the personal computer (PC) comprising a computing device configured with the input 404. The input device 404 further comprises an input module for receiving characters and user inputs. At least the input module configured for receiving user input further comprises a switch device being configured with the software and disposed with the hardware. Disclosed embodiments further provide the communication apparatus 400 configured with sensors operable for detecting relative movements on the display/input device 404. The display/input further comprises a keypad. The input device 404 further comprises camera and webcam.

The information processing apparatus comprises executers being operable for executing varieties of processes. Certain embodiments provide the personal computer (PC) 424 further comprising a controller operable for controlling operations of the executers, including information, authentication information authenticating each user. At least a user mapping storage medium is disposed with the personal computer (PC) 424 configured for storing correspondence information responsive to the executers. Some embodiments provide the personal computer (PC) 424 comprising the controller operable for identifying identifies corresponding user information in accordance with the correspondence stored information.

Referring to FIG. 40 is seen exemplary embodiments of communication apparatus 400 comprising touch screen display/input 404, being operable through sensational touch by at least an object, including a human hand 600. The communication apparatus 400 further comprises a mobile phone comprising a pocket PC, a PDA phone with dual processor. Disclosed embodiments provide communication apparatus 400 comprising a touch screen 412, display/input device 404, including a remote control device 427 operable for remotely controlling a television, a stereo, a video cassette recorder (VCR), a digital video disc (DVD) player, a compact disc (CD) player, and a video game device. The communication apparatus 400 further comprises a wired network device, 431, an optical network device 432, and/or wireless network device 433 operable for receiving and transmitting data, including voice and/or video signals, multimedia signals, electrical energy transmission, data signals and video signal transmission. Certain embodiments provide a network device comprising a switched telephone network, transmission towers operable for receiving wireless signals and for forwarding wireless signals to intended destination, packet switched networks, including Internet protocol (IP) based network, an intranet, a local area network (LAN), a wide area network (WAN), a personal area network (PAN), Internet, and data transmitting network. Embodiments further provide communication apparatus 400 configured with speakers 405, microphones 408, and antenna apparatus 201 in communication with signal booster 403 being operable with logic circuit 407. Certain embodiments provide the communication apparatus being configured with at least a sensor 708.

Referring to FIG. 41 is seen exemplary embodiments of communication apparatus 400 comprising a mobile phone with a touch screen panel operable for communications; interactive gaming; music applications; a virtual slider operable for accessing multimedia buttons. Disclosed embodiments provide communication apparatus 400 comprising at least one of: at least a variable gain modules 434, a mobile device, 435, internal peripheral devices 436, external peripheral devices 437. Certain embodiments provide communication apparatus 400 comprising at least one of: cell phones, smart phones, laptops, handheld communication devices, handheld computing devices, satellite radios, global positioning systems, and PDA. Some embodiments provide internal peripheral devices being disposed in the mobile device. Other embodiments provide communication apparatus 400 further comprising a Bluetooth radio, wireless local area network (WLAN) radio, a wireless wide area network (WWAN) radio. The external peripheral device further comprises camera, printer, card reader, scanner, radio connection, wireless device connection. Embodiments further provide communication apparatus 400 configured with speakers 405, microphones 408. Certain embodiments provide the communication apparatus further comprises a display/input device 404 being operated by at least a human hand 600. The display/input device 404 further comprises a touch screen 412 being further operable on a detection platform 706.

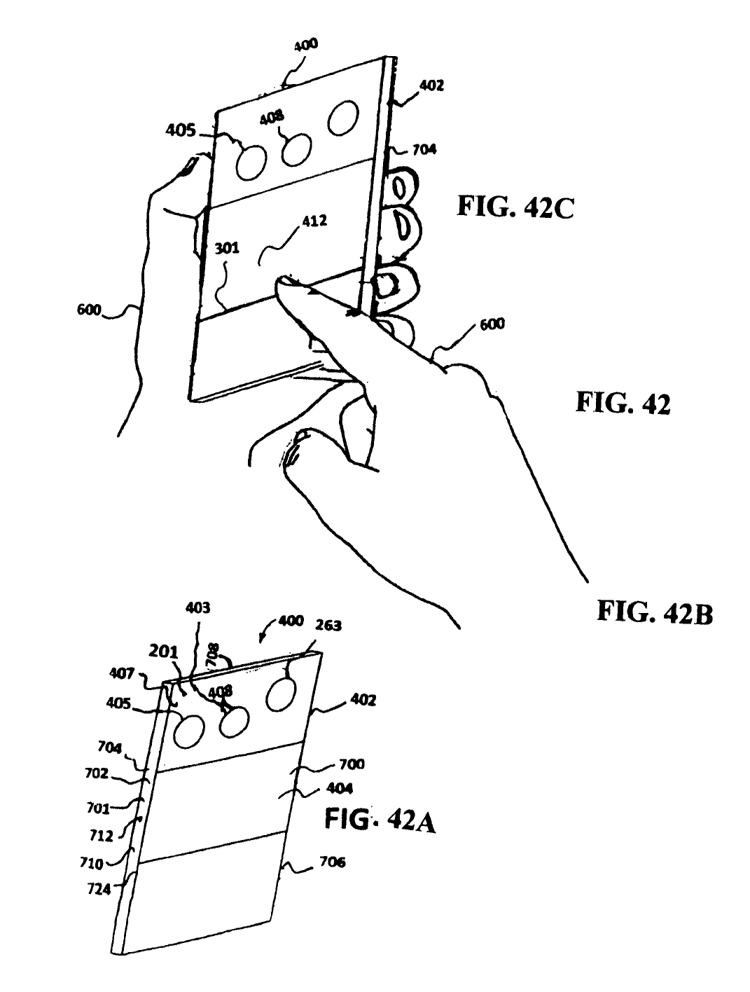

Referring to FIG. 42 is seen exemplary embodiment of a communication apparatus 400 comprising a mobile phone with numeric keypads operable to provide voice over texting applications; a slide out keyboard; and resistive touch screen character recognition in accordance with one embodiment of the invention. Referring to FIG. 12A, the communication apparatus 400 comprises a housing 402 comprising of a sensory platform 700 consisting of nanotechnology application. Some embodiments provide the housing 402 comprising of at least a cell phone housing and/or belt clip. The sensory platform further includes strain gauges 701 embedded in load cells 702. Disclosed embodiment further provide nano technology applications comprising nano sensors 704 being embedded in silicon substrate 712 and fused/etched in microfiber/nano-fiber material 710, providing a silicon microfiber/nano-fiber 724. The sensory platform 700 being operable to provide a detection platform 706 being further operable for communications and/or for converting at least a form of energy into electrical energy. Disclosed embodiments further provide the sensory platform 700 further comprising a display/input device 404 being disposed with the housing 402. Certain embodiments provide the housing 402 further consisting of speakers 405, microphones 408, embedded antenna apparatus 201, in communication with at least a signal booster comprising a chip 403, in communication with a logic circuit 407. The communication apparatus 400 further comprises the detection platform 706 comprising sensors 708 being operable for detecting objects proximity to at least the display/input 404. The communication apparatus 400 may comprise at least one of: cellular telephone, telephonic, media device, PDA device, cellular telephone, GPS device, entertainment device and/or an information device being operable for road and traffic communications, including road side advertisement. Embodiments further provide communication apparatus 400 configured with speakers 405, microphones 408. Certain embodiments provide the communication apparatus 400 further comprises a display/input device 404. The display/input device 404 further comprises a touch screen 412 being further operable on a detection platform 706. Disclosed embodiments provide a device being configured for input/output on a substrate comprising at least one piezoelectric sensor formed on the substrate. The device further comprises a display/input formed on the substrate. The piezoelectric sensor is formed on the substrate in communication with at least a processor being further operable to calculate applied force and activate a force response based on the calculated value. Disclosed embodiments provide communication apparatus comprising a device configured for monitoring resistance associated with one or more piezoelectric sensors to detect changes in a force applied to a display/input device. The display/input device is further configured for detecting change in resistance associated with the one or more piezoelectric sensors being further configured with electrical crystals operable for measuring force applied to the display/input device based on the detected change in resistance.

Referring to FIG. 42B is seen an exemplary embodiment of a human hand 600, holding communication apparatus 400. The communication apparatus is disposed in a housing 402 configured with nano sensors 704, a display/input device 404, a speaker 405, and a microphone 408. The display/input device 404 further comprises a touch screen 412 being further configured with an interface device 301. The communication apparatus 400 further comprises a media device further consists of input and output devices. Disclosed embodiments provide the communication apparatus 400 including at least a housing 402.

The communication apparatus 400 further comprises a cellular telephone, a game device, and a media player and a PDA. The communication apparatus 400 is portable and may fit within the hand of normal adult and grown children. In one embodiment, the display/input device 404 may include at least one of multi-point interactive touch screen input device 412, an LCD display. Disclosed embodiment provide a display/input device 404 comprising liquid crystal display (LCD), a touch screen display or another type of display operable for providing information to a use. Certain embodiments provide a display/input device being further operable for providing information regarding incoming or outgoing telephone calls and/or incoming or outgoing electronic mail (email), instant messages, short message services, multi-media message services, calendar application, text message application, the current time display, video games applications, downloaded content display, media applications. In one embodiment, the multi-point interactive touch screen is a capacitive sensing medium configured to detect multiple touches, including blobs on the display from a user's face or multiple fingers touching or nearly touching the display.

Referring to FIG. 42C is seen an exemplary embodiment of the disclosure comprising human hand interaction 600. Certain embodiments provide the communication apparatus 400 comprising a hand held device, further comprises a display/input device 404 as seen in further 42B, being operated by at least a human hand 600 as seen in FIG. 42C.

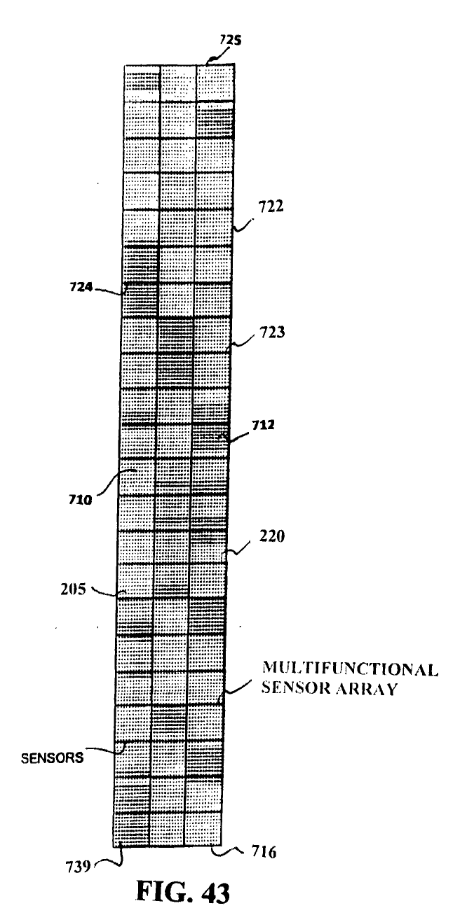

Referring to FIG. 43 is seen exemplary embodiments of nanotechnology application of CMOS multiple antenna on a chip to realize at least a 60 GHz frequency. The CMOS multiple antennas 724 comprise miniaturized alloyed material comprising meta-material structured surface cavity 722 embedded/coupled in silicon-substrate-microfiber/nano-fiber platform 723. Disclosed embodiments provide the platform 722 comprising CMOS multiple antenna apparatus 724 configured for communication apparatus 400. The platform 722 further comprises methods and systems for generating electrical energy. The communication apparatus comprises microfiber/nano-fiber material 710 further configured with sensors on silicon substrate 712. The sensor comprises electrode and/or temperature sensor 716. Certain embodiments provide the substrate-microfiber/nano-fiber 724 comprise miniaturized non ferrous materials 734 being embedded in the silicon substrate 712. Some embodiments provide the substrate-microfiber/nano-fiber 724 comprise energy transport platform 725. Certain embodiments provide the CMOS multiple antenna apparatus 724 coupled to the silicon substrate 712, further comprises at least glass 739 comprising a gallium nitride high electron mobility transistor (GaN-HEMT) to improve communication signal amplification, faster data transport speed, and reduce energy consumption for the communication apparatus 400. Some embodiments provide the communication apparatus being configured with a silicon to silicon bonding and/or silicon to ceramic wafer bonding to further provide a detection platform and for generating electrical energy. The silicon is further provided with ceramic wafer bonding responsive to solar energy. The silicon to ceramic wafer bonding may include at least silicon to glass bonding, forming single crystal silicon to improve the micro-acoustics and micro optics in the nanotechnology applications to further reduce energy consumption and produce electrical energy. Disclosed embodiments provide optical properties of thin films being operable for the advancement of the integrated circuit for converting solar energy into electrical energy. Certain embodiments provide optical properties of thin films being operable for the advancement of the integrated circuit for converting solar energy into electrical energy. Some embodiments provide energy platform consisting of at least surface acoustic wave line, paste, MEMS, thin film deposition, and multifunctional sensor array 205 embedded in the silicon substrate 712 and etched/fused in a micro-fibered material 220. The application of ceramic materials further provides many features, including high hardness, physical stability, extreme heat resistance and chemical inertness. Certain embodiments provide highly resistant material to aggressive chemicals, melting, bending, stretching, and corrosion.

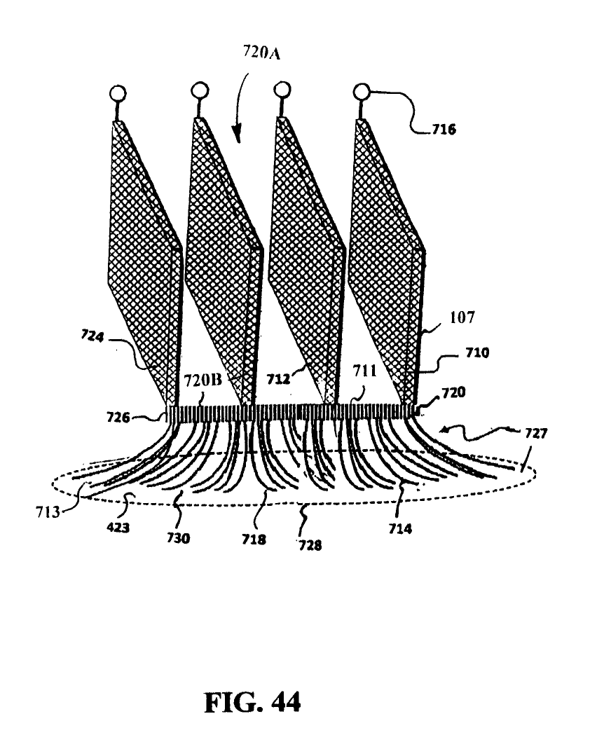

Referring to FIG. 44 is seen exemplary embodiments of the energy transport medium. Disclosed embodiments further provide communication apparatus comprising methods and systems for generating and storing electrical energy. Certain embodiments comprise nano-materials 710 comprising microfiber/nano-fiber material. Disclosed embodiments further provide the microfiber/nano-fiber material 710 comprising materials with excellent electrical properties being disposed with substrate 712 being alloyed with meta-material structure and etched/fused in a microfiber/nano-fiber material to enable energy cell platform and remove radiation pattern back lobe. The microfiber/nano-fiber material 710 includes material components with nanometer dimensions in which at least one dimension is less than 100 nanometers. Some embodiments provide the microfiber/nano-fiber materials being further configured with nano-wires/tubes 714. The nano-wires/tubes 714 being further embedded in the silicon substrate 712. Certain embodiments provide a communication apparatus comprising the substrate 712, being configured with electrodes 716 at the opened end of the CMOS multiple antennas network in communication with the nano-wires/tubes 714. Some embodiments provide nano-sensors on silicon microfiber/nano-fiber comprising nano-fibers formed on the microfiber/nano-fiber. Other embodiments provide the electrode 716 further comprising at least a temperature sensor. Disclosed embodiments provide a microfiber/nano-fiber membrane configured to provide structural communication and data transmission integrity.

Certain embodiments provide the nano-fibers being formed using electro-spray deposition. Other embodiments provide the nano-wires/tubes 714 comprising at least one component of: carbon char, carbon black, metal sulfides, metal oxides and other organic materials being alloyed with the microfiber/nano-fiber material 712. Disclosed embodiments further provide communication apparatus being disposed with alloyed material comprising apparatus 718 being configured for exhibiting unique electrical and electrochemical properties to provide efficient transportation of energy properties. The apparatus 18, in some embodiments, comprises multiple CMOS antenna on a chip operable for intra-chip wireless communication network 727. Embodiment provide a combination of the silicon substrate and metal oxide and/or thin film or miniaturized metallic material in communication with signal booster chip, providing an energy platform comprising a battery cell for the communication apparatus. Disclosed embodiment further provide a communication apparatus consisting of a detection platform comprising touch screen display device configured with a processor means comprising a pattern recognition technique for producing “Sensing,” a controlled data/communication signal and communicating sensed detection to a wireless modem or control module being operable to provide wireless communication. Certain embodiments provide the carbon char being configured with silicon substrate and microfiber/nano-fiber material to further provide an energy platform. Embodiments described herein include multiple antenna apparatus fabricated on relatively low resistivity CMOS-grade silicon substrate microfiber/nano-fiber with reasonable radiation efficiency. The communication apparatus is reconfigured with integrated sensor elements on at least a circuit board operable for energy harvesting. Disclosed embodiments provide the sensor elements comprising at least a sensing mode configured with nano sensors operable to measure environmental characteristic by generating electromagnetic charge and outputs a time-encoded signal indicative of the measurement, at least a platform comprising of energy harvesting mode to harvest energy from solar energy, wave energy, electromagnetic energy, and ambient energy source. Certain embodiments provide a switchable circuit board configured to switch from the sensing mode to the energy harvesting mode responsive to at least a predetermined threshold.

Disclosed embodiments further provide communication apparatus comprising methods and systems for producing energy properties from the presence of high surface areas and charge transport mechanism. Certain embodiments provide the charge transport mechanism being further derived from the flow of pressured fluid 423. Certain embodiments of the pressure fluid 423 comprise sound waves, solar energy, vibration, and wind. Disclosed embodiments further provide apparatus for thermal expansion of fluid in communication with the nano-wires/tubes 714. Embodiments provide silicon-microfiber/nano-fibers and nano-wires/tubes 714 being further provided with methods for converting thermal energy into electrical energy. Certain embodiments of the thermal expansion of the fluid comprise sound waves, solar energy, vibration, and wind and/or material pyrolysis. Some embodiments provide energy medium, including apparatus 720 comprising means through which electron transfer occurs at the electrode 716, through the release of chemical energy to create a voltage through oxidation/reduction reactions 722. Certain embodiments further provide the apparatus 720 comprising at least energy cell platform. Some embodiments provide the apparatus 720 further comprising CMOS multiple antennas configured with meta-material surface cavity. Disclosed embodiments provide the apparatus 720 comprises CMOS multiple antennas platform comprising opened ends 720A and shorted ends 720B. The oxidation and reduction reactions 722 is being separated through the electron 716. The electrode 716 is being configured with CMOS substrate-microfiber/nano-fiber 724 embedded with multiple antennas comprising intra-chip network re-enforcements to external electric circuit communication and data transmission efficiency. Certain embodiments provide at least a storage medium, comprising internal transport voltages at electrodes configured for providing useful energy transport stream to batteries 724 and/or capacitors 726. Disclosed embodiments provide silicon microfiber/nano-fiber further comprising of Si-substrate consisting of a patterned isolation layer.

Certain embodiments provide the Si-substrate being etched and/or fused through openings of the patterned isolation layer to form a plurality of electric-conducting platform. At least the electric conducting platform further comprises electric-conducting wires and/or at least heat-conducting wires in communication with an opto-electronic device. The opto-electronic device further comprises opto-isolation apparatus being configured with at least a LED. Disclosed embodiment provide silicon microfiber/nano-fiber, further comprising a remote sensor assembly comprising multiple antennas being configured with a plurality of micro electromechanical system (MEMS) embedded on the silicon substrate. The silicon substrate further comprises a wireless communication circuit being configured with a processing device operable to obtain data, such as measurement values from at least one of plurality of MEMS sensors. Certain embodiments provide the silicon substrate further configured to perform at least a filtering operation on at least one of: communication signals; data transmissions; measurement values. Disclosed embodiments further provide silicon microfiber/nano-fiber further comprising apparatus for coupling light between input and output waveguides comprising structures having higher portions or lower portions being arranged at a fine pitch equal to or shorter than a wavelength of visible light on base surface responsive to plurality of arc track rows.

Disclosed embodiments provide the CMOS multiple antennas 724 further comprises at least a chip configured with integrated circuit comprising nano wires 714 embedded in silicon substrate microfiber/nano-fiber 712, being alloyed with meta material structure comprising of surface cavity. The CMOS multiple antennas further comprises radio frequency applications operable to provide intra-chip antenna network, enabling GHz frequencies for Bluetooth, WiFi wireless network, and mobile phones. In the disclosure, the chip is further configured with power amplifiers operable to provide communications and data transmissions over short range to longer ranges. At least a metal oxide semiconductor is configured with silicon substrate microfiber/nano-fiber to provide better power efficiency, achieve better communication clarity, and achieve extended power life. The CMOS multiple antennas on chip with embedded amplifiers is operable to realize high operating frequencies to enable high data rate communications and to prevent atmospheric absorption. Nano wires 714 are operatively configured with the CMOS antennas 724, in some embodiments, to provide multicast protocol label switching network for wireless communication. The CMOS antennas 724 are operable to realize a wireless network region better than at least 60 GHz, for wireless communications, military application, high speed data transmission applications, and homeland security intelligence applications. Certain embodiments provide the nano wires 714 configured to provide a platform to protect against oxygen absorptions, avoid interference from other networks, and protect against human health concerns. Some embodiments provide a communication apparatus configured to provide desirable high definition television “HDTV” signals with high data rate communications being operable at the realized transmission frequencies.

Disclosed embodiments provide the realized transmission frequencies comprises providing better communications for wireless personal area network “WPAN,” local area network “WLAN,” and allowing communications for wireless Gigabit Ethernet, mobile devices synchronizations, wireless fire wire, and USB display. Embodiments further provide the high rate WPAN further includes point to point transport for bulk data transfer, multimedia streaming, and streaming HD multimedia contents. Some embodiments provide the CMOS multiple antennas operable on a chip comprising silicon substrate microfiber/nano-fiber being alloyed with meta-material for integrated circuit. Other embodiments provide the integrated circuit being configured for low power consumption. Disclosed embodiments further provide the integrated circuit further comprising digital signal processing “DSP” for higher frequencies. Certain embodiments provide the chip comprising at least a single chip circuit or a module operable for converting digital signal into at least a 60 GHz modulated radio wave. Other embodiments provide the module further operable for converting radio wave signals into at least 60 GHz digital signals. Further embodiments provide the silicon substrate microfiber/nano-fiber providing additional output power gain and long term data transmission reliability. Disclosed embodiments provide the meta-material further comprising die-electric materials operable to provide at least a metal gate electrode 716. Disclosed embodiments provide the antennas 724 further comprising a chip configured with at least a software program. The chip is further disposed on a logic circuit further configured with at least transistorized switches to provide at least on chip multiple antennas arrays that are programmable for boosting signal reception and/or for changing signal transmission directions. The CMOS multiple antennas 724 is opened at one end 716, and shorted at the other end 720. The shorted end 720 is integrated with power supply circuitry 726, 728, and 730 to further reduce/eliminate critical signal looses. Disclosed embodiments further provide the nano wires operatively configured for restraining internal noise and for providing stable communication operations.

Disclosed embodiments further provide the antenna apparatus 201, 418 comprising at least a field programmable gate array “FPGA.” Certain embodiments provide the FPGA disposed with meta material coupled to semiconductor substrate in communications with nano wires 714. The nano wires comprise signal interconnect lines in communication with the shorted end of the FPGA meta material structured surface 712. The first antenna portion 201 is connected to the second antenna portion 418 at the shorted end 720. The shorted end further contains thin conductor layers portion characterized as having a plurality of thin, fine-pitch nano wires conductors 720. The nano wires are further configured to convert electromagnetic wave energy into electrical energy to provide further additional operating power platform for the communication apparatus 400. The opened end contains conductive material configured to absorb electromagnetic wave energy in communication with the shorted end 720, consisting of the FPGA meta material structured surface. Plurality portions of three dimensional antennas are joined at the shorted end comprising a MEMS wafer leveled surfaces within flatness at the top and nano wires protruding at the bottom of the flat surface. The nano wire portions are fused and/or etched.

Disclosed embodiments provide a CMOS multiple antennas 201 and 418 disposed on a semiconductor chip 403. Certain embodiments provide the chip consisting of integrated transceiver. In the disclosed embodiments, the antennas 201 and 418 are further configured to transmit, and to receive, comprising of a transmitter and a receiver. The transceiver is formed on a semiconductor substrate comprising silicon substrate alloyed with meta material 712. At least one semiconductor substrate is configured with microfiber/nano-fiber material 710 to provide electrical connection between the transceiver 724 and the semiconductor substrate 712. The antenna is further formed with a dielectric layer 711 being connected to the transceiver 724. At least the meta material structured surface 712 further comprises a reflective plate 713 connected to the substrate. The separation between the reflective plate 713 and the antennas 201 and 418 are about a quarter wavelengths of millimeter waves, which enhances radiation efficiency of the antennas. Some embodiments provide an array of silicon substrate microfiber/nano-fiber 712 being formed and filled with the dielectric material 711 to reduce the effective dielectric constant of the material between the antennas 201 and 418 and the reflector plate 713, thereby reducing the wavelength of the millimeter wave and enhance the radiation efficiency. Other embodiments provide the antenna apparatus 201, 418 being fabricated on a low resistivity CMOS-grade silicon substrate microfiber/nano-fiber. The antennas are configured to resonate at least at 6 GHz.

Embodiments relate generally to wireless communication systems that employ micro machined antennas 201 and 418 fabrication on at least a field programmable gate array, comprising a removal of silicon substrate underneath the antenna structure to increasing the overall radiation efficiency. Disclosed embodiments provide CMOS multiple embedded antennas that include a feeding portion, a radiating portion, a grounding portion, and a short portion. The feeding portion is operable to feed electromagnetic signals through an opened end 716. The radiating portion 724 is connected to the feeding portion 716, to radiate the electromagnetic signals. The radiating portion includes a first radiator 201 and a second radiator 418. The first radiator is “L” shape, with a first end electrically connected to the feeding portion. The second radiator is formed by a plurality of radiating sections connected one by one. The second end of the first radiator and the second end of the second radiator are connected to the radiator shorted end 720. The first end of the shorted portion 720 is connected to a common node 726 of the first radiator 201 and the second radiator 418, and a second end of the shorted portion 720 is connected to the grounding portion consisting of nano wires 714.

Disclosed embodiments provide CMOS multiple antennas in a chip and could include employing an antenna that resonates at least at 5.8 GHz. Another disclosed embodiment includes a differential feed operationally coupled to CMOS multiple antennas. In one disclosed embodiment, the antennas are fabricated on relatively low resistivity CMOS-grade silicon substrates. In one such exemplary non-limiting embodiment, CMOS multiple antennas and a photo-resist form an antenna approximately 400 um in thickness and is 12 mm long×2.8 mm wide. In another embodiment, at least one CMOS antenna is provided, the CMOS multiple antennas portion is separated from the CMOS antenna, and a photo-resist material connects the first and second CMOS portions. The antenna 201 includes at least one CMOS antenna 418 and the CMOS multiple antennas portion 724. A photo resist material 711 is coupled or connected to the CMOS portions 418 and 724. The antennas 201 and 418 can be fabricated on a silicon substrate microfiber/nano-fiber with a thickness of at least 10 um and/or between 10 um and 700 um. Disclosed embodiments provide the communication apparatus 400 further comprising the COMS multiple antennas 201 and 418 being disposed on the chip 403 operable for digital signal processing “DSP.” The chip 403 is further coupled to an application specific integrated circuit 107. Certain embodiments provide the antennas further comprising meta material structured surface cavity for enabling high data transmission. Some embodiments provide the meta material structured surface comprising at least a reflective element operable for wireless interconnections and for transmitting data wirelessly at a much faster speed.

Other embodiments further provide a silicon wafer comprising folded dipole antennas configured with meta material structured surface on at least a dielectric micro-fibered material to provide better conductor gain at a resistivity of at least 5 cm, and with a thickness of at least 10 um, and impedance of at least 100 being fed through at least the nano wires consisting of lengths of at least 1.5 mm. Disclosed embodiments are not limited to the dimensions herein. Certain embodiments further provide exemplary embodiments of the antenna being constructed of conducting nano wires 714 being coupled with a size of at least a 2.50 mm×4.3 mm at a height of at least 525 um. In the embodiments, the antenna further comprises at least silicon substrate microfiber/nano-fiber disposed with the meta material structured surface configured for low resistivity and better conductor gain to enable a broader bandwidth. The CMOS multiple antennas is further disposed on flat surfaces consisting of at least a vertical slot being narrowed with at least a wavelength of at least a quarter deep. The antenna 201 and 418 are further configured for surface wave propagation to at least the shorted end 720B. In some disclosed embodiments, impedance is higher at the opened end 720A. In other disclosed embodiments, at least a corrugated meta slap is coupled to at least a vertical wall to modify radiation pattern to increase antenna gain. Disclosed embodiments provide the radiation pattern further includes a radiation pattern back lobe comprising nano wires being etched and/or fused at the shorted end 720B with the meta material surface configured to provide higher gains.

The antenna 201 can be derived from a dipole antenna in one exemplary generalized non-limiting antenna embodiment. The antenna can be a differential-fed antenna and can be easily integrated into active circuits. Disclosed embodiments provide a complementary metal-oxide-semiconductor (CMOS) consisting of integrated multiple antennas circuits 724 being disposed in at least a chip, comprising at least one of: microprocessors, digital logic circuits, static RAM, and microcontrollers. Certain embodiments provide the multiple antennas 201 and 418 comprises CMOS configured with silicon substrate microfiber/nano-fiber being alloyed with meta material structured surface 712 to provide wide variety of analog circuits such as image sensors, and data converters. Some embodiments provide highly integrated transceivers 724 configured for variety of communications, including military applications. Disclosed embodiments provide the CMOS further comprising complementary and symmetrical pairs of p-type and n-type metal-oxide-semiconductor field-effect transistors (MOSFETs) operable for logic functions. Certain embodiments provide the CMOS further comprising a structured material with relatively low resistivity and relatively inexpensive. Certain embodiments provide a CMOS multiple antennas apparatus comprising means for radiating or for receiving electromagnetic energy and operable to accepts power from a source and radiates the power into the shorted end. The received energy is radiated to the source, or dissipated it to a resistive load. The ratio of the power radiated into the ground nano wires to the power received from the source is the radiation. Radiation efficiency is defined as “the ratio of the total power radiated at the shorted end by the multiple antennas to the net power accepted by the antennas from the opened end” (Pradiated/Pinput=ηefficiency).

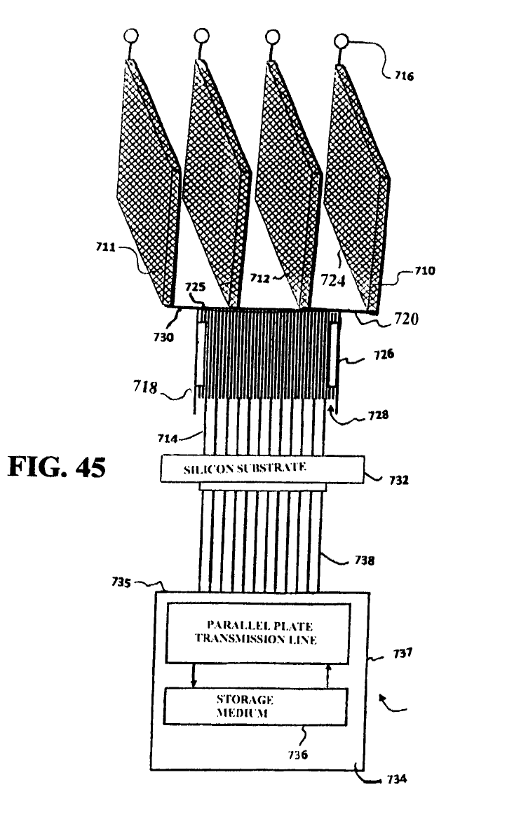

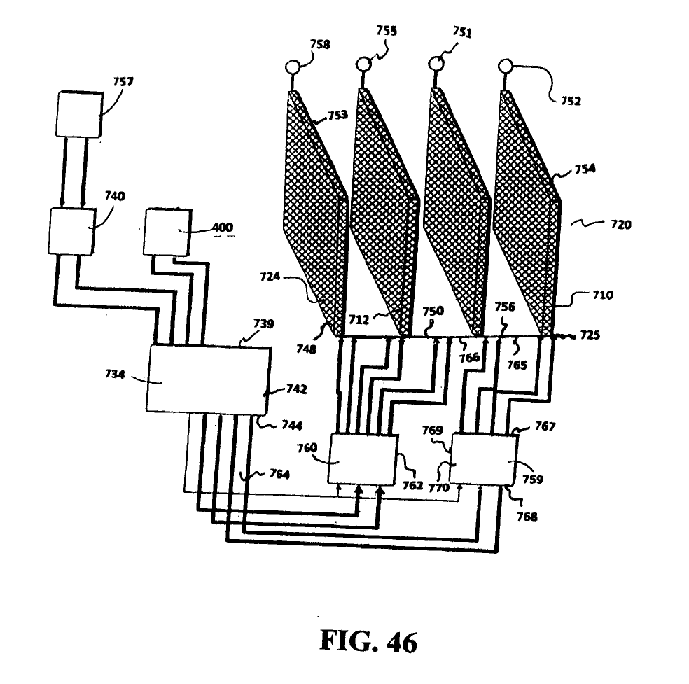

Referring to FIG. 45 is seen further exemplary embodiments of the CMOS multiple antennas 724 on a chip comprising substrate microfiber/nano-fiber embedded with meta-material for communications and for an energy medium. The CMOS multiple antennas 724 is opened on one end configured with electrode and temperature sensor 716, and shorted on the other end 720, being configured with nano wires for antenna network communications, in communication with the energy storage medium further comprising energy storage apparatus coupled to the shorted end 720. Disclosed embodiments provide methods and systems for realizing frequencies of at least 60 GHz and for generating electrical energy. Certain embodiments provide apparatus for generating electric energy from the energy released by at least a reaction, such as pressure, thermal transport, heat, force, motion, and vibration. Certain embodiments provide microfiber/nano-fiber material 710 being configured silicon substrate for converting pressure, vibration, heat, thermal transport, wind, force into electrical energy. Some embodiments of the energy being generated comprise electrical energy 730. Other embodiments of the energy being converted comprise thermal energy 732. The thermal energy, in other embodiments, is being transported through the nano-wires/tubes 714 in communication with the silicon-microfiber/nano-fiber material and/or the electrode. Certain embodiments provide the nano wires/tubes further configured to provide a platform for each shorted CMOS antenna to engage in antenna network to achieve at least a 60 GHz frequency. The microfiber/nano-fiber material 710 further comprises plurality meta-material comprising textile fibers 711, being alloyed with zinc oxide (ZnO) nano-wires 734 to form at least a meta-material structured surface cavity. Disclosed embodiments provide the zinc oxide nano-wire 734 further configured with piezoelectric crystals for generating electrical energy 728 and at least a coil for communicating and/or transporting the electrical energy being generated to at least a capacitor. Disclosed embodiments further provide the piezoelectric further comprising an electromagnetic composite meta-material including an electromagnetic medium.

Certain embodiments of the piezoelectric comprising plurality of spaced electromechanical resonators disposed in the electromagnetic medium configured to control electromagnetic wave propagation properties in the electromagnetic composite meta-material. Certain embodiments provide a communication apparatus being configured with signal booster chip in communication with an antenna apparatus being operable to allow current flow 730 from plurality fiber pairs 736. Other embodiments provide the fiber pairs being configured for converting at least one of: vibration, pressure, blood flow, sound, waves, force, thermal energy, and other electrical properties into electrical energy 730. Some embodiments provide a device for generating pressure, thermal energy, and force and producing electrical energy 730. Certain embodiments of the device for producing electrical energy 730 further comprise radiation apparatus. Other embodiments of the radiation apparatus comprise a radiator device being configured with silicon substrate microfiber/nano-fiber and at least an electrode.

Disclosed embodiments provide the radiator device comprising a device that emits radiant energy. Disclosed embodiments provide nanotechnology application comprising nano sensors and MEMS, being embedded on a silicon substrate and etched/fused in a micro fiber material, preferably fabricating together a unified process with supporting integrated circuit (IC) on the same semiconductor substrate comprising integrated silicon platform comprising a chip configured with CMOS multiple antennas 724. Certain embodiments provide the integrated silicon platform in at least a single chip to greatly reduce the size, weight and power consumption of the communication apparatus 400 and enhance the performance of all applications for the communication apparatus. Disclosed embodiments provide the energy platform comprising a cell platform 720 being further configured for medical devices applications. Other embodiments of the cell platform comprise CMOS multiple antennas configured for intra-chip antenna network for effective communication applications. Disclosed embodiments further provide the cell platform comprising at least a nickel-cadmium (NiCd) configured with nickel oxide hydroxide and metallic cadmium for energy capture. Disclosed embodiments provide the nickel oxide and metallic cadmium further consisting electrodes 716 being configured for deep discharge applications. Other embodiments provide methods and systems for storing electrical energy, comprising the cell platform 720. The cell platform includes battery cells and/or capacitor configured for withstanding higher number of charge/discharge cycles and faster charge and discharge rates. Certain embodiments of the cell platform further comprise an electrode device comprising at least electrically conductive nano wires/tubes 714 being coated with at least one electrically isolating layer. The nano wire/tubes further comprises silicon nano wire operable to display biological analysis results such as electrical responses to either pH changes or receptor-ligand interactions of at least one of: protein disease, viruses, and DNA hybridization in real-time.

Embodiments further provide communication apparatus comprising apparatus for generating pressure, thermal energy, and force, and for converting the pressure, thermal energy and force into electrical energy. Disclosed embodiments further provide methods and systems for converting wind force into electrical energy. Some embodiments provide microfiber/nano-fiber material 710 comprising zinc oxide (ZnO) being configured for converting pressure and force into electrical energy 730. Some embodiments of the microfiber/nano-fiber material 710 further comprise meta-material structured surface cavity comprising nanotechnology applications. Disclosed embodiments provide a method of selectively etching a solid sacrificial sensory layer, comprising wet etching and/or dry etching. Other embodiments provide methods and systems of generating renewable electrical energy through nanotechnology applications. The nanotechnology applications comprise at least a single layer microfiber/nano-fiber 736. Other embodiments of the microfiber/nano-fiber 710 further comprise miniaturized meta-material arrays comprising nano-wire 734 being configured for applications in hybrid communication applications to increase data transmission speed, including HDTV applications, further comprising generator assembly 738 in communication with the energy platform. Certain embodiments provide the generator assembly 738 comprising at least semiconductor properties consisting of non ferrous material arrays. The non ferrous material array comprises vertically-aligned zinc oxide (ZnO) nano-wires 734. The zinc oxide nano-wire 734 is being configured to exhibit flexible electrode 716. Certain embodiments provide the flexible electrode 716 comprising complementary metal oxide semiconductor. Some embodiments provide the flexible electrode further comprising conductive platinum tips 735 comprising of CMOS-MEMS. The CMOS MEMS further comprises probes switches operable to actuate down onto a specific programmable addressable location and deliver a current Phase change (PC). The CMOS MEMS is embedded within a reconfigurable circuitry to provide a low or high resistance state. When the reconfiguration is complete, the heaters in the probe are turned off and electrical and/or mechanical contacts are broken. The application provides the reconfiguration of radio-frequency circuits further configured for repeatable contact resistance.

Other embodiments provide the microfiber/nano-fiber material 710 further comprising plurality fibers being operable for characterizing excellent electrical properties. The microfiber/nano-fiber material is coupled with meta-material structured surface cavity and/or coated with polymer and/or with zinc oxide layer 734 to realize at least 60 GHz frequency and to provide energy transport platform 725. Certain embodiments provide the nano-wires 734 configured to provide antenna network platform 718. Some embodiments further provide the nano-wires 734 being coated with gold 737, and fused or etched on the energy transport platform 725. Other embodiments provide the nano-wires 714 further configured for harnessing energy from at least a medium, comprising at least one of: vibration, pressure, blood flow, sound, waves, thermal source, wind, motion and Force. Further embodiments provide the CMOS multiple antenna apparatus 724 further comprising zinc oxide (ZnO) 734 being embedded in a silicon substrate configured with at least polymer. Disclosed embodiment further provide a single crystal silicon to improve the fabrication of micro-acoustics and micro optics and to provide an energy platform for converting solar energy, sound wave, vibration, pressure force, and wind force into electrical energy.

The micro-acoustics and micro-optics are further fabricated in a micro-electro-mechanical system and thin film technique to enable the integration of microelectronics circuit and multifunctional sensor into the detection platform for the communication apparatus. Wafer bonding in single crystal silicon is applicable to significantly lower acoustic losses and improve optical properties and energy production. Disclosed embodiments further provide silicon on insulator bonding method having a silicon layer formed on a silicon microfiber/nano-fiber oxide film as an insulator film comprising parasitic capacitance being configured for high radiation-proof ability. At least a layer in the substrate surface layer portion comprise a region electrically isolated from the inside of the substrate via oxide film layer to eliminate effects such as a high speed/low power consumption operation and/or prevention of low signal transmission. The substrate further includes single-crystal silicon substrates comprising at least a single-crystal silicon substrate that becomes an SOI layer and/or a bond wafer. Certain embodiments provide the silicon substrate comprising a single-crystal silicon substrate that becomes a support substrate being configured with an oxide film on the surface of at least one silicon substrate microfiber/nano-fiber. The single-crystal silicon substrates may be bonded to each other via the oxide film there-between and heat treated to increase bonding strength. Then, a film thickness of the bond wafer is reduced to obtain an SOI substrate

Referring to FIG. 46 is seen further exemplary embodiments of communication device including energy medium comprising energy platform. Embodiments further provide silicon-substrate-microfiber/nano-fiber comprising energy transmission/storage apparatus 720. Certain embodiments provide data being converted into electrical energy. The data may be derived from at least one of: vibration, pressure force, wind flow, sound waves, force, and electrical properties. The pressure may include pressure force from at least an object. The object may also include human hand being used to operate the communication apparatus 400. The operation of the communication apparatus include keyboards, touch screen, gaming, texting, programming, display/input, output, and normally utilized operations. Disclosed embodiments further provide the silicon-substrate-microfiber/nano-fiber comprising charge couple apparatus 740 being configured with miniaturized conduit particles 734. Certain embodiments of the conduit particles 734 comprise of at least glass 739. Other embodiments of the conduit particle comprise of at least Zinc Oxide (ZnO) and/or gold. Some embodiments of the disclosed particles comprise of at least non-ferrous material being alloyed with at least a substrate-microfiber/nano-fiber 724.

Disclosed embodiments further provide materials consisting of conduit properties comprising of at least glass fiber 739 being responsive to light data transmission. Further embodiments of the charge particle apparatus 740 comprise electron-silicon substrate-oxide 742 configured with materials being characterized with good optical properties for exhibiting effective sensitivity to electron range. Disclosed embodiments further provide the electron-silicon substrate-oxide 742 comprising coatings to prevent glass-glass interface 744. Certain embodiments comprise the silicon substrate 712, being at least the constituent of glass 739. Other embodiments provide the silicon substrate 712 being layered with fibers 710 to exhibit durability and better charged properties. Certain embodiments provide an energy platform comprising AIN thin film. Disclosed embodiments provide communication apparatus consisting of solar cell methods of generating electrical energy and silicon wafers process of producing a simpler and cheaper alternative green energy communication apparatus. Disclosed embodiments further provide a communication apparatus comprising of direct band-gap semiconductors cadmium telluride (CdTe), copper indium diselenide alloy (CuInSe2) and copper indium gallium diselenide alloy Cu(InGa)Se2, comprising materials with high optical absorption coefficients being applicable for the photo absorption layer in thin film photovoltaic (TFPV) cells for the energy platform.

The electrodes 716 further comprise of battery cells 748. Other embodiments provide the battery cells 748 further include electrolyte 750 comprising of cathodes 751 and anodes 752. The cathodes 751 comprising the oxidized form of the electrode metal and the oxidizations and reductions are controlled by the electrochemical potential being responsive to the thermal expansion, pressure, composition and concentration of the electrolyte 750. The electrical potential differential being produced is the sum of the electrochemical potential at the electrode 716. Disclosed embodiments further comprise of Zinc batteries and/or zinc fuel cells 754 being configured for electrochemical power applications through the oxidation of zinc with oxygen from the air. Embodiments provide a device for exhibiting high energy density. Certain embodiments comprise nano-materials 734 being embedded in the substrate 712 and etched/fused in the microfiber/nano-fiber material 710 to provide advanced cell platform 756. Some embodiments of the cell platform 756 are being communicatively connected to the electrodes 716. Other embodiments of the cell platform 756 comprise a battery cell 753. Yet, other embodiments of the cell platform 756 comprise fuel cell 754. Still, other embodiment of the cell platform comprise energy storage medium. Disclosed embodiments further comprise a capacitor and/or a battery cell apparatus for electronic devices.

Yet, some embodiments provide CMOS multiple antennas platform configured with at least an opened end 755, and at least a shorted end 766 in communication with conductive nano wires 764 forming at least antenna network environment.

Disclosed embodiments provide the cell platform 756 further configured for medical devices applications 757. Other embodiments of the cell platform 756 comprise communication applications 758. Disclosed embodiments further provide the cell platform 756 comprising nickel-cadmium batteries (NiCd) 758 configured with nickel oxide hydroxide and metallic cadmium 760. Disclosed embodiments provide the nickel oxide and metallic cadmium 760 further consisting electrodes 716 being configured for deep discharge applications. Other embodiments provide methods and systems for storing electrical energy, comprising the cell platform 756. The cell platform 756 includes battery and/or capacitor configurations for withstanding higher number of charge/discharge cycles and faster charge and discharge rates. Certain embodiments of the cell platform 756 further comprise an electrode device 762 comprising at least electrically conductive nano wires/tubes 764 being coated with at least one electrically isolating layer 765. Disclosed embodiments further provide nano-wires/tubes 714 764 comprising at least a substrate 712 being coated with at least one metallic layer 760 having a nano-metric pattern thereon, and being at least partially exposed at a tip of electrically conductive core 760. The cell platform 754 further comprises at least plurality nano-wires/tubes 714 764 being configured with flexible electrode devices 762 disposed in a guided re-enforced silicon substrate 712. Other embodiments further provide each electrode device 764 being configured with plurality of micro-wires 734 being connected to at least one nano-wires/tube. The nano-wires/tubes 714 762 further comprise flexible electrode devices 762 being configured to provide electrical communications, video recording, mobile broadband applications, camera/webcam, and television applications.

Disclosed embodiments further provide the cell platform 756 comprising particles of zinc mixed with an electrolyte consisting of at least potassium hydroxide solution. Certain embodiments provide a communication apparatus configured for converting sound waves, solar energy, vibration, and wind into electrical energy. Some embodiments provide oxygen from the air to enable reaction at the cathode 751. The reactions can form hydroxyls, which is being migrated into zinc paste and form zinc oxide hydroxide 734 configured for releasing electrons to the cathode 751. Disclosed embodiments further provide the reactions comprising zinc decaying into zinc oxide 734, the communication apparatus generating electrical energy from sound waves, solar energy, vibration, and wind, in communication with the cell platform 756. The cell platform 756 is being configured so that the sound waves, solar energy, vibration, and wind and hydroxyls from the anode 752 are being recycled for energy production at the cathode 751. The recycling would enable the sound waves, solar energy, heat, vibration, and wind to serve only as a catalyst to effectively produce maximum voltage. Embodiments provide a substrate 712 and microfiber/nano-fiber material 710 for the design configuration of the cell platform 756. The cell platform further comprises electro-active material to enable better charge transport. The cell platform 756 further comprise of plurality nano-components consisting of nano-particles 767 forming conductive carbon-based nano-clusters 768 bound together by a conductive carbon-based cluster binder having high densities of mobile charge carriers such as electrons, electronic acceptors, and ionic species. The cell platform 756 further comprises at least a terminal 769, being electrically coupled to the nano-particles 768 for enabling a charge transport being operable for supplying electrons and electron acceptor sites. Other embodiments of the cell platform 756 further comprise charge transport 740, occurring by means of the electron traveling through the highly conductive and short path of the binders 770. Disclosed embodiments provide the binders in close proximity with the nano-clusters 768 for enhancing the energy and power densities. Disclosed embodiments further comprise battery cell and/or capacitor.

Disclosed embodiments provide a radiator apparatus comprising a renewable energy source. Certain embodiments provide communication apparatus comprising solar panels made of crystalline silicon wafers for converting solar energy into electrical energy. Some embodiments provide thinner wafers using laser processing to ablate the circuit board, providing more electrically efficient communication environment for signal amplification. Disclosed embodiments provide the radiator apparatus being further configured with substrate-microfiber/nano-fiber and metallic materials to prevent any radioactive or chemical impact within the environment. Disclosed embodiments further provide the radiation apparatus being further configured for extracting energy from the opposing outside wind to be stored within the cell platform. Disclosed embodiments provide methods and systems that don't produce noise and pollution. More electricity could be generated at any time without physically plugging the communication apparatus into a wall socket for recharge, thereby extending the life of the battery.

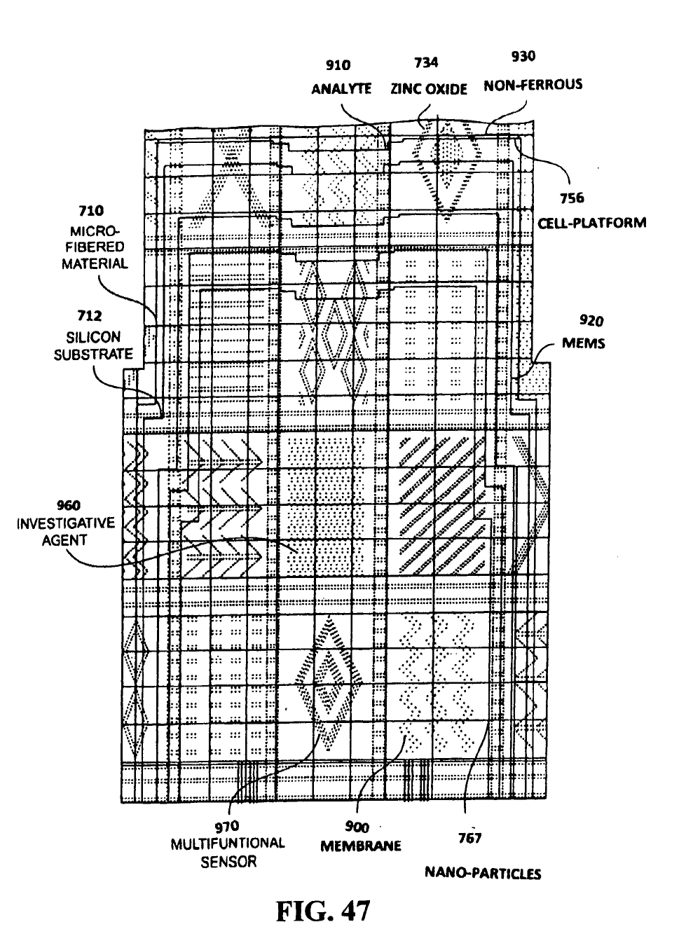

Referring to FIG. 47 is seen exemplary embodiments of a charge transport comprising microfiber/nano-fiber material 710 being configured with silicon substrate 712. The silicon microfiber/nano-fiber comprises cell platform 756. The cell platform 756 comprises nonferrous material 930 embedded in the silicon substrate 712. Multifunctional sensors 970, nano-sensors 360, 327 and MEMS 920 are embedded in the silicon substrate for detection of charge characteristics. The cell platform 756 further comprises nano particles 767 being configured with membranes 900. Disclosed embodiments provide methods and systems for generating electrical energy and for transporting the energy into a storage medium. Some embodiments provide zinc oxide 734. Certain embodiments comprise an analyte 910. Other embodiments provide an investigative agent. Embodiments provide a MEMS 2-D scanning micro-mirror with miniature optics and flexible electronics for unrestricted probe movement. Embodiments provide communication apparatus being configured with flexible electronics for unrestricted freedom of movement due to pressure, vibration, and sound waves to generate energy through voltage-transformation circuitry in communication with the battery cells. The platform provides safety into MEMS system to protect consumers from dissipative radiant energy. Certain embodiments provide communication apparatus being operable on low power consumption. Certain embodiments provide highly efficient fiber amplifiers using ultrafast laser technique.

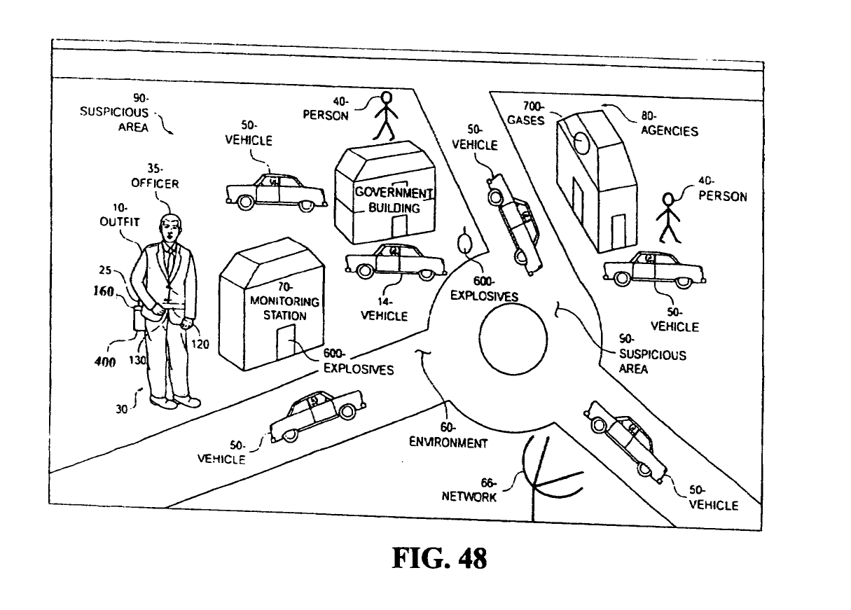

Referring to FIG. 48 is seen communication environment 60, comprising a monitoring station 70, agencies 80 and a government building. Vehicles 14 and 50 and at least a person 40 are being watched by an Officer 35 monitoring a suspicious area 90. The Officer 35 is outfitted with certain embodiments of the disclosure, comprising outfit 10 on the officer 35, a communication apparatus 400, communication apparatus 400 being disposed in an outfit 160 operable for housing the communication apparatus, wearable outfit 30, waist belt 120, outfit 160 is firmly secured on the officer's waist by the waist belt 120, and connector 25 being disposed within the waist area 130. Officer 35 is seen to have identified a suspicious person 40 patrolling at least agencies 80. The outfits 10, 30, and 120 are seen to provide exemplary embodiments of detected explosives 600 and gases 700. The communication apparatus 110 is further configured to analyze detections and is in communication with a network 66.

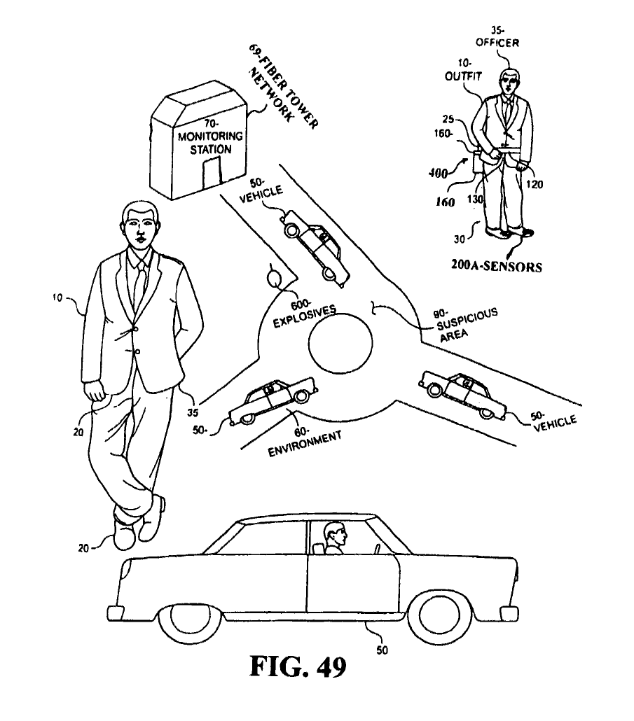

Referring to FIG. 49 is seen further embodiment of a monitoring station 70 comprising a fiber tower network. A person 35 is seen wearing a detection outfit comprising of sensors embedded in silicon substrate and fused/etched in a microfiber/nano-fiber material, a communication apparatus 400 is disposed in an outfit 160 comprising a housing being secured on the waist area 130 via a waist belt 120 by the person 35. The housing further comprises silicon substrate micro fiber being embedded with sensors operatively configured for generating electrical energy. The communication apparatus 400 is communicatively configured with signal booster operable to prevent cancerous disease and is responsive to network communications with the monitoring station 70 and/or fiber optic tower 69. The communication apparatus is further configured with battery cells responsive to energy being created and responsible for supplemental empowering of the detection platform for the display device. Further embodiment of a person 35 is being disposed with communications apparatus 400. Disclosed embodiments provide the respective person 35 wearing outfits 10, 20, 30, 120, 160 and 130, operable for detecting weapons of mass destructions. The person 35 is communicating with communication apparatus 400 disposed in a vehicle 50 being positioned within an environment 60. The communication apparatus 400 may be configured to detect suspicious area 90 containing explosive 600. A suspicious vehicle 50 is seen to have been detected with weapons of mass destructions.

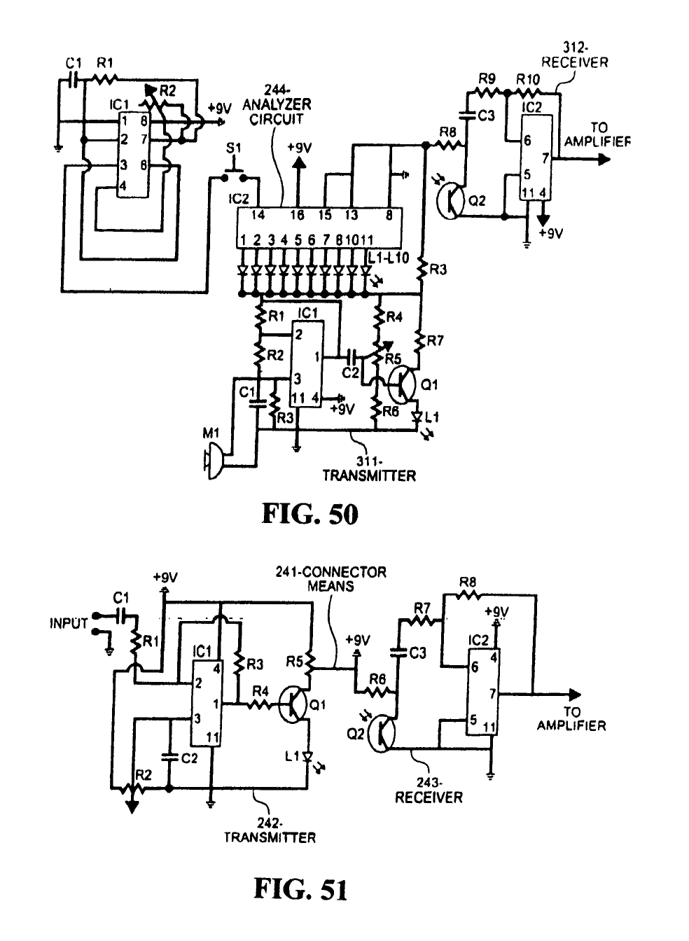

Referring to FIG. 50, the transmitter 242 is configured with energy apparatus comprising a battery cell which may be charged wirelessly. An amplifier is configured with the communication apparatus for amplifying signal communications. Transmitter 311 and receiver 312 are communicatively connected. Transmitter 311 and receiver 312 are communicatively connected to analyzer circuit 244. The CMOS circuitry is operable to dissipate less power. Certain embodiments of the disclosure further provide a static logic configuration being operable on p-type and n-type metal-oxide-semiconductor field-effect-transistors “MOSFET's.” being configured for implementing logic gates.

Referring to FIG. 51 is seen an exemplary embodiment of a transmitter 242 and 311, and a receiver 243 and 312. The amplifier is seen responsive to signal communications. Transmitter 242 is operatively configured with receiver 243 and communicatively connected to connector beam 244 responsive to communication network connections. The amplifier comprises a chip communicatively connected to receiver 243 and operatively configured with transmitter 242. The transmitter 242 and 311, and the receiver 243 and 312 comprise CMOS comprising of solar cells on n-type CZ silicon substrates, including Polycrystalline thin-film cells, lightly boron-doped CZ, or gallium-, indium-, and aluminum-doped CZ for converting solar energy, pressure force, sound wave, vibration, wind force into electrical energy. Disclosed embodiments further provide a thin-film comprising of thin layer of transparent conducting oxide, including tin oxide. Certain embodiments provide the oxides being highly transparent and configured to conduct electricity efficiently. Some embodiments provide antireflection coatings.

Other embodiments provide Polycrystalline thin-film cells comprising tiny crystalline grains of semiconductor materials operable for converting solar energy into electrical energy. At least a CPU-1C1 is provided in communication with RFID chip reader-1C2. L1 and L2 are LED. S1 is an automatic momentary single pole double throw switch operative for transmitting and for receiving signals. C1 is an electrolytic capacitor being disposed on an energy platform comprising C2 and C3, which are IMF capacitors. Q1 and Q2 are infrared LED emitter and M1 is a speaker microphone. R1 through R10 are resistors responsive to signals. Disclosed embodiments provide a digital signal processing system which allows reconfiguration of signal transmission to the environment and signal conditions. At least the antenna is developed for electrical operation, which can be reconfigured in terms of frequency and may also increase or decrease its directivity. The increase and/or decrease of signal directivity is a measure of the gain of the antenna in a particular direction. Disclosed embodiments provide the communication apparatus being configured with the antenna to operatively pick up faint signal by increasing its gain or overcome interference by creating a null point. Certain embodiments provide a smart communication apparatus being configured for any given network or environment. Some embodiments provide a miniaturized adaptive micro antenna in communication with at least a chip being configured for signal amplification and to minimize interference and maximize intended signal reception. Disclosed embodiments provide signal booster chip comprising of at least a MEMS, in communication with a logic circuit. The MEMS further comprises MEMS based phase shifters being configured on at least a single silicon substrate microfiber/nano-fiber comprising communication control circuitry. The sensors are being coated with silicon substrate polymer and/or with zinc oxide layer to provide energy transport platform. Certain embodiments provide communication apparatus comprising silicon substrate microfiber/nano-fiber configured with optical properties of thin films being operable for the advancement of the integrated circuit for converting solar energy into electrical energy. Disclosed embodiments further provide smaller feature sizes, faster switching speeds, and lower power consumption apparatus. Some embodiments provide basic wiring such as dielectric and photolithographic layers, providing a circuit for electrical energy production. This integrated circuit could employ copper/low-k interconnects, silicon-germanium and silicon on insulator-based transistor structures. Infrared spectroscopy is provided and offers metrology approach to sensing through the display/input device/outfit, complementary to UV-VIS techniques that provide excellent sensitivity to layer composition, including chemical bond densities and free carriers with the enhanced immunity to roughness induced scattering.

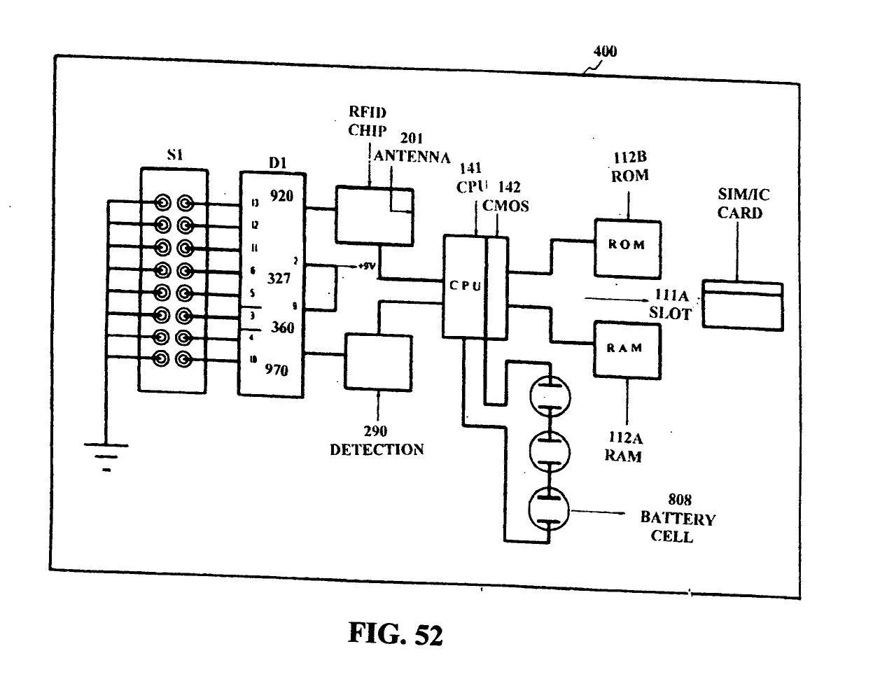

Referring to FIG. 52 is seen an embodiment of the circuit diagram of the communication apparatus comprising a privacy indicator. Switch (S1) is communicatively connected to RFID CHIP for signal amplification. Certain embodiments provide a common node display (D1) comprising touch screen operatively configured with multifunctional sensors 970. The display device is further operable for generating energy. RFID CHIP is operatively configured with antenna 201. A CPU 141 is operatively configured with detection device 290 communicatively connected to at least a CMOS 142. The detection device is responsive to detection signal communications and operatively connected to a battery cell 808. The communication apparatus 400 further comprises an IC and/or SIM card slot 111A comprising SD card slot and/or HDMI/USB ports. Embodiments further provide user identification card 112. The communication apparatus 400 comprises operating system consisting of software operatively configured with ROM 112B to read the ID card 112. The ROM 112B is communicatively configured to provide communications to the RAM 112A. The RAM 112A is responsive to communication database 113 where information may be stored or retrieved. A screen read-out 113A is provided configured with the communication apparatus. An 8-pin privacy indicator switch (51) is operatively configured with the communication apparatus 400 and responsible for providing private communications. Switch (51) comprises of display selections corresponding to cathode A, cathode G, and cathode D of at least a 7-segment common anode display settings (D1). Chip 200a comprises a detection tool responsible for providing communications to at least a network. The IC and/or SIM card 112 is further operable with the communication apparatus 400, comprising wireless communication applications in communication with a software program.

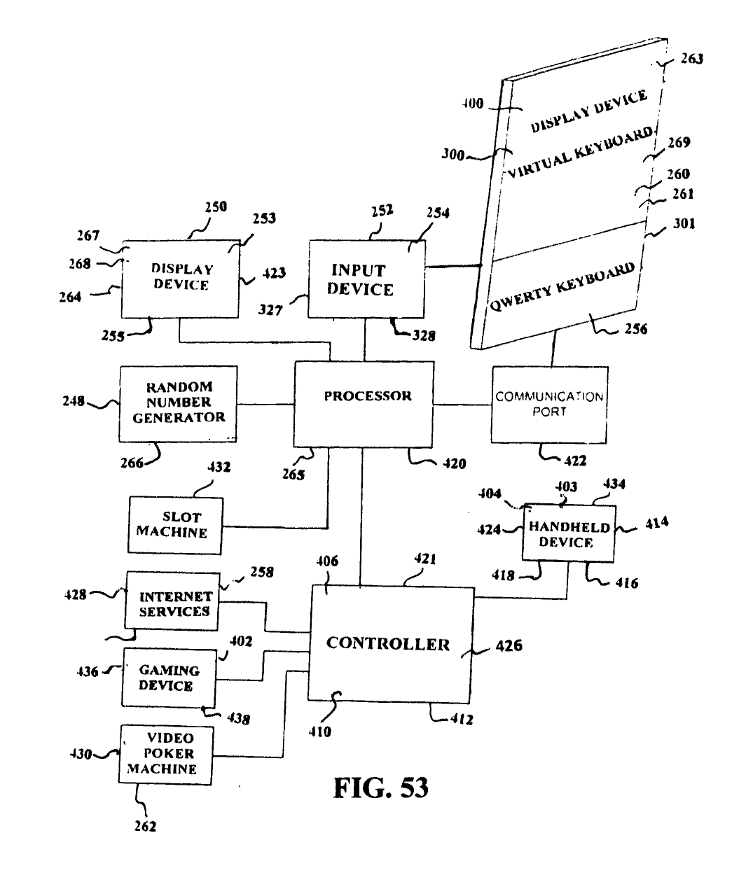

Referring to FIG. 53 is seen an exemplary embodiment of the communication apparatus. The communication apparatus 400 comprises at least an input device 252, including a keyboard 254. The keyboard 254 may consist of a virtual keyboard 255 and/or QWERTY keyboard 256 in further communication with a random number generator 248. At least a social network application 258 is configured with the keyboard and in communication with the processor 420. Disclosed embodiments further provide the keyboard being disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265, and camera 263. Disclosed embodiments further provide the communication apparatus further comprising at least one of: a mobile communication device 400, a gaming device 402, a media device 403, and an interface device 404. Disclosed embodiments provide the interface device comprising at least an integrated phone/PDA 400 being configured with integrated connectivity apparatus 406 operable to provide global roaming. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber/nano-fiber consisting of resistive touch screen 260 and/or character recognition 269 and/or a communication board 300. Certain embodiments provide housing 301 for the communication apparatus 400 comprising a carbon fiber 408 and/or a silicon microfiber/nano-fiber. Disclosed embodiments further provide a communication apparatus being configured with at least a WAP browser 410 and/or an integrated GPS device 412 and/or an MP3 music device 414 and/or a camera apparatus 416 and/or an internal antenna apparatus 418 being configured with a controller 421 in communication with a predictive text messaging applications 423. Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 430 and/or a slot machine 432, and/or a handheld device 434 and/or a gaming device 436 and/or a play station 438 in communication with communication port 422.

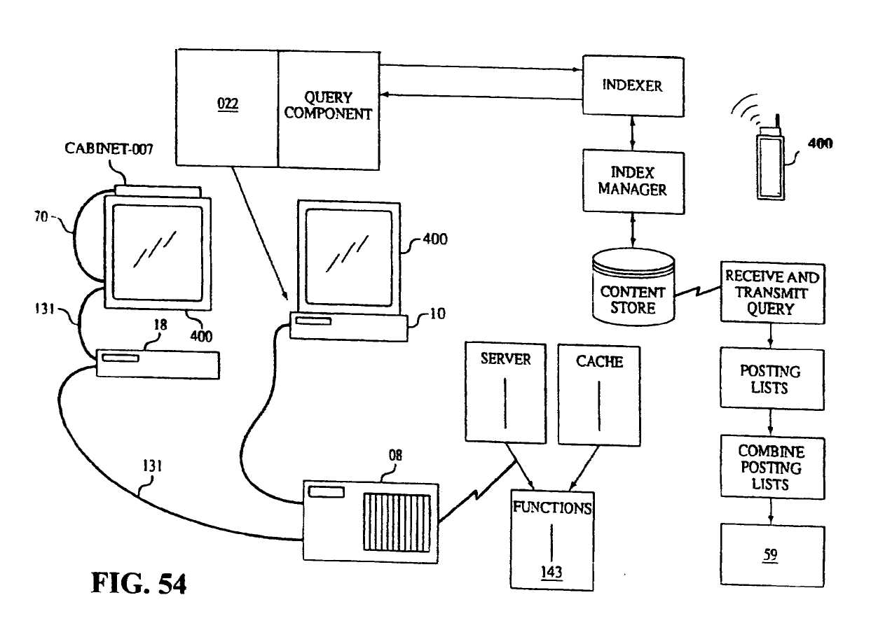

Referring to FIG. 54 is seen an exemplary embodiment of a network environment, comprising a communication apparatus 400 in communication with an output device 70. The communication apparatus further comprise a computer system 10 being configured with a readout tool 008 in communication with an address book 131. A network terminal 022 is provided in communication with a query component. The query component is configured with an indexer in communication with an index manager. Embodiments further provide a network environment comprising a server and a cache engine in communication with functions 143. The functions 143 further include social network environment being operable to receive and transmit communications to at least one of: a memory, a cabinet 007, and/or a content store. Certain embodiments provide the communication apparatus comprising a memory consisting of a content store in communication with an input device. The input device is further operable to receive and transmit query, and in communication with posting lists and/or combine posting lists. At least a display adaptor is communicatively connected to the posting lists.

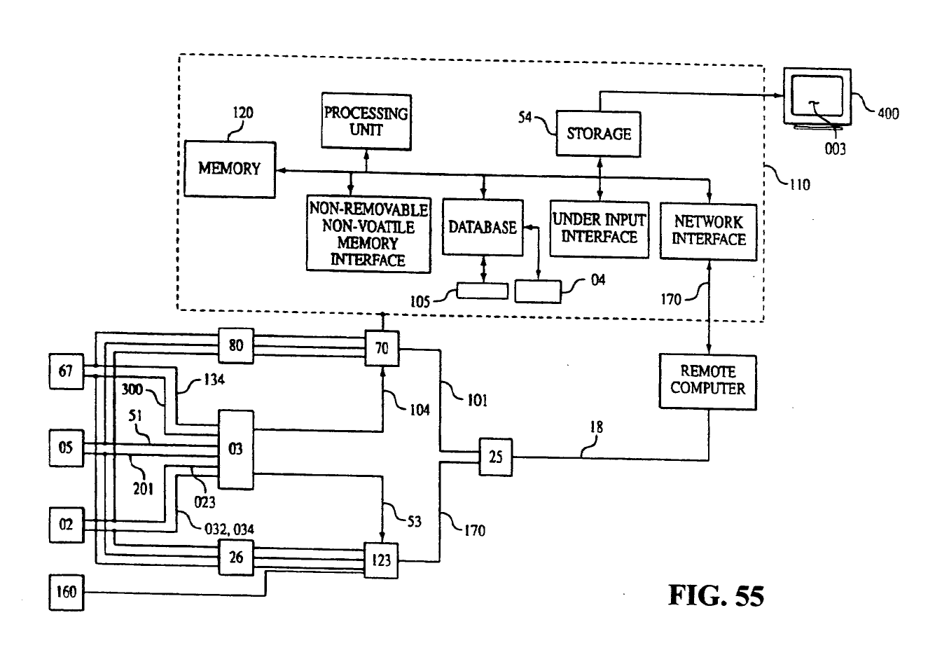

Referring to FIG. 55 is seen further exemplary embodiment of the communication apparatus 400 comprising, storage medium 54, a processing unit 122 in communication with a memory device 120. Disclosed embodiments further provide a non-removable non-volatile memory interface, a database, input interface and network interface 170. Certain embodiments provide a communication apparatus comprising hardware 105, a graspable hardware/browser 04, and a display device 003. Other embodiments provide a communication apparatus 400 comprising software 300, central processor 51, a RAM 05, a ROM 02, a network adaptor 160, and a media device 201. Disclosed embodiments further provide a communication apparatus 400 comprising at least an output device 70, a remote computer in communication with a connection key 25. The connection key is further in communication with industrial files 18, network files 110, decision engine 123, graphic user interface 101, sensors 104, and system memory 53. Certain embodiments provide a communication apparatus being further configured with system bus architecture 67 in communication with an input device 80. Some embodiments provide the output device 70 further comprises a report generator 134 in communication with an instruction program 26. At least a CPU 03 is provided, in communication with a java class 023, a clickn Vest Servlet class 032, and a Servletrunner application 034.

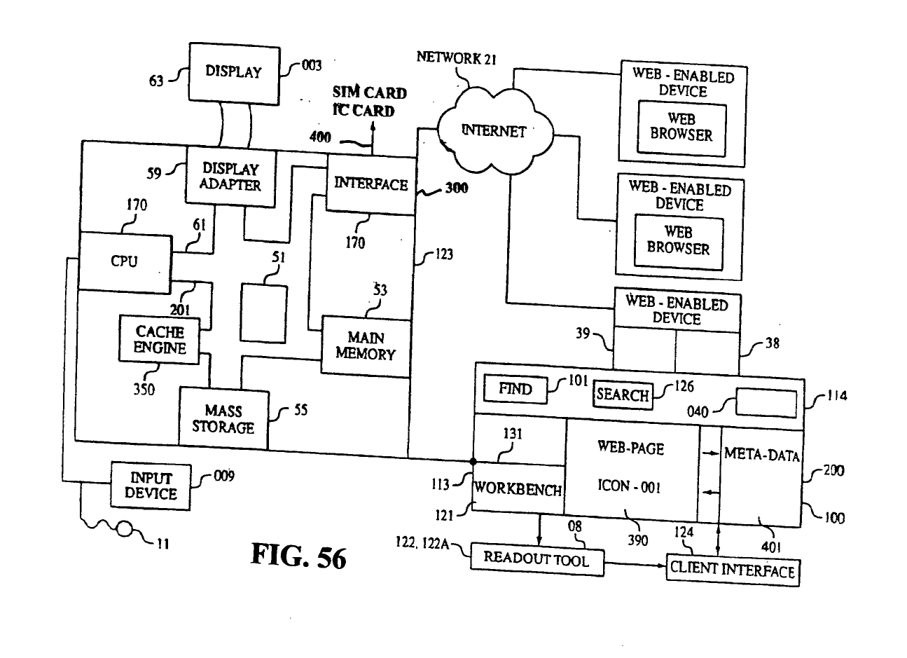

Referring to FIG. 56 is an illustration of a network environment comprising a communication apparatus 400 in communication with a computer system comprising a display device 003, a sound card 61, speakers 63, a cache engine, a network interface 170, a display adapter 59, intelligence logic 350, a media device 201, and a central processor 51. The communication apparatus further include an input device comprising at least a keyboard 009 and a mouse 11. The communication apparatus further include an IC card, SIM card, and interface. The CPU is operable with the intelligence logic to process commands and applications, in communication with memory 53, decision engine 123 and web-enabled devices. The network 21 is responsive to communications through the Internet. Certain embodiments provide a communication apparatus being configured with a browser, a server search report 39, and client search programs 38. Disclosed embodiments further provide a communication apparatus configured with graphic user interface 101, a search program manager 126, a browser 040, an ICON 001, and a storage medium comprising at least a meta-data 114. At least a web-page manager is provided comprising addresses 131, corporations 200, industries 100, schools and ware houses 121 and a workbench 113. The computer system further comprises an affinity analyzer 122, a data analyzer 122A, a readout tool 08, a web-page 390, a report generator 124, files 401, and client interface being operable with software application 300.

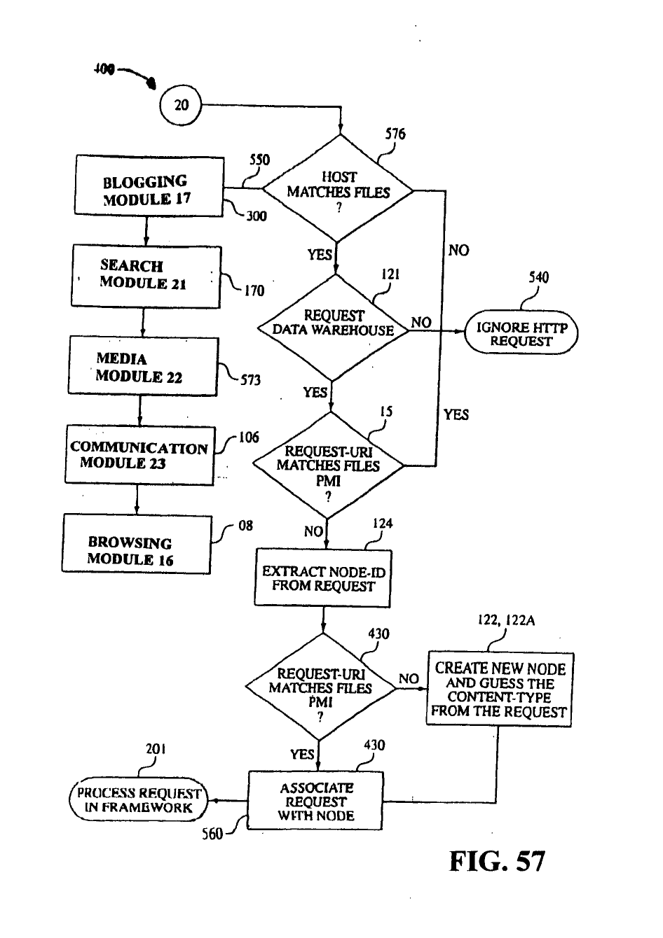

Referring to FIG. 57 is an illustration of the intelligence logic for the communication apparatus 400, comprising a blogging module 17 configured with the session layer 550 and software 300, a search module 21 in communication with network interface 170, a media module 22 configured with signal booster chip 573, a communication module 23 in communication with signal booster chip 573 and antenna circuit 106, and a browsing module 16 in communication with a readout tool 08. At least a file memory is provided in communication with the software 300. A data warehouse 121 is communicatively connected to the search module 21 being configured with a primary memory interface “PMI” in communication with primary programs 15. Disclosed embodiments further provide a communication apparatus configured with a client identification node “ID NODE” in communication with affinity analyzer 122 and data analyzer 122A. The media module is communicatively connected to the media device 201, and the search module is communicatively connected to HTTP report generator 124 in communication with presentation layer 540. Some embodiments provide a communication apparatus configured with a default gateway 430 in communication with a transport layer 560. Certain embodiments provide the communication apparatus being operable on an energy platform 576.

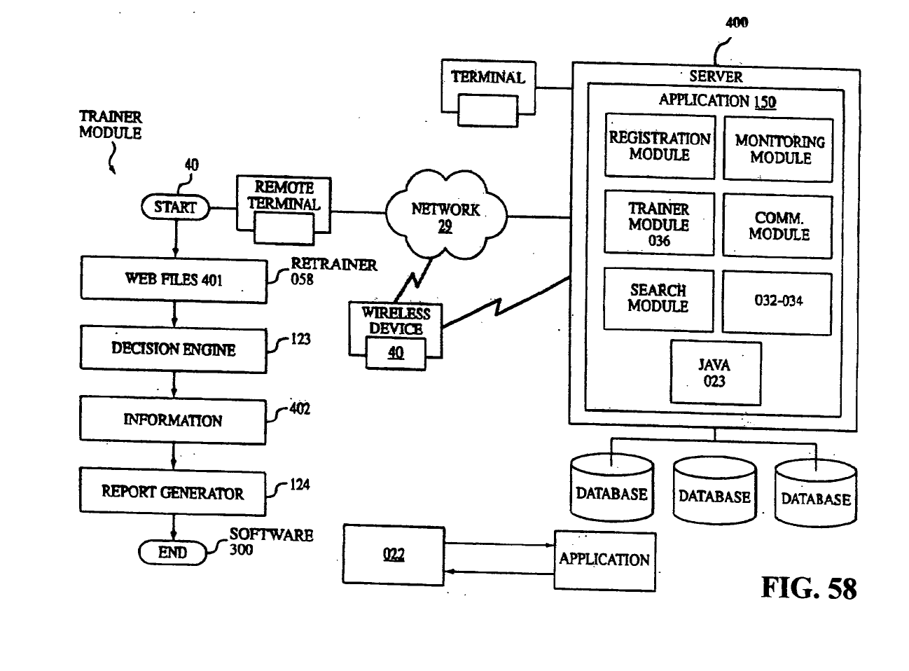

Referring to FIG. 58 is a further illustration of the communication apparatus 400 in a network environment 29, comprising at least a server application 150. The server application 150 further includes at least one of: a registration module, a monitoring module, a trainer module, a communication module, a search module, and/or java application software 023. Certain embodiments provide the java application software 023 in communication with a database server. Disclosed embodiments provide the communication apparatus further comprises ports and/or terminals comprising a network terminal 022 in communication with at least an application. Certain embodiments provide the communication apparatus being turn on by at least a start button in communication with at least a control device 40. Other embodiments provide the control device 40 comprising a wireless device communicatively configured for communications with remote terminals. Disclosed embodiments further provide a communication apparatus comprising at least one of: report generator module 124, information module 402, retrainer module 058, web-files module 401, a clickn Vest Servlet class 032, and a Servletrunner application 034, and/or a decision engine.

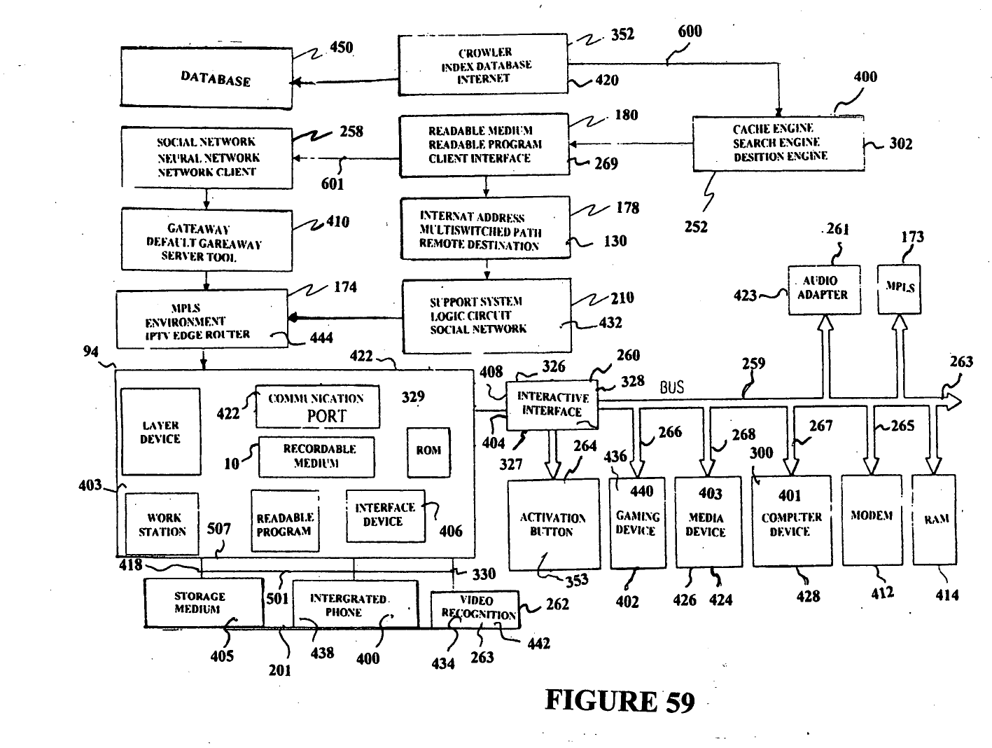

Referring to FIG. 59 is an exemplary embodiment of the communication apparatus 400 in communication with a virtual private network 178, further comprises a centralized transportation search engine topics data processing system 180 operable on a social platform 258. The social platform 258 is operatively configured for communication via multicast virtual private network 258 operable for advancing transportation media and engineering knowledge. The social platform 258 comprises a social network application in communication with processor 420. Disclosed embodiments further provide the communication apparatus further comprising keyboard 269 disposed on an LCD display screen 260 being configured with sensors 327 operable for object recognition. Certain embodiments provide the sensors 327 being configured for video recognition 262. Some embodiments provide the communication apparatus 400 configured with the display device 260 in communication with at least an activation button 264 configured to activate at least one of: phonebook 266, calendar 268, dictionary 267, calculator 265, voice recognition 261 and camera 263. Disclosed embodiments further provide the communication apparatus further comprising at least one of: a mobile communication device 400, a gaming device 402, a media device 403, an interface device 404, and a content store 405. The communication apparatus further comprises a computer apparatus 400 comprising a Computer recordable medium 10 being operable on a computer readable program 300 being recorded to cause at least one computer device 401 to receive at least a media reference documents 130. The communication apparatus further comprising a router module in association with at least a traffic implementation module.

The media reference documents 130 further comprise database comprising topics of information relating to transportation topics, television media topics and/or communication data topics. The communication apparatus is further operable for storing at least a frequency through which a module generates content when queried and is further operable for determining keyword compatibility based on the frequency. Disclosed embodiments provide the interface device 404 comprising at least an integrated phone/PDA 400 being configured with integrated connectivity apparatus 406 comprising a CMOS multiple 201 antennas on at least a chip 329 operable with the CMOS multiple antennas 201 to realize at least 60 GHz frequency for faster data transmissions, and to provide global roaming for communications and for accessing transportation media topics of information, television media topics of information, communication media topics of information, educational media topics of information, and entertainment media topics of information. At least a communication port 422 is provided with the communication apparatus 400. Certain embodiments of the disclosure provide the communication apparatus comprising a GSM phone 400 being operable with at least a microprocessor 420. Some embodiments provide the communication apparatus comprising at least a tunnel module being operable to allow multiple inputs/outputs 252. Other embodiments provide the communication apparatus comprising a touch interface 404 operable on a touch screen 260 configured for at least one of: interactive communication, interactive gaming, interactive music download, interactive television, video, social network, and phone book.

Yet other embodiments provide the communication apparatus being configured with at least a slider 352 operable to access multimedia buttons 353 and/or numeric keypads being configured with multi layer piezoelectric sensors 327. The multi layer piezoelectric sensors 327 further comprise crystals 328 configured with silicon-substrate-microfiber/nano-fiber chip 329 configured to further provide voice operations and/or voice over text applications. Disclosed embodiments provide the communication apparatus being configured with voice over text technology operable to provide hands free texting applications while driving. Still, other embodiments provide the communication apparatus comprising of sensors 327 embedded in carbon fiber 408 and/or silicon substrate microfiber/nano-fiber 330 to provide a resistive touch screen 260 and/or character recognition 269 and/or a communication board 301, in communication with at least one of: the chip 329, the multiple antennas 201, and the readable program 300. Certain embodiments provide housing 302 for the communication apparatus 400 comprising a carbon fiber 408 and/or a silicon substrate microfiber/nano-fiber 329. Disclosed embodiments further provide the communication apparatus 400 being configured with at least a WAP browser 410 and/or an integrated GPS device 412 and/or an MP3 music device 414 and/or a camera apparatus 263 in communication with an interactive interface apparatus 172. The interactive interface apparatus 172 is operatively configured with at least a multi-protocol label switching 173 comprising at least a label switched path 174 operable on at least a support system 210. The support system 210 is operatively configured for mapping desired communications and to execute at least a process to at least one reference document 130. Disclosed embodiments further provide the communication apparatus 400 further configured with another CMOS antenna apparatus 418 being configured with a controller 421 in communication with a predictive text messaging applications 423. The controller 421 further comprises at least a logic circuit 422 in communication with the chip 329 in further communication with antenna apparatus 201 and 418. Certain embodiments provide the logic circuit 422 further comprises a computer readable program 300. The computer readable program further comprises a software program. At least the CMOS antennas 201 and 418 are coupled in parallel and shorted at a metal plate 501 to provide parallel plate transmission 507.

Disclosed embodiments further provide the support system 210 communicatively connected to at least a dedicated processing element 432 being operable for providing carrier based multicasting virtual private networks 178. Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 434 and/or a slot machine 436, and/or a handheld device 438 and/or a gaming device 4440 and/or a play station 442, and/or a television handset 444, in communication with communication port 422. Preferred embodiments provide the communication apparatus 400 comprising at least a client 450, at least a search engine for entertainment media, television media, wireless communication media, and for routing transportation media topics of information. In the disclosed embodiments, the communication apparatus 400 is configured with the CMOS antennas 201 and 418 being coupled to a chip 329 in communication with a logic circuit for signal amplification. Certain embodiments provide the CMOS antennas 201 and 418 further configured to provide a massive available bandwidth operable on high bit rates consisting of several Gbits per second. Some embodiments provide the multiple antenna apparatus 201 and 418 comprising of phase antenna array configured with a programmable phase shift to accommodate variable incoming signals on the same chip 329 and/or separate chip 403 and 329. Other embodiments provide the antenna apparatus 201 and 418 comprising CMOS based phased array transceiver operable on at least 60 GHz wireless network 600 for providing fast kiosk downloading and wireless high definition multimedia interface applications on at least a low power communication link 601. Embodiments further provide the antenna apparatus further comprising adaptive beam-forming multiple antenna apparatus being aligned on the communication circuit board 94 in communication with at least the logic circuit 407 and/or the software 300.

The antenna 201 can couple with a router 179 to provide antenna functionality to the router 179, for example where the router is a wireless router 179. For example, the router 179 can include at least one antenna 201. The antenna 201 can include a first reflective circuit 108 and a second lead 154 to couple to a radio-frequency (RF) transceiver 724 and/or to a radio-frequency (RF) transceiver 158. The RF transceiver 724 is coupled to a processor 420, which in one or more embodiments can operate as a baseband processor to process baseband signals. The processor 420 in one or more embodiments can operate as a broadband processor to process broadband signals. The processor 420 can couple to dedicated processing memory 432 that can store one or more instructions, including programs and data that can be utilized by processor 420. The processor 420 can be coupled to an interface module 172 to couple router 179 to network 20 and 21.

Alternatively, router 179 wirelessly couples to the network 20 and 21. In one embodiment, the network 20 and 21 can include the internet or similar type of distributed network. Certain embodiments provide the network 20 and 21 comprises various network such as a local area network (LAN), wide area network (WAN), metropolitan area network (MAN), WPAN, WWAN, WLAN, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wideband CDMA (WCDMA), CDMA-2000, and the like. In one or more embodiments, the network 20 and 21 can comprise a cellular telephone network, a virtual private network, and a public switched telephone network.

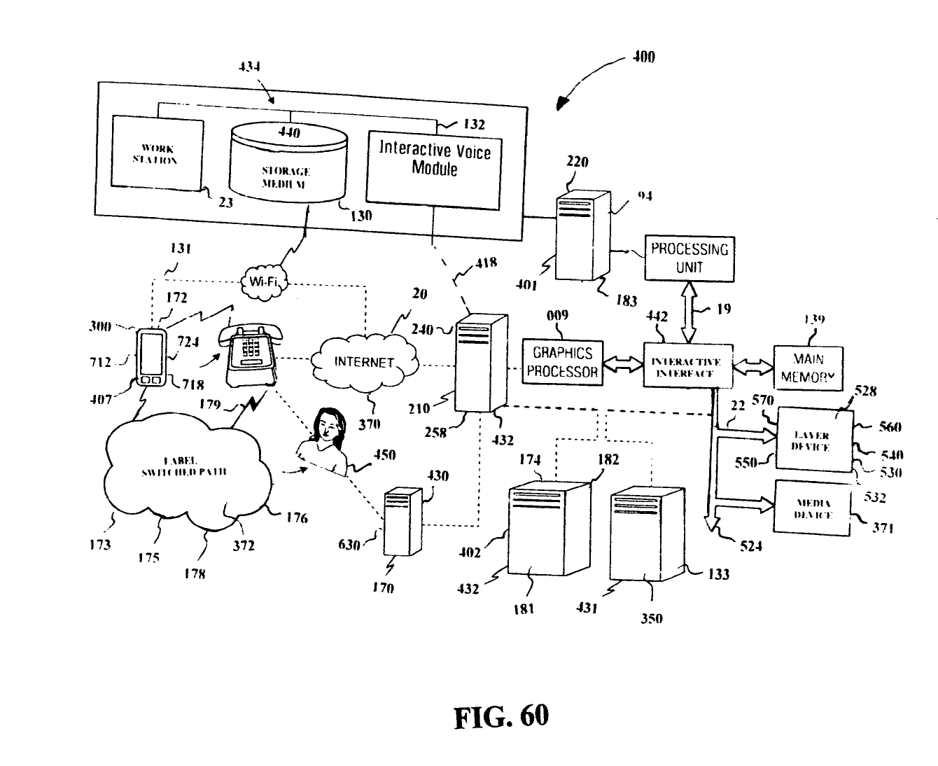

Referring to FIG. 60 is seen exemplary embodiments of the communication network. Some embodiments provide a network 20 comprising distributed collection of nodes 22, interconnected by communication links 131 and segmented for transporting reference document data 130 between end nodes 22. Other embodiments provide at least one end notes 22 comprising computer devices and workstations 23. Disclosed embodiments provide the network 20 comprising local area networks (LANs); wide area networks (WANs). The communication apparatus 400 further comprises circuit board 94 comprising electronic system's applications, including embedded network and CMOS multiple antennas 201 and 418 in a network for at least one of: a wired communications device, a wireless communications device, a cell phone, a handheld communication device, laptop computer, desktop computer, telemetry device, a switching device, MP3 player, a router, a repeater, a codec, a LAN, a WLAN, a Bluetooth enabled device, a digital camera, a digital audio player and/or recorder, a digital video player and/or recorder, a computer, a monitor, a television set, a satellite set top box, a cable modem, a digital automotive control system, a control module, a communication module, a digitally-controlled home appliance, a printer, a copier, a digital audio or video receiver, an RF transceiver, a personal digital assistant (PDA), a digital game playing device, a digital testing and/or measuring device, a digital avionics device, a media device, a medical device, an entertainment device, and a digitally-controlled medical equipment.

Disclosed embodiments further provide the communication apparatus 400 disposed in a housing 301 consisting of silicon substrate microfiber/nano-fiber 714. Certain embodiments provide the silicon substrate microfiber/nano-fiber comprising a sensory platform operable to convert at least one of: temperature variations, pressure, force, vibration, solar energy, and motion into modulating frequencies and operating electrical energy. In further embodiments, the integrated circuit “1C” further comprises multiple antenna apparatus 201 and 418 embedded on at least a complementary metal oxide semiconductor integrated circuit 724, operable for communications with each other to form an intra-chip comprising of on chip multiple antennas communication network environment 718. Certain embodiments provide the on chip antennas 201 operable for wireless interconnections. Some embodiments provide the on chip antennas 201 and 418, operable for metal interconnections. Other embodiments provide the on chip antennas 201 and 418 comprising multiple CMOS antenna apparatus 724. The multiple antenna apparatus 201 and 418 further comprising on chip signal communication network 718 for wireless communications. The network 718 further comprises nano wires 714 configured for multicast protocol label switching network 173 on a contemporary chip layer 403 comprising a network platform. The contemporary chip layer 403 is in communication with a logic circuit 407. Disclosed embodiments provide the logic circuit 407 further comprises a software program 300.

The support system 210 further comprises a social network platform 240 comprising a social network environment operatively configured for multicast virtual private network 178. Disclosed embodiments provide the virtual private network 178 comprising apparatus operable for transmitting same data to multiple receivers in a network. Certain embodiments provide the multicast virtual private network 178 comprising at least a multicast packet 176 configured for replication with at least a router 179. The multicast private network 178 further configured with the network interface 170 for advancing transportation media knowledge, entertainment media, advertisement media, and television media. The network interface 170 further comprises: at least a computer device 401 comprising a computer recordable medium 10 being operable on a computer readable program 300. The computer readable program 300 is configured to cause at least one computer device to receive plurality of media reference documents in communication with client interactive interface module 172. The client interactive module 172 is further operatively configured with at least a multi-protocol label switching 173 operable with at least the support system 210. The support system 210 is further configured for mapping desired communications. Disclosed embodiments further provide the multicast-protocol label switching 173 further comprising apparatus being configured to direct data from network note 22 to network 20 and 21 in communication with the virtual link 131. Certain embodiments provide the multi-protocol label switching further comprising apparatus configured for carrying data from network note 19 to network note 22 in communication with the virtual link 131. Some embodiments provide at least a note comprising a sensor note. Certain embodiments further provide the sensor note configured for reusable frequencies. At least one support system 210 is configured with the social platform 240 and communicatively connected to at least a dedicated processing element 432. The reusable frequencies further include impulse UWB radio modules, narrow-band-radio modules, and event-driven-radio modules. At least one of the radio modules is in associations with the communication apparatus. At least one of the radio modules is in association with the computer apparatus. Further comprises at least a millimeter-wave-module.

The multi-protocol label switching 173 is further configured to speed up network traffic flow to effectively manage structured reference documents comprising transportation media topics of information. Other embodiments provide the virtual private network 178 further comprising the router 179 in communication with the multiprotocol label switching network 173. The router 179 is configured for the distribution of reference documents and media topics of information across a shared multiprotocol label switching network 173. Disclosed embodiments provide the router further includes Internet protocol addresses 181 for establishing multiple switched paths 182 with the multiprotocol label switching network 173. Other embodiments provide the multiple switched paths comprising plurality point to point paths assignments for the reference documents, transportation media documents, and for social network. Some embodiments provide the router 179 further configured for maintaining communications with at least the database 130 containing reference documents and transportation media reference documents, including transportation topics of information. Other embodiments provide the database further comprising prefix of the topics of information that matches addresses in the packet's network address fields, comprising transportation media topics addresses, communication media topics address, television media topics address, advertisement media topics addresses, and entertainment media topics address. Disclosed embodiments further provide the communication apparatus 400 comprising Internet protocol configured to determine at least a direction for the packet transmission from the router 179 to at least a remote computer device 401. In the disclosure, the packets further include Internet protocol data-gram comprising network addresses for remote destinations 431.

Certain embodiments provide the dedicated processing element 432 further operable for providing carrier based multicast virtual private networks environment 178. Some embodiments provide multi-protocol label switching 173 consisting of labels 175 comprising packets 176 to forward decisions made on the contents of the labels. Disclosed embodiments further provide the communication apparatus 400 further operable for categorizing files for at least one of: transportation media topics; communication media topics; television media topics; advertisement media topics; and entertainment media topics referenced by initial search results; comprising implementing at least a method for receiving at least a query that maps to objects identifier for transportation media topics addresses, communication media topics address, television media topics address, educational media topics addresses, advertisement media topics addresses, and entertainment media topics address. The virtual private network further comprises interactive collaboration within the media topics reference documents. The communication apparatus 400 in communication with the virtual private network 178, further comprises a server-based social network platform 258 operable for community distribution of knowledge, including transportation media topics, educational media topics, communication media topics, television media topics, advertisement media topics, and entertainment media topics. The virtual private network 178 is further configured with document management system 183 comprising a server database that includes at least a professional functionality and a plurality of interactive functionalities. Disclosed embodiments provide the interactive functionality further comprising transportation media topics personnel, communication media topics personnel, television media topics personnel, educational media topics personnel, advertisement media topics personnel, entertainment media topics personnel, and other personnel who may assemble into the networks through the social platform 258. The interactive functionalities further include allowing networks of transportation media topics personnel, communication media topics personnel, educational media topics personnel, television media topics personnel, advertisement media topics personnel, entertainment media topics personnel, and other personnel, including scientists, engineers, students, universities, transportation personnel to share knowledge and documents in a remote secured environment. Disclosed embodiments provide the communication apparatus 400 further configured with software applications 300, further operable to remotely create, delete, edit and manage transportation media documents, television media documents, educational media documents, communication media documents, advertisement media documents, educational media documents, and other media documents, and view information about these documents in a plurality of customized locations.

Certain embodiments provide the communication apparatus 400 further comprising at least a neural network 220 in communications with at least a cache engine 350 operable for responding to at least a topic request comprising at least one of: transportation media documents, television media topics, entertainment media topics, communication media topics, advertisement media topics, educational media topics, and other media topics, using a server response data that is cached at the networks 20 and 21, being operable with at least a programmable architecture 524. Disclosed embodiments provide the programmable architecture 524 being configured with at least one dedicated processing elements 432. Certain embodiments further provide the cache engine 350 in communication with cache database 133. Some embodiments provide the communication apparatus 400 further comprising a search engine 402 in communication with the cache engine 350 being configured for applications that include interne 370. Other embodiments provide the search engine 402 in communication with at least a crawler 174 and an index database 132. The communication apparatus 400 further comprising virtual private networks 178 configured to deliver/broadcasting communications data via Internet Protocol Television edge routers 371 operable on the multi-protocol label switching environment 372. Disclosed embodiments provide the multi-protocol label switching environment 372 operable for sharing multicast state media data through a delivery tree comprising at least a server tool 009 in communication with other electronic devices via at least one of: Internet 370; broadcast channels; media communication channel; entertainment channel; educational channel; network channel. The computer device 401 is further configured with software program 300 comprising at least computer instructions in communication with at least an application tool comprising a module 630 operatively configured for delivering broadcast channels via Internet Protocol Television edge routers 371, in communication with the multicast virtual private networks 178. Certain embodiments provide the virtual private network 178 operable for sharing and/or permitting at least a network client 450 to access a database 130 and 133 comprising structured media topics of information contained within at least one of: transportation media topics addresses, communication media topics address, educational media topic addresses, television media topics address, advertisement media topics addresses, and entertainment media topics address.

Some embodiments provide the communication apparatus comprising computer readable storage medium 440. The computer readable storage medium 440 further comprises computer instruction being further operable for sharing the same multicast state and multicast delivering tree through a centralized communication environment 370. The centralized communication environment further comprises the search engine 402 operable for centralizing at least one remote computer apparatus 401 through at least a cable and/or wireless connections. The communication apparatus 400 is further configured for providing at least a physical connection for at least a network infrastructure operable for managing at least one computer device at a remote location. Disclosed embodiments provide at least one interface module 170 operatively configured for network connectivity in communication with network infrastructures 20 and 21. At least one network connectivity further comprises communications with at least a remote computer apparatus 401, and the network infrastructure 20 and 21 further operable for disposing at least one of: network management, remote network operation, network client authentication, security, network communications, identifications, permissions and/or rights, and for locating at least a physical address of at least one remote computer within the networks 20, 21 and 178. Disclosed embodiments further provide the communication apparatus 400 is configured with interactive voice module. The communication apparatus further comprising at least a layer device 528.

The layer device 528 further comprising at least one of: a model Layer 532 comprising computer instructions operable in multicast virtual private network for providing structured network communications consisting of at least one of: transportation media topics of information, television media topics of information, communication media topics of information, education media topics of information, advertisement media topics of information, and entertainment media topics of information; an application layer 530 comprising computer instructions operable in at least a multicast domain tree for providing structured application services for at least one of: consisting of at least one of: transportation media topics of information, television media topics of information, communication media topics of information, advertisement media topics of information, education media topics of information, and entertainment media topics of information; a presentation layer 540 comprising private edge router operable for providing coding to structured data for at least one of: transportation media topics of information, television media topics of information, communication media topics of information, education media topics of information, advertisement media topics of information, and entertainment media topics of information; a session layer 550 comprising at least one module operatively configured with at least one interface module 170 operable for broadcasting/channeling at least a single communication signal for delivering structured data from at least one of: transportation media topics of information, television media topics of information, communication media topics of information, education media topics of information, advertisement media topics of information, and entertainment media topics of information, to at least an end client; a network layer 570 comprising at least a call signal transmission processing module operable for providing structured communications consisting of at least one of: transportation media topics of information, television media topics of information, communication media topics of information, education media topics of information, advertisement media topics of information, and entertainment media topics of information, via at least an Internet protocol 370; and a transport layer 560 comprising apparatus operable for providing structured topics of information for at least one of: transportation media documents, television media documents, entertainment media documents, communication media documents, advertisement media documents, educational media documents, and other media documents, for communication between at least a computer apparatus 401 and at least a gateway/default gateway 442. Certain embodiments provide the communication apparatus 400 further comprising apparatus for updating connectivity and/or for providing/receiving structured technical support. Further comprises flexible error coding.

In one or more embodiments, router 179 is configured for utilizing antenna 201 to communicate using one or more wireless transmission standards. For example, at least one of RF transceiver 724 in communication with router 179 which can be arranged to communicate using a wireless local area network transmission standard. Disclosed embodiments provide the router 179 operable for multiple-input, multiple output (MIMO) communications. In a MIMO type embodiment, the router 179 can utilize one of antenna 201 for MIMO type and/or smart antenna type communication, for example where RF transceiver 724 and RF transceiver 418 are arranged to operate in a MIMO type mode. In one particular embodiment, router 179 can be a MIMO Wireless Router. Certain embodiments provide the router 179 comprising at least one of: a spatial division multiple access (SDMA) system, smart antenna system, and/or a multiple input, multiple output (MIMO) system in communication with the network 20 and 21. The network 20 and 21 can include a public network such as a telephone network, the internet, and virtual private network. The processor 420 can operate to provide baseband and/or media access control (MAC) processing functions. The processor 420 further comprises at least one of: a single processor, a baseband processor, and an applications processor. The processor 420 can couple to dedicated processing memory 432 which can comprise volatile memory such as DRAM, non-volatile memory such as flash memory, including storage. Some portion or all of dedicated processing memory 432 can be included on the same integrated circuit as processor 420. Disclosed embodiments provide the dedicated processing memory 432 disposed on an integrated circuit and/or other medium, for example a hard disk drive that is external to the integrated circuit of processor 420. Disclosed embodiments provide a CMOS multiple antennas comprising a shorted end further comprises reactive loading portion of the antenna configured with means to lengthen the current path, thereby reducing the overall resonant. The antenna shorted end comprises nano wires consisting of a coaxial feed configured to receive electromagnetic waves and to transmit the energy through the nano wires for conversion into electrical energy. Certain embodiments provide the shorted end comprising a wireless communication framework for communication with networks and other remote electronic devices. The dedicated memory further comprises a memory bus comprising of bus architectures, including read-only memory (ROM), random access memory (RAM), basic input/output system (BIOS) memory, EPROM, and EEPROM.

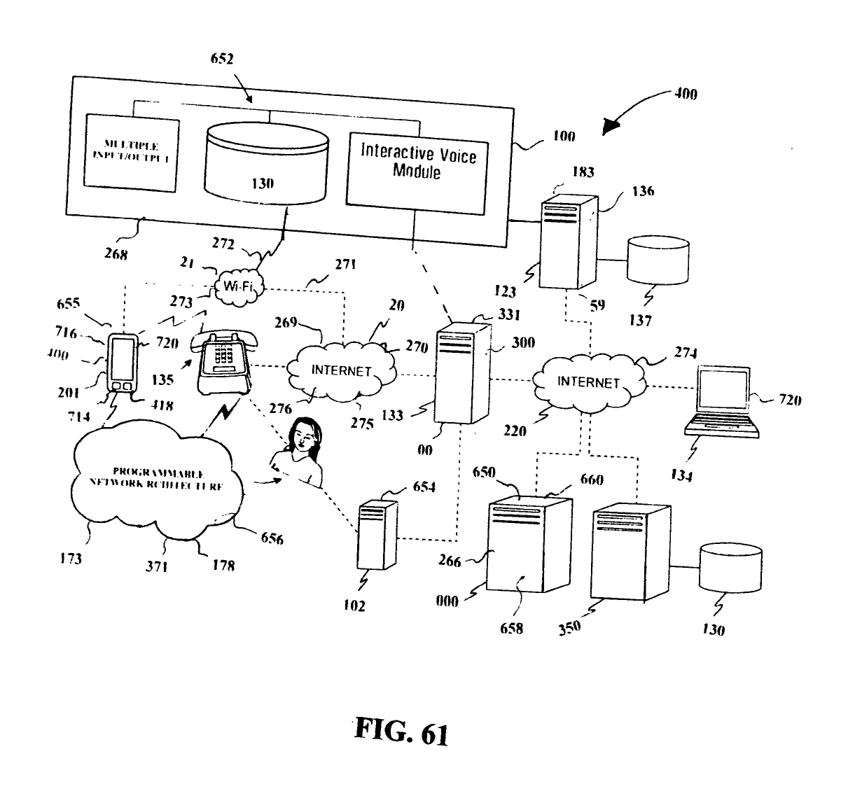

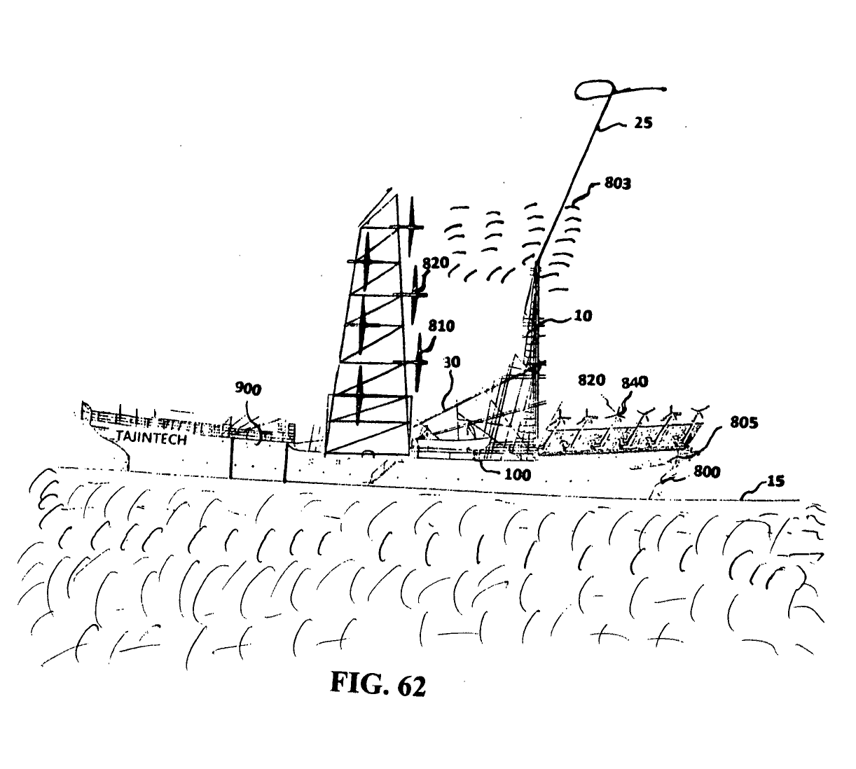

Referring to FIG. 61 is seen further exemplary embodiments of the communication apparatus 00 in communication with interactive voice module. The communication apparatus is seen operable in a network environment 20 and 21. Disclosed embodiments provide a neural network 220 configured with the data modeling tool 100 operable for deleting and/or updating at least a structured database 130 and 133, comprising at least one of: transportation media documents, television media documents, entertainment media documents, communication media documents, advertisement media documents, educational media documents, and other media documents. At least one data modeling tool is communicatively connected to at least an array 102 operable for Web browsing. At least one neural network 220 further configured with a decision engine 123 responsive to the topics of information. Disclosed embodiments provide the neural network 220 further configured with at least one cache engine 350, further responsive to at least a downloadable context 130, comprising at least one of: transportation media documents, television media documents, entertainment media documents, communication media documents, advertisement media documents, educational media documents, and other media documents. Certain embodiments provide the computer readable program 434 in communication with the neutral networks 220. The at least one computer readable program 434 further comprising at least software 300 operable with computer instructions programmed for at least one of: delivering broadcast channel through Internet Protocol Television edge routers 371, using multicast virtual private networks 178 for at least a broadcast channels, applying at least a multicast protocol label switching 173 to at least one virtual private networks 178, sharing the same multicast state and providing at least one broadcast channels in communication with each virtual private networks 178, training each neural network 220 for adjusting at least a correlation of at least one media topics as a function of at least an activity consisting of at least a topic and/or a product of content consisting of at least one of: transportation media documents, television media documents, entertainment media documents, communication media documents, advertisement media documents, educational media documents, and other media documents or topics of information. The communication apparatus further comprises wireless body area network. Disclosed embodiments provide the communication apparatus further comprises software defined radio modules consisting of at least one of: system-on-chip-integration; system-on-package-integration; analog-front-end-silicon-integration; and wireless sensor networks. Servers 00 and 000 are configured with at least a key to the database 130 and 133 to encode a particular location in a hierarchical grid comprising the media topics. The topics are distributed among the constituent database servers on the basis of the location regions of the database that each server manages. The database servers are partitioned for the media topics for communications among the constituent servers. Each server is configured to mange different media topics partitions for distribution efficiency. At least larger clusters 134 are broken down into smaller clusters 135 comprising smaller key groups of the media topics of information for logical representation of splitting process through binary tree 136. Disclosed embodiments further provide the servers 00 and 000 configured for receiving a topic request specifying a particular key group combination that determines if a query should be processed. Certain embodiments provide logical steps needed to respond to the query in case the server 00 and 000 determines that the key group combination is incorrect, or that the query should be communicated to an alternate server. The communication apparatus 400 is further disposed for detailing the steps a client is seeking to determine the appropriate server for a particular key group.

The communication apparatus is further configured for applying adaptive load distribution technique based on the representation of the media topics on a distributed hash table 137. The communication apparatus further comprises document management tool 183 comprising information processing apparatus communicatively connected to memory device 59 for storing digital broadcast content of the reference document for which a number of copies can be made, and include a writing device 650 for writing the content on external recording medium 652, in communication with an IC medium reader/writer 654 and 655 operable for reading an IC medium 656 and for recording the number of copies that can be made of the content on the IC medium in association with the document identifier 658. The communication apparatus is further configured for determining whether an identifier of the content is recorded on the IC medium 656 when the content is copied to the external recording medium 652 and, when it is determined that the identifier is recorded, the hash table 137 controls the writing device to write the content on the external recording medium and updates the number of copies that can be made of the content and a hash value is recorded in the memory 660. In the disclosed embodiments, key groups of the media topics are associated with a variable depth of topics of information based on virtual private network 178. The virtual private network 178 further directs identifiers 266 containing queried media topics 268 to a particular key group server comprising target servers 00 and 000. The servers 00 and 000 are distributive, operable to exchange local signaling messages to determine the particular topics of information that is being queried in relation to the media topics 268. The communication apparatus 400 is further operable on various networks 20, 21, and 178, including CDMA 269, TDMB 270, DIGITAL 271, ANALOG 272, GSM 273, local area network “LAN” 274, WPAN 275, and WLAN 276. Disclosed embodiments provide the chip 329 disposed with amplifier apparatus 331. Certain embodiments provide the chip 329 disposed with CMOS multiple antenna apparatus 201 and 418, operable on a logic circuit 407 for analyzing signal strength and for providing faster data transmission speed. Some embodiments provide the chip 329 comprising CMOS antennas 201 and 418 disposed with at least an opened end 716, and at least a shorted end 720. The opened end is further disposed with temperature sensor and/or electrode 716. The shorted end 720 is further configured with nano wires 714 for antenna network and for communication with energy platform 730. The platform further comprises silicon substrate microfiber/nano-fiber consisting coupled to CMOS antenna circuit 724. The CMOS circuit 724 comprises a logic gate consisting of p-type and n-type metal oxide semiconductor comprising field effect transistors operable on multiple state paths consisting of: 1. at least a path to the output from the voltage “pulled up;” 2. at least a path from the ground “pulled down.”

Referring to FIG. 62 is seen some exemplary embodiments of the apparatus comprising wind and hydropower vessel plant 10 operatively configured with turbines 810 and 840. The turbines 810 and 840 are operatively connected to a generator 820 configured to generate electrical energy. The electrical energy is a renewable and the vessel plant is a renewable energy plant configured to overcome several of the disadvantages of conventional wind and hydropower turbines. The renewable energy 130 is generated through ocean wind 803 and from the abundance of ocean energy. In certain embodiments of the disclosure, the renewable energy is generated through regenerative hydropower on a vessel 800. Other embodiments of the vessel include submersible apparatus and floatable apparatus. In some embodiments, the apparatus is a mobile device. In certain embodiments, the apparatus is a fixed device. Yet in other embodiments, the apparatus is transportable. Still in some embodiments, the apparatus is skid mounted. Yet, in certain embodiments, the apparatus is crane mounted. In other embodiments, the apparatus is vessel mounted. In some embodiments, further disclosure of the vessel configuration includes at least a crane. The vessel 800 may be positioned anywhere in vast ocean areas 15, where it does not obstruct shore views or endanger migratory birds or land based animals. The vessel 800 significantly takes advantage of higher average ocean wind speeds 803. The wind and hydropower vessel plant 10 further produces hydrogen 100 to be transported for later use. The generated electrical energy by the vessel plant 10 could be transported through transmission lines 25 or be offloaded to grids 30. The vessel plant 10 comprises electrical energy storage medium 805, including ultra-capacitor 900.

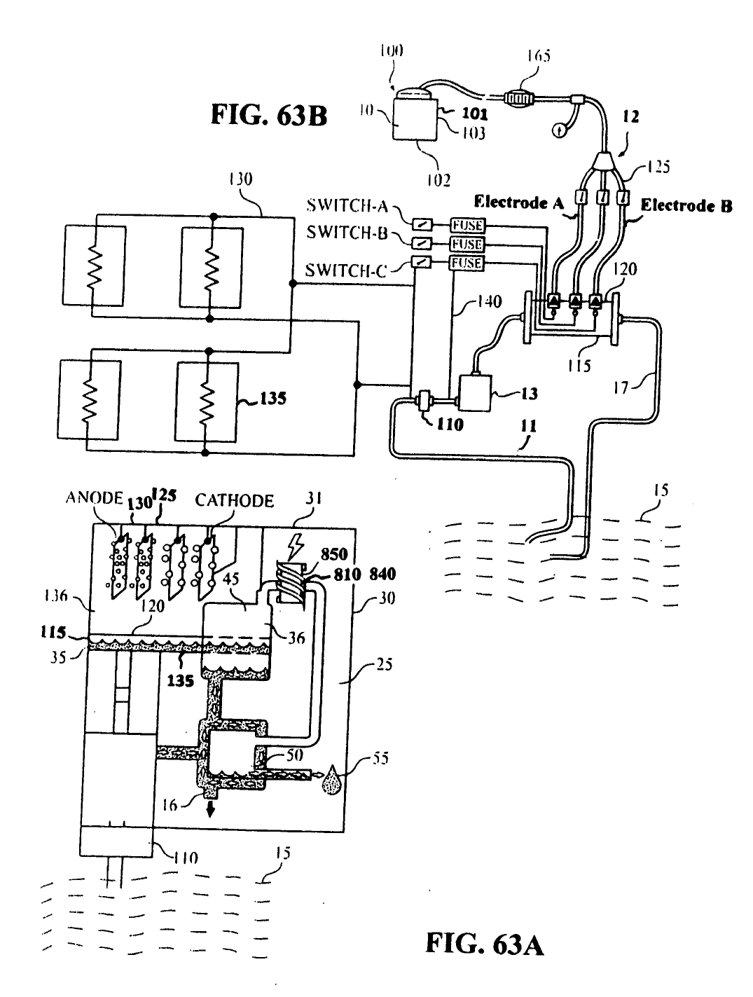

Referring to FIG. 63A is seen further exemplary embodiments of the vessel configured with further devices for producing hydrogen 100. Hydrogen does not naturally exist in its free state, so it must be separated out from other compounds in nature, such as seawater 15. In the disclosed embodiments, a pump 110 is provided to direct ocean water into a heat exchanger 115. The heat exchanger 115 “Evaporator” is operatively connected to a reaction chamber 120 operatively configured with control valves 125. The control valves 125 are responsive to flow rate of hydrogen 100 and oxygen 101. In some embodiments of the disclosure, the devices for producing hydrogen 100 comprise of electrolysis apparatus. In some embodiments, the apparatus is configured with electrical energy 130 to empower the heat exchanger 115. In this disclosure, the electrical energy 130 is the energy generated from the abundance of ocean energy and is a renewable energy.

In certain embodiments, the configuration for obtaining the required energy 130 comprises a circuitry 135. The circuit 135 is further configured for heating the seawater 15 to separate the hydrogen 100 from the oxygen 101. In certain embodiments of the disclosure, the apparatus is further configured for increasing the temperature of the seawater 15 to increase the rate at which the hydrogen would be produced. In the disclosed embodiments, the salt 16 contained in the seawater 15 is the electrolyte. In other embodiments, the salt 16 enhances the ability to conduct electricity. In some embodiments of the disclosure, a direct current 130 controlled from the renewable energy is applied between two electrodes (A and B) ‘Anode and Cathode’. In certain embodiments of the disclosure, the electrodes (A and B) are immersed in the solution 136 to enable hydrogen bubble through the steamed seawater. The hydrogen bubble is enabled from the negative electrode A (Anode). The positive electrode B (Cathode) contains the oxygen 101. Yet in other embodiments, evaporation chamber for the steamed seawater is disclosed. The evaporation chamber creates vapor 36, which turns turbine 810 and/or 840. The vapor 36 is piped to condenser chamber 50 where all the heat from the steamed seawater is rejected through further recycling of cold sea water.

Referring to FIG. 63B is seen some exemplary embodiments of the hydrogen production apparatus configured with the vessel plant 10. In some embodiments, the pump 110 is configured with a suction line 11. In certain embodiments, the hydrogen apparatus is further configured with transmitters 140 responsible for regulating the flow of energy 130 to the electrodes A and B for the reaction chamber 120. Hydrogen and oxygen wires 12 are disposed in the reaction chamber 120 responsive to hydrogen 100 and oxygen 101. The control valve 125 is operatively configured with the hydrogen and oxygen wires 12 for controlling the hydrogen 100 and oxygen 101 flow volumes. The flow volumes are read at the pressure gauge and directed to storage tanks 10 and 30. The vapor from the steam is piped to the condenser chamber 50. Some embodiments herein describe a device 50 wherein steam is rejected. The vapor from the steamed seawater is directed to the condenser chamber 50, where all the heat are rejected through further recycling of cold seawater 15. In some embodiments of the disclosure, the distillates are isolated and processed through at least a membrane 13 filtration.

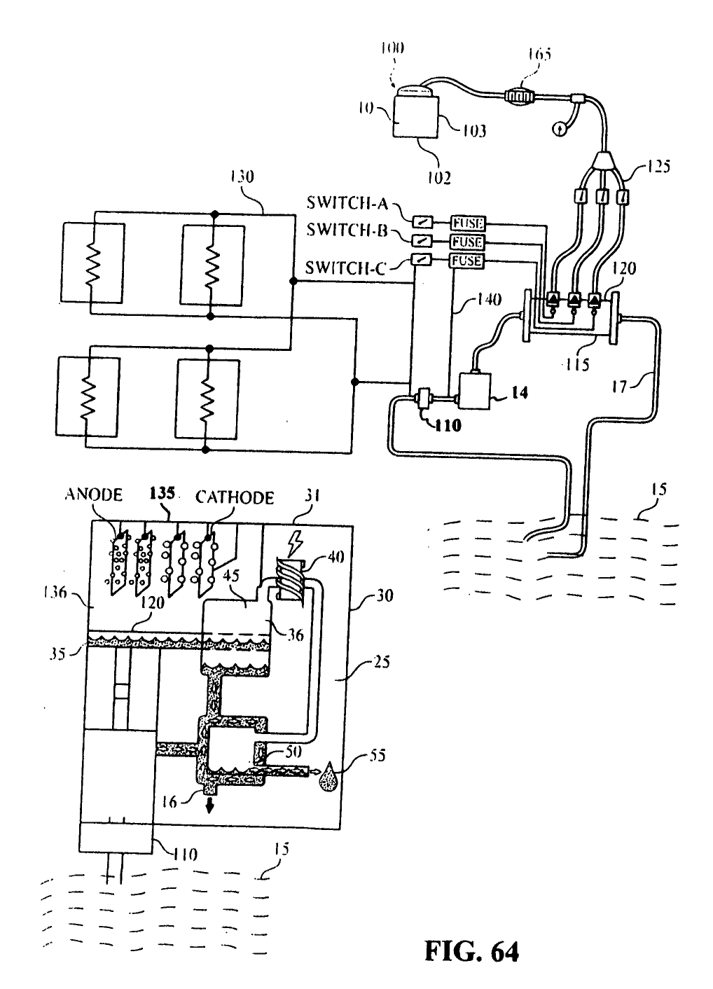

Referring to FIG. 64 are seen certain exemplary embodiments of the hydrogen production apparatus. The apparatus include, in some embodiments, a device for generating electrical energy from the variety of ocean energy sources. In some embodiments of the disclosure, the device further includes transmitter circuits communicatively connected to the generated electrical energy source. In certain embodiments of the disclosure, the transmitter circuit is a DC to AC power inverter. In some embodiments, transmitter circuit is a transmitter comprising of energy source operatively configured with the heat exchanger 115. The heat exchanger is configured for raising the temperature of the seawater to improve the rate of producing hydrogen gas 100. Some embodiments herein describe an apparatus for producing hydrogen gas 100 by immersing a magnesium/magnesium alloy anode electrode (Electrode A) and an aluminum/aluminum alloy cathode electrode (Electrode B) in water electrolyte chamber 120. The water in the electrolyte chamber 120 is seawater 15, which have been heated to raise the temperature. In some embodiments, the seawater temperature is raised by direct solar energy reflection on the surface of the seawater

The apparatus, in some embodiments, include switches (A, B, and C), which are activation switches. A switch is responsible for turning on the water pump 110, and a switch is responsible for turning on the reaction chamber 120. Some embodiments provide a system configuration for efficient electrolyte chamber reaction. The configuration further comprises a cell comprising a transmitter 140 for providing regulated flow of electrical energy 130 at the electrodes (A & B) for producing hydrogen 100 and oxygen 101. The transmitter 140 is further responsive to the polarity of the electrodes (A and B). The cathode is responsive to electrode reduction reaction and the anode is responsive to electrode oxidation reaction. The apparatus, in some embodiments, comprise of at least a process for producing methanol and other useful solutions.

The apparatus, in further embodiments, comprise the pump 110 configured with a suction line responsive to pulling seawater 15 into the heat exchanger 115 in which the seawater 15 is heated. The system include, in some embodiments, process of heating the seawater 15, separating salt 16 from it, and directing the steam 35 to an evaporation chamber 45. Some embodiments provide the evaporation chamber 45 in configuration with a supplemental turbine 40. In this embodiment, the heat exchanger 115 is operatively configured with the reaction chamber 120 and the evaporation chamber 45. The steam 35 from the chambers 115 and 120 is separated from salt 16, and the steamed vapor 36 is pressure driven to further turn the supplemental turbine 40, further generating electrical energy. Some embodiments herein describe a device for producing desalinated water and salt. The device, in some embodiments, comprises a supplemental turbine 40 operatively configured for generating electrical energy, thereby regaining more than the energy lost to thermal energy for the production of hydrogen 100, desalinated water 55, and salt 16. The system includes, in some embodiments, an apparatus for the wind and hydropower vessel plant 10 which produces 100 percent renewable energy that is cleaner, nonpolluting, reliable, viable, and available.

The supplemental turbine 40, in some embodiments, is vapor driven and would regain the energy lost to the heating process. The vapor 36 leaving the turbine is directed to the condenser chamber 50, where it is condensed and cooled by the cold pumped seawater 15, producing desalinated water 55. The desalinated water is produced from the condensation process. The vapor from the steam is piped to the condenser chamber 50 where all the heat from the steamed seawater is rejected through further recycling of cold seawater 15. Some embodiments provide isolation process where the distillates are then isolated and processed through a membrane 13 for filtration. The desalinated water from the filtration process could then be used and/or processed as drinking water. The temperature and electrical energy is very important in the hydrogen gas generation process. Higher temperature of the water 35 and higher electrical energy 130 for the electrolysis would produce higher hydrogen output 100. Additionally, a small 350 MW of energy producing vessel plant could produce about 420 million liters of drinking water a day. A large wind and hydropower vessel plant could produce more than 1000 MW of electrical energy a day.

The vessel plant 10 is an offshore platform for renewable energy, hydrogen, oxygen, methane, salt, and drinking water plant. If all the disclosed energy sources are utilized for converting ocean energy into electrical energy, the plant 10 would produce more electrical energy than a typical nuclear power plant. Some embodiments of the vessel plant include offshore nuclear energy plant. The construction of the vessel plant would offset its expenses from the energy that would be produced and the sale of hydrogen, desalinated water, salt and methane. The entire energy process is carbon free. The vessel would be connected to transmission lines 25, grids 30 through connections to other storage devices such as ultra-capacitors 900. The connections to transmission lines 25 and grids 30 are by cables 31. Further embodiments of the disclosure include the production of sea salt 16 offshore for transportation to other markets. The device, in some embodiments, produces hydrogen 100, which could be used to empower cars, airplanes, ships, and trucks. The only non polluting hydrogen generator to date is water, and the disclosure of the preferred embodiments teaches the best method to generate electrical energy, desalinated water, hydrogen, oxygen, methane, and salt without leaving any pollutant. The vapor 36 from the steam is piped to the condenser chamber 50, where all the heat from the steamed sea water is rejected through further recycling of the cold seawater.

In some embodiments, the distillate is isolated and processed through a membrane 13 for filtration. The membrane 13 is further configured with nano technology applications embedded in silicone substrate 14. In certain embodiments, the silicon substrate 14 further comprises nano sensors operatively configured for detections. Some embodiments herein describe a detection device, further include detecting any bacteria or contaminant and further comprise of bacteriological analysis to enable safe drinking water from more secured water production process.

In other embodiments of the disclosure, the electrical energy lost to thermal energy is regained when the vapor 36 turns the turbine 40, 810 and/or 840 to further produce supplemental electrical energy. The amount of electrical energy to be produced through the evaporation process depends on the volume of the evaporator and the amount of thermal energy generated. Cold sea water is used as heat sink in the condensation process to cool the vapor to produce desalinated water 55. Salt 16 is also produced in the disclosure of certain embodiments.

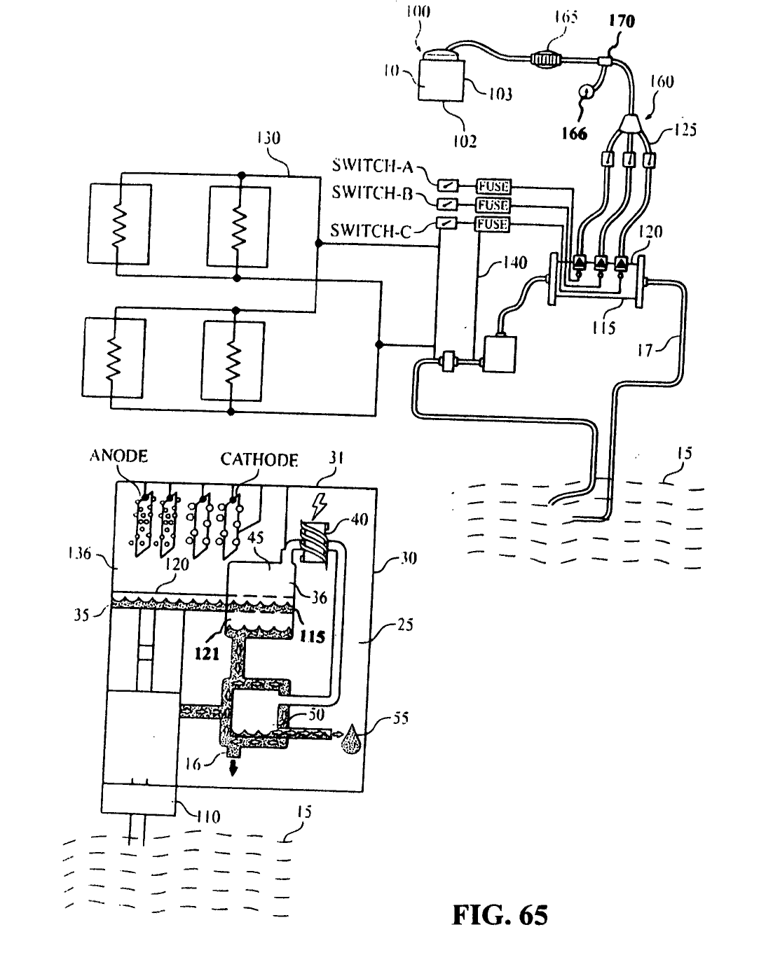

Referring to FIG. 65 is seen further exemplary embodiments of the disclosure for hydrogen gas production. The hydrogen gas 100 from the reaction chamber 120 is collected through pipes 160 and stored in hydrogen tank 102. The apparatus include, in some embodiments, a one way pressure valve 165 configured to prevent back pressure and to enable rapid repair downstream without losing any amount of hydrogen and/or oxygen from the tanks 102 and 103. In certain embodiments of the disclosure, the configuration of the hydrogen production system is responsive to DC over AC to enable better hydrogen/oxygen separation. Some embodiments provide the electrical energy to produce the hydrogen 100 from an apparatus responsive to the abundance of ocean energy sources. In certain embodiments, the electrical energy is to enable efficient hydrogen production in larger scale.

Seawater 15 already contains the necessary electrolyte substances to enable the production of hydrogen 100 at much larger scale. This could be achieved through the disclosure of certain aspects of the embodiments. The wind and hydropower vessel plant 10 further comprises an apparatus responsive to the abundance of sea energies. The apparatus include, in some embodiments, the hydrogen system configured with switch-A, configured for turning on the reactor chamber 120. A return line 17 is operatively configured with the reaction chamber 120. Switch-B is configured for activating the water pump 110. Switch-C is operatively configured for closing and opening the electrical shutoff valves 125 for the hydrogen tank 102 and or oxygen tank 103. The vessel plant 10 is further configured to supply fuel cell power plants with consumable hydrogen 100 for peak load periods. The hydrogen is also stored in tanks 102 for later use.

The hydrogen 100 may be used as transportation fuel or as a natural gas supplement when needed. Refining renewable energy through the wind and hydropower vessel plant 10 would provide future advantages over land-based units. The hydrogen 100 is separated from its molecular bond with oxygen by exposing the seawater 15 to the reaction chamber 120. The reaction chamber 120 is operatively configured with a water pump 110 responsible for pumping water from the ocean 15 into the chamber 120. The reaction chamber 120 is further configured with a heat exchanger 115 comprising heating the seawater to a predetermined temperature to enable efficient and effective hydrogen production. The electrical energy for empowering the heat exchanger 115 to enable thermal energy is from the renewable electrical energy generated by converting the ocean energy sources. The energy to empower the heat exchanger is renewable, reliable, available, viable and non pollutant. The apparatus, in some embodiments, converts the thermal energy back into renewable electrical energy.

The energy to the electrodes is DC and comprises a positive charge (Cathode) and a negative charge (Anode). A transmitter 140 is operatively configured with the reaction chamber 120 and comprises these charges. Hydrogen 100 is attracted to the negative charge (Anode) and oxygen is attracted to the positive charge (Cathode). The positive charge draws oxygen molecules, which may be vented through the return line 17 and/or stored in tank 103. In some embodiments, the hydrogen 100 attracts electrode and extent through welded pipes 160 to the hydrogen tank 102. A pressure gauge 166 is connected to the hydrogen tank 102. A pressure regulator 170 is configured with the pressure gauge 166 and communicatively connected to the tanks 102 and 103.

Some embodiments herein describe hydrogen processing system further configured with a secondary tank 121 operatively configured with the heat exchanger 115. The secondary tank 121 further comprising a pump 110 operatively configured with the system for generating and/or capturing energy. An evaporation chamber 45 is configured with the tank 121. Steam 35 from the thermal process is created through the heat exchanger 115 into the evaporation chamber 45. Vapor 36 from the steam 35 is elevated at the evaporation chamber 45, and directed to turn a turbine 40. In other embodiments, the turbine 40 is configured for generating electrical energy. The vapor 36 is piped to a condenser chamber 50 and condenses as cold seawater 15 is circulated. Pure water 55 “Desalinated water” is produced as a result. In the thermal process, salt 16 is separated from the seawater 15 and could be processed for commercial use. The produced hydrogen/oxygen 100 and 101 are stored in tanks 102 and 103.

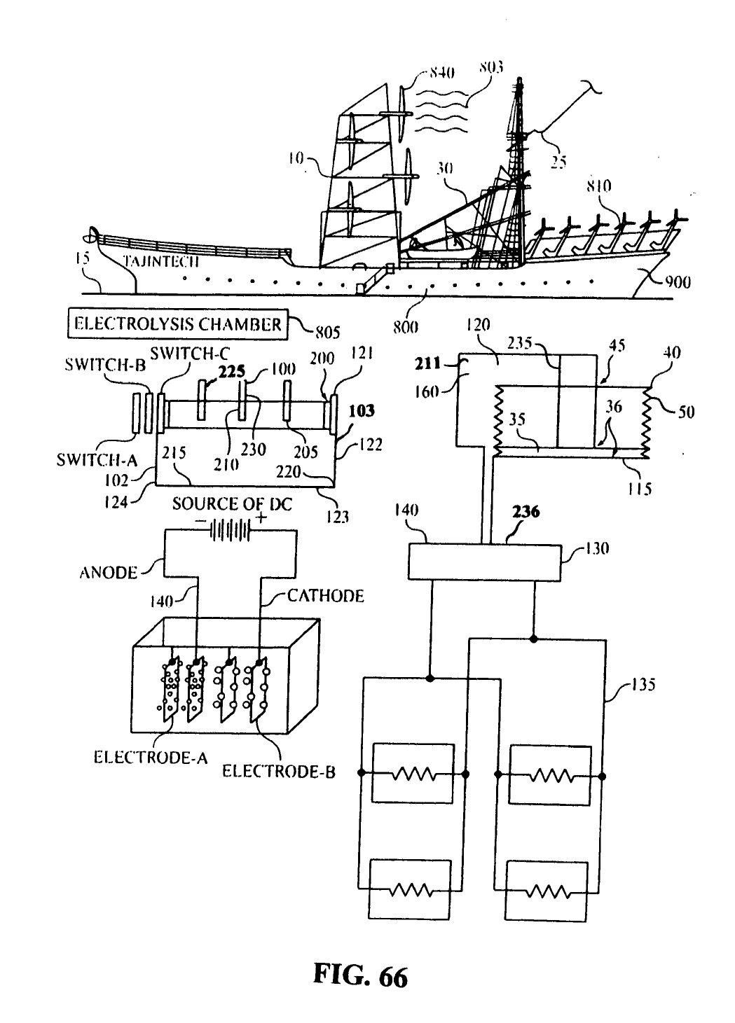

Referring to FIG. 66 is seen further exemplary embodiments of the vessel plant 10 comprising wind turbines 810 and 840. The vessel plant is positioned in the ocean 15 where ocean wind 803 exists. The force of the ocean wind 803 propels the turbine 810, 840, which then produces electrical energy. The electrical energy could be stored in a storage medium 900, or it could be transported to grids 30 or transmission lines 25. Further embodiments, the configuration of the vessel plant includes apparatus for producing hydrogen 100. The apparatus for producing hydrogen 100 further comprising seams 200 configured with dual shield 205 welded from both sides to enable efficient penetration with minimal porosity. Hydrogen resistance tubes 210 are operatively configured with the device, comprising plastics 211 disposed at the center of the larger steel pipes 160. The steel pipes 160 are operatively configured with plates 215 securely attached to the outer and inside tanks. These plates 215 have openings 220 that allow the hydrogen gas 100 to pass through the full length of the tank 102. The surfaces 121, 122, 123, 124 of the tank 102 are electro plated to protect against corrosion and also to protect the hydrogen. The electroplating may comprise at least one of: a copper base material, a nickel material, and a cadmium material.

The tank 102 further comprises couplings 225 communicatively connected to the hydrogen reaction chamber 120 for adding liquid to the tanks and for purging air prior to producing hydrogen 100 and oxygen 101. The tanks 102 and 103 comprise an inlet 230 through which hydrogen and oxygen are filled, and an outlet 235 through which the hydrogen and oxygen are drained. The tanks are communicatively connected to pressure monitors comprising a control system 236 which shuts the electrolysis system down when the tanks pressures reach predetermined threshold value. The control system 236 is further responsive to high speed switching circuit 140. The circuit 140 comprises at a transmitter operatively configured to modify the high amperage low voltage DC responsive to the electrolysis for maximum efficiency.

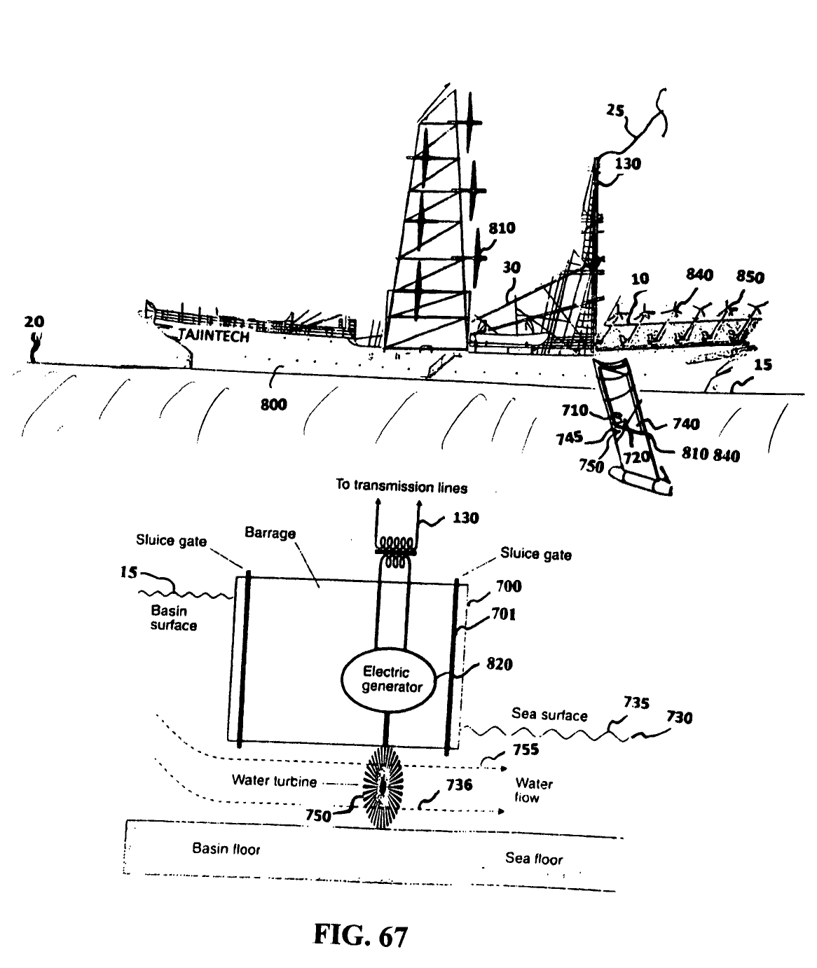

Referring to FIG. 67, is seen certain embodiments of the disclosure, including a vessel 800 comprising of a vessel plant 10 configured for converting ocean energy sources into electrical energy. In some embodiments, the energy generated by the vessel plant 10 could be offloaded and transported offshore 20. The energy could also be transported to electrical power grids 30 or to transmission lines 25. Current advantages include higher average wind speeds, wave energy not available to land based windmills, regenerative hydropower not available in conventional hydropower plants, and other ocean energy such as tidal power not also available on land-based energy plants.

In certain embodiments, the configuration of the vessel plant further includes apparatus for converting tidal energy into electrical energy. The tidal energy conversion through a vessel plant 10 is reliable, predictable, and non-polluting. The wind and hydropower vessel plant 10 is further configured with devices to harness ocean flow that reverses directions. The turbine 810, 840 further comprises a nacelle 850 responsive to the flow direction of the ocean wind to maximize efficiency and effectiveness. The wind and hydropower vessel plant 10 further comprises devices for converting ocean's variable energy sources into renewable electrical energy. These devices are configured to capture, convert, and store free ocean energies. The vessel plant 10 is disposed with wind turbine 810, 840 comprising wind operated devices for harvesting the natural available wind energy within the ocean and converting the abundant of energy into electrical energy 130. The vessel plant 10, in certain embodiments, further include the apparatus configured with a tank 700 comprising a sluice gate 701, a turbine 810 configured with a generator 820 for converting tidal energy into electrical energy 130.

A wing 740 configured with the vessel 800, comprising a horizontal or vertical hull 710. The hull 710 comprising a turbine 810 and 840 operatively configured with a generator 720 for converting ocean wave 730 into electrical energy 130. Some embodiments of the apparatus further include a wing 740 configured with a device for capturing hydrogen from underwater. The wing 740 is further rigged for capturing wave energy, and comprises tapered hull 745 configured with wheels/gears 750 responsive to kinetic energy.

The kinetic energy propels the wheels 750. The wheels 750 are responsive to converting the kinetic energy into mechanical energy. The mechanical energy is converted into electrical energy by the generator 720. The wings 740 could be driven by the entire weight of the vessel plant 10 as it rides through the waves 730. This disclosure further teaches regenerative hydropower. The wings 740 may be positioned very deep in seawater 15, responsive to static or laminar layer of the water. In further embodiments, the static and/or laminar layer of the seawater 15 is responsive to the differential between the wave surface 735 and the stable lower water 736. In certain embodiments, the floatation of the wheels 750 above and below the waves 730 enables the static layer to capture the potential energy differential. The wave energy is the friction between the air and the water surface. This friction causes ripples that grow into wavelets before turning into waves 730.

In other embodiments, the vessel plant 10 is further configured with a tank 700 comprising a sluice gate 701, a turbine 810 configured with a generator 820 for converting tidal energy into electrical energy 130. Yet, in some embodiments, the waves 730 are turned into swells 755, which contain the capacity to generate usable power. The power is dissipated when the swells reach the shore in the form of breakers 756. The turbine 810 and 840 are responsive to the swells 755 and are configured with generator 820 for converting the power of the ocean swells into electrical energy. In other embodiments of the disclosure, the apparatus comprises at least a hole which is operatively connected to the turbine.

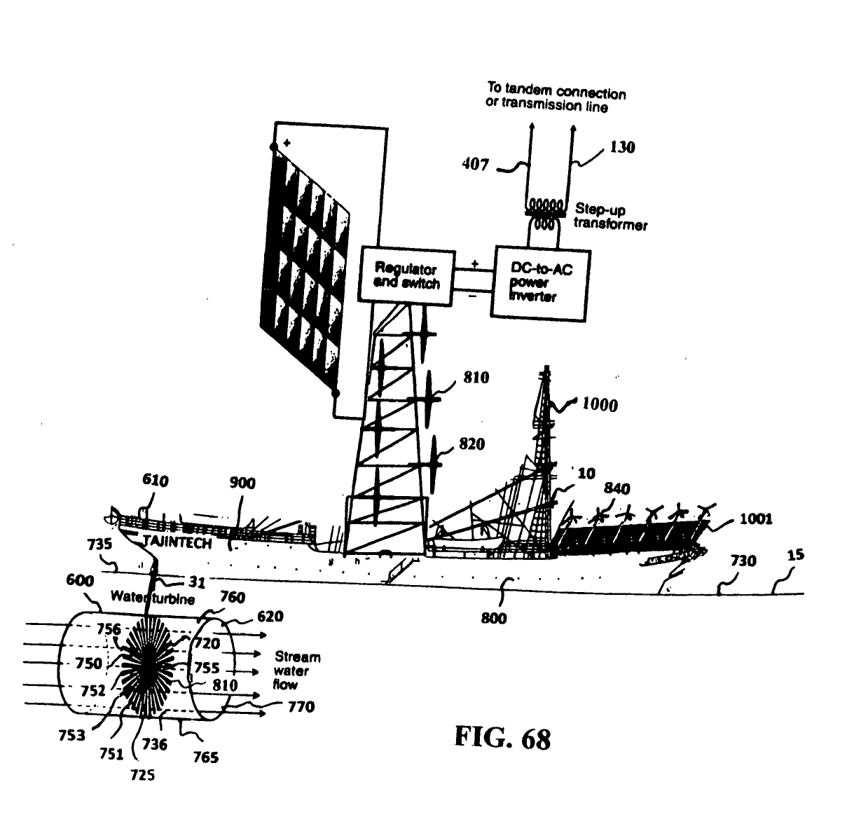

Referring to FIG. 68 is seen further exemplary embodiments of the wave energy conversion device configured with the vessel 800. The vessel 800 comprises a vessel plant 10 comprising wind energy turbine 810 and 840 responsive to the movement of the ocean wind. The vessel plant 10 is positioned on the ocean 15 consisting of surface waves 730. The vessel plant 10 is operatively configured to dispose a buoy 760 in the ocean 15. The buoy 760 is operatively configured with an actuator 765 responsive to up and down motion of the wave 730. The buoy 760 is further configured for generating electrical energy. The upstream and downstream motion 735 and 736 of the wave 730 drives the electric generator 720 that is responsible for generating renewable electrical energy 130. The wave energy 730 is captured and converted into electrical energy by turbine generator 720. The configuration of the turbine for capturing the wave energy may include fiberglass fins 770 comprising water wheels 750 driven by kinetic energy. The water wheels are configured for converting kinetic energy into mechanical energy. The wheels 750 are further angled responsive to maximum torque. The wheels 750 are operatively connected to rotatable shaft 755, which may comprise of a fiberglass. The collars 756 are responsive to the kinetic energy created due to the wave current 730. In some embodiments of this disclosure, the kinetic energy is converted into mechanical energy. In other embodiments of the disclosure, the mechanical energy is converted into rotational motion through the shaft 755 to the generator 720. The generator 720 then converts the mechanical energy to electrical energy. The generator 720 is environmentally sealed for protection against ocean water.

In other embodiment, the buoy 760 comprises a system for generating energy. The system is configured with a water tank 600 and a controller 610, which is communicatively connected to the vessel plant 10. The vessel plant 10 further comprises a storage medium 900 for storing electrical energy. The buoy 760 further comprises the turbine 810 and 840, which are submersible into the ocean 15. The turbine is operatively configured for generating electrical energy in response to transmission signal from the buoy. In certain embodiments of this disclosure, the buoy 760 is configured and operable where ocean current speed is desirable. In some embodiments of the disclosure, the buoy is operatively configured with the water turbine 810 and 840. The turbine 810, 840 is communicatively connected to a mooring 721, which is communicatively connected to the vessel 800. In other embodiments, the vessel 800 comprises the vessel plant 10 operatively configured with crane 1000. Still in certain embodiments of the disclosure, the vessel plant 10 further comprises a platform configured on a skid 1001. The buoy 760, in certain embodiments, is operatively connected to the mooring 721 and disposed into the ocean 15 through the crane 1000 configured with the vessel 800. A communication means 31 communicatively connects the buoy 760 to the vessel plant 10. The vessel 800 is responsible for disposing and retrieving the buoy 760 to and from the ocean 15. The design structure is such that the velocity of the ocean flow initiates rotation on the blade 751. The rotational torque is then transmitted to the generator 720. The generator 720 then converts the torque into an alternating electric power for transmission to the storage medium 900, grids 30, and/or transmission lines 25.

The controller 610 is operatively configured with the vessel plant 10 and responsive to the generated energy from the buoy 760. The generated energy is transportable and transferable to external storage mediums through the communication means 31. The communication means may be comprised of cables for transmissions and/or for offloading. The turbine 810, in some embodiments of the disclosure, is further configured with bodies that are operatively connected to a generator. These bodies further include the shaft 755, the gear 750, and/or the blade 751. The generator 720 comprises a winding 725, which is completely sealed to prevent the entry of water. The buoy 760 is further configured with the controller 610 and responsive to turbine operation. The turbine 810, in other embodiments of the disclosure, further comprises a bearing 752 operatively configured with a magnet 753. The magnet 753 is communicatively connected to the winding 725, which is operatively configured with the blade 751. The flow pressure of the ocean 15 rotates the blade 751 to enable rotation through the shaft 755 to the magnet 753. The rotation at the magnet is perpendicular to the ocean flow and is responsible for the electrical energy being generated.

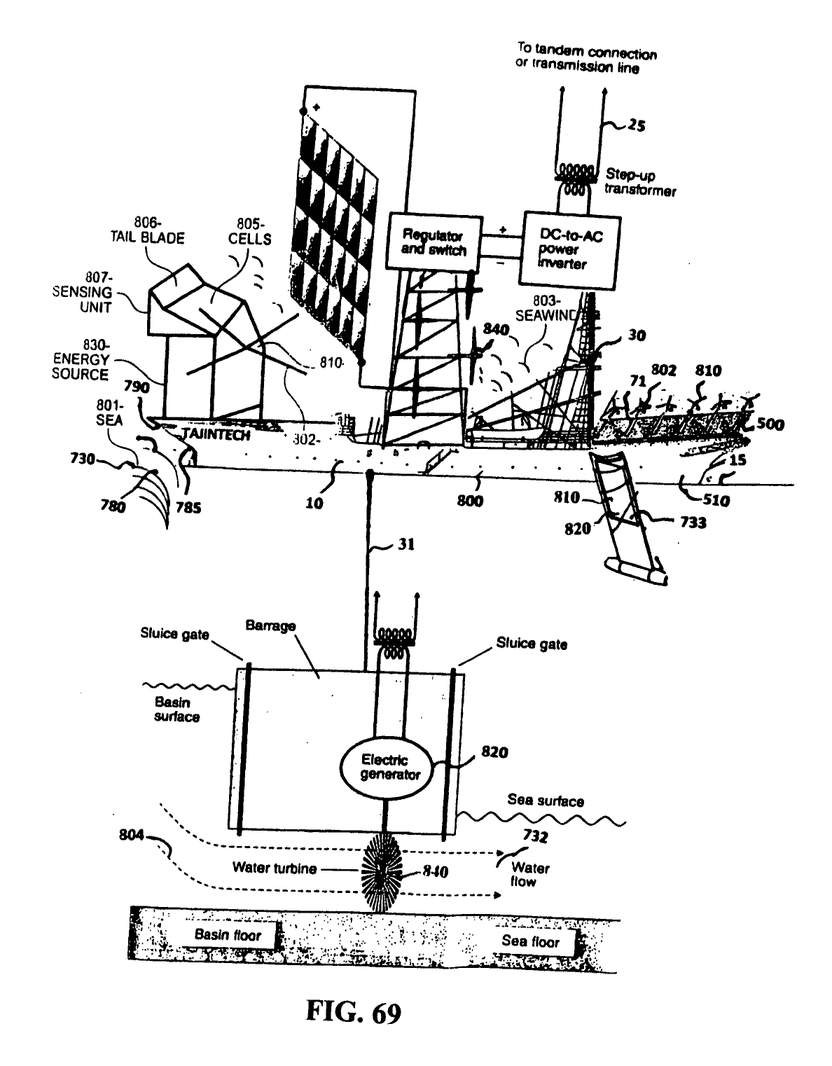

Referring to FIG. 69 is further seen an exemplary embodiments of the wind and hydropower vessel plant 10. The disclosed embodiment is related to a wind and hydropower vessel plant 10 for converting ocean energy into renewable electrical energy. The vessel 800 comprises wind and hydropower turbines 810 and 840 each configured for converting at least one of ocean wind, ocean current, ocean wave, and ocean tides into renewable electrical energy. The vessel 800 comprises wind tower 71 comprising turbine 810, 840 and generator 820. The 800 vessel is positioned at the ocean 801 comprising ocean current 804, ocean wave 730, tidal current 732, and wind 803. In some embodiments, a regenerative hydropower device 733 is configured with the vessel 800. Other embodiments include an apparatus for harnessing the abundance of energy from the ocean 801. The ocean 801 consist of natural energy such as ocean wind 803, ocean wave, ocean tidal energy, and ocean current 804. The vessel 800 is operatively configured with devices for converting the ocean wind 803, ocean current 804, tidal current 732, wave energy 730, and the energy from the regenerative hydropower 733 into renewable electrical energy. The turbine 810 and 840 is configured for converting kinetic energy into mechanical energy. The mechanical energy is then converted into electrical energy by the generator 820, producing renewable energy which is stored at the energy source 830. In certain embodiments of this disclosure, multiple sources of energy conversion are incorporated. In the later embodiment, the ocean wind 803, the ocean wave 730, the ocean tidal energy 732, the regenerative hydropower, and the ocean current 804 are converted into renewable electrical energy which is stored into the energy source 830 for transmissions.

The turbine is operatively configured with the electrical generator 820. The generator 820 is responsive to kinetic energy from the ocean flow, converting the kinetic energy into electrical energy. The apparatus further include, in some embodiments, converting the constant availability of the ocean energy sources into renewable electrical energy. The electrical energy generated from the flowing ocean is attractive and consistent, enabling efficient renewable energy source. The wind and hydropower vessel plant 10 is an advanced supplemental energy plant that could be readily deployed with all installations assembled to meet the maximum product demand similar to operating a conventional land-based electrical power plant and/or nuclear power plant. The renewable energy by the vessel plant is transportable and could be produced on demand. The hydropower 733 comprises a floatable wing 733 which is immersed in the sea. The apparatus, in some embodiments, comprises the wing 733 operatively configured with a generator armature. In certain embodiments, the generator armature comprises at least a linear generator operable in a linear reciprocating motion relative to the stator for generating electrical power. The hydropower 733 is configured with the vessel 800 further comprising apparatus for detecting the onset or occurrence of sea conditions non favorable to the operation of the generators. The detection apparatus, in certain embodiments, is operatively configured with a communication means 31 responsive to the floatation of the hydropower 733. The communication means 31 is operatively configured with the controller responsible for submerging the hydropower 733 sufficiently in the ocean to avoid any significant damage to the generator. The hydropower 733 further comprises hydroelectric power configured with turbine generator apparatus that could be lowered into and/or raised from their operating positions.

In some embodiments of this disclosure, the vessel 800 is further configured with at least a turbine and operatively connected to blades/gears in communication with the generator. In certain embodiments, the turbine comprises of at least a tail vane 806. In other embodiments, the tail vane 806 comprises of at least a sensing unit 807. Yet in certain embodiments, the turbine 810, 840 comprise of at least a propeller blade 802. Still in some embodiments, the tail vane 806 is configured with at least a cell 805. Yet in another embodiments, the turbine 810, 840 comprise of at least a wind tower 71 operatively configured with the tail vane 806 and the propeller blade 802. The propeller blade 802 is operatively configured to be powered by the ocean wind 803. The tail vane 806 is operatively configured to enable the propeller blade 802 to rotate due to the force of the ocean wind 803. The propeller blade 802 is operatively configured with rotors responsible for enabling rotation with the wind.

Kinetic energy is created along the blades movement. The kinetic energy is converted into mechanical energy by the turbine blade rotation 802. The mechanical energy is transferred through the turbine shaft to the generator 820 for conversion into electrical energy. The vessel plant 10 is further configured with devices for converting the flow of ocean current 804 into renewable electrical energy. In this disclosure, the energy is to be stored in storage medium such as energy source 830 and cells 805. The stored energy at the cells 805 is transferable to transmission lines 25 and/or grids 30.

The configuration of the vessel 800, in some embodiments, further relates to underwater structure designed to increase the velocity of the tidal currents 732 through the walls 790. The electrical output of the underwater turbines is maximized by the acceleration structure of the walls 790. The configuration of the walls 790 further relates to improving the efficiency of the regenerative hydropower 733. The wind and hydropower vessel plant 10 would produce more renewable energy to supplement the current capacity of conventional hydropower systems. Conventional hydropower systems are limited to the power that could be generated from the turbines. In addition, maintenance cost for conventional hydropower systems are expensive and requires personnel to plug-in their bodies into high risk areas.

The vessel 800 includes, in some embodiments, multiple turbines for different applications, such as wave energy, tidal current, hydropower, wind energy, and ocean current. The advantage of the wind and hydropower vessel plant 10 for generating renewable energy is that, the vessel 800 could operate in any area where the ocean current speed 804 is lower and/or much higher.

The vessel plant 10, in some embodiments, includes for generating renewable energy to further increase market applications. The availability exists through this disclosure to maximize the limitation of ocean energy sources for renewable energy applications. In some embodiments of the disclosure, the wind and hydropower vessel plant 10 is utilized as one instance for generating electrical energy from the abundance of ocean energies. In certain embodiments, the structure for accelerating the ocean energy is disclosed. The accelerating structure comprises at least a wall 790, whereby the speed of the ocean is increased upon contact with the vessel 800. In other embodiments, the increasing use of the regenerative hydropower 733 is maximized by the accelerating structure 790.

The configuration of the vessel structure includes further embodiments of this disclosure. In some embodiments, the force of the ocean current increases at the accelerating structure 790. In certain embodiments, the ocean current pressure increases through the walls 790. Hydropower is created as a result, whereby the kinetic energy is converted into mechanical energy. The mechanical energy is then converted into electrical energy by the generator 820. The vessel structure is designed to resist maximum loads due to the high currents, as well as the wave loads which resemble a storm. The material used for the vessel is suitable to withstand shock loads and is excellent for high current environment.

The regenerated hydropower 733, in some embodiments of the disclosure, includes apparatus for generating electrical energy from the high accelerated flow of the ocean current against the walls 790. The regenerative hydropower 733 may also be utilized by motioning the vessel 800 and enabling the drag force to propel the blade/wheel configuration with the turbine. The regenerative drag force creates rotational torque on the blade/wheel, which is converted into mechanical energy. The mechanical energy is then converted into renewable electrical energy.

The body of the vessel 800, in some embodiments, further comprises tidal current accelerating structure 785. The tidal current accelerating structure is disposed with the vessel to direct ocean current 730 and increase the speed of the flow. Higher pressure areas resulting from the obstructions to current flow caused by the structure forces the accelerating current to flow with higher velocity. Kinetic energy is concentrated on the high velocity area 780 and the tidal current is maximized and converted into electrical energy. The vessel body structure, in some embodiments, includes elements for accelerating tidal current. In certain embodiments, the vertical walls 500 of the vessel 800 are configured to increase the velocity of the incoming tidal current so that the tidal energy is also increased. The walls 500 are reinforced by structural members 510, which are designed to absorb the shock loads applied to the corresponding sections of the vessel 10. In some embodiments of this disclosure, the vessel body structure is utilized. The body structure is designed to further recharge the velocity of the tidal current and the wave energy of the ocean, creating a hydropower around the accelerated area. Kinetic energy is created as a result, and the kinetic energy is converted into mechanical energy through the turbine blade/wheel. The mechanical energy is then converted into renewable electrical energy by the generator.

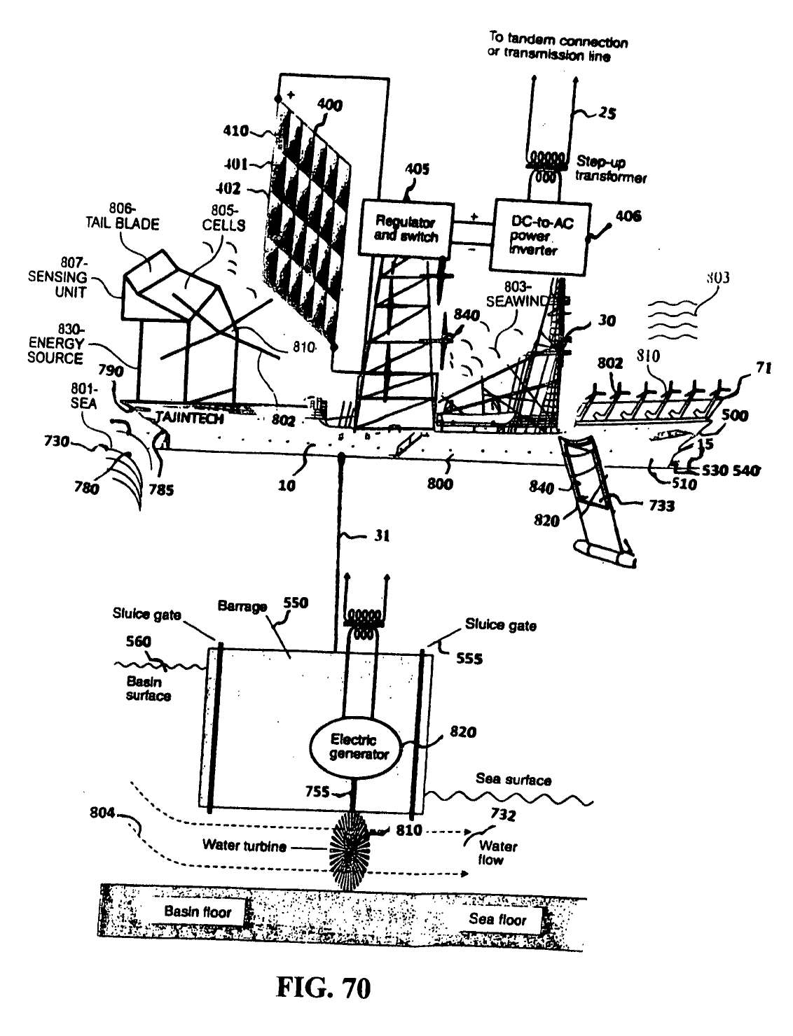

Referring to FIG. 70 is seen an exemplary embodiments of a vessel 800 operatively configured with the vessel plant 10. The vessel plant 10 comprises wind turbine 810 and 840 configured on towers 71. The wind turbines 810, 840 are configured with propeller blades 802, which are driven by the ocean wind 803. The tower 71 further comprises cells 805 operatively configured with tail blades 806 and communicatively connected to a sensing unit 807. The cells 805 comprises energy storage medium and the sensing unit 807 comprises a communication means. The cells 805 are operatively configured with energy source 830 comprising the energy generated from the abundance of ocean energy. In some embodiments, the energy to the energy source 830 further includes converted energy from tidal current 732, which are caused by the gravitational fields of the moon and the sun, in conjunction with the rotation of the earth on its axis. In certain embodiments, the vessel 800 comprises structures 500 consisting of structural members 510 responsive to ocean flow acceleration. The vessel plant 10 further comprises high velocity area 780 caused by the walls 790 of the structural members 510. The high velocity area is responsive to the structure 500 for accelerating the tidal current 785. The vessel plant 10 is disposed on seawater 801, which comprises the ocean 15. The wind and hydropower vessel plant 10 further comprises a controllable regenerative hydropower 733, operatively configured with apparatus for producing renewable electrical energy.

Other embodiments of this disclosure include apparatus for converting solar energy into electrical energy. In certain embodiments, a solar panel 400 is operatively configured with the apparatus for converting the sunlight into electrical energy. In some embodiments, the apparatus for converting the sunlight into electrical energy is comprised of at least silicon wafers 401 configured with at least a regulator switch 405 and operatively connected to a DC to AC converter 406 deployed with the vessel 10. The DC to AC converter 406 comprises an inverter configured for converting the voltage into alternating current. The converter 406 is communicatively connected to a transformer 407, which is a tandem connection to transmission lines 25.

In some embodiments, transmission line 25 and a grid source 30 are operatively connected to the converter 406. Yet in certain embodiments, the reflective rays from the sun's heat against the surface of the ocean are attracted by PV cells 402. In other embodiments, the PV cells 402 are communicatively connected to a module 410 configured with the solar panel 400 for producing electrical energy. Still in some embodiments, the ocean tides 732, which are caused by the gravitational fields of the moon and the sun, in conjunction with the rotation of the earth on its axis, are captured and converted into electrical energy through the wind and hydropower vessel plant 10. The tidal energy 804 is the energy that is contained in the moving ocean mass caused by tides. The tides create kinetic energy, and the turbine 810 is configured responsive to the kinetic energy caused by the tidal energy 804 for generating electrical energy. In the later teaching, mechanical energy is first created and the energy is transferred to the generator through the turbine shaft 755. Multiple turbines could be disposed at high and low accelerating current 530, 540 caused by the vessel structure 500, or positioned where the velocity is maximized.

Yet in other embodiments, a tidal barrage 550 is configured with the vessel 800, comprising a sluice gate 555. The sluice gate 555 is operatively configured to open and close, allowing water 15 to flow between bodies of water with different elevations. The flow pattern operates the turbine 810, which is operatively configured with a shaft 755. The shaft 755 is mechanically coupled to a generator 820. In some embodiments, when the tide 732 comes in, the basin 560 fills through a large channel for the tides 732 to reach its highest point. The sluice gate 555 closes during the fill up process. In certain embodiments, when the tide falls, the sluice gate 555 opens for water to flow through the turbine 810, creating a mechanical energy. The mechanical energy is transmitted to the generator 820 through the shaft 755. The generator 820 then converts the mechanical energy into electrical energy.

This tidal energy is the energy that is contained in the moving ocean mass caused by tides. The tides create kinetic energy and the turbine is responsive to the kinetic energy for generating electrical energy. The mechanical energy is first created and transferred to the generator through the turbine shaft 755. Multiple turbines could be disposed at high and low accelerating current 530, 540, or positioned where the velocity is maximized.

The apparatus as described, in some embodiments, comprises a platform. In some embodiments, the apparatus as described comprises platform array. In certain embodiments, the apparatus as described comprises a fixed platform array. In other embodiments, the apparatus as described comprises a mobile platform array. Still in some embodiments, the apparatus as described comprises a submersible platform array. Yet in other embodiment, the apparatus as described comprises a transportable platform array. In some embodiments, the apparatus as described is skid mounted. In some embodiments, the apparatus as described is crane mounted. Still in certain embodiments, the apparatus as described is mounted on a cargo vessel. In some embodiments, the apparatus as described is a mobile plant. In some embodiments, the apparatus as described is a fixed plant. In some embodiments, the apparatus as described is a transportable plant. Yet, the apparatus as described, in some embodiments, is a nuclear plant.

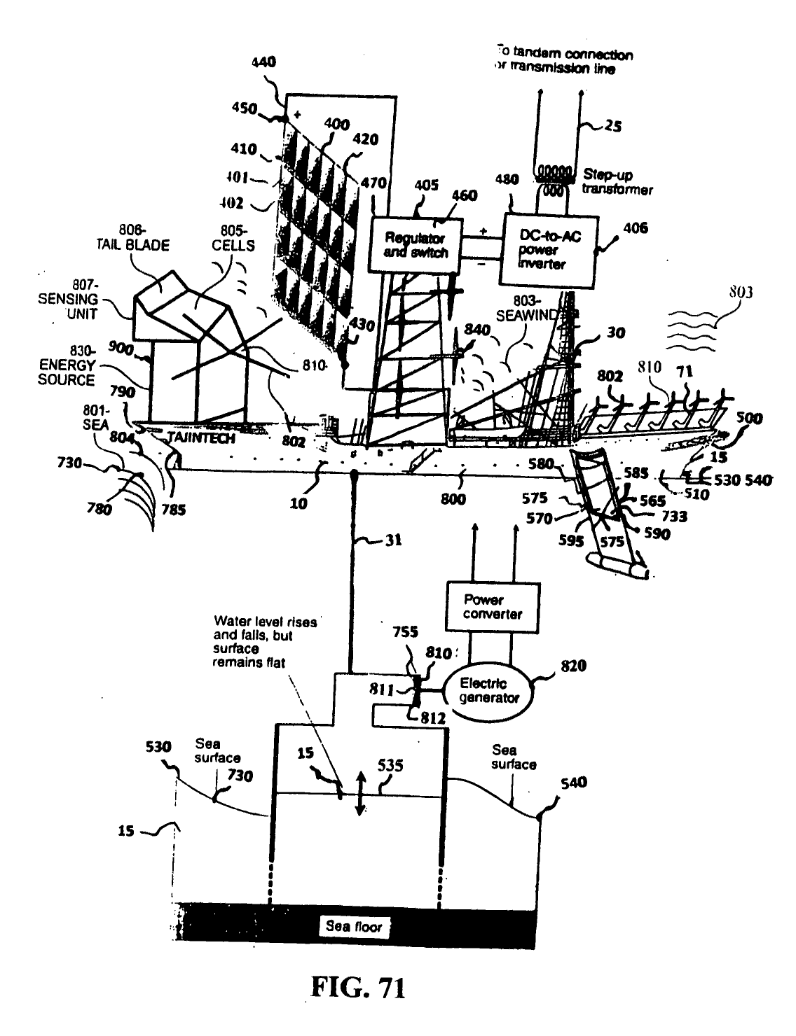

Referring to FIG. 71 is seen some exemplary embodiments of the disclosure. The teachings include the ocean 15 consisting of ocean wave 730 comprising sea surface high current area 530 and sea surface low current area 540. The seawater rises at the high current area 530 and falls at the low current area 540 leaving a flat surface 535. A turbine 810 is configured with a generator 820 for converting the wave energy into electrical energy. The abundance of energy exists in the ocean, including tide like current which could also be produced by offshore storm system. Renewable electrical energy is produced with the vessel plant where large scale persistent ocean current exist. This ocean current travels more slowly than the atmospheric wind, but because the water is denser than the air, much greater force is produced.

In some embodiments, turbine 810, 840 are placed side by side in a sequence that would result in increased energy conversion. In certain embodiments, the vessel structure 510 is responsive to tidal current frequency, turbulence and flow separation. Further application of the vessel structure 510 would increase the efficiency of the renewable energy production. In some embodiments of this disclosure, the wind and hydropower vessel plant 10 is utilized, but ocean energy sources and/or solar energy are the sole energy sources used for generating renewable electrical energy. The apparatus for harnessing these energies further comprise hydrokinetic devices 810, 840 to increase the potential to capture energy from the ocean tides 732, the ocean waves 730, the ocean wind 803, and ocean current 804. The apparatus includes, in some embodiments, further utilization of the wind and hydropower vessel plant to avail a reliable approach to the abundance of ocean energy and reduce U.S dependence on foreign oil. The energy generated from the ocean through the wind and hydropower vessel plant 10 is renewable and causes no environmental pollution.

Some embodiments herein describe an apparatus comprising wind and hydropower vessel plant 10 operatively configured to minimize the potential environmental and navigational impacts found in conventional wind and hydropower systems. In some embodiments of this disclosure, the apparatus comprises wind and hydropower vessel plant 10 configured with unique potential to produce renewable energy, transportable energy, and to produce energy on demand.

Further design configuration include, in some embodiments, the wind turbine 810, 840 on the vessel 800 is configured to convert the kinetic energy of the wind into mechanical energy. The mechanical energy is transferred to a generator 820 by a shaft 755. The generator 820 is operatively configured to convert the mechanical energy into electrical energy which is distributed through transmission lines 25 or to grids 30. In certain embodiments, the vessel plant is skid mounted. In some embodiments, the vessel plant is submersible. In other embodiments, the vessel plant is fixed. Yet in other embodiments, the vessel plant is mobile. Still in other embodiments, the vessel plant is transportable. The vessel plant is configured with turbine 810, 840 to generate electricity for electrical grids 30, transmission lines 25, or for states that are undergoing environmental emergencies. In certain embodiments, the turbines comprise of vertical and/or horizontal axis design for downwind and upwind applications. In some embodiments of this disclosure, the wind and hydropower plant on a vessel 800 produces renewable electrical energy, hydrogen, oxygen, methane, drinking water, and salt.

In some embodiments, the turbine further comprises impulse turbine responsive to deep sea applications were the velocity of the water is much higher. The walls 790 of the vessel include runners, enabling the water to flow with acceleration after initial contacts. In other embodiments of the vessel plant 10, a submersible wing 733 is operatively configured with the vessel 800. The submersible wing 733 comprises a turbine 565 operatively configured with blades/gears 570 that are connected to shaft 575 responsive to ocean kinetic energy. The kinetic energy enables the blades/gears 570 to rotate, creating mechanical energy. The mechanical energy is transferred through the shaft 575 to generator 580. The generator 580 is responsible for converting the mechanical energy into electrical energy. The generated electrical energy is then stored in storage medium 805, 830, and 900. Some embodiments provide transmission of the electrical energy to grids 30 or to transmission lines 25.

In some embodiments, the wing 733 is retractable and submersion is only necessary for regenerative hydropower applications. Still in other embodiments, the vessel 800 is engaged in motion, initiating a relative flow force of the ocean 15 acting relative to the line of motion of the vessel 800. In certain embodiments, the relative flow force comprises drag force acting upon the blades/gears 570, whereby mechanical energy is created and transferred to the generator 580 through the shaft 575. The generator 580 is configured to convert the mechanical energy into electrical energy for storage and/or for transmission. In other embodiments, the wing configuration further includes a tapered hull 590 comprising an entrance 585 and an exit 595. Pressure or head is created at the hull 590 due the changes in the water relative to the water level outside of the hull 590. The turbine blade/gear 575 is disposed in the hull 590 and securely fastened on the shaft 575. The shaft 575 is operatively connected to the generator 580. In other embodiments, velocity of the ocean flows through the hull 590, creating rotation upon the blade/gear 570. The rotation is then transferred to the generator 580 as mechanical energy. The generator 580 then converts the mechanical energy into renewable electrical energy.

The impulse turbine, in some embodiments, includes deep sea applications. The entrance 585 at the hull 590 allows the ocean 15 to flow through the blade/gear 570 creating a rotational movement, and exiting out through the outlet 595. Yet in other embodiment of this disclosure, the turbine comprises of a reaction turbine whereby hydropower is developed from the ocean pressure and movement. The application of reaction turbines is necessary in areas of lower heads and higher ocean flow. Sill in some embodiments, the turbine comprises of kinetic turbine. The kinetic turbine is configured to generate electrical energy from kinetic energy of the ocean instead of the head energy.

The wind and hydropower vessel plant 10 include, in some embodiments, solar panels 400 comprising PV cells 402 to convert solar energy into electrical energy. The solar panels 400 are configured for converting sunlight into electrical energy. The solar panels 400, in certain embodiments, comprises at least silicon wafers 401 configured with at least a regulator switch 405 operatively connected to a DC to AC converter 406 deployed with the vessel 10. In some embodiments, the DC to AC converter further comprises an inverter operatively connected to a transformer. The DC to AC converter 406, in other embodiments, further comprises a transformer configured for converting the voltage into alternating current. A transmission line 25 and a grid source 30 are operatively connected to the converter 406. Still in some embodiments, the reflective rays from the sun's heat against the surface of the ocean are attracted by the PV cells 402. The PV cells 402, in certain embodiments, are configured with the solar panel 400 for producing renewable electrical energy. In other embodiments, the PV cells 402 are connected to modules 410 comprising panels 420 and arrays 430.

In some embodiments, the PV cells 402 are disposed on turn-able mounts 440 comprising swivel joints 450. In certain embodiments, a controller 460 is operatively configured with the PV cells 402 and PV mounts 440. The controller 460, in some embodiments, turns the mounts 440 responsive to the direction of the sun. The controller 460 includes, in some embodiments, a computerized mechanical system 470 operatively connected to the swivel joints 450 and/or a bearing. The PV cells 402 are operatively configured with inverters/transformers 480 that are disposed with the vessel plant 10. The inverters/transformers 480, in some embodiments, are configured to be connected to electricity grids 30 or transmission lines 25 for power distributions. Still some embodiments of this disclosure, the vessel plant further comprise a device for converting ocean wave, ocean current, and ocean tide into renewable electrical energy. In the later teaching, the turbine 810 rotates as air 811 is pumped in and out of a hole 812. The resulting mechanical torque due to the force of the air 811 drives the electric generator, which is configured to convert the mechanical torque into electrical energy. The air is created as the wave 730 falls from high elevation 530 to low elevation 540.

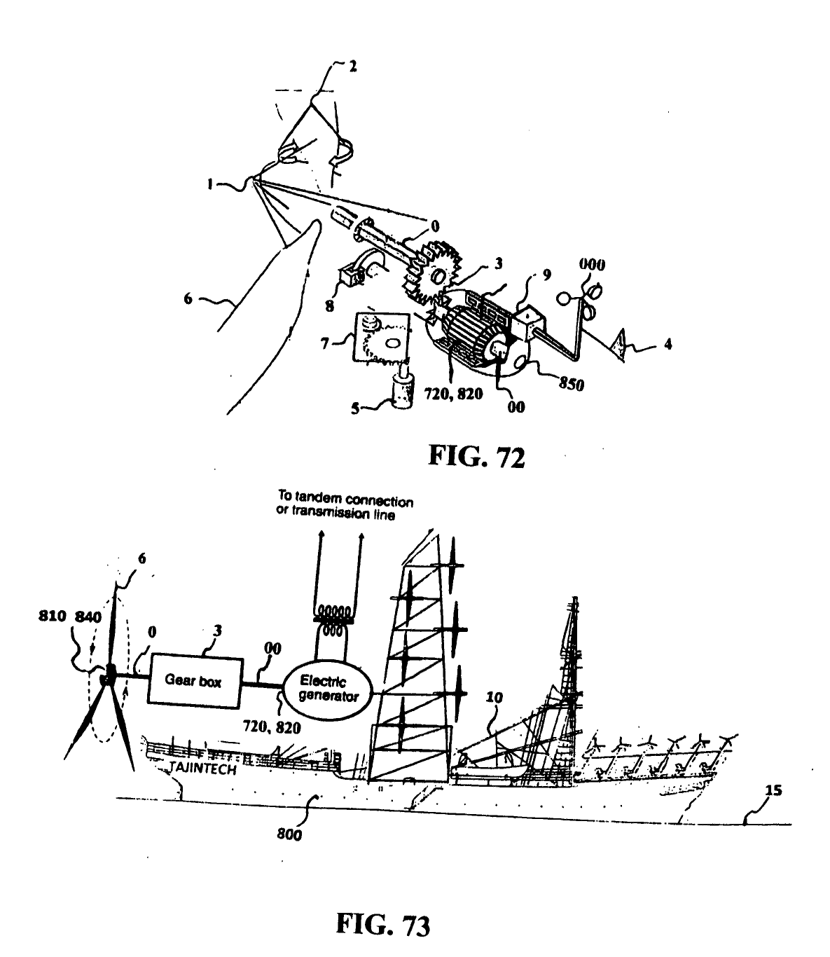

Referring to FIG. 72 is seen further exemplary embodiment of a turbine configuration. In some embodiments of the disclosure, the wind and hydropower vessel plant 10 is configured for producing renewable energy. The vessel plant 10 include, in certain embodiments, standard turbine design configuration, comprising an anemometer 000 responsive to wind speed. A high speed shaft 00 operatively configured with a generator 720, 820. The generator 720, 820 is responsible for generating electrical energy. Some embodiments of the disclosure include a rotor 1 comprising at least a blade 6 and/or a hub operatively configured with a pitch 2. The pitch 2 is responsive to the wind and responsible for the speed of the rotor 1. A low speed shaft 0 is operatively configured with the rotor 1.

The low speed shaft 0, in some embodiments, is responsive to the rotor's operation. A gear box 3 is communicatively connected to the generator 720, 820 through the low speed shaft 0. In certain embodiments, the generator 720, 820 is configured with the high speed shaft 00. A controller 9 is responsible for the operation of the turbine. Still, some embodiments of this disclosure further include the controller 9 responsive to the wind speed. The controller 9 is operatively configured to operate the turbine at a prescribed wind speed value. A nacelle 850, in certain embodiments, is operatively configured with the turbine 810, 840. The nacelle 850, in some embodiments, is further disposed with a tower and comprises the gear box 3, the low speed shaft 0, the high speed shaft 00, the brake 8, the controller 9, and the generator 720, 820. Some embodiments herein further describe a yaw drive 7 operatively configured with the rotor 1. The rotor is further connected to the brake 8, which may be operated either through a hydraulic, mechanical, or electrical means. The yaw drive 7 is responsible for directing the rotor 1 towards the direction of the wind. In some embodiments, the yaw drive 7 is communicatively connected to a wind vane 4 responsible for measuring wind direction and for turning the turbine with respect to the wind. The yaw drive 7 is responsive to the operation of a yaw motor 5.

Since no fuel-oil is used in the disclosed embodiments, the application of these embodiments would reduce greenhouse gases caused by the use of fuel, diesel, or other types of fuel. Some embodiments provide wind and hydropower vessel plant, which configured for producing electrical energy without producing any nitrogen, carbon dioxide, and water vapor as seen in other types of power plants. The wind and hydropower vessel plant 10 is relatively easy to operate and maintain. The vessel 800 would be utilized by States with natural emergencies because the energy is transportable and could be produced on demand. Yet, another benefit includes reducing U.S. dependence on fossil fuels and foreign oil. Oil use in vehicles is a non-renewable resource and burning fossil fuels would further generate greenhouse gas emission and other pollutants.

In some embodiments, the wind and hydropower vessel plant would:
Reduce greenhouse gas “GHG” emissions.
Improve worldwide air quality and reduce petroleum consumption by more than 8 million barrels per day.
Reduce global warming and other emissions through wide-scale applications of the embodiments over time.
Reduce the need for research and development dollars associated with building dams.
Reduce U.S. dependence on imported oil.
Reduce smog caused by emissions of nitrogen oxides and carbon monoxide emissions.
Contributes significantly to the national effort to reduce greenhouse gas emissions.

Referring to FIG. 73 is seen further exemplary embodiments of the turbine. In other embodiments, the turbine comprises a gear box 3. In certain embodiments, the gear box 3 comprises wind and hydropower vessel plant 10 configured with turbine 810, 840. In some embodiments, the turbine 810, 840 comprise the gear box 3 which is disposed for vertical or horizontal rotation with the vessel 800. Some embodiments of the vessel 800 includes the vessel plant 10 positioned disposed on the ocean 15. In some embodiments of the disclosure, the vessel plant 10 further comprises an island. In other embodiments, the island is configured with strategic submersible gearboxes that are configured with sluice gates that are opened to allow wave and water to flow through. The speed of the gears in the gearbox 3, in some embodiments, is responsive to at least one of: the force of the wind, the ocean current, the tidal energy, or the flow force of the ocean wave.

Yet, some embodiments further include the low speed shaft 0 configured with the rotor 1, which comprises of the blade 6. The blade 6 is operatively connected to the gearbox 3. Still, in some embodiments, the low rotational speed of the shaft 0 is translated into high rotational speed through the configuration of the gear box 3. The high rotational speed is communicated to the generator 720, 820 through the high speed shaft 00. Some embodiments include the turbine configured for regenerative hydropower. In this disclosure, where the ocean current is low or the flow force of the wave is low, engaging the vessel 800 in motion would generate a drag force which would act upon the blade. In some embodiments, the vessel is propelled by at least one of: an electrical motor, electrical/internal combustion engine, an internal combustion engine.

In certain embodiments, the hydropower is regenerated when the vessel engages in motion. Still in other embodiment, the vessel is configured with turbines. Yet, in some embodiments, each of the turbines is configured for specific operations, including operations in the ocean 15 and/or out of the ocean. Additionally, low current or wind force is compensated by the movement of the vessel. In certain embodiments, the vessel plant 10 attracts the force of the wind and the force of the seawater. In other embodiments, the attractions are responsive to the energy contained within the wind and/or the ocean for producing of at least one of: electrical energy, hydrogen, desalinated water, oxygen, methane, and salt.

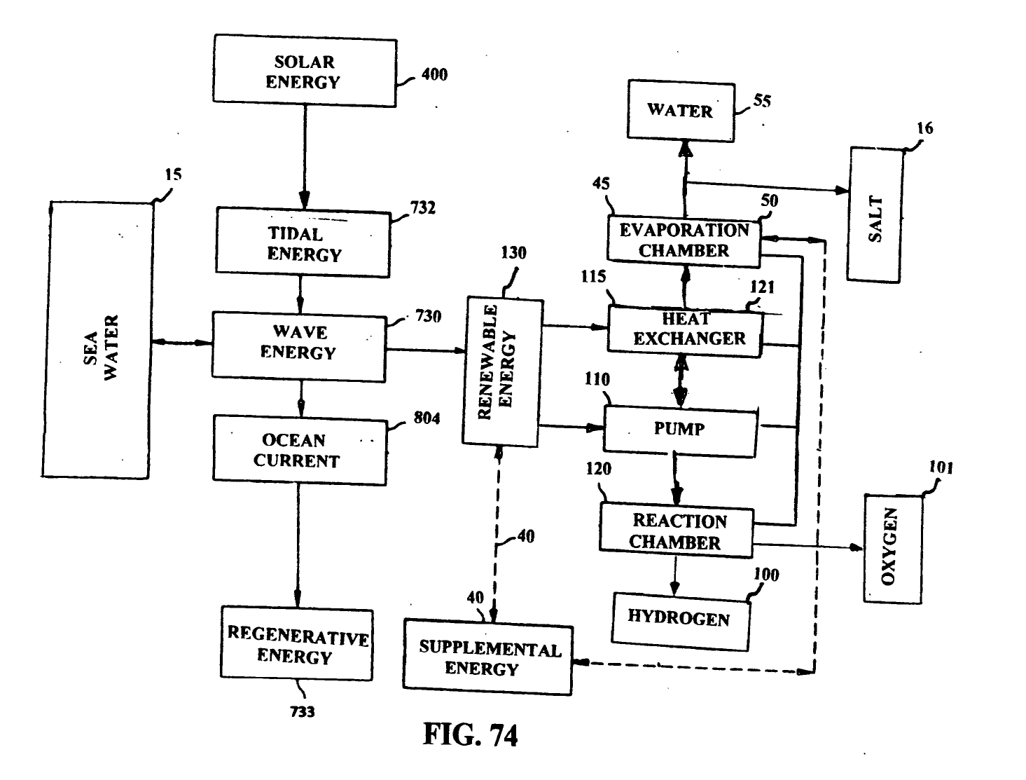

Referring to FIG. 74 is seen an exemplary embodiments of the disclosure of the platform configuration for harvesting the abundance of ocean energies. In certain embodiments, the platform is disposed on the ocean 15 for harvesting solar energy 400, tidal energy 732, wave energy 730, and ocean energy 730. In some embodiments, these energies are converted into renewable energy 130. Some embodiments of the disclosure further include regenerative energy apparatus 733. In other embodiments, the renewable energy 130 is configured to empower a heat exchanger 115 and a suction pump 110. The suction pump 110 and the heat exchanger are operatively configured with the evaporation chamber 45 and the reaction chamber 120. A condenser chamber 50 is configured with the evaporation chamber. The evaporation chamber is further configured for generating vapor to empower a turbine for generating supplemental energy 40. The vapor is condensed at the condenser chamber and desalinated water 55 and salt 16 are produced. The reaction chamber 120, in some embodiments, is configured for producing hydrogen 100 and oxygen 101.

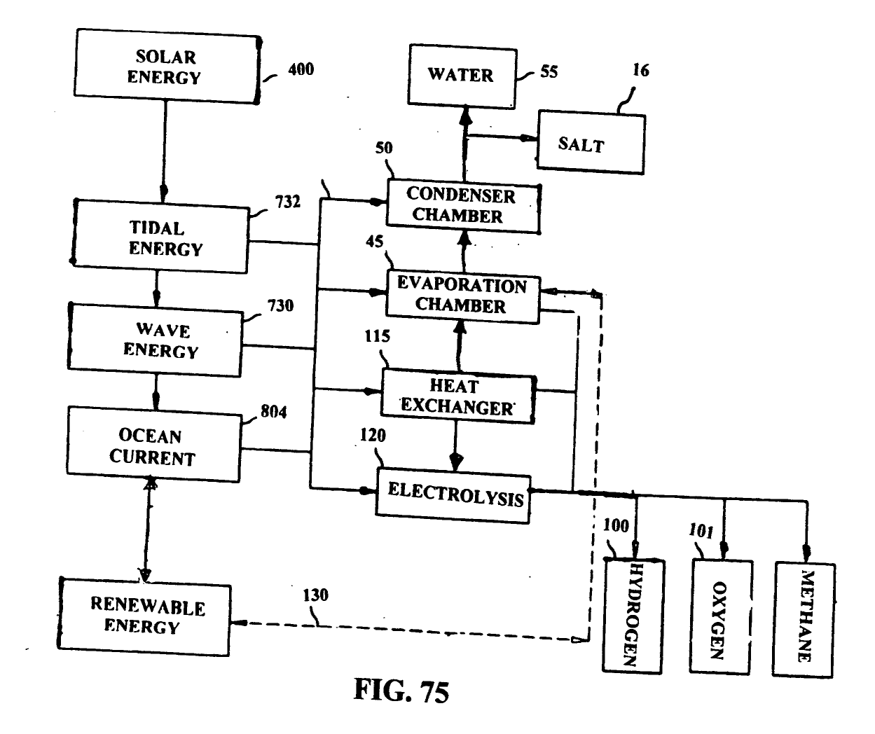

Referring to FIG. 75 is seen further exemplary embodiments of the disclosure of the platform configuration for harvesting the abundance of ocean energies. In certain embodiments, the platform is disposed on the ocean 15 for harvesting solar energy 400, tidal energy 732, wave energy 730, and ocean energy 730. In some embodiments, these energies are converted into renewable energy 130. Some embodiments of the disclosure further include regenerative energy apparatus 733. In other embodiments, the renewable energy 130 is configured to empower a heat exchanger 115 and a suction pump 110. The suction pump 110 and the heat exchanger are operatively configured with the evaporation chamber 45 and the reaction chamber 120. The reaction chamber further comprises electrolysis. A condenser chamber 50 is configured with the evaporation chamber. The evaporation chamber is further configured for generating vapor to empower a turbine for generating supplemental energy 40. The vapor is condensed at the condenser chamber and desalinated water 55 and salt 16 are produced. The reaction chamber 120, in some embodiments, is configured for producing hydrogen 100, oxygen 101, and methane.

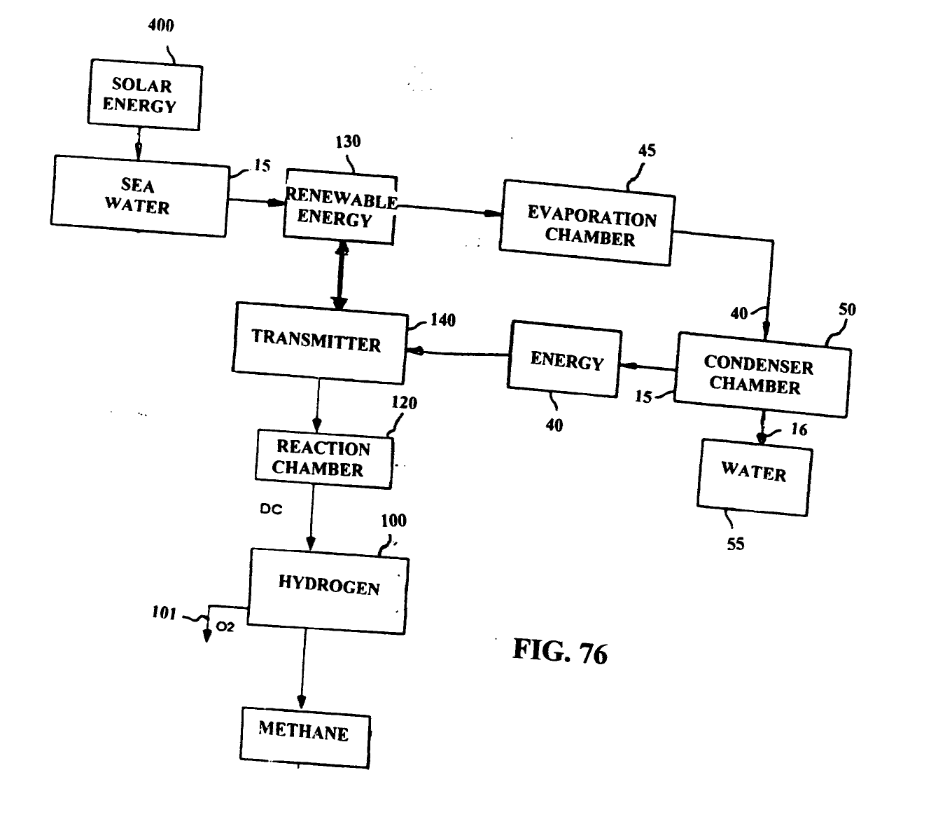

Referring to FIG. 76 is seen further exemplary embodiments of the disclosure of the platform configuration for harvesting the abundance of ocean energies. In certain embodiments, the platform is disposed on the ocean 15 for harvesting solar energy 400, tidal energy, wave energy, and ocean energy. In other embodiments, the reflective rays of the solar energy against the surface of the ocean 15 are absorbed by the solar energy apparatus 400. In some embodiments, these energies are converted into renewable energy 130. Some embodiments of the disclosure further include a transmitter 140 operatively configured with the renewable energy 130 and communicatively connected to the reaction chamber 120. In other embodiments, the renewable energy 130 is configured to empower a heat exchanger and a suction pump. The suction pump and the heat exchanger are operatively configured with the evaporation chamber 45 and the reaction chamber 120. The reaction chamber further comprises electrolysis. A condenser chamber 50 is configured with the evaporation chamber. The evaporation chamber is further configured for generating vapor to empower a turbine for generating supplemental energy 40. The vapor is condensed at the condenser chamber and desalinated water 55 and salt 16 are produced. The reaction chamber 120, in some embodiments, is configured for producing hydrogen 100, oxygen 101, and methane.

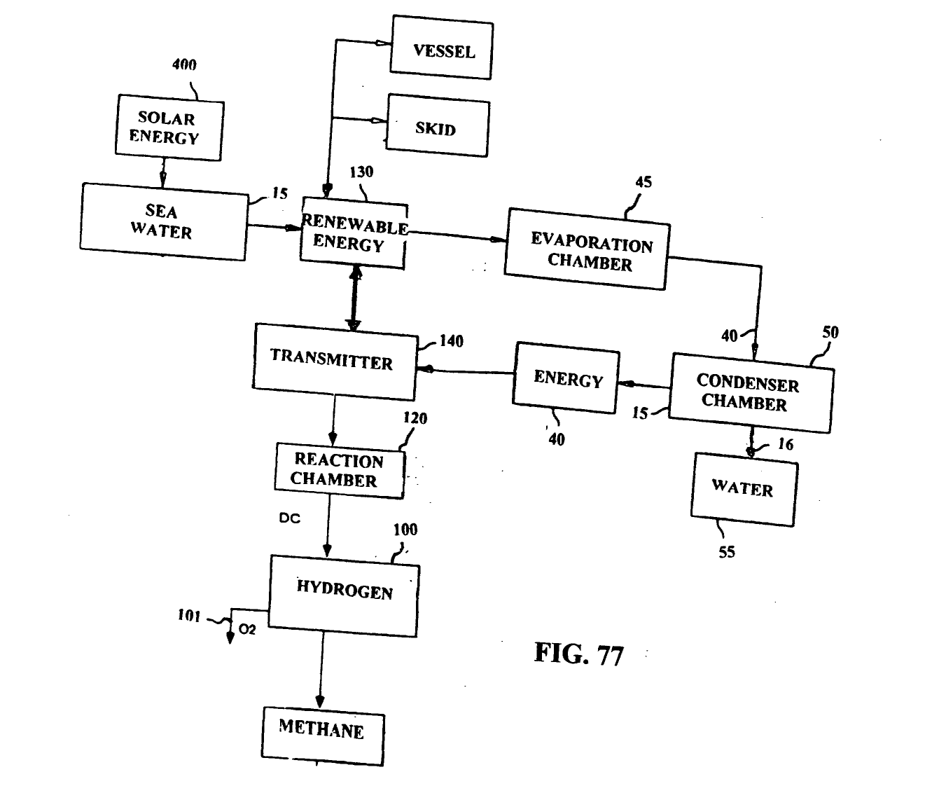

Referring to FIG. 77 is seen further exemplary embodiments of the disclosure of the platform configuration to be mounted on a skid. In some embodiments, the skid is mounted on a cargo vessel to be transported to prescribed and/or predetermined location. In certain embodiments, the platform is configured for harvesting the abundance of ocean energies. In certain embodiments, the platform is disposed on the ocean 15 for harvesting solar energy 400, tidal energy, wave energy, and ocean energy. In other embodiments, the reflective rays of the solar energy against the surface of the ocean 15 are absorbed by the solar energy apparatus 400. In some embodiments, these energies are converted into renewable energy 130. Some embodiments of the disclosure further include a transmitter 140 operatively configured with the renewable energy 130 and communicatively connected to the reaction chamber 120. In other embodiments, the renewable energy 130 is configured to empower a heat exchanger and a suction pump. The suction pump and the heat exchanger are operatively configured with the evaporation chamber 45 and the reaction chamber 120. The reaction chamber further comprises electrolysis. A condenser chamber 50 is configured with the evaporation chamber. The evaporation chamber is further configured for generating vapor to empower a turbine for generating supplemental energy 40. The vapor is condensed at the condenser chamber and desalinated water 55 and salt 16 are produced. The reaction chamber 120, in some embodiments, is configured for producing hydrogen 100, oxygen 101, and methane.

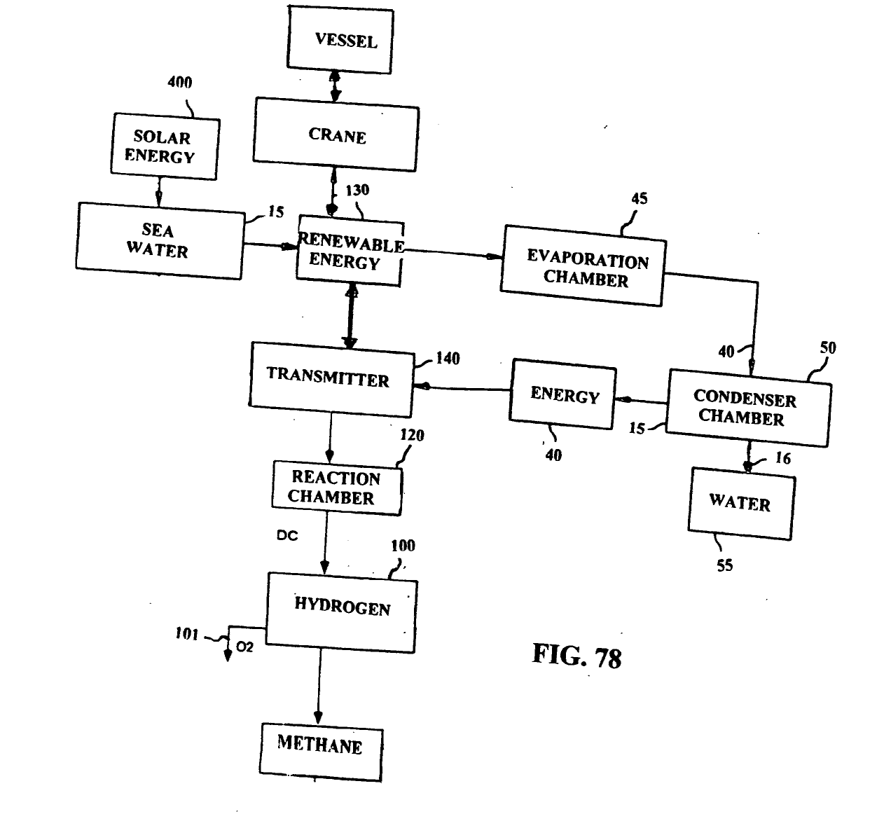

Referring to FIG. 78 is seen further exemplary embodiments of the disclosure of the platform configuration to be mounted with a crane on a vessel. In some embodiments, the crane is mounted on a vessel configured with the platform as disclosed. In certain embodiments, the platform is loaded on a vessel by at least a crane. In some embodiments, the crane is mounted on the platform. In other embodiments, the crane is disposed on a vessel configured for loading and offloading the platform. In certain embodiments, the platform is disposed on the ocean by the crane. In other embodiments, the platform is loaded and/or offloaded on the vessel with the crane. Yet in other embodiments, the platform is submersible. Still in some embodiments, the platform is fixed. Some embodiments of the disclosure include the platform further loaded on a vessel for transportation to a prescribed and/or a predetermined location.

In certain embodiments, the platform is configured for harvesting the abundance of ocean energies. In certain embodiments, the platform is disposed on the ocean 15 for harvesting solar energy 400, tidal energy, wave energy, and ocean energy. In other embodiments, the reflective rays of the solar energy against the surface of the ocean 15 are absorbed by the solar energy apparatus 400. In some embodiments, these energies are converted into renewable energy 130. Some embodiments of the disclosure further include a transmitter 140 operatively configured with the renewable energy 130 and communicatively connected to the reaction chamber 120. In other embodiments, the renewable energy 130 is configured to empower a heat exchanger and a suction pump. The suction pump and the heat exchanger are operatively configured with the evaporation chamber 45 and the reaction chamber 120. The reaction chamber further comprises electrolysis. A condenser chamber 50 is configured with the evaporation chamber. The evaporation chamber is further configured for generating vapor to empower a turbine for generating supplemental energy 40. The vapor is condensed at the condenser chamber and desalinated water 55 and salt 16 are produced. The reaction chamber 120, in some embodiments, is configured for producing hydrogen 100, oxygen 101, and methane.

The detection platform of FIG. 30 further comprises micro-fibered material 220 which may be etched on second materials, including a non woven material being operable to produce a detection outfit 10 for homeland security and other security applications, including military applications and postal service applications. The outfit 10 is configured for detecting biological and chemical agents on work/public places and may be applicable in public water supplies. The silicon substrate 205, micro-fiber material 220, and the nano-sensors are unique to advanced detection sensitivity and selectivity. Disclosed embodiment further include ferrous and/or non-ferrous materials 221 alloyed with the micro-fibered material 220 and embedded, fused, or etched to provide material toughness and sensor durability of the finished product.

Still, other embodiment provides a wearable outfit detection method, further comprises malleable miniaturized steel 222 being alloyed with other materials to exhibit advanced toughness of the finished product for different applications. These applications further include police outfit, military outfit, or any uniformed law enforcement outfit. Certain embodiments of the disclosure provide a detection platform being configured to exhibit elastic properties. Some embodiments provide alloyed materials to enable the outfit 10 exhibits elastic shrinkage. In this approach, the outfit 10 may further consists of miniaturized micro-steel material 222 being operable for providing reinforcement within the structures of the silicon substrate 205 and/or the micro-fibered material 220. Disclosed embodiments further provide reinforcement to enable the detection platform exhibits toughness in various applications that include hostile environment where bullets may be exercised. The reinforcement of the detection platform further consist of other properties such as elasticity and/malleability within the structures of outfit 10. The reinforcement of the detection platform further comprising means for preventing bullets penetration through the outfit 10. In other embodiment, the methods further consist of alloying the miniaturized steel material 222 with micro-fiber material 220 such as polypropylene in a silicon substrate 205. The silicon substrate 205 is operatively connected to/etched on the normally used material for military and/or uniformed law enforcement outfit.

The advancement of nanotechnology application to wearable outfit 10 further requires the biological sensing elements to be selectively recognized as a particular biological molecule through a reaction specific adsorption, or other physical or chemical processes. Transducer 315 is further configured for converting data results into usable signals, which are quantified and amplified, and communicable to a network. The transducer 315 may consist of optical, electro-optical, or electrochemical devices, providing many sensing opportunities such as tailoring biosensors for specific detections. The transducer 315 further comprises means for translating physical or chemical changes within the detection environment into useful signal communications by recognizing an analyte and relaying its analysis through electrical signal communication. The electrical signal communication is initiated from the detection platform in communication with the receptor 110. Further development of the outfit 10 via nanotechnology applications would provide homeland security intelligence with the proper tool for monitoring and better response to detection, protection, and communication.

Referring to FIG. 21, is seen further embodiment of the receptor environment being configured for empowering the detection environment and for propagating through in-depth detection analysis, eliminating false communication while providing at least a communication with a network. The detection platform in response to the environmental problem is essential for the application of disclosed embodiments.

In FIG. 17 is further seen the nanotechnology approach to providing the detection platform 295. The detection platform 295 further includes RFID chip 200a. The RFID chip 200a is embedded in the silicon substrate 205 and fused/etched in micro-fibered material configuration. Disclosed embodiments further provide nano-sensors in a silicon substrate 205 and fusing the silicon substrate in a micro-fibered material 220 for providing reinforcement in pipeline applications for the detection of elements flowing within the pipe line. In this regard, the RFID chip 200a is configured in a similar fashion, providing a sealant made out of the silicon substrate configuration with the micro-fibered material 220.

The sealant could be in the form of an O-ring being used for the construction of a valve, such as a butterfly valve for water pipeline monitoring. Disclosed embodiments provide methods of detecting objects flowing within the water lines, and consisting of RFID chip 200a serving as a numerical identifier being responsive to automated flow data within a closed system comprising a flow pipe.

Embodiments further provide the detection platform being disposed on the flow walls of the flow pipe, while the RFID chip 200a positioned at the flow valve, which analyzes all data signals and enables communication if detection or threat is eminent. Certain embodiments provide analytical methods of contextual detection within a closed system.

Disclosed embodiments provide advanced detection method for Homeland Intelligence Systems Technology “H-LIST,” comprising an outfit 10a normally worn by officers, security officers, TSA officers, FBI, CIA, custom officers, border patrol officers, military officers and the like. The outfit 10A is operable for detection of deadly gases 700, and explosives 600, such as any weapons of mass destructions. Referring to FIG. 28, a receptor 110 is configured for analyzing information and for transporting the analyzed information wirelessly to a central security monitoring station 70 or networks. The timely response of receptor 110 speedily prevent any use of such weapons, and would advice occupants to depart from such environment 60 as seen in FIG. 2, where one of such weapons such as gases 700 had been used.

FIG. 14 is further seen comprising a piezoelectric device being operable with a piezoelectric crystal 260, which allows antibodies 270 to be coated to provide multiple use potentials in a solid, liquid, gaseous and explosive detections in all environment, including military, customs, CIA, FBI, chemical firms, biological firms, radioactive firms, healthcare, hospital facilities, commercial industries monitoring and healthcare monitoring, transit buses, buses and transit trains, airports, nuclear power plants and the like. The piezoelectric device further comprises immunologically active sensing element in the outfit 10a, being configured with electronic transducer 315, further responsible for sensing antigen/antibody concentrations by direct changes in the transducer output. The transducer 15 is further responsible for converting immunoreactions activities into different physical signals.

Certain embodiments provide antigen/antibody affinity reactions which are identified directly by measuring the frequency change of an environment, which corresponds to a mass change of the sensor surface. Some embodiments provide a detection platform method on an outfit operable for high sensitivity and lower power supply automation to enable specific detection of deadly weapons. Perspective embodiments consists of antibody coated piezoelectric quartz crystal transducer 315, comprising in signal-processing systems, operable for causing coated crystals (A) to selectively vibrate at fundamental harmonic frequencies. The coating traps particulates that change the effective mass 265 on the sensing surface and configured to enable a change in oscillating frequency of the antibody-coated crystal (A). The change in the oscillation provides signal communication through receptor 110 to the central security monitoring stations 70 and other agencies 80 or networks. The receptor 110 is responsive to detections, identifying the chemical and biological mass that has been detected based on the impacted crystal or specifically on the coated region of the recognition pattern. The device particularly employs transducer 315 for detection and integrates with the piezoelectric crystal technology.

Referring to FIGS. 14 and 19, antibodies 270 are coated on the crystals of the piezoelectric 260 and/or the surface of the microprocessor electronic 180 at specific harmonic nodal positions to enable detection of a change in mass that will cause a change in the frequency of the associated harmonic. Disclosed embodiments further provide detection configuration to detect a change in mass 265 that changes harmonic frequencies of the detection material. The receptor 110 is operatively configured with sensors 200 to provide further detection of the presence of particular biological and chemical explosives. The receptor 110 further enables detection of oscillating frequencies of two crystals due to their absolute frequency shift. A transmitter 311 is configured to generate radio frequency signals and sends detected signals to a frequency-modulating receiver 312. The FM receiver 312 receives signals from the radio frequency identification “RFID” chip 200a through the chip's antenna 201 Signals are decoded and send to the central security monitoring station 70. These signals could be sensed agent based on the pattern recognition of the foreign wave in the radio wave frequencies and the like. The sensors 200 or 200a, and decoder 314 are operatively connected to a detection memory 291 responsible for repetitive signaling. The encoder 313 and the transmission control 194 are operatively connected to an analyte chamber 195. The frequency transmitter 311 is connected to the encoder and the transmission control 194, providing real time interactive control means, detection means, and communication means to fiber towers or networks 69.

The transmission control 194 provides information about status of the detected agent to avoid false recognition due to unidirectional pressure effect on the wave's path. Signals are coded and sent to and from the transmitter 311 to the FM receiver 312. The transmitter 311 transmits continuous and repetitive coded signals until they are received by the central security monitoring station 70 or network 69. The sensors 200 or 200a, transmitter 311, detector 290, and the FM receiver 312 are the basis of the wireless communication responsive to homeland security monitoring. The outfit 10 provides uniformed army personnel or officers 35 the ability to monitor the deployment of deadly agents and the detection of other weapons of mass destruction within a defined environment.

FIG. 15 further shows Officers 35 wearing outfit 10a, which is etched with plurality nano-sensors 200 or 200a. Officer 35 is further seen assigned to a detection zone, battlefield, or environment 60 for monitoring plurality characteristics. The outfit 10 is configured for monitoring and detecting weapons of mass destructions and also the physiological conditions of personnel within the vicinity of the detection. The receptor 110 is configured such that the detection of anticipatory suspicious person carrying deadly gas 700 or explosives 600 will not only produce limited visual or audio signal, but would rather inform the officer 35 through other means, such as vibration, while wirelessly communicating to a central security monitoring station 70, wind fiber towers 71, or at least a network 69.

Disclosed embodiments provide radio frequency means on its RFID chip 200a or receptor 110 to receive and transmit sensed data. Receptor 110 may comprise a cell phones 111 and two-way radios 112 being operable as auxiliary receptors to further add protection in the homeland security monitoring. In other embodiment, sensor 200 is seen to represent at least an RFID chip 200a in the size of at least a human hair.

Referring to FIG. 26B and FIG. 26C, outfit 10, 10A, 20, 20, 120, and 130 further comprises chip 200a embedded in the silicon substrate 205 and etched in a micro-fibered material 220. Disclosed embodiments provide a detection platform on an outfit comprising sound wave apparatus for tracking communication between terrorist networks and the like. Outfit 10, 10A, 20, 20, 120, and 130 are responsible for providing interactive communication thereof and for detection of weapons of mass destruction. The configuration of the outfit 10, 10A, 20, 30, 120, and 130 is such that antenna 201 is etched in the chip 200a and faced outward to track foreign objects traveling through the wind waves. The chip 200a is embedded in a silicon substrate 205; the antenna 201 is operatively configured with the chip 200a. The chip 200a and the antenna 201 are embedded in the silicon substrate 205 and etched in a micro-fibered material 220 providing a fabric material for the outfit 10, 10a, 20, 30, 120 and 130. The outfit is communicatively configured for wireless communication network and mobile detection apparatus for detection of weapons of mass destruction. In another embodiment, the detection platform further comprises sensors in silicon substrate and micro-fibered material 220, providing sound wave detection apparatus operable for innovative military outfit being configured with chip 200a coded to detect enemy personnel and persons, such as a terrorist carrying at least a weapon 600, or guerilla fighters in their normal hidings, such that detections are enabled and communicated to networks 69 or command post 70 or 71 as seen in FIG. 24.

The outfit 10, 10a, 20, 30, 120, 130 is designed to receive input signals and to send out output signals through the embedded antenna 201, configured for gathering data (such as physiological condition of a fallen soldier) and for providing communication indicative of the physiological conditions of personnel, whether or not they are alive. Disclosed embodiment provide a system that monitors heart rates, vital signs, blood pressure and respiratory system; and provide communication to at least a network if the heart stops beating or the respiratory system under goes a drastic change. Certain embodiments provide apparatus for modernizing homeland security and battlefield personnel with wearable digital combat gears to protect against any act of terrorism and/or guerilla style attack, wherein all field communications are connected to at least a common network 69, 70 and 71 seen in FIG. 24. A typical example of a common network 69 is at least, the equipment used in a battlefield to attack enemies or to monitor enemy movements, wherein detection and communication to battlefield personnel is enabled through disclosed embodiments. By networking homeland personnel and/or army personnel, whether independently or collectively, allows a cohesive integration and collaboration through wirelessly sharing of field data to enable real time responses and provide devastating force of action towards weakening enemy lines. In a similar example of a typical network, the embedded antenna 201 in the RFID chip 200a or sensor 200 comprises retractable devices that read information traveling through waves. This information may travel through radio waves or micro-waves. Disclosed embodiments provide apparatus for communicating such information wirelessly to command post computers or at least a common network station computer for further analysis and instructions to expedite responsiveness.

Referring back to FIG. 26B, the disclosure provides outfit 10, 10a, 20, 30, 120, and 130 in communication with receptor 110. The chip 200a is configured to emit beams through the antenna means 201, invisible beams that will travel through waves, such as radio waves, micro-waves, ultrasonic waves and the like. Each emitting wave is responsive to current travelling through trained pattern and reading information that would provide the exact location of weapons of mass destruction, or the activities in anticipation of weapons of mass destruction, or the location of enemy personnel. Disclosed embodiments further provide radio frequency identification chip 200a “REED CHIP” being configured with embedded antenna 201, wherein both the chip 200a and the embedded antenna 201 are further embedded in a silicon substrate 205 operatively configured with GPS technology and then etched in a micro-fibered material 220.

The micro-fibered material 220 as seen in FIG. 30 is alloyed with non-ferrous material such as at least silver micro-fibers, innovatively re-enforces the fabric and enabling a wired outfit 10a, further comprising pathogen detection apparatus. It is anticipated that the disclosure of a non ferrous micro-fibered material 220 within the structures of the fabric for the outfit, such as silver micro-fiber in particular, would improve the electrical properties of the material, respond to temperature conditions, convert solar energy into electrical energy, and provide a platform for pathogen detection. Disclosed embodiments provide apparatus to enable rapid responses to bacterial in human bodies. These bacterial is normally created by the environmental condition of the site, such as biological agents 630 or chemical agents 620 in the air. Such that, in a real severe environmental weather condition, the electrical properties of the silver micro-fiber 220 will reverse or bias the situation, enabling the system to thermostatically operate partly as an HVAC control system's outfit 10a, partly as an outfit 10a comprising anti-bacterial device that fights biological and chemical agents that could possibly come in contact with the skin of a personnel wearing the said outfit 10, and largely as a protective and monitoring outfit 10a device for the detection of weapons of mass destruction. The silver micro-fiber 220 is further responsible for tracking physiological conditions of army personnel, wherein communication is enabled when any of such detection is sensed. Once the chip 200a encounters any detection of wavelike particles, wireless communication means is enabled through the receptor 110. The receptor 110 further comprises means for amplifying communication signals to a network 69 of security agents or military personnel. Such network 69 includes wind towers 71 for tracking down other terrorist activities and interactively communicating with personnel wearing the outfit.

Referring to FIG. 21, the receptor 110 is further configured with an insertion slot 111a configured for checking identification cards to be used by homeland security agents. In this embodiment, trained personnel would request an identification card 112 such as a driver's license from a real suspect in anticipation of an attack and insert the ID card 112 in the slot 111a. Inserting the driver's license into the slot 111a of the receptor 110 will enable the ROM 112b to read the ID card 112 and communicate to the RAM 112a to access the database 113 where such ID information is stored for retrieval. The receptor 110 is further configured with a screen read-out 113a responsive to information about the anticipatory suspect being retrieved from at least database 113 containing driver's licenses or a common network of HIT-LIST. Disclosed embodiments provide an 8-pin privacy indicator (S1) operable with the receptor to communicate to an officer in private when a weapon is sensed. The indicator include a switch S1 as in communication with the display selector and corresponds to cathode a, cathode g, and cathode d of a 7-segment common anode display settings (D1). The chip 200a is configured with the receptor and acts as a detection tool. The receptor 110 comprises a communication means for applications in global homeland security agencies and/or the military, making it very possible for agencies to identify threats or any object of terrorist attack or enemies at battlefields.

The RFID chip 200a is further coded, comprising GPS technology being operable to identify members of the agencies such as battlefield personnel and other security personnel, and is configured to distinguish personnel from enemies at battle front or terrorist personnel. By coded the chip 200a, the system provides means to feed trained security personnel and military personnel with reliable, accurate, and real time information about anticipatory act of terrorism or any mobility of enemy personnel in a battlefield. Certain Embodiment provides innovative approach to combating any war, including the war against terrorism and any other war thereon.

Disclosed embodiments further provide an outfit method of equipping airport personnel to be efficiently pro-active in their assignments. Some embodiments provide apparatus operable to read off information in a wallet, pocket book, or luggage and single out any one of such luggage if detected or suspected of any weapon for extra checks, providing a vision possible in H-LIST. Certain embodiments provide a computer implemented method, comprising a communication apparatus in communication with a detection platform consisting of the fabric material being used for the outfits and providing wireless communications and mobile detection of weapons of mass destruction, including conduction of body heat and anti-bacterial means.

In another embodiment, the combination of the silicon substrate, the metal oxide and/or thin film or miniaturized metallic material with the chip 200a provide an energy platform on the outfit comprising battery cells configured for converting solar energy into electrical energy, and may include a battery-powered fabric for the outfit 10. The energy platform is operable with receptor 110 to amplify detection pattern of weapons of mass destruction. Certain embodiments provide energy platform comprising of a silver micro-fiber 220 responsive to anti-microbial composites, for covering wounds, for dressing, and for cloths. The energy platform is in communication with the detection platform to provide the ability for the outfit to eliminate static electricity by dissipating the static electric charges. Disclosed embodiment further provide a detection platform configured with a processor means, comprises a pattern recognition technique for producing “Sensing,” a controlled communication signal and communicating any sensed detection to a wireless modem or control module being operable to provide wireless communications to security monitoring agencies or network 69. The network is responsible to optimize the protection against terrorism and monitoring the mobile capabilities to assigned terrorist locations. Disclosed embodiments provide the energy platform comprising a cell platform being further configured for medical devices applications. Other embodiments of the cell platform comprise communication applications. Disclosed embodiments further provide the cell platform comprising nickel-cadmium (NiCd) configured with nickel oxide hydroxide and metallic cadmium. Disclosed embodiments provide the nickel oxide and metallic cadmium further consisting electrodes being configured for deep discharge applications. Other embodiments provide methods and systems for storing electrical energy, comprising the cell platform. The cell platform includes battery cells and/or capacitor configurations for withstanding higher number of charge/discharge cycles and faster charge and discharge rates. Certain embodiments of the cell platform further comprise an electrode device comprising at least electrically conductive nano wires/tubes being coated with at least one electrically isolating layer.

Referring to FIG. 17, disclosed embodiments further provide a wearable detection apparatus configured for battlefield applications, civil establishment hospitals, homeland security personnel, police officers, security agents, security agencies, security stations, and guards in anticipation of a terrorist act, such as suicide bombing. When such detection is eminent, disclosed embodiment would provide communications to other agencies for immediate reaction. The pattern recognition technique as disclosed processes signals that are generated by objects and the said signals are periodically modified by interacting with other objects in order to determine which of the classes the objects belong to, including radioactive, biological, chemical, and explosives. Certain embodiments provide apparatus that generates signals based on the detection of at least a class of the object. Disclosed embodiments further provide apparatus that determines if the object is of a specified class and then assigns the object to the specified class code, or sends out other signal if the object is not a member of any of the coded classes in the set. The signals thus generated are electrical signals and emanates from at least a transducer 315. The transducer 315 is seen to be very sensitive to radiation originating from weapons of mass destruction. Some embodiments provide apparatus for anticipatory sensing pattern recognition technique and providing communication to network 69 in anticipation of terrorist activities.

In other embodiment, sensors 200 and 200a are etched in a silver fibered material 220 to form a bimetallic layer, providing antibodies of chemicals and bio-molecules responsible for detection of high explosive substances in their solid, gaseous, and liquid phases as seen in FIG. 16. The bimetallic layer is mixed with other substances at different points of their embodiment, providing a highly specified detection platform for terrorism device applications. Certain embodiments provide mixtures of micro-layers consisting of surface plasmon resonance spectroscope on the surface of sensors 200 and 200a. Other embodiments provide etching/fusing the combination on a silver micro-fibered material 220 to provide a highly sensitive detection device for anti-terrorism application. These teaching combinations are highly reliable for security monitoring and for detection of weapons of mass destruction. The teaching further requires portable, mobile and wireless detection devices to be configured with networks 69, wind station networks, satellite networks and the like as seen in FIG. 10. Disclosed embodiments provide an innovative approach to security and monitoring, including all branches of exposures, such as military, Government, law enforcement, hospitals, industries, recreational facilities, athletes, sporting events and facilities, amusement facilities and the like.

The receptor 110 further empowers the outfit 10a to enable high specificity and low detection levels for various design application of security and monitoring, and the detection of weapons of mass destruction. Embodiments provide the receptor 110 being configured for amplification of the embedded sensors to allow speedy detection within a mobile environment. Embodiments further provide an innovative method of detection. Its wireless communication means to network stations provides convenience to use. The receptor 110 is very specific in its analysis and it is self-diagnostic. The receptor 110 provides detection of contraband substances within a container or luggage. The CPU 141 enables interface between the sensors on the outfit 10a, the receptor 110. The network stations are responsible to enable interactive communication thereof when detection is eminent. Detection of vapors emanating from explosive substances and weapons of mass destruction is timely, such that when a particulate matter is emitted from its substance, its concentration or presence will immediately be detected. Communication is then enabled from the detection environment to the network stations 69, which are classified and/or unclassified for security monitoring of at least a nation.

The receptor 110 functions both as an amplification device and also as a control/communication system. The receptor is responsible for controlling and processing the overall detection analyses instantly, and for providing wireless communication to at least a network station. The detection apparatus provide constant monitoring and requires no tunnel for people to walk through. The system detects these people as they walk pass a person wearing the outfit 10a. Its mobile detection means is portal and invasive, preventing any act of suicide bombing or other acts of terrorism while also providing a non invasive detection means when the particulates in the wind waves are non destructive. Embodiments provide detection of explosives or contraband emission from concealed substances on individuals, luggage, vehicles, trashcans, airplanes, buildings, and other areas where such weapons could be used. Because many particulates of substances can be contained in wind waves, the sensors on the outfit 10a are outlined and configured to single out each concentration of various particulates that may be sensed or detected within terrorist networks. The outfit is further configured with plurality sensors being configured for providing effective sensitivity and reliability to detections. Embodiments further provide absolute solution for advancing critical analysis of weapons of mass destruction.

The silver micro-fibered material 220 as seen in FIG. 29 and FIG. 30 also serves as a filter element, providing a sensing medium to absorb particulates for analysis in their mobile environment. The antenna 201 also provides a thermal means to vaporize and evaporate the particulates to increase selectivity and sensitivity for detection. The outfit is further configured to thermostatically provide HVAC means in response to other environmental conditions to burst reliability under all weather conditions. The communication devices for the central security monitoring station 70 are configured with the receptor 110, which enables communication with various stations through transmitter 311 as seen in FIG. 19.

A microprocessor 140 is connected to memory 291 of FIG. 19 through input and output interface 300 to the analyte chamber 195. The receptor 110 further includes an antenna system 109 being operable for receiving radio frequency signals from the sensors 200 and/or 200a of FIG. 29 and FIG. 30, which are empowered by the transmitter 311. The receiver 312 and decoder 314 of FIG. 6 process signals, and decoded signals are then transmitted through the interface 300 and 3001 to the central security monitoring station 70 or network 69 and other agencies 80 of FIG. 24. The receptor interface 300 and the central security monitoring station interface, wind towers 71, or other networks such as megatel 3001, vehicles 14, computers 11, base stations 13, branch stations 16, highway advertisement board 007, industries, police stations, and schools as seen in FIG. 23, are communicatively connected through wireless links or modem to radio frequency or infrared links.

The receptor powers the outfit 10 through a fiber optic ribbon 240 or wireless connection means 241 as seen in FIG. 25. The wireless connector beam 241 includes a transmitter 242 and a receiver 243 being operable with at least a 9 Volt power for its initial energy, and may be charged wirelessly through the silicon battery cell 808 configuration as seen in FIG. 21. The silicon battery cell 808 is represented in FIG. 12 as +9V, and is the central energy source and empowers the amplifier to enable active emission of beams of electricity over the sensing surfaces of the outfit 10. The outfit is comprises of silicon substrate microfiber/nano-fiber configured to convert solar energy, vibration, sound wave, and pressure for into electrical energy. Because the sensitivity of the wireless connection depends on the light in the environment, the transmission and reception quality is then enhanced by shielding the JR LED and the phototransistor by focusing the IR beam with lenses. The potentiometer is adjustable to get the best possible connection signal. The wireless connection is a secondary connection means when the fiber optic ribbon or cable connection becomes faulty. The wireless connection further comprises infrared transmitter and receiver operable to transmit energy to the sensing medium. Since the wireless connection is a secondary means, more emphasis is on the ribbon connecting means. With the fiber optic ribbon connecting means, a more timely sequence of events is preprogrammed, so that when any of the sensors senses weapons of mass destruction, plurality reaction is enabled through the receptor's random analyzing circuit 244, providing a random detection output through the receptor 110.

The receptor's antenna constantly receives and transmits energy. This transmitted energy powers a circuit responsible for converting alternating current “AC” into direct current “DC.” The impedances of the antenna would match the impedances of the circuit. The operating frequency of the receptor 110 is operatively configured with the silicon battery cell 808. The silicon battery cell is configured with a wind energy source configured for wirelessly empowering the receptor 110. The transmitter for the wind energy source sends signals at set frequencies to the circuit board of the receptor 110. The receptor then converts the received signals into DC voltage to charge the receptor. Signal is generated and fed into an amplifier responsive to output signal through a radiating antenna configured to interface with the air. The antenna may be internal, embedded into the circuit board in communication with signal amplifier. The antenna is operatively connected to the amplifier, which is configured with a radio frequency source comprising a circuit that outputs signals to the receptor specified frequency and voltage. The circuit is designed so that when AC current/voltage is inputted, it outputs a DC current voltage—AC to DC converter that would rectifies the AC current voltage and elevates the DC current voltage level. A transformer is configured to isolate the input from the output to prevent overload and transient pikes on the input line.

The configuration of the receptor 110 as seen in FIG. 25 comprises an LED being fired each time the sensors 200 or RFID chip 200a sends a pulse or signal. The pulse rate of emission is adjustable through the potentiometer configuration to enable flexibility for random adaptability to other sensing environment. One lead of the LED represents the anode and the other is a cathode. All the anodes may be connected to the resistors R3. A pulse from any of the sensors enables contact at switch S1, which will then provide connections to networks and other security institutions. When S1 is broken, at least one of the LED will stay lighted to indicate active power in the IR system and can be adjusted to higher clock speed. The transmitter 242 and 311 accepts signals from the sensors in the outfit 10, modifies the signals and transmit the signals through waves or beams to the satellite or network stations “Receiver.’ The beams, which are of infrared light, are translated at the receiving end back into signals that can be easily amplified to understandable and/or readable information and communication data. Reply from the receiver is obtained through the receiving circuitry comprising receivers 243 and 312 of the receptor 110.

For further military combat settings, FIG. 22 is seen a military advanced combat system's technology which employs a battle ship 800 with wind tower 71 positioned in the sea 801. The wind tower 71 has propeller blades 802 which are aeronautically powered by nature's sea wind 803. The wind tower 71 has a tail-vane 806 that enables the tower to rotate with the wind, creating a kinetic energy along its movement. The kinetic energy along the movement of the wind 803 enables the flow sea current 804, which is then stored in cells 805 responsible for energizing the receptors 110 through the receptor's silicon battery cells 808 of FIG. 8 while in combat operations. The empowerment of the receptors 110 with the energy generated by the wind tower 71 is much powerful and will continuously energize the receptor wirelessly for the entire life of the combat. Creating a night-time and day light energizing means that is much stronger, powerful, and dependable than solar energy means. The receptor utilizes the natural form of electrical energy from ocean current through the wind tower 71. Similar towers could be positioned around the country to empower commercial homeland security receptor devices wirelessly.

The wind tower 71 includes an automatic sensing unit 807 configured with a revolving beacon light and/or an antenna. The antenna is further configured with an amplifier means responsible for emitting constant beams of electrical energy to the receptors 110. The amplifier means is further responsive to detections, and empowering the military outfit 10 to enable unique sensing range. When a sensor 200 or 200a senses gases or other objects, the transmitter 311 will generate a radio frequency signal-using antenna 109 as the communication source. The communications is through continuous wave burst with an identification code unique to the type of wave normally generated by biological or chemical gases and explosives. When such wave signals are matched, communication is enabled to promptly protect the vicinity where such signals were matched. The radio frequency signals are sent and received through the antenna system 109 to the receiver 243 and 312, which are comprised of frequency modulators or modems. The modulator 312 outputs modulated signals to the microprocessor chip 140 as seen in FIG. 14, FIG. 16 and FIG. 17. The microprocessor 140 is operatively configured to filter out the signal output to improve signal to noise ratio and compares with the wave pattern of the coded detection agents.

The sensors 200 or 200a operates on many different principles of detection. These principles include, but are not limited to infrared and thin-film detection, piezoelectric crystal and transducer detection, piezoelectric cantilever detection, piezoelectric MEMS detection and the like. The receptor 110 comprises a cell phone 111 and/or a two-way radio 112, which receives output from each of these sensors and output signals indicative of the signals being received as seen in FIG. 8. The algorithm of the techniques of the sensing pattern minimizes the likelihood of any false detection of deadly agents. The output of each of the sensors and detectors are connected to the input of a central processing unit “CPU” 141 comprising a CMOS 142 as seen in FIG. 21.

FIG. 15 is further seen to show a perspective view of an officer 35 wearing such outfit 10a and patrolling an environment 60, responding to a suspicious areas 90 and/or between suspicious vehicles 50. The outfit 10a is operatively configured to detect deadly gases 700 or explosives 600 around such vehicle 50. The officer 35 is wearing such outfit 10a and patrolling around a suspicious person 40. The detection platform is operatively configured with the outfit 10 to enable detection of explosives 600 or gases 700 within a person 40, if said person has any of such explosives 600 in his possession.

The constructions of explosives 600 and deadly gases 700 have recognizable wavelike properties. The detection platform is configured with sensors that have trained behaviors responsive to the detection of the wavelike properties. The detection platform and the receptor are operatively configured for providing the detected information to be transported in data format to a central security monitoring station 70 or network close to the area of detection.

FIG. 19 is seen to depict a perspective embodiment of receptor 110, comprising vibrating means, ringing means, and/or sounding means operable for sounding an alarm when the detection platform senses any weapon of mass destruction. The detection platform is responsive to detection of any weapon that would require activation of the receptor 110. The receptor is further configured with means for enabling wireless communication to the central security monitoring station 70 or network. The receptor 110 and the detection platform on the outfit may comprise GPS technology coded to identify personnel, their base or location. The base could be the airport or an assigned government building being on alert each time communication is enabled to a central security monitoring station 70.

The transmitted data is communicated to these stations wirelessly for urgent responses to the referenced emergency situation within the vicinity of the detection. This could be explosives 600, chemical agent 620, gases 700, biological agent 630 or other agents and the like, which are normally hidden in a transit bus. Disclosed embodiments provide wearable detection outfit for detection of weapons of mass destructions. Certain embodiments provide the sensors in the outfit configured with pattern recognition technique. The outfit further provides discerning meaningful destructive information on detected materials that are mostly carried by people in anticipation of terrorist or destructive intensions. Embodiments provide the outfit communicatively configured with the receptor, comprising significant recognizable pattern technique to enable prompt actions to any emergency situation.

Embodiments further provide H-LIST comprising a detection system, which is comprised of a biological, chemical, or explosive tool. H-LIST enables wireless communications and comprises to receptors 110 configured with a central security monitoring stations 70. Certain embodiments provide apparatus to facilitate the work of TSA, military, police officers, civil establishment hospitals, transit authorities, and home land security, filtering out analyzed data from an environment 60 and communicating the data to a portable receptor 110 configured to relay the communication to the nearest central security monitoring station 70 or network 69.

FIG. 16 is further seen to show H-LIST detection which allows subsequent position readout from cantilever beam deflection technique. The deflection technique comprise of micro-fabricated array of cantilever type sensors 210 embedded in the silicon substrate 205 and etched/fused on the micro-fibered material 220, providing a detection platform on a wearable outfit operable for mobile detection within an environment 60. The cantilever 210 is coated at the side with different sensor material 212 to further provide detection of specific gases 700 or explosives 600. Embodiments provide apparatus operable to detect wavelike patterns for detection types 600 and 700. The sensors are selectively arranged in micro-machined etched cavities 216 on silicon substrate 205 or wafers with the rear face terminated with micro-fibered materials 220 acting as a lining 20 or insulator. The material 220 comprises multifunctional sensors 215 operable to provide multiple detections through knowledge, and information on optical properties of the sensing gases 700 and explosive elements 600 as they are being exposed to the analyte 175 carrying aqueous solutions.

Certain embodiments provide H-LIST detection which operates on multifunctional sensing and further employs an electronic nose 230 to enable detection of different odors from the receptor layers 170 to the analyte 175. The receptor 110 is operatively configured with an analyte chamber 195, which is linked to the silicon substrate sensor array configured with the micro-fibered material 220. The silicon substrate array is interfaced with the output connector 25 of the said micro-fibered fabric 220. The outfit 10 comprises input adaptor 160 configured with the receptor 110, to provide advanced detection selectivity and sensitivity. The receptor is operable to expedite timely responses to multifunctional detections. The array of the cantilever 210 is micro-mechanical, operable with multiple silicon substrate cantilevers that are linked to the analyte chamber 195. The analyte chamber 195 is configured to absorb and analyze sensed information.

Grains of membrane 190 are etched in the analyte chamber 195 as seen in FIG. 3 to enable signal separation for specific reporting to network stations 69. The cantilevers 210 comprises of at least a micro-machined single crystal micro-cantilevers with multiple resistors. The resistors further comprises piezoelectric-resistor 211, being fabricated in the cantilevers 210, and operable for determining the cantilever stresses resulting from stress films deposition on the cantilevers 210. FIG. 3 further shows a capacitor cantilever beam 212 configured to electro-statically be pulled-in into a substrate 205, to enable the pulled-in voltage (Vp) to operate as a function of the dimensions of the micro-beam devices 280 and the modulus and stress state of the beams 280. The beam deflection signals are transformed into information specific to the analytical useful signal from the reaction of the analyte 175 or the physical property of the investigative agent 176. The analyzed information is communicable simultaneously through a beam deflection 284, outputting through a multifunctional fiber-optic ribbon 240 and/or microelectronic grains of sensors.

Multiple light sources 245 are connected through the membrane 190 into the analyte chamber 195 to illuminate individual cantilever 210 with light beam through the fiber. The deflection of the light 245 from the cantilevers 210 is configured to shine on a position sensitive detector 250. The position sensitive detector 250 enables bending of related sensors through photocurrent 275 due to stress factor acting on the beam 280. The photocurrent 275 is transformed into voltage (Vp) and the voltage creates pressure on the cantilever 210, enabling bending indicative of the detected signals being communicated to the central security monitoring/communication station 70. The occurrence of the bending is due to surface stress on the sensors and creates resonance frequency shift 514 caused by the surface stress change, which is subsequently caused by the change of mass 265 as seen in FIG. 1, FIG. 3, and FIG. 4.

FIG. 17 is seen to show a piezoelectric micro-mechanical system and thin film in the detection system. Embodiments provide the detection platform comprising a combination of micro-electro-mechanical systems 420 and thin film 430 technologies into the design of H-LIST detection. The H-LIST detection includes the integration of silicon micro-fibered materials 220 and microelectronics circuits 410 into multifunctional sensor arrays 330. The sensor array 330 is fabricated on a sensor in silicon substrates 205 to provide further sensitivity. The sensor array may be affixed on at least a material for the outfit fabric for the detection platform. The detection platform is configured for detecting biological, chemical, mechanical, and physical parameters of enforceable destructive material/agent. The thin film and the micro-electro-mechanical process requires the sensors to be embedded inside the silicon substrate 205 and etched inside the micro-fibered material 220 or other fabric materials. The microelectronic circuit 410 is further integrated into the detection platform for the H-LIST device and interfaced with multiple sensors. The designed patterns of the sensors are responsible for advancing pattern recognition techniques through the application of the sensing materials being used for the development of the detection platform.

Disclosed embodiments further provide application and implementation of H-LIST, which prescribes advanced sensors for multifunctional applications and the integration of other technologies to enhance interactive homeland security detection system by adopting other microprocessor electronics 85 as seen in FIG. 19 into a digitized system. The microprocessor electronics 85 is further responsive to wireless/mobile detections of biochemical, chemical agents, providing multifunctional sensing through a wearable fashioned outfit 10a. The outfit is worn by law enforcers, or security officers 35, or other government agencies for monitoring biological and chemical gases 700 or other explosive elements within a common environment 60 or for national security and global protection.

H-LIST could be transformed into H-LIST.IP Homeland Intelligence systems Technology for International Protection,” and will search and process any material of mass destruction such as biological, chemical gas, or other explosive devices in an assigned environment. Disclosed embodiments provide detection platform comprising tiny grains of the sensors 200 and 200a being embedded in a silicon substrate 205 and affixed on a micro-fibered material 220. The micro-fibered material 220 is affixed on the interior of a regular outfit 10a, such that are normally worn by officers, security officers 35, law enforcement officers, military personnel, Doctors, civil establishment hospital patients and the like as seen in FIG. 28. The tiny grains of sensors comprise of nano-sensors 200 being trained to recognize different gases 700, biological 630, chemical 620, or explosive materials in their wavelike pattern structure. The sensors are intelligently constructed and architecturally structured to invisibly run through the silicon substrate 205 in the micro-fibered material 220. The sensors comprises nanotechnology applications consisting of tiny grains of sensors 200 or 200a being coded and wired in the micro-fibered material 220, such that an extended output connector 25 is exposed out of the micro-fibered material 220 to the side of the outer or inner assembly of the wearable outfit 10a. Disclosed embodiments further provide a rechargeable receptor 110 being worn on a waist belt 120 and on the waist area 130 of the security officer 35 as seen in FIG. 26. The receptor 110 comprises an input terminal comprising adaptor 160 in communication with the detection platform being communicatively connected to the receptor 110.

FIG. 28 is seen to show a receptor 110 and a detection platform on the outfit 10a worn on the officer's body to further detect personnel's physiological conditions. A silicon micro-fibered material 220 is affixed on the detection platform for the outfit 10. The affixation in certain embodiment could be easily detached off the outfit 10 during normal cleaning. The silicon micro-fibered material 220 acts as an insulator on the officer's body, and further comprise of detectors on its mobile environment 60. The outfit is responsive to intelligent monitoring of explosives 700 or deadly devices. The sensors 200 and 200a run through the interior part of the outfit 10a, and the output terminal 25 extends outwardly at the lower side of the outfit 10a, such that the extended output connector 25 is connected to the input adaptor 160 of the receptor 110. The receptor 110 is made of microelectronic materials comprising intelligent microprocessor chip 140 that empowers the trained brains of the embedded sensors 200 or 200a being disposed in the silicon micro-fibered material 220. The sensors are responsible for timely detections of deadly materials or weapons of mass destructions and the receptor's analysis and reporting is seamlessly in real time.

The receptor 110 connects and report to the central security monitoring station 70 through wireless networks 66 or wind towers 71 and remotely empowers the detection platform, enabling it to monitor assigned environments 60 for materials such as radioactive cesium, chemical, biological, explosives, toxic, biochemical, and the like. Such an environment 60 includes, but is not limited to battlefield, office buildings, public recreation areas, transportation equipment, city centers, stadiums, government buildings, airports, schools, tunnels, civil establishment hospitals and the like. The application of H-LIST further advances the knowledge needed in monitoring anticipatory or suspected terrorist acts and also enables Homeland Intelligence Systems to be more communicative by advancing knowledge and information systems into a detection platform. The detection platform further contains information of suspected terrorist movements via the receptor. The application of H-LIST is further integrated in either analog or digital systems or both, with higher degree of processing of large information at much higher sensing speed. Disclosed embodiments provide advanced sensing through the multifunctional sensors 215. Detections and communications are provided simultaneously with higher communication signal strength to noise ratio. The multifunctional sensors 215 are further responsive to cross sensitivity being covered by the sensing amplification through the receptor chips 140. The detection platform 295, which consist of sensors, is operatively configured with detectors 290 and responsive to communications through an active interface means with variable electrical, mechanical, optical, or chemical impedance. The detection platform 295 further generates electrical output signals or pulses indicative of the detected information and enables communication thereof.

As further shown in FIG. 19, sensors 200 and 200a are developed with optimized selectivity and sensitivity, using semiconductor fabrication line in their development process to enable communication of human body responses to at least an environment, such as physiological conditions of personnel, including heart rates or respiratory data reporting. Because of the selectivity and sensitivity of explosive 600 and other chemical or biochemical materials, different materials being provided, nano-crystalline material could be used in patterning the sensing medium. These materials offer immersed promises to improving the sensitivity of H-LIST detection. In targeting mixed gases and some odors within a confined environment, other devices such as electronic nose 230 are used to detect specific patterns or finger prints of the gas mixtures, which may consist of more than one chemical sensors to sense a specific gas and also be trained for a particular pattern recognition via a system in detecting explosives 600 and other destructive materials. The incorporation of a detection platform 295 on outfit 10a for sensing and detecting of weapons of mass destruction further embraces multiple sensors for mobile detection. In similar configurations, a silicon micro-fibered multifunctional-sensor array 330, gas sensing and other sensing are seen responsive to changes in the surface or near surface oxide conductivity 440, which are caused by the formation of space charge region 445 induced by gas absorption or oxygen vacancies on the surface environment 446.

Discloses embodiments further provide detection of gas concentration as seen in FIG. 17. Gas selectivity, which is the detection of specific gases 700 in a mixed gas environment 60, is very importance in the smartness of the disclosure. Disclosed embodiments provide silicon micro-fibered material 220 and the fabrication of microelectronic circuit 410 as shown in FIG. 6 to enhance H-LIST detection. Certain embodiments provide a silicon substrate 205 being micro-machined through a chemical or electrochemical etch technique, employing silicon-to-silicon 460 and or silicon-to-glass and or ceramic wafer bonding 470. This bonding is responsive to strengthen the micro machining or microelectronics integration to enable multifunctional sensing 215. The silicon-to-glass and or ceramic wafer bonding 470 to allow the use of single crystal silicon instead of polycrystalline silicon to improve the design of micro-acoustics and micro optics and also to provide an energy platform for converting solar energy, sound wave, vibration, pressure force, and wind force into electrical energy. The micro-acoustics and micro-optics are further fabricated in the micro-electro-mechanical system 420 and thin film technique 430 to enable the integration of microelectronics circuit 410 and multifunctional sensor 215 into the detection platform 295 on the outfit 10a. Wafer bonding 460 and 470 in single crystal silicon would significantly lower acoustic losses and improve optical properties and energy production.

Though other bonding method may be used in the microelectronic processes, the detection platform is configured with sensitive electronic being operable for monitoring comprises the MEMS 420 and piezoelectric sensors 180 or the cantilever sensor 210 seen in FIG. 16 and FIG. 14 operable for wearable outfit 10, 10A, 20, 30 and 120. With these, bulk and surface acoustic wave resonators 500 are configured for multifunctional, physical, and chemical sensing, and includes other sensors like viscosity sensors and the like as seen in FIG. 17. The resonator-based sensor 500 measures resonance frequency shift such as in surface plasmun resonance spectroscope, caused by mechanical, chemical, or electrical perturbation of the boundary conditions on the active interface 300. These electrical perturbations occur in metal films 543 with different conductivity values deposited on the resonator 500, enabling various loading effects in the liquid and solid media 505, which will damp the oscillations 514 of the resonator 500 and modify the sensor resolution. The resolution of the sensor is determined by the resonance frequency shift response to the external perturbations, adding the capacity of the monitoring electronics to accurately measure the frequency shift within the detection environment and enabling damping of the oscillation 514. The damping of the oscillating frequency is caused by the acoustic energy drained which occurs when free quartz resonance 510 is brought to contact with solid liquid medium 505. Disclosed embodiments provide resonators such as mechanical resonators 500 to measure the frequencies and to provide higher accuracy in sensor sensitivity and selectivity.

However, the selectivity process depend on the parameters of the gas absorption and co-absorption mechanism, surface reaction kinetics, and electron transfer to and from the conduction band of the semiconductor 142, which are achieved by enhancing gas absorption or electronic effect in plurality method such as surface modification. The enhancement can also be influenced by the addition of metal clusters 520 to increase the sensor sensitivity caused by close coupling between the sensing 400 and catalytic properties 504 of the metal oxide 530.

FIG. 17 further shows metal clusters 520, which are added to the sensors 180, 200a and 200 to increase selectivity and consist of chemical sensitization, which enables metal particles 522 acting as centers for surface-gas absorption and may spill over onto the oxide surface 540, providing reaction with the negatively charged chemisorbed oxygen. The addition of metal clusters 520 enables electronic sensitization resulting from direct electronic interaction between the oxide surface 540 and the metal particles 522 through metal oxidation and reduction processes.

In other embodiment, thin film coating 430, which is sensitive to the measured parameters of the sensors, is deposited on the resonator 500 to enable changes in the physical or chemical parameters that will change the resonant frequency shift. The resonant-based sensors 180 and 200 are configured to measure resonant frequencies shifts caused by mechanical, electrical perturbations, chemical or biochemical equivalent. With the incorporation of piezoelectric resonator 500, electrical perturbation will occur in the metal films 543 with different conductivity values deposited on the resonator. When the resonator 500 is immersed in water, it will be deposited in ion-conducting electrolyte. The resolution of the sensors is determined by the resonance frequency shift in response to the external perturbations and the capacity of the monitoring electronics to accurately measure the frequencies. Disclosed embodiments provide amplification of electronic signals through multifunctional sensors 215. In this, the oxidized particles are reduced, providing a change in carrier concentration of the semiconductor oxide substrate 560 to enhance sensitivity through doping to modify the carrier concentration and mobility, or through micro structured changes by the reduction of oxide particle sizes.

Certain embodiments provide film processing comprising thin film deposition processes like chemical vapor condensation or sputtering, and screen-printing or tape casting. Embodiments provide the thin film 430 being deposited on the piezoelectric resonant line 570, providing additional acoustic shear wave modes that will not couple electrically to fluid to avoid heavy loss of acoustic energy. Each film is provided to detect a corresponding gas component. Still in other embodiment, silicon and a non-piezoelectric substrate are used to configure a surface acoustical wave to enable detection selectivity and sensitivity. Some embodiments provide transducers 315 being coated with ZnO, which is a piezoelectric material that is deposited using reactive magnetron sputtering. The surface acoustic wave line 570 is enabled when the sensing coating changes its mechanical parameters in the presence of the gas to which partial pressure is measured, providing the resonant frequency shifts due to the surface acoustic wave propagation velocity. The surface acoustic wave line 570 is coated with passive glass film for calibration, allowing the pattern recognition techniques to be administered and detection data are communicated in order to analyze the signals coming from the various sensor arrays 330. The resonator 500 has a maximum conductivity and behaves like a resistor corresponding to a zero phase shift.

In another embodiment, a military ship 800 positioned in the sea 801. The sea 801 comprises wind current 804 traveling through waves 820, such as radio wave or microwaves being empowered by a wind energy source 830. The operation of the wind energy source 830 is interactive with at least a turbine 840 responsive to ocean current for generating matching electrical energy in communication with apparatus to detect weapons of mass destruction. Such weapons of mass destruction include verbal aerial communication between enemy networks such as networks run by terrorist groups. The wind energy source 830 communicatively connected to wind fiber tower 71 to enable interactive networks spectrum for communication indicative of reaching homeland security broadband networks for local, state, regional and federal first responders. Whereby the outfit comprises a platform for detection and is configured with a receptor for providing high resolution chemical, biological and explosive detection data and other critical data to first responders.

In another embodiment, FIG. 17 is further seen a paste or ink 585 printed on a suitable substrate with two-stage heat treatment to form a dense layer with a favorable structure. In yet another embodiment, the paste 585, which is of powder mixed with an organic medium and a binder, collaborate the correct theological properties to deposit layers of sensor materials on the substrate.

The paste 585 further contains nanoparticles, being deposited in different substrates and heated at various temperatures to obtain the required dimension of the film 430, providing reactive sputtering processes or vapor deposition process that is superior for the use of H-LIST wearable outfit in mobile detection, monitoring and security. Still in another embodiment, a low temperature and pressure deposited aluminum Nitride “AIN” thin film 316 is used to integrate with microelectronic devices and sensors with conventional photolithographic patterning technique, being embedded in a silicon substrate 205, and etched on a micro-fibered fabric material 220 for the outfit 10a. Other materials that are not mentioned in the perspective embodiment could be used as a fabric to etch the embedded sensor on the silicon substrate 205. A flexural plate wave gravimeter sensor fabricated from SOI wafers will enable the aluminum nitride “AIN” 316 to be deposited on its surface, allowing the integrated digital transducers 315 to act on the piezoelectric aluminum nitride layer to enable the lunching and detection of plate waves on a thin silicon membrane 190, which is coated with binding site-specific polymers, such that a change in the silicon membrane resonance frequency will detect a change in the piezoelectric crystal mass 265 as a result of a subsequent change in the membrane mass 195. Disclosed embodiments provide an energy platform comprising SOI wafers.

The binding of the associated antibody/antigen caused by specific recognition will result in mass increase and decrease in frequency. The change of frequency reflects the presence and amount of the targets. In another embodiment, the piezoelectric AIN thin film is deposited on a glass and or ceramic substrates and embedded in a silicon material to improve the flexibility of the sensors 180, 200, and 200a etched in the micro-fibered material 220, allowing specific designs that are prescribed for any outfit for detection of personnel's physiological conditions and for security monitoring of deadly gases 700 and explosives 600. Certain embodiments provide an energy platform comprising AIN thin film. Achievement is obtained through manipulation of the structure of the film by controlling the deposition parameter precisely. However, both nanopowder and nanostructured film are utilized in some disclosure. Nanostructured materials are the essentials to achieving high gas sensitivity, but the technique requires desired oxide composition with a specific dopant and few processing steps. Oxide materials are made more sensitive by introducing dopants, which have unique gas absorption characteristics and utilizes materials with specific catalytic properties to enhance gas sensitivity.

The drawings clearly outline the scope and embodiment of disclosed embodiments. As per FIG. 12, the following components are further explained.
1C1=CPU
1C2=RFID Chip reader
L1+L2=LED
S1=ASPDT “Automatic momentary single pole double throw” switch, for transmitting and receiving signals.
CI=Electrolytic capacitor
C2=imf capacitor
C3=imf capacitor
Q1=Infrared or general purpose silicon transistor
Q2=Phototransistor detector
L1=Infrared LED emitter
M1=speaker/microphone
R1 through R10=Resistors

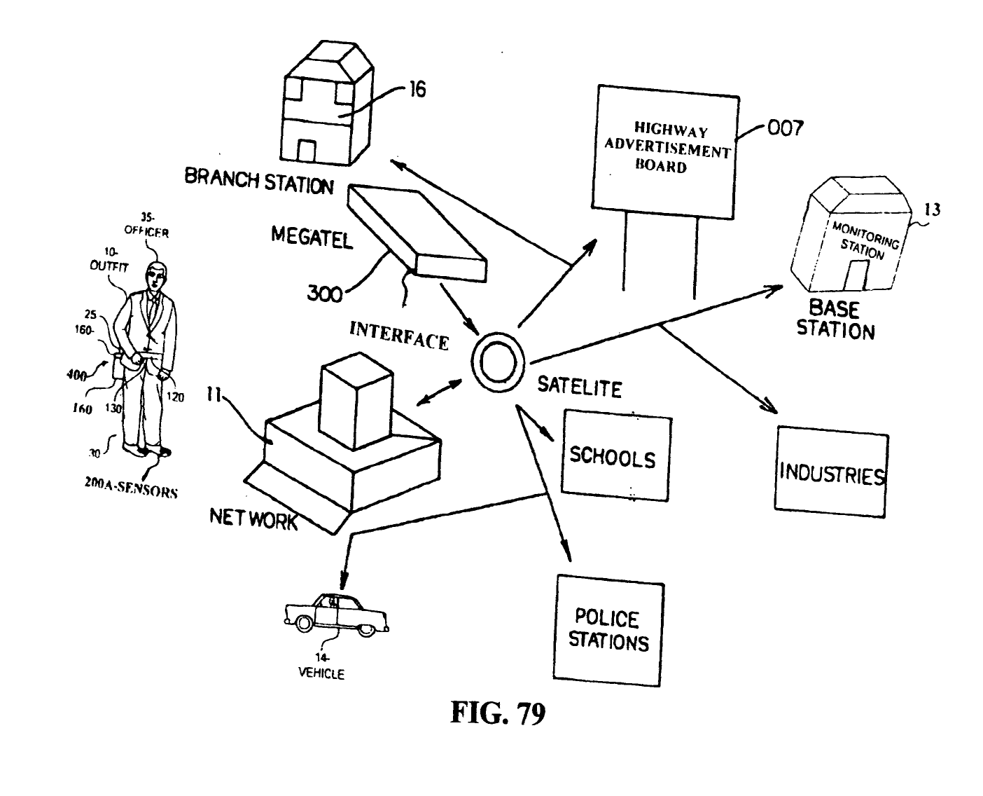

Referring to FIG. 79 is seen exemplary embodiments of a communication apparatus 400 in communication with a network environment. A person 35 is seen wearing a detection outfit 10 comprising of sensors embedded in silicon substrate and fused/etched in a microfiber/nano-fiber material, the communication apparatus 400 is disposed in an outfit 160 comprising a housing being secured on the waist area 130 via a waist belt 120 by the person 35. The housing further comprises silicon substrate micro fiber being embedded with sensors and operatively configured for generating electrical energy. The communication apparatus 400 is communicatively configured with signal booster apparatus operable to prevent cancerous disease on the person 35. The communication apparatus 400 is further configured for network communications, including communicating with branch station 16 and/or the base station 13. The communication apparatus 400 comprises a detection platform being further configured with battery cells comprising power generator engine responsive to solar energy, vibration, sound, pressure force, and wind force. The detection platform is further configured with sensors embedded in silicon substrate micro fiber to detect traveling cancerous cells and/or circulating tumor cells “CTC” in cell phone user's blood through valuable information from perspiration. Disclosed embodiments provide the respective person 35 wearing outfits 10, 20, 30, 120, 160 and 130, further operable for detecting weapons of mass destructions. The person 35 is seen communicating through communication apparatus 400, and a second communication apparatus 300 is disposed in a vehicle 14. The communication apparatus 400 further comprises megatel 300 further comprising an interface device in communication with at least one of: a branch station 16, a highway sign 007, a base station 13, a satellite station, a school, a police station, a vehicle 14, and/or a network 11. The base station routes calls from communication apparatus 400 through a switching center, and the calls may be transferred to other cell phones, and other base station, including local land-line telephone system. With prior art devices the farther a cell phone is from the base station antenna, the higher the power level is needed to maintain the connection. This distance determines, in part, the amount of RF energy exposure to the user. Disclosed embodiment provide the detection platform comprising a cell-capture platform consisting of at least nano-structured substrates comprising silicon chip consist nano-tubs/nano-pillars being densely packed to provide effective sensory surface area to detect traveling CTC's. The cell capture platform further comprises at least a nano-chip device being configured to receive electric current to direct DNA probes from the detection platform to specific sites.

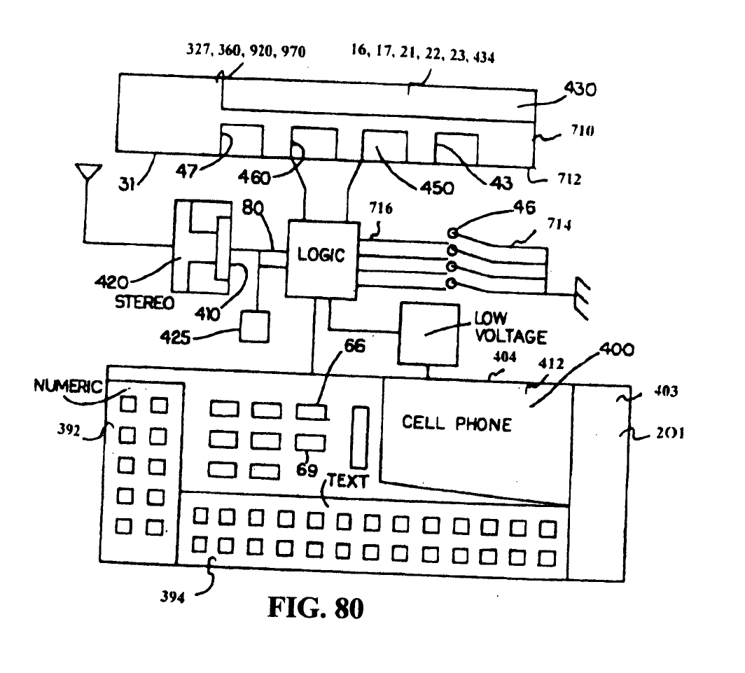

Referring to FIG. 80 is seen exemplary embodiments of the communication apparatus comprising a cell phone 400 configured with at least one of: a numerical pad 392, a text pad 394, a dialer 69, and/or an encoder 66. The numeric pad is separated from the text pad to enable easier access to text and/or numeric characters. Disclosed embodiments further provide communication apparatus 400 comprising methods and systems for generating and storing electrical energy. Certain embodiments comprise nano-materials 710 comprising microfiber/nano-fiber material. Disclosed embodiments further provide sensors 327, 360 920 and 970 being embedded in silicon substrate 712 and fused/etched in the microfiber/nano-fiber material 710 comprising materials with excellent electrical properties. The microfiber/nano-fiber material 710 includes material components with nanometer dimensions in which at least one dimension is less than 100 nanometers. Some embodiments provide the microfiber/nano-fiber materials being further configured with nano-wires/tubes 714. The nano-wires/tubes 714 being further embedded in the silicon substrate 712. Certain embodiments provide a communication apparatus 400 comprising the substrate 712, being configured with electrodes 716 in communication with the nano-wires/tubes 714. Embodiments further provide the electrode comprising at least temperature sensor. Other embodiments provide the nano-wires/tubes 714 comprising at least one component of: carbon char, carbon black, metal sulfides, metal oxides and other organic materials being alloyed with the microfiber/nano-fiber material 712. The communication apparatus 400 further comprises a logic circuit in communication with at least one of: signal booster chip 403 in communication with antenna 201, display device comprises input/output 404 comprising a touch screen 412, electronic switches 46, CPU 425, radio device 410, low voltage indicator, and/or a media device 420. The logic circuit is further connected to at least one of: a wireless Internet means 430, signal transmitting source 31, encoder 47, at least an electro-optical-modulator 460, a demodulator 450, at least one module 16, 17, 21, 22, 23, 434, diodes 80 and/or a decoder 43. Embodiments further provide the communication apparatus being configured with semiconductor devices being operable for higher scale of signal integration and functional intelligence, providing improved cellular communications and vehicular wireless Internet services. The logical circuitry is further configured for enabling effective computing. In the disclosure, numeric counts start from 0 to 9 on the numeric pad, while the text characters are on a text pad, with counts starting from 10 to 35. The arrangements of the counts are not absolute, as could further be arranged in different applications and settings. Separating numeric pads from text pads provide ease of computing.

NUMERIC NUMBERS TO DIGIDAL DIALING SYSTEM
“DECIMAL TO BINARY CONVERTION”

| DECIMAL | 0 | 1 | 2 | 3 | 4 | 5 | 6 | 7 | 8 | 9 | 10 |
|---|---|---|---|---|---|---|---|---|---|---|---|
| BINARY | 0 | 1 | 10 | 11 | 100 | 101 | 110 | 111 | 1000 | 1001 | 1010 |

| | TEXT | |
|---|---|---|
| DECIMAL | CHARACTER | BINARY |
| 10 | A | 1010 |
| 11 | B | 1011 |
| 12 | C | 1100 |
| 13 | D | 1101 |
| 14 | E | 1110 |
| 15 | F | 1111 |
| 16 | G | 10000 |
| 17 | H | 10001 |
| 18 | I | 10010 |
| 19 | J | 10011 |
| 20 | K | 10100 |
| 21 | L | 10101 |
| 22 | M | 10110 |
| 23 | N | 10111 |
| 24 | O | 11000 |
| 25 | P | 11001 |
| 26 | Q | 11010 |
| 27 | R | 11011 |
| 28 | S | 11100 |
| 29 | T | 11101 |
| 30 | U | 11110 |
| 31 | V | 11111 |
| 32 | W | 100000 |
| 33 | X | 100001 |
| 34 | Y | 100010 |
| 35 | Z | 100011 |

When the numeric and text character dialing system is used for assigning cell phone 400 numbers, the numbers will be digitized and coded to turn on series of switches representing 0s and 1s in digital counting. The 0s and 1s are the number of bright light and dark, a representation of the change of optical properties when exposed to electrical data source. Numeric numbers and text characters are converted to binaries and coded to speed up the counting processes.

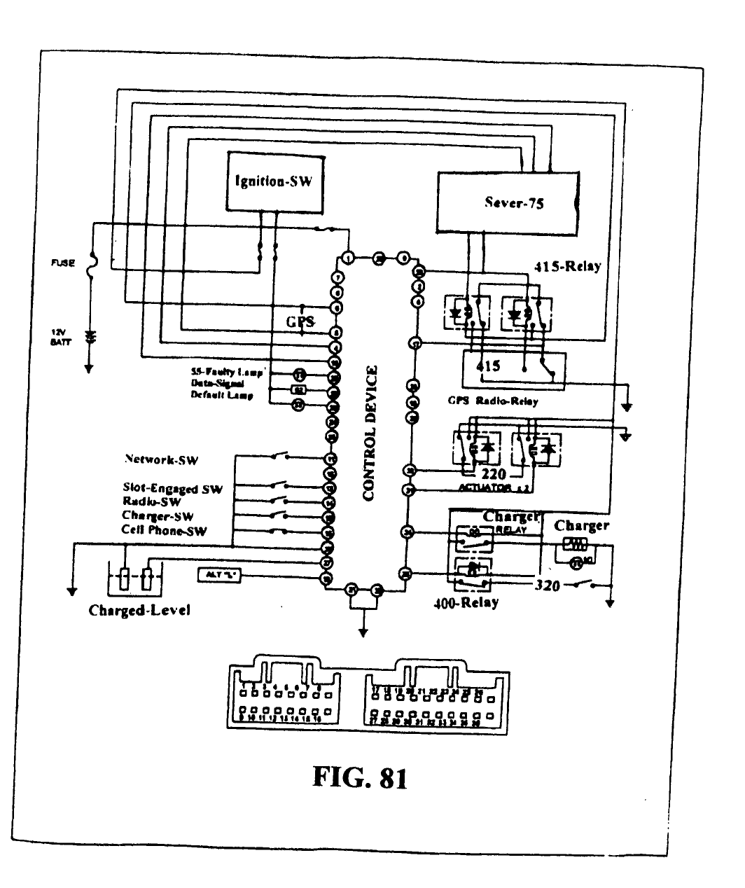

Referring to FIG. 81 is seen exemplary embodiments of the communication apparatus 400 operatively configured with a communication control apparatus. The communication apparatus further comprises at least one of: a cell phone device, social network platform, a server device, a GPS device, a radio device, an energy platform comprising a charging device, TV applications, a gaming device, energy production platform, a mobile broadband device, a webcam, a detection device, and a camera/video device. The communication apparatus is operatively configured with control device configured with transistorized switches in communication with at least one of: a relay device, an accelerometer, a cell platform, and detection platform. Embodiments further provide at least one of: fault indicator, date signal, charged indicator, at least a memory, at least an actuator, at least a chip, and at least a wireless communication device.

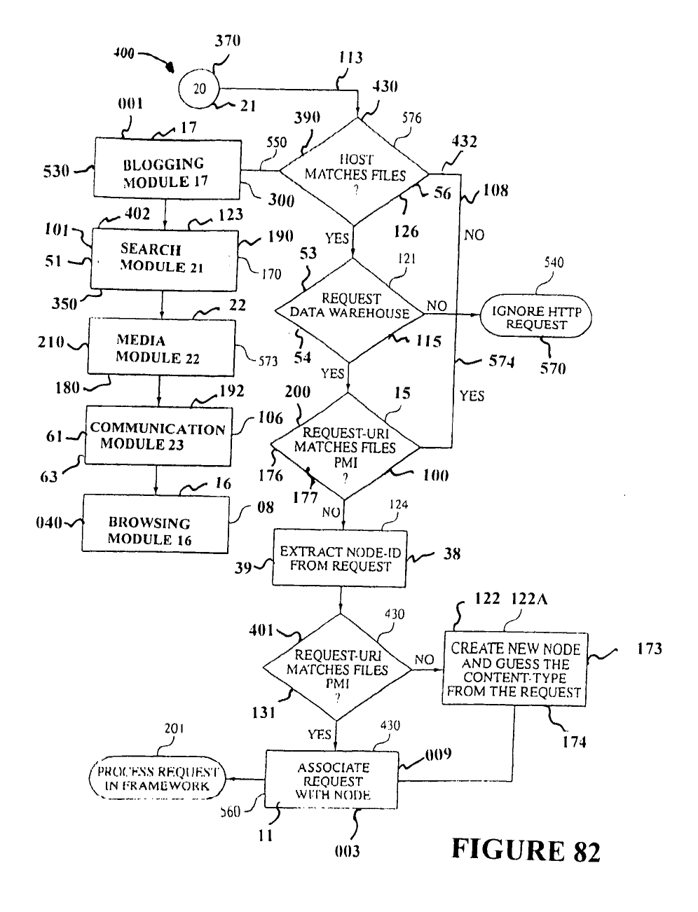

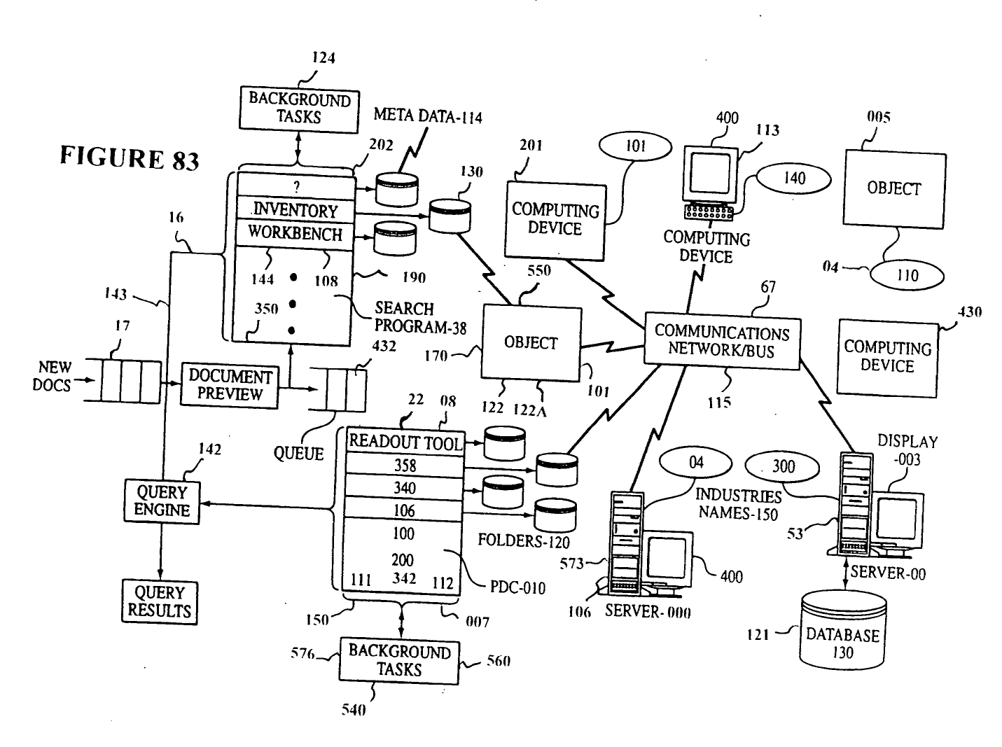

Referring to FIG. 82 is an exemplary illustration of a flowchart comprising intelligence logic for the communication apparatus 400. The communication apparatus comprises a blogging module 17 configured with application session layer 550 and software 300, a search module 190 in communication with network interface 170, a media module 22 configured with signal booster chip 573, a communication module 192 in communication with signal booster chip 573 and antenna circuit 106, and a browser module 16 in communication with a readout tool 08. At least a file memory device 53 is provided in communication with the software 300. Disclosed embodiments provide the communication apparatus 400 further comprising a data warehouse 121 communicatively connected to the search module 190 configured with a primary memory interface “PMI” 54. The PMI is further in communication with primary programs 15. Certain embodiments provide the communication apparatus configured with a personnel identification node “ID NODE” in communication with affinity analyzer 122 and data analyzer 122A. The media module 22 is communicatively connected to the media device 201, and the search module is communicatively connected to HTTP report generator 124 in communication with presentation layer 540. Some embodiments provide a computer apparatus 430 configured with a default gateway 432 in communication with a transport layer 560. Certain embodiments provide the communication apparatus operable on a platform 576 for processing mileage, fuel consumptions, host files, and personnel conditions/information. The PMI 54 further comprises at least a content file in communication with at least a subscription identifier 56, which is programmable for providing at least a hash table network 176. Disclosed embodiments provide the hash table network 176 further comprising a decentralized distribution of a structured reference documents consisting of battlefield topics of information. The distribution hash table 177 is operable for providing a lookup network service, providing connections and records, including a peer to peer network communications for battlefield personnel. At least one cache engine 350 is provided, operatively configured with at least one array operable for implementing steps for intercepting battlefield topics at network element. The network element comprises one or more battlefield data packets that at least a military personnel application addresses to a server application.

The search engine further comprises at least a markup language configured with at least one array for determining at least an application layer message that is contained in at least one portion of at least one data packets for specifying a particular request necessary for entering the searchable battlefield topics of information. The search engine 402 further comprises at least one of: a spider 173, a crawler 174, at least one is operable for disseminating battlefield topics of information. Embodiments further provide network environment 20 comprising a communication apparatus 400 configured for processing request in framework, in communication with remote computer systems configured for providing mileage readings and fuel consumptions. The communication apparatus 400 is further configured with search columns 21 and file columns 22. Certain embodiments provide the communication apparatus 400 configured with column 23 comprising forms 16, preventive maintenance programs “PMI” 15, and personnel files. Some embodiments provide the communication apparatus 400 configured with an indexer 108 in communication with at least a centralized data warehouse 121, social platform layer 574, and report generator 124. Other embodiments provide the communication apparatus 400 operable for data warehouse request. The communication apparatus is further configured to associate request with notes and to create new notes if a queried note with associated name does not exist, such as a falling personnel.

In the disclosure, request to URI is compared for matches to files and ignoring HTTP request is enabled. Embodiments provide apparatus operable for extracting notes that contains Identifications from request. The network environment comprises the communication apparatus 400 in communication with a computer system comprising a display device 003, a sound card 61, speakers 63, a cache engine 350, a network interface 170, a display adapter 59, intelligence logic, a media device 201, and a central processor 51. The communication apparatus further include an input device comprising at least a keyboard 009 and a mouse 11. The communication apparatus further include an IC card, SIM card, and interface. The CPU is operable with the intelligence logic to process commands and applications, in communication with memory 53, decision engine 123 and web-enabled devices. The network 21 may be responsive to communications through the Internet. Certain embodiments provide a communication apparatus configured with a browser, a server search report 39, and client search programs 38. Disclosed embodiments further provide a communication apparatus configured with graphic user interface 101 comprising interactive interface apparatus, a search program manager 126, a browser 040, an ICON 001, and storage medium comprising at least a meta-data and/or a database server 115. At least a web-page manager is provided comprising addresses 131, military base 200, available equipments 100, equipment ware houses 121 and a workbench 113 containing military topics of information. The computer system further comprises an affinity analyzer 122, a data analyzer 122A, a readout tool 08, a web-page 390, a report generator 124, files 401, and client interface operable with the software application 300.

At least one application layer 530 message is a java message consisting of battlefield topics of information configured for Web based applications. The search engine 402 further comprises structured military network environment 20 communicatively connected to at least one support system 210 comprising a social platform 573 configured with at least an index and/or a catalog comprising battlefield/personnel data. The data further includes at least one of; parts request, standard maintenance solution, preventive maintenance scheduling, preventive maintenance forms, fuel consumption log, mileage log, solutions to failed components, equipment request, parts graphics, name search, sounds, text content file, terrorist name monitoring, video, Internet protocol television 180 comprising a communication system, battlefield materials and/or tools, and at least global positioning system “GPS.” Disclosed embodiments further provide the communication apparatus 400 comprising at least one software program 300 further configured for communications with at least one support system 210 responsive to structured directory of battlefield topics and providing communications relating to at least battlefield topics of information in a network infrastructure. At least one support system 210 is further responsive to global communication via Intranet/Internet 370 for routing the occurrences of battlefield topics of information. Certain embodiments provide the computer apparatus 430 operatively configured with the software program 300. Some embodiments provide the software program 300 further comprises at least a protocol being programmed for providing directory approaches to routing battlefield topics of information and for analyzing at least an occurrence of the information. Other embodiments provide the information further comprises of keywords that are communicable to prioritize keywords in the list that frequently occur in a set of battlefield topics documents. Disclosed embodiments further provide the Internet protocol television 180 comprising apparatus for delivering Internet television services consisting of structured battlefield topics of information.

At least one protocol is operable for accessing and/or for delivering structured data containing battlefield topics of information over the Intranet/Internet 370. At least one computer apparatus 430 is configured to cause a computer device in communication with the cache engine 350, operable to apply integral reference content rate for each battlefield topics in at least a set of annotation type. The cache engine 350 is further operable for caching data operations being requested from at least one computer apparatus 430. The computer apparatus 430 is further operatively configured with at least one network data storage medium in communication with at least a network client. The network storage medium further comprising a cache memory for caching structural functions and further operable for requesting data structures comprising battlefield topics of information by personnel through the network environment 20. At least one software program is operatively configured with at least one support system 210, further comprising at least a mapping circuit comprising a lookup table which is indexed by a pattern ID value for providing at least one battlefield topics of information using at least a pattern responsive to at least a potential query of the topics. Disclosed embodiments further provide the communication apparatus 400 comprising a support system 210 configured with at least a chat function for topics of information comprising at least one of; personnel social network, battlefield project sharing and/or project development, transportation preventive maintenance, transportation services, transportation failure analysis, transportation solution to failed components, transportation fuel consumption, transportation mileage classifications, and transportation classifications and/or information, transportation equipment request, parts graphics, personnel physiological conditions, at least a name search, sounds, text, content file, video, Internet protocol television communication system, engineering/battlefield tools, and at least enemy information.

Referring to FIG. 83 is seen exemplary embodiments of the communication apparatus 400 comprising a query component configured with an indexer 108 in communication with an index manager 202. Embodiments further provide a network environment comprising a server 000,000 and a cache engine 350 in communication with functions 143 configured for operations with software 300. The functions 143 further include social platform 573 comprising social network environment operable to receive and transmit communications to at least one of: personnel information in a memory 53, enemy information in a memory/cabinet 007, further comprising a content store for battlefield topics of information. Disclosed embodiments further provide a centralized engine in a network system configured with server 00 and 000 comprising adaptors to maximize battlefield productivity and personnel longevity. Certain embodiments provide the server adaptor configured to allow personnel to personnel communication through the centralized search engine. Certain embodiments provide a centralized communication network system comprising a bus 67. The bus is further configured to periodically provide maintenance information for battlefield equipments, in communication with the URL. The URL may be modified at random times by at least a web master. The communication network bus 67 is further configured to produce a single link that either point to terrorist web site or their modified web site/enemy information by continuously finding, indexing, and cataloging the web pages. Some embodiments provide password module 140 in communication with the server adaptor software configured to automatically reroute traffic signals when any of the server port experiences a failure or is disconnected/interrupted. Other embodiments provide a query engine 142 in communications with files and forms modules being monitored by military personnel to allow access to multiple server files containing personnel data to enable prevention of any loss of information when the hardware experiences a failure.

Disclosed embodiments further provide the query engine 142 configured for communications with multiple file storage system being centralized for maximum protection and for providing real time query results. Certain embodiments provide the query engine 142 in communication with communication apparatus 400. The communication apparatus further comprising computer apparatus 430 configured with user interface 101 operable to centralized battlefield network system. Some embodiments provide the communication apparatus further comprises a PDC 010 configured with a switch to connect personnel system and servers together to create personnel server network within the system and a social environment for battlefield communications. Other embodiments provide the communication apparatus comprising application module 130 in communication with data warehouse 121, folders 120, readout tool 08, search program 38, and document parser 144. The document parser further includes new documents and battlefield/terrorist findings. Disclosed embodiments provide the search program 38 further comprising background tasks. The background tasks further include types of battlefield activities, transportation 340, failed components 342, stations 100, personnel base 200, station names 150, government agencies 111, and bunker 112. Some embodiments further provide the backup storage software operable for providing backup file scheduling such as tape backups and server file storage backups. The backup storage further allows the centralized battlefield system access to remotely recover any lost file. Other embodiments provide the communication network bus 67 operable to eliminate single point failure. In the disclosed embodiments, indexer 108 is provided for storing of links pointing to information resources including some or all of the data associated with the information resource, including workbench 113, inventory 114, and term center 115. The query engine 142 further provides objects 110 stored in graphical hardware 04. The objects are displayable on display devices 003. Certain embodiments provide the communication apparatus comprising a memory consisting of the content store in communication with input devices. Some embodiments provide the content store comprising database containing topics of information for advancing science, engineering, and transportation knowledge in battlefield operations. The input device is further operable to receive and transmit query, and in communication with listings and/or combine posting relating to battlefield topics of information. At least a display adaptor is communicatively connected to the posting and/or the listings.

Certain embodiments provide the network environment comprising the communication apparatus 400 being configured with intelligence logic comprising a blogging module 17 in association with the session layer 550 and software 300. Disclosed embodiments provide the communication apparatus 400 further comprising a search module 190 in communication with network interface 170, a media module 22 configured with signal booster chip 573, a communication module 23 in communication with signal booster chip 573 and antenna circuit 106, and a browser module 16 in communication with a readout tool 08. At least a file memory is provided in communication with the software 300. The data warehouse 121 further comprises database server communicatively connected to the search module 190. The search module 190 is configured with a primary memory interface “PMI” in communication with primary programs 15. Disclosed embodiments further provide a communication apparatus configured with at least personnel identification node “ID NODE” in communication with affinity analyzer 122 and data analyzer 122A. The media module is communicatively connected to the media device 201, and the search module is communicatively connected to HTTP report generator 124 in communication with presentation layer 540. Some embodiments provide a communication apparatus configured with a default gateway 432 in communication with a transport layer 560.

Certain embodiments provide the communication apparatus operable with means 576 for categorizing science, transportation and engineering files for battlefield operations referenced by initial search results. Certain embodiments provide the means for categorizing files further comprising implementing at least a method for receiving at least a query that maps to objects identifier for battlefield topics of information. Some embodiments further provide the means 576 configured with at least a neural network in communications with at least a cache engine operable for responding to battlefield topic requests using a server response data that is cached at a network. Disclosed embodiments further provide the network comprising network element operable with at least a programmable architecture configured with at least a dedicated processing elements. Certain embodiments provide the communication apparatus communicatively connected to the interactive interface apparatus in communication with at least a link to at least a profile configured for providing network services relating to battlefield topics of information.

While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the following claims;

What is claimed:

1. Homeland intelligence and battlefield apparatus for detecting weapons of mass destructions and for monitoring physiological conditions of a person; comprising:
at least a wearable apparatus;
at least a communication apparatus in communication with said wearable apparatus; and
at least a sensor apparatus disposed with said wearable apparatus.

2. Homeland intelligence and battlefield apparatus of claim 1, wherein said wearable apparatus comprises at least an outfit.

3. Homeland intelligence and battlefield apparatus of claim 1, wherein said wearable apparatus comprises is worn by at least a person.

4. Homeland intelligence and battlefield apparatus of claim 1, wherein said wearable apparatus comprises at least a military camouflage.

5. Homeland intelligence and battlefield apparatus of claim 1, wherein said sensor apparatus comprises at least a tire apparatus comprising a detection platform.

6. Homeland intelligence and battlefield apparatus of claim 5, wherein said tire apparatus configured to detect at least one of: weapons of mass destructions; tire pressure; tire temperature; tire balance; contextual characteristics influential to tire pressure change; contextual characteristics influential to environmental change; contextual characteristics influential to proper vehicle operation; explosives; battlefield environmental conditions.

7. Homeland intelligence and battlefield apparatus of claim 1, wherein said wearable apparatus configured with means to power itself.

8. Homeland intelligence and battlefield apparatus of claim 1, wherein said wearable apparatus comprises means to detect at least one of: sound; voice; weapons of mass destructions; personnel locations/positions; personnel physiological conditions; biological agent; chemical agent; nuclear agent; explosives; concealed weapons; bleeding.

9. Homeland intelligence and battlefield apparatus of claim 1, wherein said wearable apparatus further comprises a protective apparatus configured with at least miniaturized alloyed material to further prevent at least bullet penetration.

10. Homeland intelligence and battlefield apparatus of claim 1, wherein said wearable apparatus further comprises at least a platform for detection; further comprising means for converting at least one of: solar energy; sound wave; vibration; motion; force/pressure; wind; into electrical energy to power itself.

11. Homeland intelligence and battlefield apparatus of claim 1, wherein said wearable apparatus comprises at least one of: GPS device; detection device; communication device; mobile device; portable device; transportable device; wireless device; DNA device; network device.

12. Homeland intelligence and battlefield apparatus of claim 1, wherein said communication apparatus communicatively connected to said wearable apparatus to perform at least one of: analyze detection signal; enable wireless communications to at least a remote station; enable communications to at least a command post; enable peer to peer communications.

13. Homeland intelligence and battlefield apparatus of claim 1, wherein said communication apparatus further comprises at least an energy platform operable to generate electrical energy to power itself.

14. Homeland intelligence and battlefield apparatus of claim 1, wherein said communication apparatus further comprises multiple antenna apparatus disposed in at least a chip.

15. Homeland intelligence and battlefield apparatus of claim 1, wherein said communication apparatus further comprises multiple antenna apparatus comprising on chip CMOS silicon substrate.

16. Homeland intelligence and battlefield apparatus of claim 1, wherein said communication apparatus further configured with on chip signal booster apparatus.

17. Homeland intelligence and battlefield apparatus of claim 1, wherein said communication apparatus further configured with said sensor apparatus to provide at least a detection platform.

18. Homeland intelligence and battlefield apparatus of claim 1, wherein said communication apparatus comprises at least an input/output device comprising at least a computer apparatus configured with at least a display apparatus comprising at least one of: at least a keyboard; at least a graphic user interface.

19. Homeland intelligence and battlefield apparatus of claim 1, wherein said communication apparatus in communication with at least a microprocessor in association with at least a CMOS configured with at least one of: at least one antenna apparatus; at least a meta-material; said antenna apparatus is further opened on at least one end and shorted on at least one end; further comprises CMOS intra-chip antennas comprising at least one of: a radio frequency transceiver; an RF transmitter; an IR transmitter; a transducer; an IR transceiver; a receiver; a transmitter.

20. Homeland intelligence and battlefield apparatus of claim 1, wherein said communication apparatus further comprises at least one of: at least a video communication apparatus; at least a SIM card processor; at least a communication controller; at least a media device; at least an entertainment device; at least a memory device; at least a search engine module; at least a storage device; at least an intra-chip device; at least an IC card processor; at least a faster data transmission device operable at speed of at least 5 GHz frequency; at least a faster data transmission device operable at speed of at least 20 GHz frequency; at least a faster data transmission device operable at speed of at least 60 GHz frequency.

21. Homeland intelligence and battlefield apparatus of claim 1, wherein said sensor apparatus comprises at least one of: a detection device; WLAN device; WPAN device; MVPN device; MPLS device; a WBAN device; a search engine device; a browser device; a router module; a traffic module; a tunnel module; a network apparatus.

22. Homeland intelligence and battlefield apparatus of claim 1, wherein said communication apparatus further comprises power management module configured to control power flow from at least a source to at least one of: an energy storage medium; a battery cell; a capacitor; a cell apparatus; a microprocessor module; a CMOS antenna apparatus; and wherein said at least one source further include at least one of: carbon char; carbon black; metal sulfides; metal oxides; organic materials; textile fibers; zinc oxide (ZnO); nano-wires; piezoelectric crystals; a sensory layer; wet etching; dry etching; electron-silicon substrate-oxide; metal oxide semiconductor; optical properties; glass fiber; substrate micro fiber; cell platform; solar cell; meta-material; wherein said at least one source is alloyed with silicon substrate microfiber/nano-fiber material.

23. Homeland intelligence and battlefield apparatus of claim 1, wherein said communication apparatus further configured with at least one of: signal amplifier comprising at least a variable gain module; social network platform; video recognition platform; voice over text platform; text to voice enabled/conversion platform; TDMA platform; WCDMA platform; CDMA platform; TDMB platform; digital/analog/GSM platform; GPS platform; GPRS platform; TIHW platform; MFSCD platform; frequency authentication platform; multiple input/output platform; EDGSM platform; EDMA platform; OFDM platform; OFDMA platform; Wi-Fi platform; Wi-Max platform; wireless library platform; educational module; touch screen sensory platform; phone book; electronic book; electronic reader; dictionary; calendar; calculator; Internet service applications; energy generating apparatus; gaming apparatus; multiple paths switching antenna; Internet service connectivity operable for global roaming.

24. Homeland intelligence and battlefield apparatus of claim 1, wherein said communication apparatus further comprises semiconductor circuit board configured with CMOS multiple antennas on at least a chip; comprising at least one of: baseband analog digital circuit; multi-antenna receiver front-end; spatial multiplexing; spatial diversity; beam forming; orthogonal code-modulation; multi-antenna signal paths; matched filters; path-sharing of multiple RF signals; single pole switchable antenna; integrated antenna switch in CMOS SOI substrate; phased antenna array configured with a programmable phase shift; multiple RF/baseband chains; Code-Modulated Path-Sharing Multi-Antenna receiver; non orthogonal code-modulation receiver; shared-path blocks.

25. Homeland intelligence and battlefield apparatus of claim 1, wherein said wearable apparatus and/or said communication apparatus comprises force responsive sensors formed in at least one of: a deformable area of the wearable/communication apparatus; a substantially non-deformable area of the wearable/communication apparatus; said force responsive sensor operable to perform at least one of: calculate an applied force on at least a surface based on at least a change in resistance in at least a force sensitive portion; activate at least a component configured to execute a plurality of actions in response to at least a force value; wherein said change in resistance controls an intensity of an action based on said force value, wherein at least an action is selected from a plurality of actions based on the force value.

26. Homeland intelligence and battlefield apparatus of claim 1, wherein said communication apparatus operable to perform at least one of: transmitting signal communications to at least a communication network; receiving signal communications from at least a communication network; sending information to identify the communication network; sending information to identify the type of communication apparatus requesting communications with the communication network.

27. Homeland intelligence and battlefield apparatus; comprising:
at least a vessel apparatus;
at least a turbine assembly disposed with said vessel apparatus; and
said turbine assembly in communication with at least a generator assembly.

28. Homeland intelligence and battlefield apparatus of claim 27, wherein said turbine assembly is configured to generate renewable electrical energy.

29. Homeland intelligence and battlefield apparatus of claim 27, wherein said vessel apparatus is configured with at least one of: a pump apparatus; a storage apparatus; an evaporator chamber; a condenser chamber; an electrolysis apparatus.

30. Homeland intelligence and battlefield apparatus of claim 27, wherein said vessel apparatus configured for producing energy.

31. Homeland intelligence and battlefield apparatus of claim 30, wherein said energy comprises at least one of: electrical energy; desalinated water; hydrogen; methane; salt; oxygen; burnable oil.

32. Homeland intelligence and battlefield apparatus of claim 27, wherein said vessel apparatus further comprises at least one of: a transportable vessel; a fixed vessel; a submersible vessel; a mobile vessel; a propel-able vessel; a drive-able vessel.

33. Homeland intelligence and battlefield apparatus of claim 30, wherein said energy may be produced on demand.

34. Homeland intelligence and battlefield apparatus of claim 27, wherein said vessel apparatus comprises at least energy platform.

35. Homeland intelligence and battlefield apparatus of claim 34 wherein said vessel apparatus is crane loaded.

36. Homeland intelligence and battlefield apparatus of claim 27, wherein said vessel apparatus is motor driven.

37. Homeland intelligence and battlefield apparatus of claim 27, wherein said vessel apparatus is disposed on at least an ocean.

38. Homeland intelligence and battlefield apparatus of claim 27, wherein said vessel apparatus is further configured to provide homeland and/or battlefield personnel with at least one of: drinkable water; electrical energy; electrification; hydrogen; burnable oil; salt; renewable energy; transportable energy; transformable energy; methane.

39. Homeland intelligence and battlefield apparatus of claim 30, wherein said energy may be transportable via grids.

40. Homeland intelligence and battlefield apparatus of claim 27, wherein said vessel apparatus is an offshore energy plant.

41. Homeland intelligence and battlefield apparatus of claim 1, wherein said communication apparatus comprises at least one of: a detection device; WLAN device; WPAN device; MVPN device; MPLS device; a search engine device; a browser device; a network apparatus.

42. Homeland intelligence and battlefield apparatus of claim 1, wherein said communication apparatus comprises CMOS multiple antenna on chip apparatus configured to perform at least one of: convert electromagnetic energy into electrical energy; convert at least one of: sound, wind force, motion, vibration, solar energy into electrical energy; boost signal communications; amplify signal communications; accelerate data transmission; accelerate data download; monitor battlefield communications; monitor enemy communication lines.

43. Homeland intelligence and battlefield apparatus of claim 31, wherein said energy further comprises at least one of: drinkable; burnable; useable; transportable; renewable; cookable; process-able; produce-able; transformable; electrifiable; loadable; storable; transmittable; radiate-able; and may be produce on demand.

44. Homeland intelligence and battlefield apparatus of claim 1, wherein said sensor apparatus embedded in at least a silicon substrate and fused/etched in at least a micro-fibered material comprising at least a material with at least electrical characteristics.

45. Homeland intelligence and battlefield apparatus of claim 1, further comprises apparatus for measuring heart rate.

46. Homeland intelligence and battlefield apparatus of claim 1, wherein said communication apparatus further comprises at least one of: command post; local area network; wireless network; a GPS antenna; at least a support system in communication with at least a network; a cache engine; a neural network; a private virtual network; a multiprotocol label switching; at least a neural network in communication with at least a cache engine; at least a cache engine responsive to at least referenced document topics of information.

47. Homeland intelligence and battlefield apparatus of claim 1, wherein said wearable apparatus further comprises at least a sensor means responsive to at least characteristics influential to environmental change.

48. Homeland intelligence and battlefield apparatus of claim 1, wherein said sensor apparatus further comprises at least nanotechnology application comprising at least one of: MEMS; RFID; CMOS; silicon; substrate; polymers; microfiber/nano-fiber; EPROM; processor.

49. Homeland intelligence and battlefield apparatus of claim 27, wherein said vessel apparatus further comprises at least a floating platform.

50. Homeland intelligence and battlefield apparatus of claim 27, wherein said vessel apparatus further disposed with at least one of: mooring apparatus; desalination apparatus; storage apparatus; hydrogen apparatus; energy apparatus; hydropower apparatus; water current energy extraction apparatus.

51. Homeland intelligence and battlefield apparatus of claim 1, wherein said communication apparatus further comprises at least one of: apparatus for converting at least electromagnetic radiation into electrical energy; internet protocol network device; integrated access device; compiler apparatus; tunnel control module; network device module; network address translator implementation module; voice over tunnel protocol telephone; voice call module; network to network connectivity module; a cable modem; a digital subscriber line modem; a set-top-box; apparatus for forwarding traffic to remote network devices; a router; a computer game console; traffic source and destination address module; traffic/tunnel rule implementation module; a personal computer “PC.”

52. Homeland intelligence and battlefield apparatus of claim 1, wherein said communication apparatus further configured for enabling at least one of: faster data transmission; wireless cognitive connectivity; mm-wave connectivity; signal booster; energy saver; front-end baseband; spectrum sensing; digital CMOS transceiver; CMOS system-in-package; wireless transceiver; wireless body area networks “WBAN;” software defined communications “SDC;” software defined radios “SDR;” programmable flexible baseband platform; scalable data converter circuit.

53. Homeland intelligence and battlefield apparatus of claim 1, wherein said sensor apparatus in association with said communication apparatus for providing at least one of: seamless connectivity; horizontal roaming; vertical roaming; reconfigurable radio signal platform; multimode operations; digital radio frequency transceiver; surface acoustic wave-less transceiver; surface acoustic wave transceiver; multi-stream baseband processing; flexible error coding; multiprocessor; higher frequency band; short range communication applications; high security characteristics; reusable frequency; uncompressed video transmission; uncompressed video distribution; faster video transmission; faster download video data; communication channel detector; MULTIMEDIA PLATFORM.

54. Homeland intelligence and battlefield apparatus of claim 1, wherein said communication apparatus further comprises at least one of: miniaturized transistors; apparatus for higher switching speed; millimeter wave analog radio circuit; analog and digital radio on-chip CMOS baseband; millimeter wave module; narrow band radios; CMOS multiple antennas integrated in at least a chip; on-chip miniaturized antenna elements; antenna and antenna interface; broadband and MIMO system; CMOS integration and system level modeling; beam forming apparatus; integrated antenna arrays; energy efficient sensor nodes; event driven radios; energy efficient sensor module; wireless sensor networks; analog front-end silicon integration; systems-on-chip-integration; system-in-package-integration; impulse radios; Internet protocol television communication apparatus.
